(19) United States
(12) Patent Application Publication
(10) Pub. No.: US 2023/0045237 A1
(43) Pub. Date: Feb. 9, 2023

(54) WEARABLE APPARATUS FOR ACTIVE SUBSTITUTION

(71) Applicant: OrCam Technologies Ltd., Jerusalem (IL)

(72) Inventors: Yonatan Wexler, Jerusalem (IL); Amnon Shashua, Mevaseret Zion (IL)

(73) Assignee: OrCam Technologies Ltd., Jerusalem (IL)

(21) Appl. No.: 17/788,940

(22) PCT Filed: Dec. 31, 2020
(86) PCT No.: PCT/IB2020/001055

§ 371 Date: Jun. 24, 2022

Related U.S. Application Data
(60) Provisional application No. 62/956,744, filed on Jan. 3, 2020.
(60) Provisional application No. 62/970,726, filed on Feb. 6, 2020.
(60) Provisional application No. 63/050,890, filed on Jul. 13, 2020.

(51) Int. Cl. H04R 25/00; G06T 7/70

(52) U.S. Cl. CPC H04R 25/505; G06T 7/70; G06T 2207/30201; G10L 17/22

(57) ABSTRACT

A hearing aid and related systems and methods. In one implementation, a hearing aid system may comprise a wearable camera configured to capture images from an environment of a user, a microphone configured to capture sounds from the environment of the user, and a processor. The processor may be programmed to receive images captured by the camera; receive audio signals representative of sounds captured by the microphone; operate in a first mode to cause a first selective conditioning of a first audio signal; determine, based on analysis of at least one of the images or the audio signals, to switch to a second mode to cause a second selective conditioning of the first audio signal; and cause transmission of the first audio signal selectively conditioned in the second mode to a hearing interface device configured to provide sound to an ear of the user.

### CROSS REFERENCES TO RELATED APPLICATIONS

This application claims the benefit of priority of U.S. Provisional Patent Application No. 62/956,744, filed on Jan. 3, 2020; U.S. Provisional Patent Application No. 62/970,726, filed on Feb. 6, 2020; and U.S. Provisional Patent Application No. 63/050,890, filed on Jul. 13, 2020. All of the foregoing applications are incorporated herein by reference in their entirety.

### BACKGROUND

### Technical Field

This disclosure generally relates to devices and methods for capturing and processing images and audio from an environment of a user, and using information derived from captured images and audio.

### Background Information

Today, technological advancements make it possible for wearable devices to automatically capture images and audio, and store information that is associated with the captured images and audio. Certain devices have been used to digitally record aspects and personal experiences of one's life in an exercise typically called “lifelogging.” Some individuals log their life so they can retrieve moments from past activities, for example, social events, trips, etc. Lifelogging may also have significant benefits in other fields (e.g., business, fitness and healthcare, and social research). Lifelogging devices, while useful for tracking daily activities, may be improved with capability to enhance one's interaction in his environment with feedback and other advanced functionality based on the analysis of captured image and audio data.

Even though users can capture images and audio with their smartphones and some smartphone applications can process the captured information, smartphones may not be the best platform for serving as lifelogging apparatuses in view of their size and design. Lifelogging apparatuses should be small and light, so they can be easily worn. Moreover, with improvements in image capture devices, including wearable apparatuses, additional functionality may be provided to assist users in navigating in and around an environment, identifying persons and objects they encounter, and providing feedback to the users about their surroundings and activities. Therefore, there is a need for apparatuses and methods for automatically capturing and processing images and audio to provide useful information to users of the apparatuses, and for systems and methods to process and leverage information gathered by the apparatuses.

### SUMMARY

Embodiments consistent with the present disclosure provide devices and methods for automatically capturing and processing images and audio from an environment of a user, and systems and methods for processing information related to images and audio captured from the environment of the user.

In an embodiment, a hearing aid system for selectively conditioning sounds is provided. The hearing aid system includes a wearable camera configured to capture a plurality of images from an environment of a user and at least one microphone configured to capture sounds from the environment of the user. Further, the hearing aid system includes at least one processor programmed to receive the plurality of images captured by the camera, receive a plurality of audio signals representative of sounds captured by the at least one microphone from the environment of the user, and operate in a first mode to cause a first selective conditioning of a first audio signal of the plurality of audio signals. The processor is further programmed to determine, based on analysis of at least one of the plurality of images or the plurality of audio signals, to switch to a second mode to cause a second selective conditioning of the first audio signal, the second selective conditioning differing in at least one aspect relative to the first selective conditioning. The processor is further programmed to cause transmission of the first audio signal selectively conditioned in the second mode to a hearing interface device configured to provide sound to an ear of the user.

In an embodiment, a hearing aid system for selectively conditioning sounds is provided. The hearing aid system includes a wearable camera configured to capture a plurality of images from an environment of a user and at least one microphone configured to capture sounds from the environment of the user. The hearing aid system further includes at least one processor programmed to receive the plurality of images captured by the camera, receive a plurality of audio signals representative of sounds captured by the at least one microphone from the environment of the user, and operate in a plurality of modes, wherein the plurality of modes includes a first mode and a second mode, wherein operating in the first mode causes a first selective conditioning of at least one audio signal of the plurality of audio signals, and wherein operating in the second mode causes a second selective conditioning of the at least one audio signal, the second selective conditioning differing in at least one aspect relative to the first selective conditioning. Further, the processor is programmed to select, based on analysis of at least one of the plurality of images or the plurality of audio signals, the first mode or the second mode, and cause transmission of the at least one audio signal, selectively conditioned based on the selected mode, to a hearing interface device configured to provide sound to an ear of the user.

In an embodiment, a hearing aid system for selectively conditioning sounds is provided. The hearing aid system includes a wearable camera configured to capture a plurality of images from an environment of a user, at least one microphone configured to capture a plurality of audio signals from the environment of the user, and at least one processor. The processor is programmed to receive the plurality of images captured by the camera, receive a plurality of audio signals representative of sounds captured by the at least one microphone from the environment of the user, identify at least one recognized individual represented by at least one of the plurality of images or by at least one of the plurality of audio signals, and retrieve, from a storage, a conditioning profile associated with the at least one recognized individual. Further, the processor is programmed to cause selective conditioning of a first audio signal of the plurality of audio signals associated with the at least one recognized individual, the selective conditioning being determined based on the conditioning profile and cause transmission of the conditioned first audio signal to a hearing interface device configured to provide sound to an ear of the user.

In an embodiment, a hearing aid system for selectively conditioning sounds is provided. The hearing aid system includes a wearable camera configured to capture a plurality of images from an environment of a user, at least one microphone configured to capture a plurality of audio signals from the environment of the user, and at least one processor. The processor is programmed to receive the plurality of images captured by the camera, receive a plurality of audio signals representative of sounds captured by the at least one microphone from the environment of the user, identify a group of individuals represented by at least one of the plurality of images or by at least one of the plurality of audio signals and retrieve, from a storage, a conditioning profile associated with the group of individuals. The processor is programmed to cause selective conditioning of a first audio signal of the plurality of audio signals associated with the group of individuals, the selective conditioning being determined based on the conditioning profile and cause transmission of the conditioned first audio signal to a hearing interface device configured to provide sound to an ear of the user.

In an embodiment, a hearing aid system for selectively amplifying sounds may include a wearable camera configured to capture a plurality of images from an environment of a user, at least one microphone configured to capture sounds from the environment of the user, and at least one processor. The processor may be programmed to receive the plurality of images captured by the wearable camera; receive at least one audio signal representative of sounds captured by the at least one microphone from the environment of the user; identify, based on analysis of at least one of the plurality of images or the at least one audio signal, at least one action of the user; cause, based on the identified action, selective conditioning of the at least one audio signal received by the at least one microphone; and cause transmission of the at least one conditioned audio signal to a hearing interface device configured to provide sound to an ear of the user.

In an embodiment, a method for selectively amplifying sounds may include capturing, by a wearable camera, a plurality of images from an environment of a user; capturing, by at least one microphone, sounds from the environment of the user; receiving the plurality of images captured by the wearable camera; receiving at least one audio signal representative of sounds captured by the at least one microphone from the environment of the user; identifying, based on analysis of at least one of the plurality of images or the at least one audio signal, at least one action of the user; causing, based on the identified action, selective conditioning of the at least one audio signal received by the at least one microphone; and causing transmission of the at least one conditioned audio signal to a hearing interface device configured to provide sound to an ear of the user.

In an embodiment, a hearing aid system for selectively amplifying sounds may include a wearable camera configured to capture a plurality of images from an environment of a user, at least one microphone configured to capture sounds from the environment of the user, and at least one processor. The processor may be programmed to receive the plurality of images captured by the camera; identify a representation of a first individual in at least one of the plurality of images; receive audio signals representative of sounds captured by the at least one microphone; identify, based on analysis of the audio signals, a first audio signal associated with a first voice associated with the first individual, and a second audio signal associated with a second voice of a second individual; cause selective conditioning of the first audio signal based on a determination by the at least one processor that the first audio signal is associated with a priority that is higher than a priority of the second audio signal; and cause transmission of the selectively conditioned first audio signal to a hearing interface device configured to provide sound to an ear of the user.

In an embodiment, a method for selectively amplifying sounds may include capturing, by a wearable camera, a plurality of images from an environment of a user; capturing, by at least one microphone, sounds from the environment of the user; receiving the plurality of images captured by the wearable camera: identifying a representation of a first individual in at least one of the plurality of images; receiving audio signals representative of sounds captured by the at least one microphone; identifying, based on analysis of the audio signals, a first audio signal associated with a first voice associated with the first individual, and a second audio signal associated with a second voice of a second individual; causing selective conditioning of the first audio signal based on a determination by the at least one processor that the first audio signal is associated with a priority that is higher than a priority of the second audio signal; and causing transmission of the selectively conditioned first audio signal to a hearing interface device configured to provide sound to an ear of the user.

In an embodiment, a hearing aid system may selectively amplifying sounds. The hearing aid system may include a wearable camera device, the wearable camera device comprising: at least one camera configured to capture a plurality of images from an environment of a user; at least one microphone configured to capture sounds from the environment of the user; and at least one first processor programmed to selectively condition audio signals received from the at least one microphone representative of the sounds captured by the at least one microphone; and a hearing aid device, the hearing aid device comprising: at least one speaker configured to provide sound to an ear of the user; and at least one second processor programmed to: cause transmission of one or more instructions to the wearable camera device; receive, from the wearable camera device, the conditioned audio signals; and provide, based on the conditioned audio signals, sound to the ear of the user using the at least one speaker.

In an embodiment, a method for amplifying sounds in a hearing aid system may include capturing a plurality of images from an environment of a user wearable using at least one camera of a wearable camera device; capturing sounds from the environment of the user using at least one microphone of the wearable camera device; selectively conditioning, using at least one first processor, audio signals received from the at least one microphone representative of the sounds captured by the at least one microphone; and providing sound to an ear of the user using at least one speaker of a hearing aid device by using at least one second processor of the hearing aid device programmed to: cause transmission of one or more instructions to the wearable camera device; receive, from the wearable camera device, the conditioned audio signals: and provide, based on the conditioned audio signals, sound to the ear of the user using the at least one speaker.

In an embodiment, a hearing aid system for selectively amplifying sounds include a wearable camera configured to capture a plurality of images from an environment of a user, the wearable camera having an image capture parameter; at least one microphone configured to capture sounds from the environment of the user; and at least one processor programmed to: receive the plurality of images captured by the camera; receive audio signals representative of sounds captured by the at least one microphone; identify a representation of at least one individual in at least one of the plurality of images; detect, based on at least one of the plurality of images or the audio signals, a speech rate associated with the at least one individual; and cause, based on the detected speech rate, an adjustment to the image capture parameter of the wearable camera.

In an embodiment, a method for amplifying sounds includes receiving the plurality of images captured by a camera; receiving audio signals representative of sounds captured by at least one microphone; identifying a representation of at least one individual in at least one of the plurality of images; detecting, based on at least one of the plurality of images or the audio signals, a speech rate associated with the at least one individual: and causing, based on the detected speech rate, an adjustment to the image capture parameter of the wearable camera.

In an embodiment, a hearing aid system may comprise at least one microphone configured to capture sounds from an environment of the user; and at least one processor. The at least one processor may be programmed to receive an audio signal representative of the sounds captured by the at least one microphone; receive an indication of a time delay associated with processing the audio signal; store, in a buffer, a plurality of audio samples representing portions of the audio signal; and process a first audio sample of the plurality of audio samples to generate a processed first audio sample. Processing the first audio sample may comprise analyzing a second audio sample of the plurality of audio samples, the second audio sample being represented in the audio signal after the first audio sample and having a length defined by the time delay, wherein an audio quality of the processed first audio sample depends on the length of the second audio sample.

In an embodiment, a method for selectively amplifying audio signals is disclosed. The method may comprise receiving an audio signal representative of sounds received by at least one microphone from an environment of the user; receiving an indication of a time delay associated with processing the audio signal; storing, in a buffer, a plurality of audio samples representing portions of the audio signal; and processing a first audio sample of the plurality of audio samples to generate a processed first audio sample. Processing the first audio sample may comprise analyzing a second audio sample, the second audio sample being represented in the audio signal after the first audio sample and having a length defined by the time delay, wherein an audio quality of the processed first audio sample depends on the length of the second audio sample.

In an embodiment, a hearing aid system may comprise at least one microphone configured to capture sounds from an environment of the user; and at least one processor. The at least one processor may be programmed to receive an audio signal representative of the sounds captured by the at least one microphone; process the audio signal to generate a first processed audio signal using a first value of at least one aspect; and process the audio signal to generate a second processed audio signal using a second value of the at least one aspect, the second value being different from the first value. The at least one processor may further be programmed to compare the first processed audio signal to the second processed audio signal to select the first processed audio signal or the second processed audio signal based on a tradeoff between the at least one aspect and an audio quality of the first processed audio signal and the second processed audio signal; and transmit the selected processed audio signal to a hearing interface device of the user.

In an embodiment, a method for selectively amplifying audio signals is disclosed. The method may comprise receiving an audio signal representative of sounds received by at least one microphone from an environment of the user; processing the audio signal to generate a first processed audio signal using a first value of at least one aspect; and processing the audio signal to generate a second processed audio signal, using a second value of the at least one aspect, the second value being different from the first value. The method may further comprise comparing the first processed audio signal to the second processed audio signal to select the first processed audio signal or the second processed audio signal based on a tradeoff between the at least one aspect and an audio quality of the first processed audio signal and the second processed audio signal; and transmitting the selected processed audio signal to a hearing interface device of the user.

In an embodiment, a hearing aid system for selectively substituting audio signals may comprise a wearable camera configured to capture a plurality of images from an environment of a user, at least one microphone configured to capture sounds from an environment of the user; and at least one processor. The at least one processor may be programmed to receive the plurality of images captured by the camera; receive a plurality of audio signals representative of the sounds captured by the at least one microphone; and identify, based on analysis of the plurality of images or the plurality of audio signals, an audio signal from among the plurality of audio signals associated with a sound-emanating object in the environment of the user. The at least one processor may further be configured to predict, based on the plurality of audio signals, a sound that will be received at the ear of the user from the environment of the user; generate a cancelation audio signal configured to neutralize at least the predicted sound at the ear of the user; generate a selectively conditioned audio signal based on the identified audio signal; and transmit the cancelation audio signal and the selectively conditioned audio signal to a hearing aid interface device configured to provide sound to the ear of the user.

In an embodiment, a method for selectively substituting audio signals is disclosed. The method may comprise receiving a plurality of images captured by a wearable camera from an environment of a user; receiving a plurality of audio signals representative of sounds captured by at least one microphone from the environment of the user; and identifying, based on analysis of the plurality of images or the plurality of audio signals, an audio signal from among the plurality of audio signals associated with a sound-emanating object in the environment of the user. The method may further comprise predicting, based on the plurality of audio signals, a sound that will be received at the ear of the user from the environment of the user; generating a cancelation audio signal configured to neutralize at least the predicted sound at the ear of the user; generating a selectively conditioned audio signal based on the identified audio signal; and transmitting the cancelation audio signal and the selectively conditioned audio signal to a hearing aid interface device configured to provide sound to the ear of the user.

In an embodiment, a hearing aid system for selectively amplifying sounds includes a wearable camera configured to capture a plurality of images from an environment of a user, at least one microphone configured to capture sounds from the environment of the user, and at least one processor. The at least one processor is configured to receive the plurality of images captured by the camera; receive audio signals representative of sounds captured by the at least one microphone; determine, based on analysis of at least one of the plurality of images or the audio signals, a location of a sound emanating object; generate, based on the location of the sound emanating object, a stereo sound representation comprising a first audio signal and a second audio signal, the first audio signal differing from the second audio signal in at least one aspect to simulate the location of the object relative to the user; and cause transmission of the stereo sound representation to a hearing aid interface device configured to provide sound based on the first audio signal to a first ear of the user and sound based on the second audio signal to a second ear of the user.

In an embodiment, a method for selectively amplifying sounds includes receiving a plurality of images from an environment of a user, the images being captured by a wearable camera; receiving audio signals representative of sounds from the environment of the user, the sounds being captured by at least one microphone; determining, based on analysis of at least one of the plurality of images or the audio signals, a location of a sound emanating object; generating. based on the location of the sound emanating object, a stereo sound representation comprising a first audio signal and a second audio signal, the first audio signal differing from the second audio signal in at least one aspect to simulate the location of the object relative to the user; and causing transmission of the stereo sound representation to a hearing aid interface device configured to provide sound based on the first audio signal to a first ear of the user and sound based on the second audio signal to a second ear of the user.

In an embodiment, a hearing aid system for selectively amplifying sounds includes at least one microphone configured to capture sounds from an environment of a user; and at least one processor. The at least one processor is configured to receive a plurality of audio signals representative of sounds captured by the at least one microphone; identify a first audio signal of the plurality of audio signals, the first audio signal associated with an individual; process the first audio signal to selectively condition at least one voice trait of the individual; and cause transmission of the processed first audio signal to a hearing interface device configured to provide sound to an ear of the user.

In an embodiment, a method for selectively amplifying sounds includes receiving a plurality of audio signals representative of sounds captured by at least one microphone configured to capture sounds from an environment of a user; identifying a first audio signal of the plurality of audio signals, the first audio signal associated with an individual: processing the first audio signal to selectively condition at least one voice trait of the individual: and causing transmission of the processed first audio signal to a hearing interface device configured to provide sound to an ear of the user.

In an embodiment, a hearing aid system is provided. The hearing aid system may selectively condition sounds. The hearing aid system may include a wearable camera configured to capture a plurality of images from an environment of a user, the wearable camera having an image capture rate; at least one microphone configured to capture sounds from the environment of the user; and at least one processor. The processor may be programmed to receive the plurality of images captured by the camera; receive a plurality of audio signals representative of sounds captured by the at least one microphone; obtain a voice print associated with an individual within the environment of the user, the individual being identified based on at least one of the plurality of images or the plurality of audio signals; detect, based on analysis of the plurality of images, at least one lip movement associated with a mouth of the individual; identify, based on at least one of the voice print or the detected lip movement, a first audio signal of the plurality of audio signals associated with a voice of the individual; process the first audio signal; and cause transmission of the selectively conditioned first audio signal to a hearing interface device configured to provide sound to an ear of the user.

In an embodiment, a computer-implemented method for selectively conditioning sounds in a hearing aid system is provided. The method may comprise receiving a plurality of images from an environment of a user, the plurality of images being captured by a wearable camera. The method may also comprise receiving a plurality of audio signals representative of sounds captured by at least one microphone. The method may also comprise obtaining a voice print associated with an individual within the environment of the user, the individual being identified based on at least one of the plurality of images or the plurality of audio signals. The method may also comprise detecting, based on analysis of the plurality of images, at least one lip movement associated with a mouth of the individual. The method may also comprise identifying, based on at least one of the voice print or the detected lip movement, a first audio signal of the plurality of audio signals associated with a voice of the individual. The method may also comprise process the first audio signal. The method may further comprise causing transmission of the selectively conditioned first audio signal to a hearing interface device configured to provide sound to an ear of the user.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a schematic illustration of an example of a user wearing a wearable apparatus according to a disclosed embodiment.

FIG. 1B is a schematic illustration of an example of the user wearing a wearable apparatus according to a disclosed embodiment.

FIG. 1C is a schematic illustration of an example of the user wearing a wearable apparatus according to a disclosed embodiment.

FIG. 1D is a schematic illustration of an example of the user wearing a wearable apparatus according to a disclosed embodiment.

FIG. 2 is a schematic illustration of an example system consistent with the disclosed embodiments.

FIG. 3A is a schematic illustration of an example of the wearable apparatus shown in FIG. 1A.

FIG. 3B is an exploded view of the example of the wearable apparatus shown in FIG. 3A.

FIG. 4A-4K are schematic illustrations of an example of the wearable apparatus shown in FIG. 1B from various viewpoints.

FIG. 5A is a block diagram illustrating an example of the components of a wearable apparatus according to a first embodiment.

FIG. 5B is a block diagram illustrating an example of the components of a wearable apparatus according to a second embodiment.

FIG. 5C is a block diagram illustrating an example of the components of a wearable apparatus according to a third embodiment.

FIG. 6 illustrates an exemplary embodiment of a memory containing software modules consistent with the present disclosure.

FIG. 7 is a schematic illustration of an embodiment of a wearable apparatus including an orientable image capture unit.

FIG. 8 is a schematic illustration of an embodiment of a wearable apparatus securable to an article of clothing consistent with the present disclosure.

FIG. 9 is a schematic illustration of a user wearing a wearable apparatus consistent with an embodiment of the present disclosure.

FIG. 10 is a schematic illustration of an embodiment of a wearable apparatus securable to an article of clothing consistent with the present disclosure.

FIG. 11 is a schematic illustration of an embodiment of a wearable apparatus securable to an article of clothing consistent with the present disclosure.

FIG. 12 is a schematic illustration of an embodiment of a wearable apparatus securable to an article of clothing consistent with the present disclosure.

FIG. 13 is a schematic illustration of an embodiment of a wearable apparatus securable to an article of clothing consistent with the present disclosure.

FIG. 14 is a schematic illustration of an embodiment of a wearable apparatus securable to an article of clothing consistent with the present disclosure.

FIG. 15 is a schematic illustration of an embodiment of a wearable apparatus power unit including a power source.

FIG. 16 is a schematic illustration of an exemplary embodiment of a wearable apparatus including protective circuitry.

FIG. 17A is a schematic illustration of an example of a user wearing an apparatus for a camera-based hearing aid device according to a disclosed embodiment.

FIG. 17B is a schematic illustration of an embodiment of an apparatus securable to an article of clothing consistent with the present disclosure.

FIG. 18 is a schematic illustration showing an exemplary environment for use of a camera-based hearing aid consistent with the present disclosure.

FIG. 19 is a flowchart showing an exemplary process for selectively amplifying sounds emanating from a detected look direction of a user consistent with disclosed embodiments.

FIG. 20A is a schematic illustration showing an exemplary environment for use of a hearing aid with voice and/or image recognition consistent with the present disclosure.

FIG. 20B illustrates an exemplary embodiment of an apparatus comprising facial and voice recognition components consistent with the present disclosure.

FIG. 21 is a flowchart showing an exemplary process for selectively amplifying audio signals associated with a voice of a recognized individual consistent with disclosed embodiments.

FIG. 22 is a flowchart showing an exemplary process for selectively transmitting audio signals associated with a voice of a recognized user consistent with disclosed embodiments.

FIG. 23A is a schematic illustration showing an exemplary individual that may be identified in the environment of a user consistent with the present disclosure.

FIG. 23B is a schematic illustration showing an exemplary individual that may be identified in the environment of a user consistent with the present disclosure.

FIG. 23C illustrates an exemplary lip-tracking system consistent with the disclosed embodiments.

FIG. 24 is a schematic illustration showing an exemplary environment for use of a lip-tracking hearing aid consistent with the present disclosure.

FIG. 25 is a flowchart showing an exemplary process for selectively amplifying audio signals based on tracked lip movements consistent with disclosed embodiments.

FIG. 26 is a schematic illustration of an example of a user wearing an apparatus for a camera-based hearing aid device according to a disclosed embodiment.

FIGS. 27A and 27B are flowcharts showing exemplary processes for selectively conditioning audio signals consistent with disclosed embodiments.

FIGS. 28A and 28B are diagrams showing exemplary processes for selectively conditioning audio signals consistent with disclosed embodiments.

FIG. 29 is a schematic illustration of an example of a user wearing an apparatus for a camera-based hearing aid device according to a disclosed embodiment.

FIGS. 30A and 30B are flowcharts showing exemplary processes for selectively conditioning audio signals consistent with disclosed embodiments.

FIG. 31 is another flowchart showing an exemplary process for selectively conditioning audio signals consistent with disclosed embodiments.

FIG. 32 is a schematic illustration showing an exemplary environment for use of a hearing aid with voice and/or image recognition according to the disclosed embodiments.

FIG. 33 is an exemplary depiction of a user with a hearing aid system according to the disclosed embodiments.

FIG. 34 is a flowchart showing an exemplary process for selectively amplifying sounds according to the disclosed embodiments.

FIG. 35 is a schematic illustration showing an exemplary environment including a hearing aid with voice and/or image recognition according to the disclosed embodiments.

FIG. 36 is an illustration of an exemplary computing device for use with a hearing aid with voice and/or image recognition according to the disclosed embodiments.

FIG. 37 is a flowchart showing an exemplary process for selectively amplifying sounds according to the disclosed embodiments.

FIG. 38 is a schematic illustration of an example of a hearing aid system including a wearable camera device, a hearing aid device, and a mobile device, consistent with the disclosed embodiments.

FIG. 39 is a schematic illustration of an example of a hearing aid system attached to a user, consistent with the disclosed embodiments.

FIG. 40 is a flowchart showing an exemplary process for a hearing aid and paired camera system, consistent with the disclosed embodiments.

FIG. 41 is a schematic illustration of an example of a hearing aid system attached to a user, consistent with the disclosed embodiments.

FIG. 42 is a schematic illustration of an example of a hearing aid system capturing images and audio from an environment of a user, consistent with the disclosed embodiments.

FIG. 43 is a flowchart showing an exemplary process of the adjusting a capture parameter of a wearable camera, consistent with the disclosed embodiments.

FIG. 44 illustrates and example audio signal that may be processed consistent with the disclosed embodiments.

FIG. 45A illustrates an example user interface through which a user may define aspects of processing audio signals, consistent with the disclosed embodiments.

FIG. 45B illustrates an example process for processing audio signals in parallel, consistent with the disclosed embodiments.

FIG. 46A is a flowchart showing an example process for selectively amplifying audio signals, consistent with the disclosed embodiments.

FIG. 46B is a flowchart showing an example process for selectively amplifying audio signals, consistent with the disclosed embodiments.

FIG. 47 is a block diagram illustrating an example process for active sound substitution, consistent with the disclosed embodiments.

FIGS. 48A, 48B, and 48C illustrate example wearable apparatuses for active sound substitution, consistent with the disclosed embodiments.

FIG. 49 is a flowchart showing an example process for selectively substituting audio signals, consistent with the disclosed embodiments.

FIG. 50A is a schematic illustration showing an exemplary environment for use of a hearing aid with sound localization consistent with the disclosed embodiments.

FIG. 50B is a schematic illustration of an exemplary image captured by an imaging capture device consistent with the disclosed embodiments.

FIG. 51 is a schematic illustration of an audio signal acquired and replayed by a hearing aid system consistent with the disclosed embodiments.

FIG. 52 is a flowchart showing an exemplary process for generating stereo sound representation consistent with the disclosed embodiments.

FIG. 53 is a schematic illustration showing an exemplary environment for use of a hearing aid with sound localization consistent with the present disclosure.

FIG. 54A is a schematic illustration of an audio signal acquired by a hearing aid system consistent with the present disclosure.

FIG. 54B is a schematic illustration of an audio signal replayed by a hearing aid system consistent with the present disclosure.

FIG. 55A is a flowchart showing an exemplary process for selectively conditioning an audio signal consistent with disclosed embodiments.

FIG. 55B is a flowchart showing an exemplary process for determining a voice trait based on visual identification of an individual consistent with disclosed embodiments.

FIG. 56 is a schematic illustration of an exemplary hearing aid system for selectively conditioning sounds consistent with the disclosed embodiments.

FIG. 57 is a schematic illustration showing an exemplary environment of a user of a hearing system consistent with the disclosed embodiments.

FIG. 58 is a schematic illustration showing a flowchart of an exemplary method for selectively conditioning sounds in a hearing aid system consistent with the disclosed embodiments.

### DETAILED DESCRIPTION

The following detailed description refers to the accompanying drawings. Wherever possible, the same reference numbers are used in the drawings and the following description to refer to the same or similar pans. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

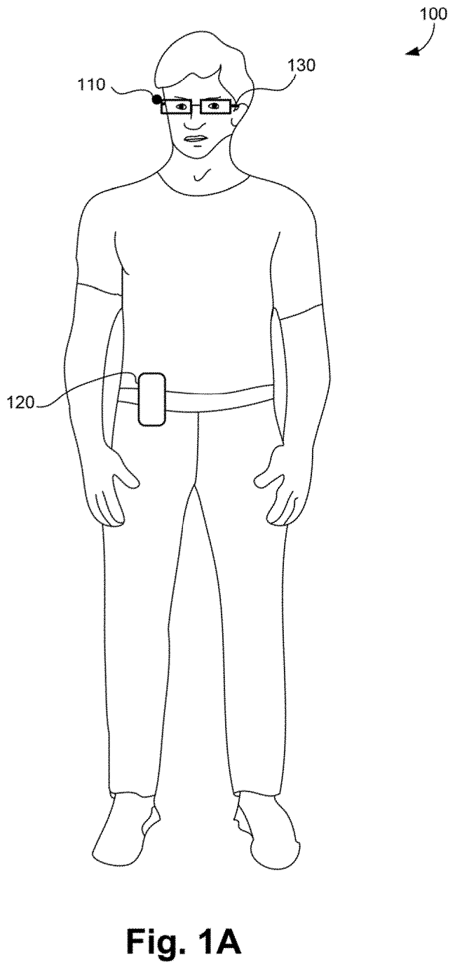

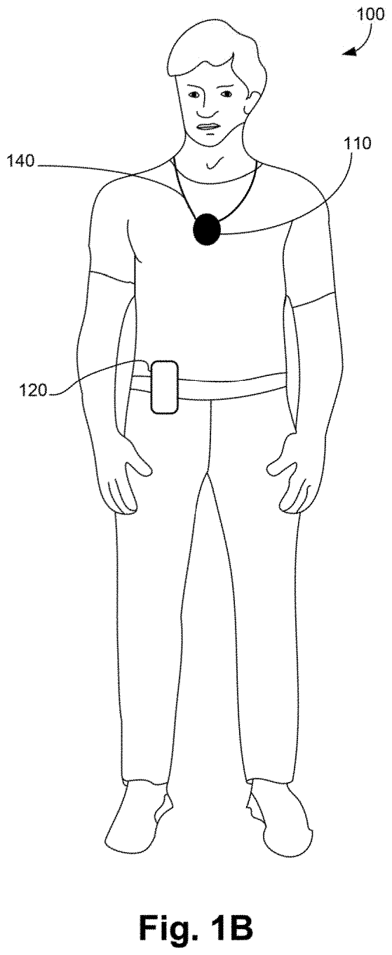

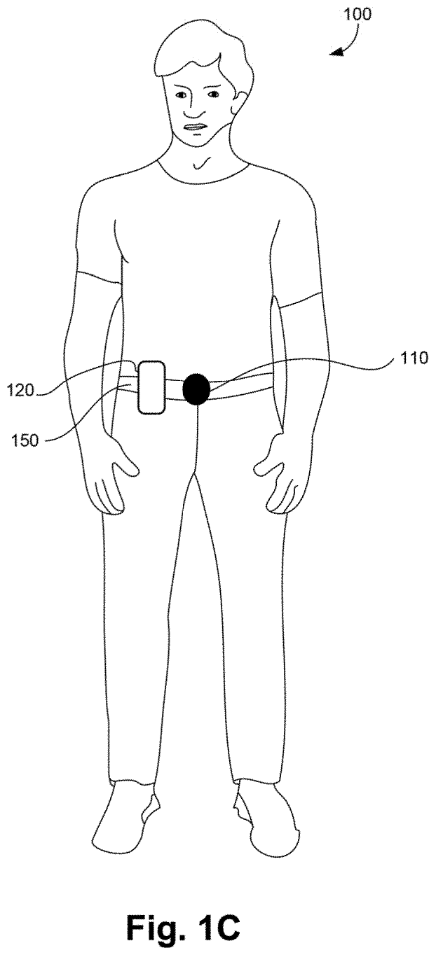

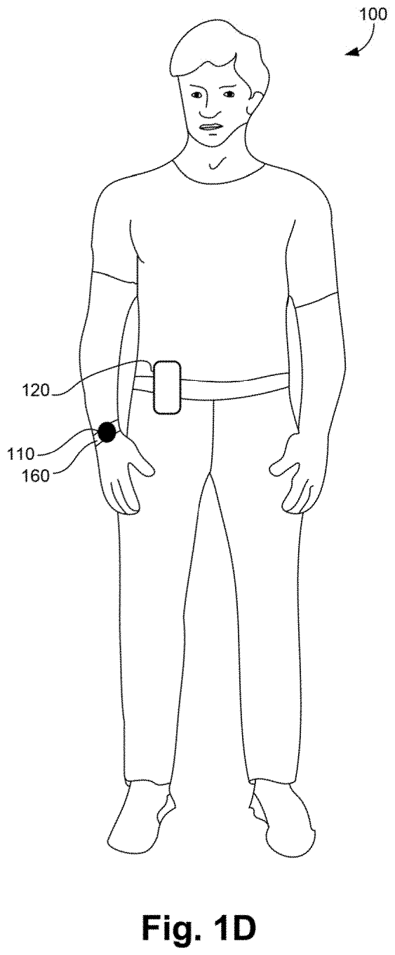

FIG. 1A illustrates a user 100 wearing an apparatus 110 that is physically connected (or integral) to glasses 130, consistent with the disclosed embodiments. Glasses 130 may be prescription glasses, magnifying glasses. non-prescription glasses, safety glasses, sunglasses, etc. Additionally, in some embodiments, glasses 130 may include parts of a frame and earpieces, nosepieces, etc., and one or no lenses. Thus, in some embodiments, glasses 130 may function primarily to support apparatus 110, and/or an augmented reality display device or other optical display device. In some embodiments, apparatus 110 may include an image sensor (not shown in FIG. 1A) for capturing real-time image data of the field-of-view of user 100. The term “image data” includes any form of data retrieved from optical signals in the near-infrared, infrared, visible, and ultraviolet spectrums. The image data may include video clips and/or photographs.

In some embodiments, apparatus 110 may communicate wirelessly or via a wire with a computing device 120. In some embodiments, computing device 120 may include, for example, a smartphone, or a tablet, or a dedicated processing unit, which may be portable (e.g., can be carried in a pocket of user 100). Although shown in FIG. 1A as an external device, in some embodiments, computing device 120 may be provided as part of wearable apparatus 110 or glasses 130, whether integral thereto or mounted thereon. In some embodiments, computing device 120 may be included in an augmented reality display device or optical head mounted display provided integrally or mounted to glasses 130. In other embodiments, computing device 120 may be provided as part of another wearable or portable apparatus of user 100 including a wrist-strap, a multifunctional watch, a button, a clip-on, etc. And in other embodiments, computing device 120 may be provided as part of another system, such as an on-board automobile computing or navigation system. A person skilled in the art can appreciate that different types of computing devices and arrangements of devices may implement the functionality of the disclosed embodiments. Accordingly, in other implementations, computing device 120 may include a Personal Computer (PC), laptop, an Internet server, etc.

FIG. 1B illustrates user 100 wearing apparatus 110 that is physically connected to a necklace 140, consistent with a disclosed embodiment. Such a configuration of apparatus 110 may be suitable for users that do not wear glasses some or all of the time. In this embodiment, user 100 can easily wear apparatus 110, and take it off.

FIG. 1C illustrates user 100 wearing apparatus 110 that is physically connected to a belt 150, consistent with a disclosed embodiment. Such a configuration of apparatus 110 may be designed as a belt buckle. Alternatively, apparatus 110 may include a clip for attaching to various clothing articles, such as belt 150, or a vest, a pocket, a collar, a cap or hat or other portion of a clothing article.

FIG. 1D illustrates user 100 wearing apparatus 110 that is physically connected to a wrist strap 160, consistent with a disclosed embodiment. Although the aiming direction of apparatus 110, according to this embodiment, may not match the field-of-view of user 100, apparatus 110 may include the ability to identify a hand-related trigger based on the tracked eye movement of a user 100 indicating that user 100 is looking in the direction of the wrist strap 160. Wrist strap 160 may also include an accelerometer, a gyroscope, or other sensor for determining movement or orientation of a user's 100 hand for identifying a hand-related trigger.

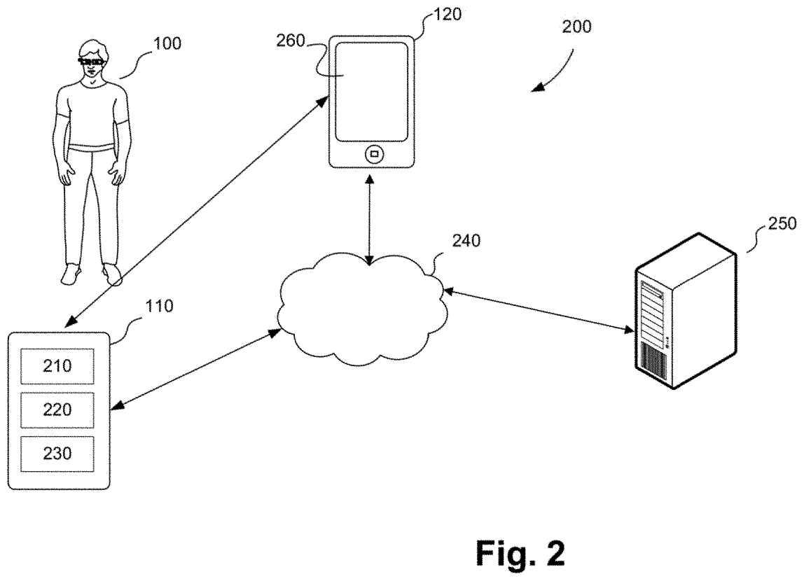

FIG. 2 is a schematic illustration of an exemplary system 200 including a wearable apparatus 110, worn by user IOU, and an optional computing device 120 and/or a server 250 capable of communicating with apparatus 110 via a network 240, consistent with disclosed embodiments. In some embodiments, apparatus 110 may capture and analyze image data, identify a hand-related trigger present in the image data, and perform an action and/or provide feedback to a user 100, based at least in part on the identification of the hand-related trigger. In some embodiments, optional computing device 120 and/or server 250 may provide additional functionality to enhance interactions of user 100 with his or her environment, as described in greater detail below.

According to the disclosed embodiments, apparatus 110 may include an image sensor system 220 for capturing real-time image data of the field-of-view of user 100. In some embodiments, apparatus 110 may also include a processing unit 210 for controlling and performing the disclosed functionality of apparatus 110, such as to control the capture of image data, analyze the image data, and perform an action and/or output a feedback based on a hand-related trigger identified in the image data. According to the disclosed embodiments, a hand-related trigger may include a gesture performed by user 100 involving a portion of a hand of user 100. Further, consistent with some embodiments, a hand-related trigger may include a wrist-related trigger. Additionally, in some embodiments, apparatus 110 may include a feedback outputting unit 230 for producing an output of information to user 100.

As discussed above, apparatus 110 may include an image sensor 220 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal—oxide—semiconductor (CMOS), or N-type metal-oxide-semiconductor (NMOS, Live MOS). In some cases, image sensor 220 may be part of a camera included in apparatus 110.

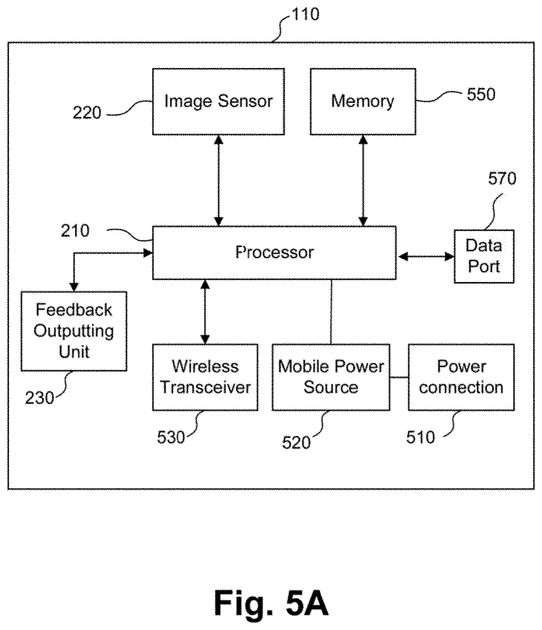

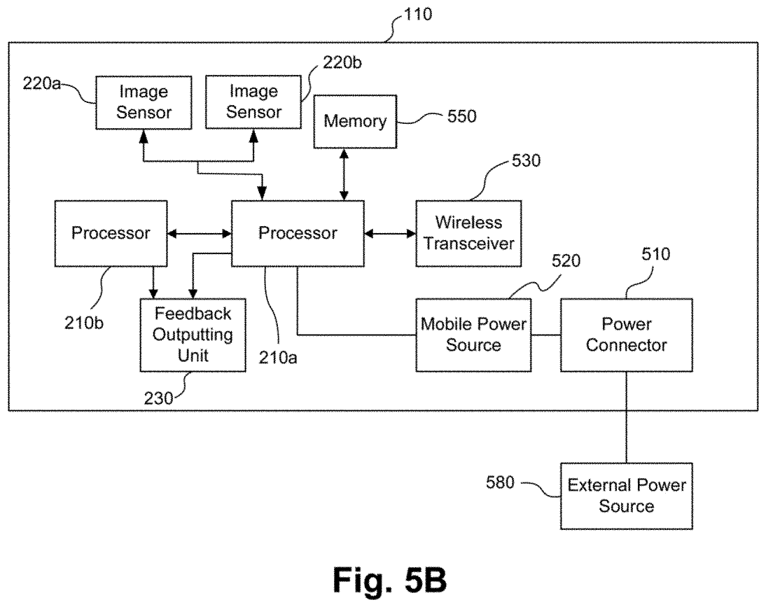

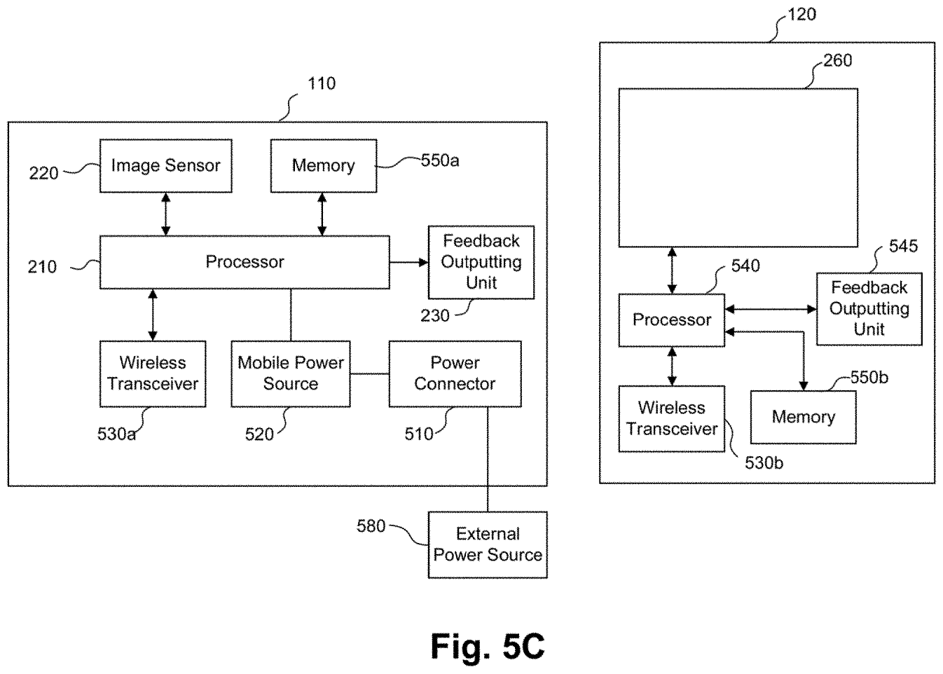

Apparatus 110 may also include a processor 210 for controlling image sensor 220 to capture image data and for analyzing the image data according to the disclosed embodiments. As discussed in further detail below with respect to FIG. 5A, processor 210 may include a “processing device” for performing logic operations on one or more inputs of image data and other data according to stored or accessible software instructions providing desired functionality. In some embodiments, processor 210 may also control feedback outputting unit 230 to provide feedback to user 100 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

In some embodiments, the information or feedback information provided to user 100 may include time information. The time information may include any information related to a current time of day and, as described further below, may be presented in any sensory perceptive manner. In some embodiments, time information may include a current time of day in a preconfigured format (e.g., 2:30 pm or 14:30). Time information may include the time in the user's current time zone (e.g., based on a determined location of user 100), as well as an indication of the time zone and/or a time of day in another desired location. In some embodiments, time information may include a number of hours or minutes relative to one or more predetermined times of day. For example, in some embodiments, time information may include an indication that three hours and fifteen minutes remain until a particular hour (e.g., until 6:00 pm), or some other predetermined time. Time information may also include a duration of time passed since the beginning of a particular activity, such as the start of a meeting or the start of a jog, or any other activity. In some embodiments, the activity may be determined based on analyzed image data. In other embodiments, time information may also include additional information related to a current time and one or more other routine, periodic, or scheduled events. For example, time information may include an indication of the number of minutes remaining until the next scheduled event, as may be determined from a calendar function or other information retrieved from computing device 120 or server 250, as discussed in further detail below.

Feedback outputting unit 230 may include one or more feedback systems for providing the output of information to user 100. In the disclosed embodiments, the audible or visual feedback may be provided via any type of connected audible or visual system or both. Feedback of information according to the disclosed embodiments may include audible feedback to user 100 (e.g., using a Bluetooth™ or other wired or wirelessly connected speaker, or a bone conduction headphone). Feedback outputting unit 230 of some embodiments may additionally or alternatively produce a visible output of information to user 100, for example, as part of an augmented reality display projected onto a lens of glasses 130 or provided via a separate heads up display in communication with apparatus 110, such as a display 260 provided as part of computing device 120, which may include an onboard automobile heads up display, an augmented reality device, a virtual reality device, a smartphone, PC, table, etc.

The term “computing device” refers to a device including a processing unit and having computing capabilities. Some examples of computing device 120 include a PC, laptop, tablet, or other computing systems such as an on-board computing system of an automobile, for example, each configured to communicate directly with apparatus 110 or server 250 over network 240. Another example of computing device 120 includes a smartphone having a display 260. In some embodiments, computing device 120 may be a computing system configured particularly for apparatus 110, and may be provided integral to apparatus 110 or tethered thereto. Apparatus 110 can also connect to computing device 120 over network 240 via any known wireless standard (e.g., Bluetooth®, etc.), as well as near-filed capacitive coupling, and other short range wireless techniques, or via a wired connection. In an embodiment in which computing device 120 is a smartphone, computing device 120 may have a dedicated application installed therein. For example, user 100 may view on display 260 data (e.g., images, video clips, extracted information, feedback information, etc.) that originate from or are triggered by apparatus 110. In addition, user 100 may select part of the data for storage in server 250.

Network 240 may be a shared, public, or private network, may encompass a wide area or local area, and may be implemented through any suitable combination of wired and/or wireless communication networks. Network 240 may further comprise an intranet or the Internet. In some embodiments, network 240 may include short range or near-field wireless communication systems for enabling communication between apparatus 110 and computing device 120 provided in close proximity to each other, such as on or near a user's person, for example. Apparatus 110 may establish a connection to network 240 autonomously, for example, using a wireless module (e.g., Wi-Fi, cellular). In some embodiments, apparatus 110 may use the wireless module when being connected to an external power source, to prolong battery life. Further, communication between apparatus 110 and server 250 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, apparatus 110 may transfer or receive data to/from server 250 via network 240. In the disclosed embodiments, the data being received from server 250 and/or computing device 120 may include numerous different types of information based on the analyzed image data, including information related to a commercial product, or a person's identity, an identified landmark, and any other information capable of being stored in or accessed by server 250. In some embodiments, data may be received and transferred via computing device 120. Server 250 and/or computing device 120 may retrieve information from different data sources (e.g., a user specific database or a user's social network account or other account, the Internet, and other managed or accessible databases) and provide information to apparatus 110 related to the analyzed image data and a recognized trigger according to the disclosed embodiments. In some embodiments, calendar-related information retrieved from the different data sources may be analyzed to provide certain time information or a time-based context for providing certain information based on the analyzed image data.

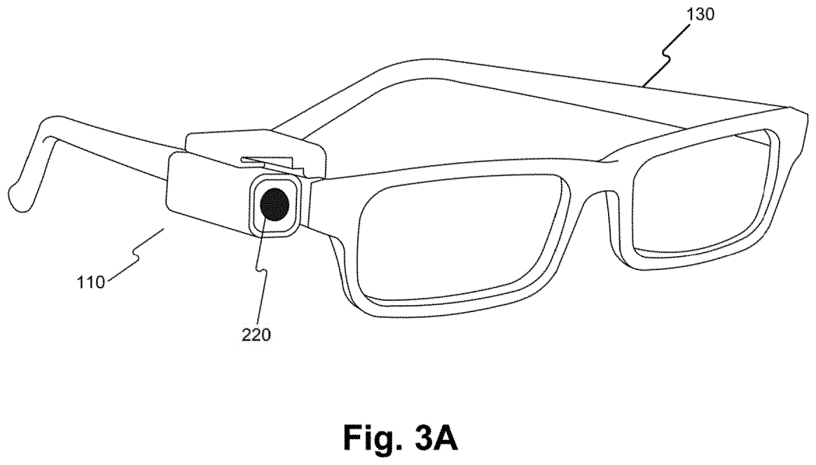

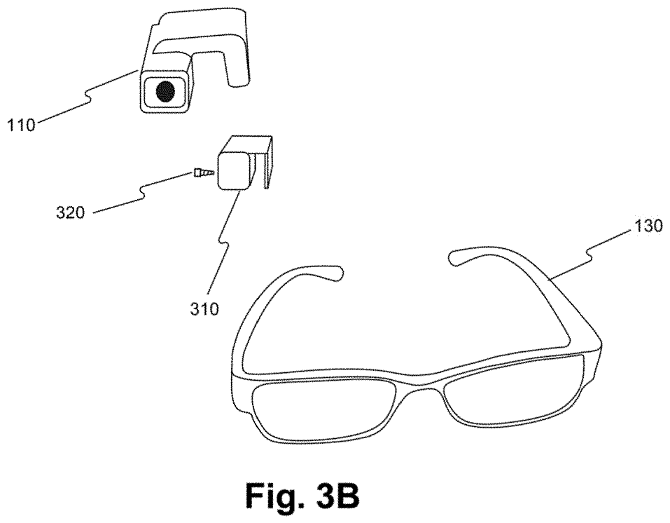

An example of wearable apparatus 110 incorporated with glasses 130 according to some embodiments (as discussed in connection with Fig. 1A) is shown in greater detail in FIG. 3A. In some embodiments, apparatus 110 may be associated with a structure (not shown in FIG. 3A) that enables easy detaching and reattaching of apparatus 110 to glasses 130. In some embodiments, when apparatus 110 attaches to glasses 130, image sensor 220 acquires a set aiming direction without the need for directional calibration. The set aiming direction of image sensor 220 may substantially coincide with the field-of-view of user 100. For example, a camera associated with image sensor 220 may be installed within apparatus 110 in a predetermined angle in a position facing slightly downwards (e.g., 5-15 degrees from the horizon). Accordingly, the set aiming direction of image sensor 220 may substantially match the field-of-view of user 100.

FIG. 3B is an exploded view of the components of the embodiment discussed regarding FIG. 3A. Attaching apparatus 110 to glasses 130 may take place in the following way. Initially, a support 310 may be mounted on glasses 130 using a screw 320, in the side of support 310. Then, apparatus 110 may be clipped on support 310 such that it is aligned with the field-of-view of user 100. The term “support” includes any device or structure that enables detaching and reattaching of a device including a camera to a pair of glasses or to another object (e.g., a helmet). Support 310 may be made from plastic polycarbonate), metal (e.g., aluminum), or a combination of plastic and metal (e.g., carbon fiber graphite). Support 310 may be mounted on any kind of glasses (e.g., eyeglasses, sunglasses, 3D glasses, safety glasses, etc.) using screws, bolts, snaps, or any fastening means used in the art.

In some embodiments, support 310 may include a quick release mechanism for disengaging and reengaging apparatus 110. For example, support 310 and apparatus 110 may include magnetic elements. As an alternative example, support 310 may include a male latch member and apparatus 110 may include a female receptacle. In other embodiments, support 310 can be an integral part of a pair of glasses, or sold separately and installed by an optometrist. For example, support 310 may be configured for mounting on the arms of glasses 130 near the frame front, but before the hinge. Alternatively, support 310 may be configured for mounting on the bridge of glasses 130.

In some embodiments, apparatus 110 may be provided as part of a glasses frame 130, with or without lenses. Additionally, in some embodiments, apparatus 110 may be configured to provide an augmented reality display projected onto a lens of glasses 130 (if provided), or alternatively, may include a display for projecting time information, for example, according to the disclosed embodiments. Apparatus 110 may include the additional display or alternatively, may be in communication with a separately provided display system that may or may not be attached to glasses 130.

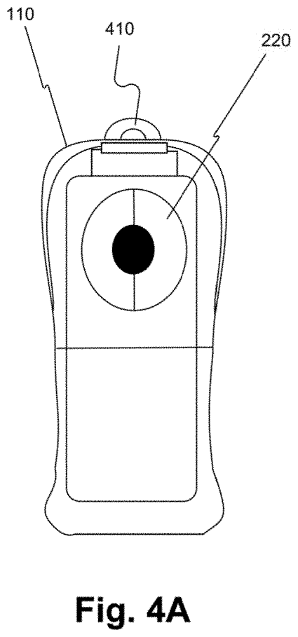

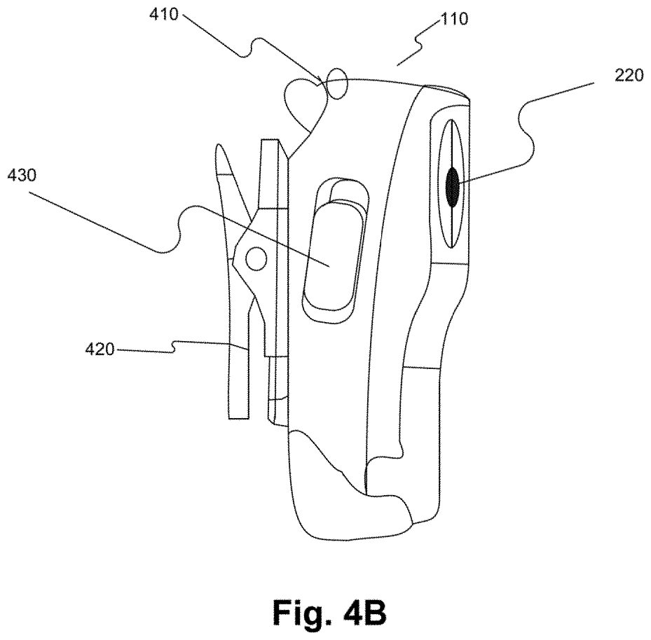

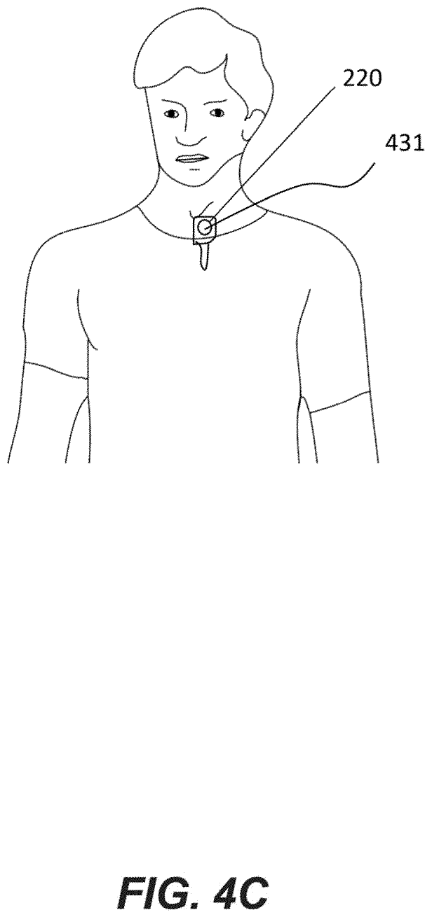

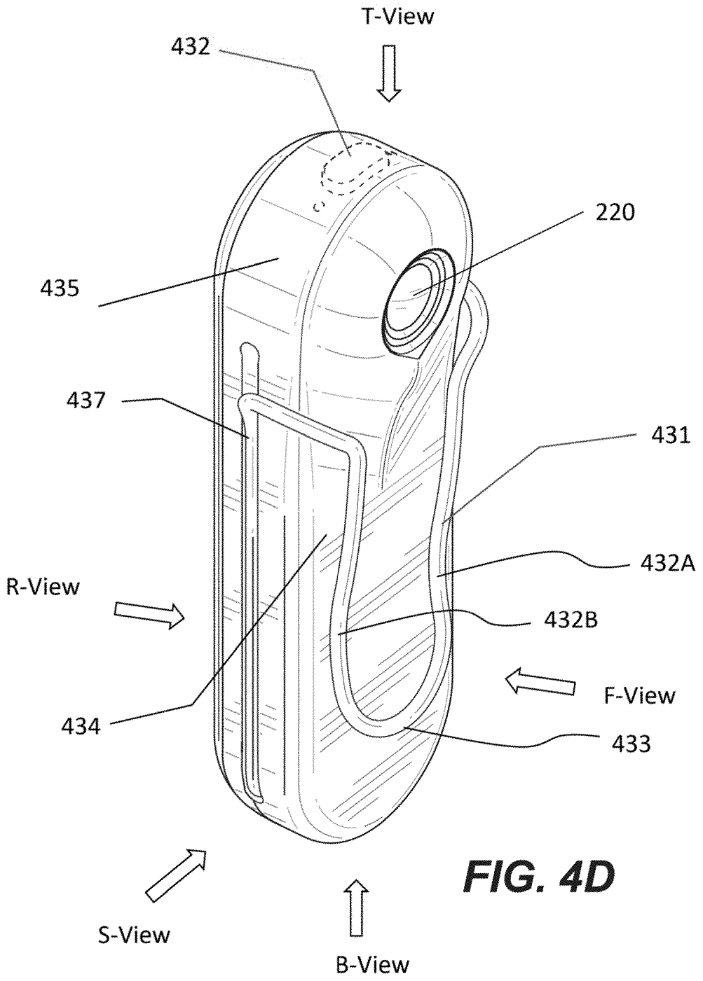

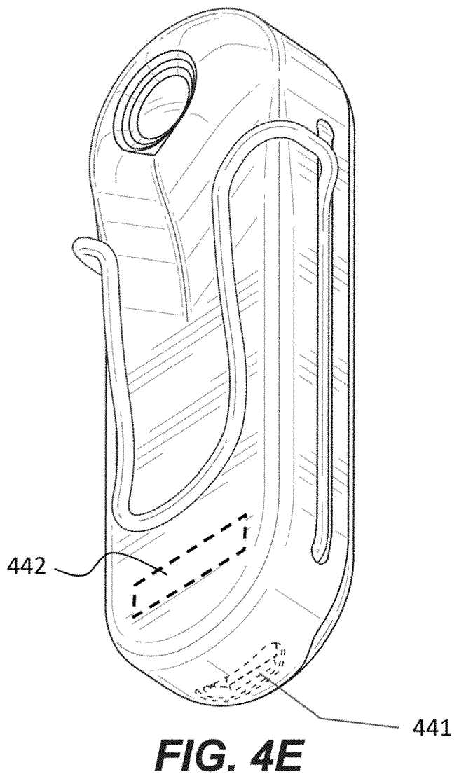

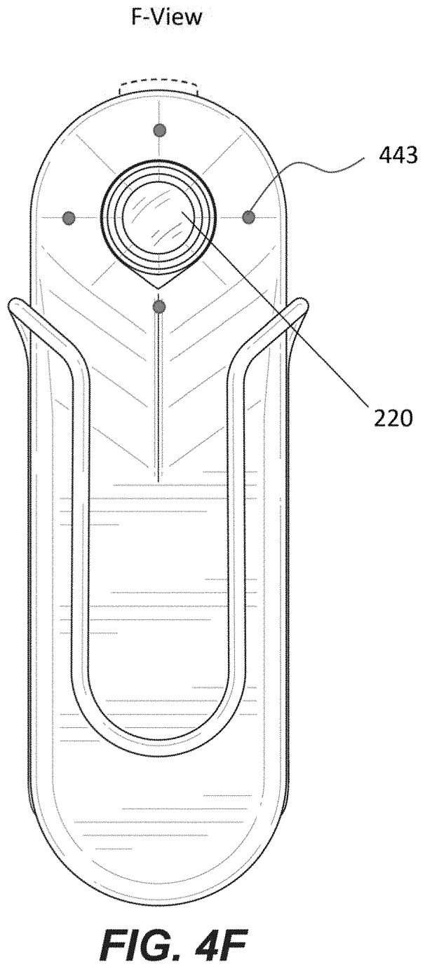

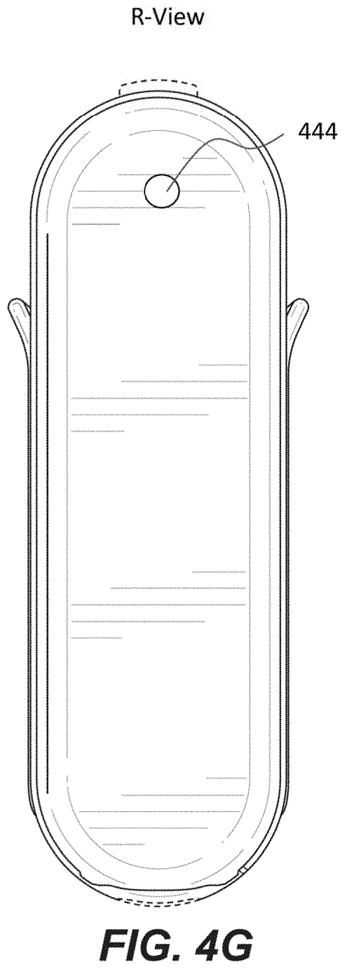

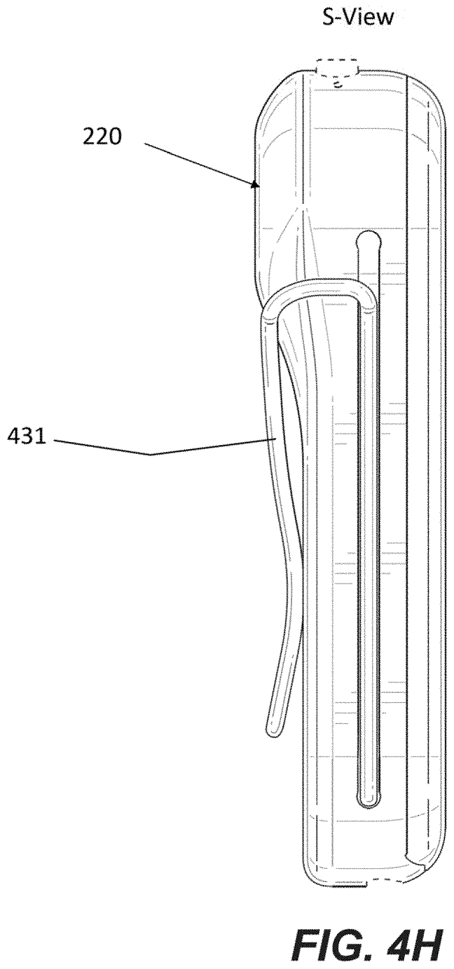

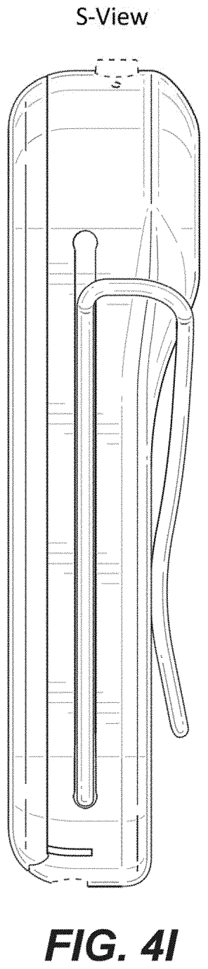

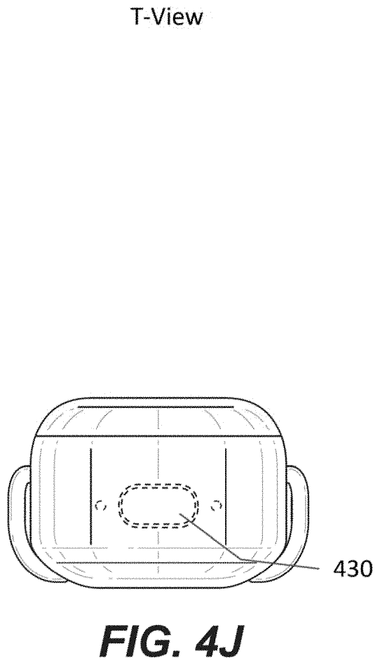

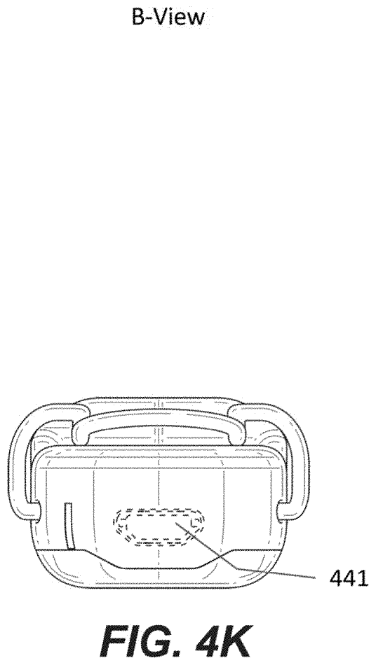

In some embodiments, apparatus 110 may be implemented in a form other than wearable glasses, as described above with respect to FIGS. 1B-1D, for example. FIG. 4A is a schematic illustration of an example of an additional embodiment of apparatus 110 from a front viewpoint of apparatus 110. Apparatus 110 includes an image sensor 220, a clip (not shown), a function button (not shown) and a hanging ring 410 for attaching apparatus 110 to, for example, necklace 140, as shown in FIG. 1B. When apparatus 110 hangs on necklace 140, the aiming direction of image sensor 220 may not fully coincide with the field-of-view of user 100, but the aiming direction would still correlate with the field-of-view of user 100.

FIG. 4B is a schematic illustration of the example of a second embodiment of apparatus 110, from a side orientation of apparatus 110. In addition to hanging ring 410, as shown in FIG. 4B, apparatus 110 may further include a clip 420. User 100 can use clip 420 to attach apparatus 110 to a shirt or belt 150, as illustrated in FIG. 1C. Clip 420 may provide an easy mechanism for disengaging and re-engaging apparatus 110 from different articles of clothing. In other embodiments, apparatus 110 may include a female receptacle for connecting with a male latch of a car mount or universal stand.

In some embodiments, apparatus 110 includes a function button 430 for enabling user 100 to provide input to apparatus 110. Function button 430 may accept different types of tactile input (e.g., a tap, a click, a double-click, a long press, a right-to-left slide, a left-to-right slide). In some embodiments, each type of input may be associated with a different action. For example, a tap may be associated with the function of taking a picture, while a right-to-left slide may be associated with the function of recording a video.

Apparatus 110 may be attached to an article of clothing (e.g., a shirt, a belt, pants, etc.), of user 100 at an edge of the clothing using a clip 431 as shown in FIG. 4C. For example, the body of apparatus 100 may reside adjacent to the inside surface of the clothing with clip 431 engaging with the outside surface of the clothing. In such an embodiment, as shown in FIG. 4C, the image sensor 220 (e.g., a camera for visible light) may be protruding beyond the edge of the clothing. Alternatively, clip 431 may be engaging with the inside surface of the clothing with the body of apparatus 110 being adjacent to the outside of the clothing. In various embodiments, the clothing may be positioned between clip 431 and the body of apparatus 110.

An example embodiment of apparatus 110 is shown in FIG. 4D. Apparatus 110 includes clip 431 which may include points (e.g., 432A and 432B) in close proximity to a front surface 434 of a body 435 of apparatus 110. In an example embodiment, the distance between points 432A, 432B and front surface 434 may be less than a typical thickness of a fabric of the clothing of user 100. For example, the distance between points 432A, 432B and surface 434 may be less than a thickness of a tee-shirt, e.g., less than a millimeter, less than 2 millimeters, less than 3 millimeters, etc., or, in some cases, points 432A, 432B of clip 431 may touch surface 434. In various embodiments, clip 431 may include a point 433 that does not touch surface 434, allowing the clothing to be inserted between clip 431 and surface 434.

FIG. 4D shows schematically different views of apparatus 110 defined as a front view (F-view), a rearview (R-view), a top view (T-view), a side view (S-view) and a bottom view (B-view). These views will be referred to when describing apparatus 110 in subsequent figures. FIG. 4D shows an example embodiment where clip 431 is positioned at the same side of apparatus 110 as sensor 220 (e.g., the front side of apparatus 110). Alternatively, clip 431 may be positioned at an opposite side of apparatus 110 as sensor 220 (e.g., the rear side of apparatus 110). In various embodiments, apparatus 110 may include function button 430, as shown in FIG. 4D.

Various views of apparatus 110 are illustrated in FIGS. 4E through 4K. For example, FIG. 4E shows a view of apparatus 110 with an electrical connection 441. Electrical connection 441 may be, for example, a USB port, that may be used to transfer data to/from apparatus 110 and provide electrical power to apparatus 110. In an example embodiment, connection 441 may be used to charge a battery 442 schematically shown in FIG. 4E. FIG. 4F shows F-view of apparatus 110, including sensor 220 and one or more microphones 443. In some embodiments, apparatus 110 may include several microphones 443 facing outwards, wherein microphones 443 are configured to obtain environmental sounds and sounds of various speakers communicating with user 100. FIG. 4G shows R-view of apparatus 110. In some embodiments, microphone 444 may be positioned at the rear side of apparatus 110, as shown in FIG. 4G. Microphone 444 may be used to detect an audio signal from user 100. It should be noted, that apparatus 110 may have microphones placed at any side (e.g., a front side, a rear side, a left side, a right side, a top side, or a bottom side) of apparatus 110. In various embodiments, some microphones may be at a first side (e.g., microphones 443 may be at the front of apparatus 110) and other microphones may be at a second side (e.g., microphone 444 may be at the back side of apparatus 110).

FIGS. 4H and 4I show different sides of apparatus 110 (i.e., S-view of apparatus 110) consisted with disclosed embodiments. For example, FIG. 4H shows the location of sensor 220 and an example shape of clip 431. FIG. 4J shows T-view of apparatus 110, including function button 430, and FIG. 4K shows B-view of apparatus 110 with electrical connection 441.

The example embodiments discussed above with respect to FIGS. 3A, 3B, 4A, and 4B are not limiting. In some embodiments, apparatus 110 may be implemented in any suitable configuration for performing the disclosed methods. For example, referring back to FIG. 2, the disclosed embodiments may implement an apparatus 110 according to any configuration including an image sensor 220 and a processor unit 210 to perform image analysis and for communicating with a feedback unit 230.

FIG. 5A is a block diagram illustrating the components of apparatus 110 according to an example embodiment. As shown in FIG. 5A, and as similarly discussed above, apparatus 110 includes an image sensor 220, a memory 550, a processor 210, a feedback outputting unit 230, a wireless transceiver 530, and a mobile power source 520. In other embodiments, apparatus 110 may also include buttons, other sensors such as a microphone, and inertial measurements devices such as accelerometers, gyroscopes, magnetometers, temperature sensors, color sensors, light sensors, etc. Apparatus 110 may further include a data port 570 and a power connection 510 with suitable interfaces for connecting with an external power source or an external device (not shown).

Processor 210, depicted in FIG. 5A, may include any suitable processing device. The term “processing device” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by the processing device may, for example, be pre-loaded into a memory integrated with or embedded into the processing device or may be stored in a separate memory (e.g., memory 550). Memory 550 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although, in the embodiment illustrated in FIG. 5A, apparatus 110 includes one processing device (e.g., processor 210), apparatus 110 may include more than one processing device. Each processing device may have a similar construction, or the processing devices may be of differing constructions that are electrically connected or disconnected from each other. For example, the processing devices may be separate circuits or integrated in a single circuit. When more than one processing device is used, the processing devices may be configured to operate independently or collaboratively. The processing devices may be coupled electrically, magnetically, optically, acoustically, mechanically or by other means that permit them to interact.

In some embodiments, processor 210 may process a plurality of images captured from the environment of user 100 to determine different parameters related to capturing subsequent images. For example, processor 210 can determine, based on information derived from captured image data, a value for at least one of the following: an image resolution, a compression ratio, a cropping parameter, frame rate, a focus point, an exposure time, an aperture size, and a light sensitivity. The determined value may be used in capturing at least one subsequent image. Additionally, processor 210 can detect images including at least one hand-related trigger in the environment of the user and perform an action and/or provide an output of information to a user via feedback outputting unit 230.

In another embodiment, processor 210 can change the aiming direction of image sensor 220. For example, when apparatus 110 is attached with clip 420, the aiming direction of image sensor 220 may not coincide with the field-of-view of user 100. Processor 210 may recognize certain situations from the analyzed image data and adjust the aiming direction of image sensor 220 to capture relevant image data. For example, in one embodiment, processor 210 may detect an interaction with another individual and sense that the individual is not fully in view, because image sensor 220 is tilted down. Responsive thereto, processor 210 may adjust the aiming direction of image sensor 220 to capture image data of the individual. Other scenarios are also contemplated where processor 210 may recognize the need to adjust an aiming direction of image sensor 220.

In some embodiments, processor 210 may communicate data to feedback-outputting unit 230, which may include any device configured to provide information to a user 100. Feedback outputting unit 230 may be provided as part of apparatus 110 (as shown) or may be provided external to apparatus 110 and communicatively coupled thereto. Feedback-outputting unit 230 may be configured to output visual or nonvisual feedback based on signals received from processor 210, such as when processor 210 recognizes a hand-related trigger in the analyzed image data.

The term “feedback” refers to any output or information provided in response to processing at least one image in an environment. In some embodiments, as similarly described above, feedback may include an audible or visible indication of time information, detected text or numerals, the value of currency, a branded product, a person's identity, the identity of a landmark or other environmental situation or condition including the street names at an intersection or the color of a traffic light, etc., as well as other information associated with each of these. For example, in some embodiments, feedback may include additional information regarding the amount of currency still needed to complete a transaction, information regarding the identified person, historical information or times and prices of admission etc. of a detected landmark etc. In some embodiments, feedback may include an audible tone, a tactile response, and/or information previously recorded by user 100. Feedback-outputting unit 230 may comprise appropriate components for outputting acoustical and tactile feedback. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface. In some embodiments, feedback outputting unit 230 may also include any suitable display device for visually displaying information to user 100.

As shown in FIG. 5A, apparatus 110 includes memory 550. Memory 550 may include one or more sets of instructions accessible to processor 210 to perform the disclosed methods, including instructions for recognizing a hand-related trigger in the image data. In some embodiments memory 550 may store image data (e.g., images, videos) captured from the environment of user 100. In addition, memory 550 may store information specific to user 100, such as image representations of known individuals, favorite products, personal items, and calendar or appointment information, etc. In some embodiments, processor 210 may determine, for example, which type of image data to store based on available storage space in memory 550. In another embodiment, processor 210 may extract information from the image data stored in memory 550.

As further shown in FIG. 5A, apparatus 110 includes mobile power source 520. The term “mobile power source” includes any device capable of providing electrical power, which can be easily carried by hand (e.g., mobile power source 520 may weigh less than a pound). The mobility of the power source enables user 100 to use apparatus 110 in a variety of situations. In some embodiments, mobile power source 520 may include one or more batteries (e.g., nickel-cadmium batteries, nickel-metal hydride batteries, and lithium-ion batteries) or any other type of electrical power supply. In other embodiments, mobile power source 520 may be rechargeable and contained within a casing that holds apparatus 110. In yet other embodiments, mobile power source 520 may include one or more energy harvesting devices for converting ambient energy into electrical energy (e.g., portable solar power units, human vibration units, etc.).

Mobile power source 520 may power one or more wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data, processed image data, extracted information) from apparatus 110 to computing device 120 and/or server 250. Wireless transceiver 530 may also receive data from computing device 120 and/or server 250. In other embodiments, wireless transceiver 530 may transmit data and instructions to an external feedback outputting unit 230.

FIG. 5B is a block diagram illustrating the components of apparatus 110 according to another example embodiment. In some embodiments, apparatus 110 includes a first image sensor 220a, a second image sensor 220b, a memory 550, a first processor 210a, a second processor 210b, a feedback outputting unit 230, a wireless transceiver 530, a mobile power source 520, and a power connector 510. In the arrangement shown in FIG. 5B, each of the image sensors may provide images in a different image resolution, or face a different direction. Alternatively, each image sensor may be associated with a different camera (e.g., a wide angle camera, a narrow angle camera, an IR camera, etc.). In some embodiments, apparatus 110 can select which image sensor to use based on various factors. For example, processor 210a may determine, based on available storage space in memory 550, to capture subsequent images in a certain resolution.

Apparatus 110 may operate in a first processing-mode and in a second processing-mode, such that the first processing-mode may consume less power than the second processing-mode. For example, in the first processing-mode, apparatus 110 may capture images and process the captured images to make real-time decisions based on an identifying hand-related trigger, for example. In the second processing-mode, apparatus 110 may extract information from stored images in memory 550 and delete images from memory 550. In some embodiments, mobile power source 520 may provide more than fifteen hours of processing in the first processing-mode and about three hours of processing in the second processing-mode. Accordingly, different processing-modes may allow mobile power source 520 to produce sufficient power for powering apparatus 110 for various time periods (e.g., more than two hours, more than four hours, more than ten hours, etc.).

In some embodiments, apparatus 110 may use first processor 210a in the first processing-mode when powered by mobile power source 520, and second processor 210b in the second processing-mode when powered by external power source 580 that is connectable via power connector 510. In other embodiments, apparatus 110 may determine, based on predefined conditions, which processors or which processing modes to use. Apparatus 110 may operate in the second processing-mode even when apparatus 110 is not powered by external power source 580. For example, apparatus 110 may determine that it should operate in the second processing-mode when apparatus 110 is not powered by external power source 580, if the available storage space in memory 550 for storing new image data is lower than a predefined threshold.

Although one wireless transceiver is depicted in FIG. 5B, apparatus 110 may include more than one wireless transceiver (e.g., two wireless transceivers). In an arrangement with more than one wireless transceiver, each of the wireless transceivers may use a different standard to transmit and/or receive data. In some embodiments, a first wireless transceiver may communicate with server 250 or computing device 120 using a cellular standard (e.g., LTE or GSM), and a second wireless transceiver may communicate with server 250 or computing device 120 using a short-range standard (e.g., Wi-Fi or Bluetooth®). In some embodiments, apparatus 110 may use the first wireless transceiver when the wearable apparatus is powered by a mobile power source included in the wearable apparatus, and use the second wireless transceiver when the wearable apparatus is powered by an external power source.

FIG. 5C is a block diagram illustrating the components of apparatus 110 according to another example embodiment including computing device 120. In this embodiment, apparatus 110 includes an image sensor 220, a memory 550a, a first processor 210, a feedback-outputting unit 230, a wireless transceiver 530a, a mobile power source 520, and a power connector 510. As further shown in FIG. 5C, computing device 120 includes a processor 540, a feedback-outputting unit 545, a memory 550b, a wireless transceiver 530b, and a display 260. One example of computing device 120 is a smartphone or tablet having a dedicated application installed therein. In other embodiments, computing device 120 may include any configuration such as an on-board automobile computing system, a PC, a laptop, and any other system consistent with the disclosed embodiments. In this example, user 100 may view feedback output in response to identification of a hand-related trigger on display 260. Additionally, user 100 may view other data (e.g., images, video clips, object information, schedule information, extracted information, etc.) on display 260. In addition, user 100 may communicate with server 250 via computing device 120.

In some embodiments, processor 210 and processor 540 are configured to extract information from captured image data. The term “extracting information” includes any process by which information associated with objects, individuals, locations, events, etc., is identified in the captured image data by any means known to those of ordinary skill in the art. In some embodiments, apparatus 110 may use the extracted information to send feedback or other real-time indications to feedback outputting unit 230 or to computing device 120. In some embodiments, processor 210 may identify in the image data the individual standing in front of user 100, and send computing device 120 the name of the individual and the last time user 100 met the individual. In another embodiment, processor 210 may identify in the image data, one or more visible triggers, including a hand-related trigger, and determine whether the trigger is associated with a person other than the user of the wearable apparatus to selectively determine whether to perform an action associated with the trigger. One such action may be to provide a feedback to user 100 via feedback-outputting unit 230 provided as part of (or in communication with) apparatus 110 or via a feedback unit 545 provided as part of computing device 120. For example, feedback-outputting unit 545 may be in communication with display 260 to cause the display 260 to visibly output information. In some embodiments, processor 210 may identify in the image data a hand-related trigger and send computing device 120 an indication of the trigger. Processor 540 may then process the received trigger information and provide an output via feedback outputting unit 545 or display 260 based on the hand-related trigger. In other embodiments, processor 540 may determine a hand-related trigger and provide suitable feedback similar to the above, based on image data received from apparatus 110. In some embodiments, processor 540 may provide instructions or other information, such as environmental information to apparatus 110 based on an identified hand-related trigger.

In some embodiments, processor 210 may identify other environmental information in the analyzed images, such as an individual standing in front user 100, and send computing device 120 information related to the analyzed information such as the name of the individual and the last time user 100 met the individual. In a different embodiment, processor 540 may extract statistical information from captured image data and forward the statistical information to server 250. For example, certain information regarding the types of items a user purchases, or the frequency a user patronizes a particular merchant, etc. may be determined by processor 540. Based on this information, server 250 may send computing device 120 coupons and discounts associated with the user's preferences.

When apparatus 110 is connected or wirelessly connected to computing device 120, apparatus 110 may transmit at least part of the image data stored in memory 550a for storage in memory 550b. In some embodiments, after computing device 120 confirms that transferring the part of image data was successful, processor 540 may delete the part of the image data. The term “delete” means that the image is marked as ‘deleted’ and other image data may be stored instead of it, but does not necessarily mean that the image data was physically removed from the memory.

As will be appreciated by a person skilled in the art having the benefit of this disclosure, numerous variations and/or modifications may be made to the disclosed embodiments. Not all components are essential for the operation of apparatus 110. Any component may be located in any appropriate apparatus and the components may be rearranged into a variety of configurations while providing the functionality of the disclosed embodiments. For example, in some embodiments, apparatus 110 may include a camera, a processor, and a wireless transceiver for sending data to another device. Therefore, the foregoing configurations are examples and, regardless of the configurations discussed above, apparatus 110 can capture, store, and/or process images.

Further, the foregoing and following description refers to storing and/or processing images or image data. In the embodiments disclosed herein, the stored and/or processed images or image data may comprise a representation of one or more images captured by image sensor 220. As the term is used herein, a “representation” of an image (or image data) may include an entire image or a portion of an image. A representation of an image (or image data) may have the same resolution or a lower resolution as the image (or image data), and/or a representation of an image (or image data) may be altered in some respect (e.g., be compressed, have a lower resolution, have one or more colors that are altered, etc.).

For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion clan image that includes a face of a person who appears in the image, but that does not substantially include the environment surrounding the person. Similarly, apparatus 110 may, for example, store a portion of an image that includes a product that appears in the image, but does not substantially include the environment surrounding the product. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In addition to the above, in some embodiments, any one of apparatus 110 or computing device 120, via processor 210 or 540, may further process the captured image data to provide additional functionality to recognize objects and/or gestures and/or other information in the captured image data. In some embodiments, actions may be taken based on the identified objects, gestures, or other information. In some embodiments, processor 210 or 540 may identify in the image data, one or more visible triggers, including a hand-related trigger, and determine whether the trigger is associated with a person other than the user to determine whether to perform an action associated with the trigger.

Some embodiments of the present disclosure may include an apparatus securable to an article of clothing of a user. Such an apparatus may include two portions, connectable by a connector. A capturing unit may be designed to be worn on the outside of a user's clothing, and may include an image sensor for capturing images of a user's environment. The capturing unit may be connected to or connectable to a power unit, which may be configured to house a power source and a processing device. The capturing unit may be a small device including a camera or other device for capturing images. The capturing unit may be designed to be inconspicuous and unobtrusive, and may be configured to communicate with a power unit concealed by a user's clothing. The power unit may include bulkier aspects of the system, such as transceiver antennas, at least one battery, a processing device, etc. In some embodiments, communication between the capturing unit and the power unit may be provided by a data cable included in the connector, while in other embodiments, communication may be wirelessly achieved between the capturing unit and the power unit. Some embodiments may permit alteration of the orientation of an image sensor of the capture unit, for example to better capture images of interest.

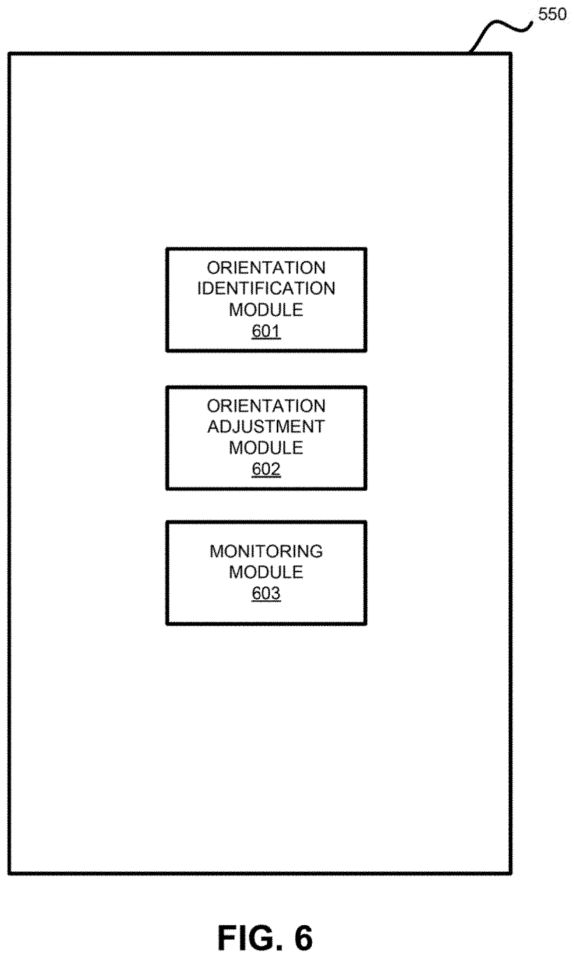

FIG. 6 illustrates an exemplary embodiment of a memory containing software modules consistent with the present disclosure. Included in memory 550 are orientation identification module 601, orientation adjustment module 602, and motion tracking module 603. Modules 601, 602, 603 may contain software instructions for execution by at least one processing device, e.g., processor 210, included with a wearable apparatus. Orientation identification module 601, orientation adjustment module 602, and motion tracking module 603 may cooperate to provide orientation adjustment for a capturing unit incorporated into wireless apparatus 110.

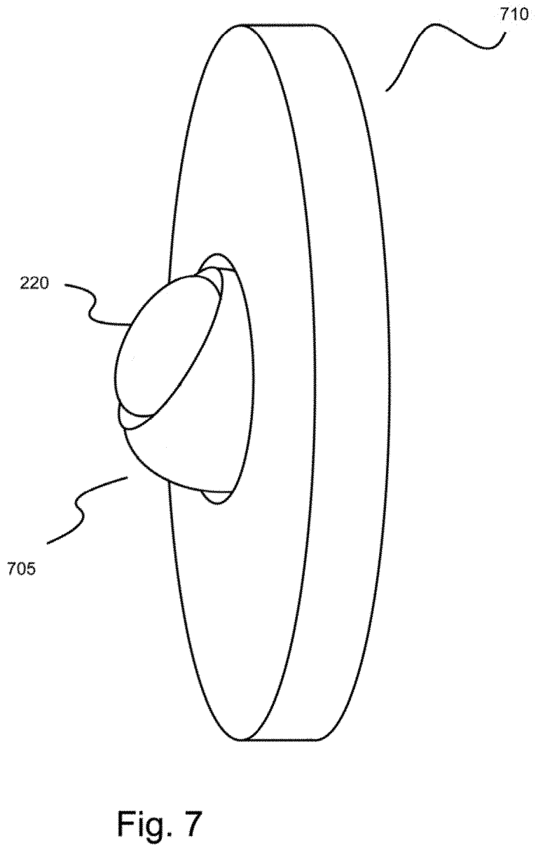

FIG. 7 illustrates an exemplary capturing unit 710 including an orientation adjustment unit 705. Orientation adjustment unit 705 may be configured to permit the adjustment of image sensor 220. As illustrated in FIG. 7, orientation adjustment unit 705 may include an eye-ball type adjustment mechanism. In alternative embodiments, orientation adjustment unit 705 may include gimbals, adjustable stalks, pivotable mounts, and any other suitable unit for adjusting an orientation of image sensor 220.

Image sensor 220 may be configured to be movable with the head of user 100 in such a manner that an aiming direction of image sensor 220 substantially coincides with a field of view of user 100. For example, as described above, a camera associated with image sensor 220 may be installed within capturing unit 710 at a predetermined angle in a position facing slightly upwards or downwards, depending on an intended location of capturing unit 710. Accordingly, the set aiming direction of image sensor 220 may match the field-of-view of user 100. In some embodiments, processor 210 may change the orientation of image sensor 220 using image data provided from image sensor 220. For example, processor 210 may recognize that a user is reading a book and determine that the aiming direction of image sensor 220 is offset from the text. That is, because the words in the beginning of each line of text are not fully in view, processor 210 may determine that image sensor 220 is tilted in the wrong direction. Responsive thereto, processor 210 may adjust the aiming direction of image sensor 220.

Orientation identification module 601 may be configured to identify an orientation of an image sensor 220 of capturing unit 710. An orientation of an image sensor 220 may be identified, for example, by analysis of images captured by image sensor 220 of capturing unit 710, by tilt or attitude sensing devices within capturing unit 710, and by measuring a relative direction of orientation adjustment unit 705 with respect to the remainder of capturing unit 710.

Orientation adjustment module 602 may be configured to adjust an orientation of image sensor 220 of capturing unit 710. As discussed above, image sensor 220 may be mounted on an orientation adjustment unit 705 configured for movement. Orientation adjustment unit 705 may be configured for rotational and/or lateral movement in response to commands from orientation adjustment module 602. In some embodiments orientation adjustment unit 705 may be adjust an orientation of image sensor 220 via motors, electromagnets, permanent magnets, and/or any suitable combination thereof.

In some embodiments, monitoring module 603 may be provided for continuous monitoring. Such continuous monitoring may include tracking a movement of at least a portion of an object included in one or more images captured by the image sensor. For example, in one embodiment, apparatus 110 may track an object as long as the object remains substantially within the field-of-view of image sensor 220. In additional embodiments, monitoring module 603 may engage orientation adjustment module 602 to instruct orientation adjustment unit 705 to continually orient image sensor 220 towards an object of interest. For example, in one embodiment, monitoring module 603 may cause image sensor 220 to adjust an orientation to ensure that a certain designated object, for example, the face of a particular person, remains within the field-of view of image sensor 220, even as that designated object moves about. In another embodiment, monitoring module 603 may continuously monitor an area of interest included in one or more images captured by the image sensor. For example, a user may be occupied by a certain task, for example, typing on a laptop, while image sensor 220 remains oriented in a particular direction and continuously monitors a portion of each image from a series of images to detect a trigger or other event. For example, image sensor 210 may be oriented towards a piece of laboratory equipment and monitoring module 603 may be configured to monitor a status light on the laboratory equipment for a change in status, while the user's attention is otherwise occupied.

In some embodiments consistent with the present disclosure, capturing unit 710 may include a plurality of image sensors 220. The plurality of image sensors 220 may each be configured to capture different image data. For example, when a plurality of image sensors 220 are provided, the image sensors 220 may capture images having different resolutions, may capture wider or narrower fields of view, and may have different levels of magnification. Image sensors 220 may be provided with varying lenses to permit these different configurations. In some embodiments, a plurality of image sensors 220 may include image sensors 220 having different orientations. Thus, each of the plurality of image sensors 220 may be pointed in a different direction to capture different images. The fields of view of image sensors 220 may be overlapping in some embodiments. The plurality of image sensors 220 may each be configured for orientation adjustment, for example, by being paired with an image adjustment unit 705. In some embodiments, monitoring module 603, or another module associated with memory 550, may be configured to individually adjust the orientations of the plurality of image sensors 220 as well as to turn each of the plurality of image sensors 220 on or off as may be required. In some embodiments, monitoring an object or person captured by an image sensor 220 may include tracking movement of the object across the fields of view of the plurality of image sensors 220.

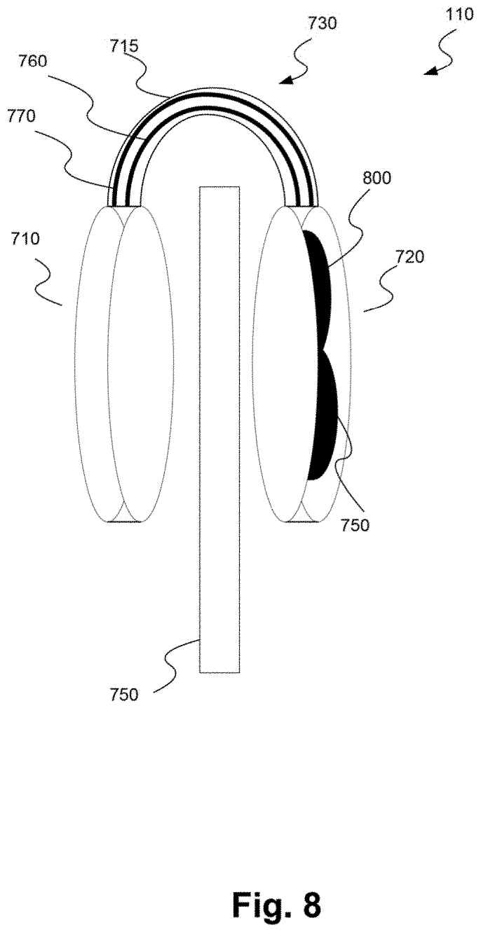

Embodiments consistent with the present disclosure may include connectors configured to connect a capturing unit and a power unit of a wearable apparatus. Capturing units consistent with the present disclosure may include least one image sensor configured to capture images of an environment of a user. Power units consistent with the present disclosure may be configured to house a power source and/or at least one processing device. Connectors consistent with the present disclosure may be configured to connect the capturing unit and the power unit, and may be configured to secure the apparatus to an article of clothing such that the capturing unit is positioned over an outer surface of the article of clothing and the power unit is positioned under an inner surface of the article of clothing. Exemplary embodiments of capturing units, connectors, and power units consistent with the disclosure are discussed in further detail with respect to FIGS. 8-14.

FIG. 8 is a schematic illustration of an embodiment of wearable apparatus 110 securable to an article of clothing consistent with the present disclosure. As illustrated in FIG. 8, capturing unit 710 and power unit 720 may be connected by a connector 730 such that capturing unit 710 is positioned on one side of an article of clothing 750 and power unit 720 is positioned on the opposite side of the clothing 750. In some embodiments, capturing unit 710 may be positioned over an outer surface of the article of clothing 750 and power unit 720 may be located under an inner surface of the article of clothing 750. The power unit 720 may be configured to be placed against the skin of a user.

Capturing unit 710 may include an image sensor 220 and an orientation adjustment unit 705 (as illustrated in FIG. 7). Power unit 720 may include mobile power source 520 and processor 210. Power unit 720 may further include any combination of elements previously discussed that may be a part of wearable apparatus 110, including, but not limited to, wireless transceiver 530, feedback outputting unit 230, memory 550, and data port 570.

Connector 730 may include a clip 715 or other mechanical connection designed to clip or attach capturing unit 710 and power unit 720 to an article of clothing 750 as illustrated in FIG. 8. As illustrated, clip 715 may connect to each of capturing unit 710 and power unit 720 at a perimeter thereof, and may wrap around an edge of the article of clothing 750 to affix the capturing unit 710 and power unit 720 in place. Connector 730 may further include a power cable 760 and a data cable 770. Power cable 760 may be capable of conveying power from mobile power source 520 to image sensor 220 of capturing unit 710. Power cable 760 may also be configured to provide power to any other elements of capturing unit 710, e.g., orientation adjustment unit 705. Data cable 770 may be capable of conveying captured image data from image sensor 220 in capturing unit 710 to processor 800 in the power unit 720. Data cable 770 may be further capable of conveying additional data between capturing unit 710 and processor 800, e.g., control instructions for orientation adjustment unit 705.

FIG. 9 is a schematic illustration of a user 100 wearing a wearable apparatus 110 consistent with an embodiment of the present disclosure. As illustrated in FIG. 9, capturing unit 710 is located on an exterior surface of the clothing 750 of user 100. Capturing unit 710 is connected to power unit 720 (not seen in this illustration) via connector 730, which wraps around an edge of clothing 750.

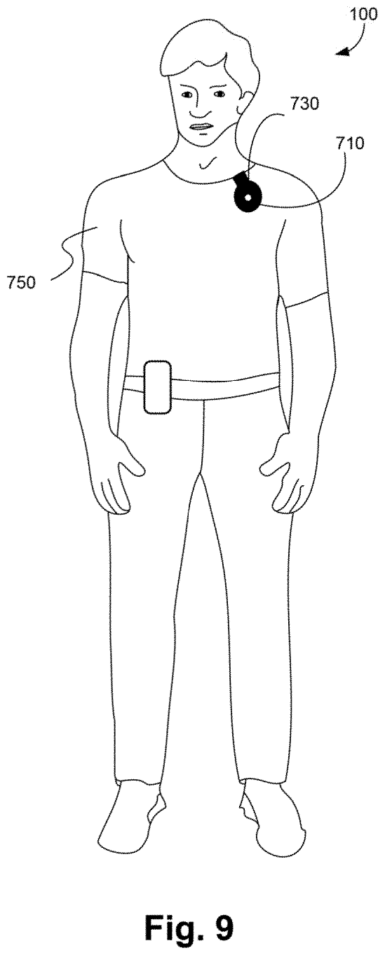

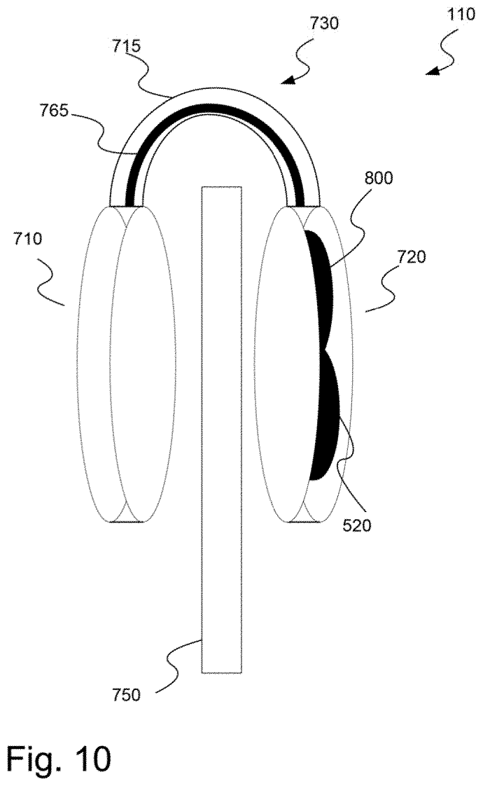

In some embodiments, connector 730 may include a flexible printed circuit board (PCB). FIG. 10 illustrates an exemplary embodiment wherein connector 730 includes a flexible printed circuit board 765. Flexible printed circuit board 765 may include data connections and power connections between capturing unit 710 and power unit 720. Thus, in some embodiments, flexible printed circuit board 765 may serve to replace power cable 760 and data cable 770. In alternative embodiments, flexible printed circuit board 765 may be included in addition to at least one of power cable 760 and data cable 770. In various embodiments discussed herein, flexible printed circuit board 765 may be substituted for, or included in addition to, power cable 760 and data cable 770.

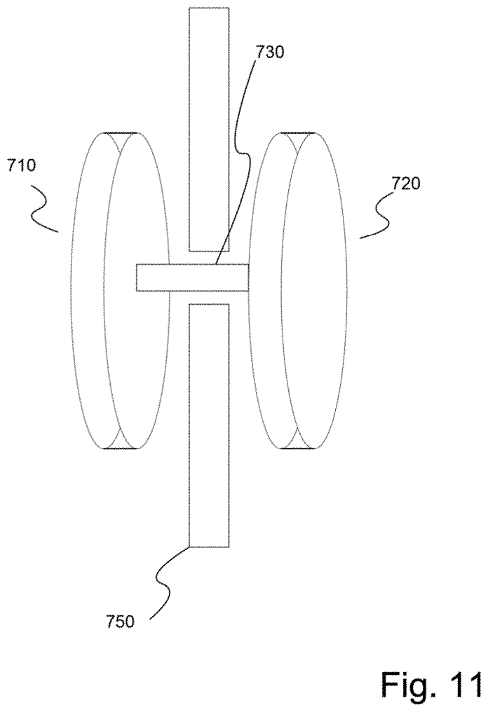

FIG. 11 is a schematic illustration of another embodiment of a wearable apparatus securable to an article of clothing consistent with the present disclosure. As illustrated in FIG. 11, connector 730 may be centrally located with respect to capturing unit 710 and power unit 720. Central location of connector 730 may facilitate affixing apparatus 110 to clothing 750 through a hole in clothing 750 such as, for example, a button-hole in an existing article of clothing 750 or a specialty hole in an article of clothing 750 designed to accommodate wearable apparatus 110.

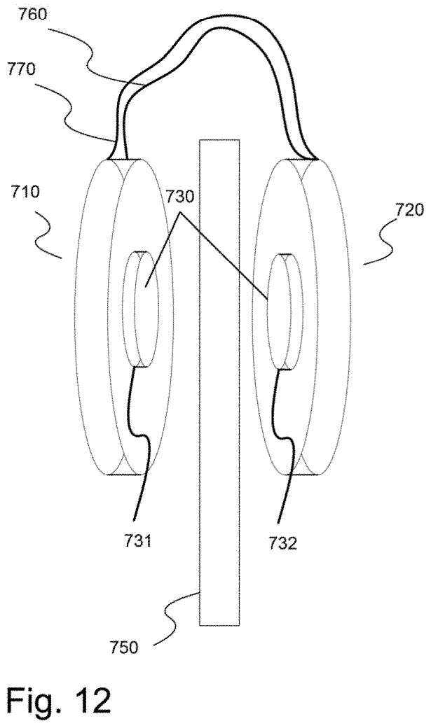

FIG. 12 is a schematic illustration of still another embodiment of wearable apparatus 110 securable to an article of clothing. As illustrated in FIG. 12, connector 730 may include a first magnet 731 and a second magnet 732. First magnet 731 and second magnet 732 may secure capturing unit 710 to power unit 720 with the article of clothing positioned between first magnet 731 and second magnet 732. In embodiments including first magnet 731 and second magnet 732, power cable 760 and data cable 770 may also be included. In these embodiments, power cable 760 and data cable 770 may be of any length, and may provide a flexible power and data connection between capturing unit 710 and power unit 720. Embodiments including first magnet 731 and second magnet 732 may further include a flexible PCB 765 connection in addition to or instead of power cable 760 and/or data cable 770. In some embodiments, first magnet 731 or second magnet 732 may be replaced by an object comprising a metal material.

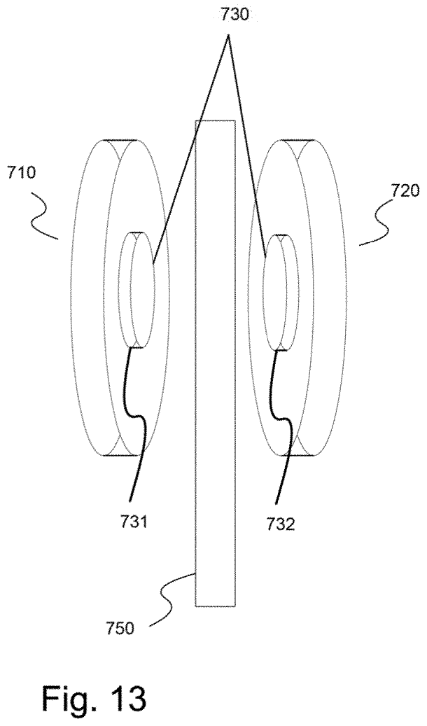

FIG. 13 is a schematic illustration of yet another embodiment of a wearable apparatus 110 securable to an article of clothing. FIG. 13 illustrates an embodiment wherein power and data may be wirelessly transferred between capturing unit 710 and power unit 720. As illustrated in FIG. 13, first magnet 731 and second magnet 732 may be provided as connector 730 to secure capturing unit 710 and power unit 720 to an article of clothing 750. Power and/or data may be transferred between capturing unit 710 and power unit 720 via any suitable wireless technology, for example, magnetic and/or capacitive coupling, near field communication technologies, radiofrequency transfer, and any other wireless technology suitable for transferring data and/or power across short distances.

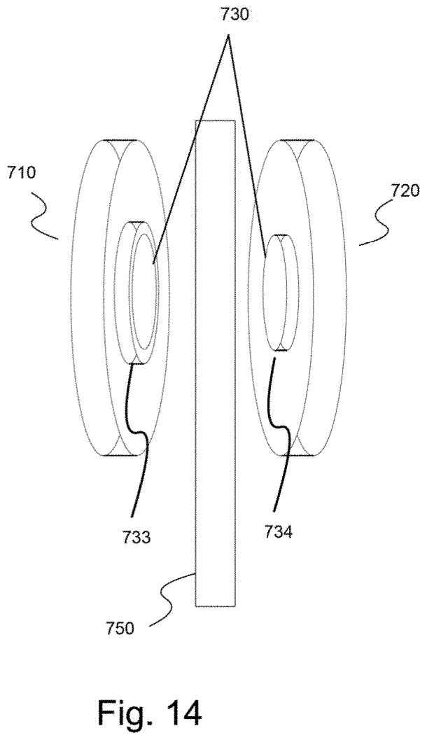

FIG. 14 illustrates still another embodiment of wearable apparatus 110 securable to an article of clothing 750 of a user. As illustrated in FIG. 14, connector 730 may include features designed for a contact fit. For example, capturing unit 710 may include a ring 733 with a hollow center having a diameter slightly larger than a disk-shaped protrusion 734 located on power unit 720. When pressed together with fabric of an article of clothing 750 between them, disk-shaped protrusion 734 may fit tightly inside ring 733, securing capturing unit 710 to power unit 720. FIG. 14 illustrates an embodiment that does not include any cabling or other physical connection between capturing unit 710 and power unit 720. In this embodiment, capturing unit 710 and power unit 720 may transfer power and data wirelessly. In alternative embodiments, capturing unit 710 and power unit 720 may transfer power and data via at least one of cable 760, data cable 770, and flexible printed circuit board 765.

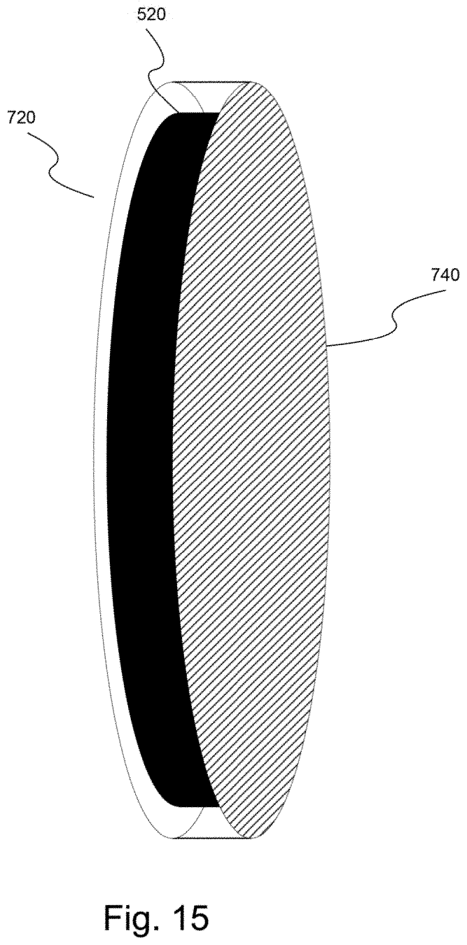

FIG. 15 illustrates another aspect of power unit 720 consistent with embodiments described herein. Power unit 720 may be configured to be positioned directly against the user's skin. To facilitate such positioning, power unit 720 may further include at least one surface coated with a biocompatible material 740. Biocompatible materials 740 may include materials that will not negatively react with the skin of the user when worn against the skin for extended periods of time. Such materials may include, for example, silicone, PTFE, kapton, polyimide, titanium, nitinol, platinum, and others. Also as illustrated in FIG. 15, power unit 720 may be sized such that an inner volume of the power unit is substantially filled by mobile power source 520. That is, in some embodiments, the inner volume of power unit 720 may be such that the volume does not accommodate any additional components except for mobile power source 520. In some embodiments, mobile power source 520 may take advantage of its close proximity to the skin of user's skin. For example, mobile power source 520 may use the Peltier effect to produce power and/or charge the power source.

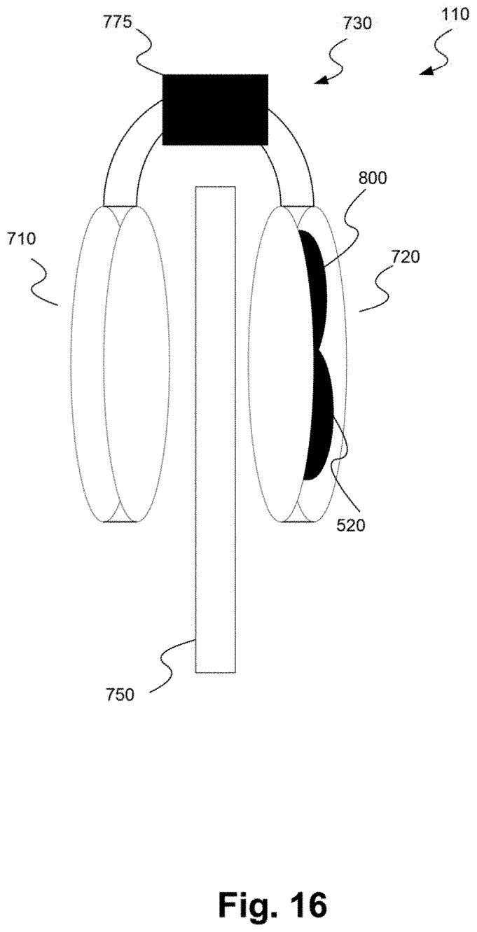

In further embodiments, an apparatus securable to an article of clothing may further include protective circuitry associated with power source 520 housed in in power unit 720. FIG. 16 illustrates an exemplary embodiment including protective circuitry 775. As illustrated in FIG. 16, protective circuitry 775 may be located remotely with respect to power unit 720. In alternative embodiments, protective circuitry 775 may also be located in capturing unit 710, on flexible printed circuit board 765, or in power unit 720.

Protective circuitry 775 may be configured to protect image sensor 220 and/or other elements of capturing unit 710 from potentially dangerous currents and/or voltages produced by mobile power source 520. Protective circuitry 775 may include passive components such as capacitors, resistors, diodes, inductors, etc., to provide protection to elements of capturing unit 710. In some embodiments, protective circuitry 775 may also include active components, such as transistors, to provide protection to elements of capturing unit 710. For example, in some embodiments, protective circuitry 775 may comprise one or more resistors serving as fuses. Each fuse may comprise a wire or strip that melts (thereby braking a connection between circuitry of image capturing unit 710 and circuitry of power unit 720) when current flowing through the fuse exceeds a predetermined limit (e.g., 500 milliamps, 900 milliamps, 1 amp, 1.1 amps, 2 amp, 2.1 amps, 3 amps, etc.) Any or all of the previously described embodiments may incorporate protective circuitry 775.

In some embodiments, the wearable apparatus may transmit data to a computing device (e.g., a smartphone, tablet, watch, computer, etc.) over one or more networks via any known wireless standard (e.g., cellular, Wi-Fi, Bluetooth®, etc.), or via near-filed capacitive coupling, other short range wireless techniques, or via a wired connection. Similarly, the wearable apparatus may receive data from the computing device over one or more networks via any known wireless standard (e.g., cellular, Wi-Fi, Bluetooth®, etc.), or via near-filed capacitive coupling, other short range wireless techniques, or via a wired connection. The data transmitted to the wearable apparatus and/or received by the wireless apparatus may include images, portions of images, identifiers related to information appearing in analyzed images or associated with analyzed audio, or any other data representing image and/or audio data. For example, an image may be analyzed and an identifier related to an activity occurring in the image may be transmitted to the computing device (e.g., the “paired device”). In the embodiments described herein, the wearable apparatus may process images and/or audio locally (on board the wearable apparatus) and/or remotely (via a computing device). Further, in the embodiments described herein, the wearable apparatus may transmit data related to the analysis of images and/or audio to a computing device for further analysis, display, and/or transmission to another device (e.g., a paired device). Further, a paired device may execute one or more applications (apps) to process, display, and/or analyze data (e.g., identifiers, text, images, audio, etc.) received from the wearable apparatus.

Some of the disclosed embodiments may involve systems, devices, methods, and software products for determining at least one keyword. For example, at least one keyword may be determined based on data collected by apparatus 110. At least one search query may be determined based on the at least one keyword. The at least one search query may be transmitted to a search engine.

In some embodiments, at least one keyword may be determined based on at least one or more images captured by image sensor 220. In some cases, the at least one keyword may be selected from a keywords pool stored in memory. In some cases, optical character recognition (OCR) may be performed on at least one image captured by image sensor 220, and the at least one keyword may be determined based on the OCR result. In some cases, at least one image captured by image sensor 220 may be analyzed to recognize: a person, an object, a location, a scene, and so forth. Further, the at least one keyword may be determined based on the recognized person, object, location, scene, etc. For example, the at least one keyword may comprise: a person's name, an object's name, a place's name, a date, a sport team's name, a movie's name, a book's name, and so forth.

In some embodiments, at least one keyword may be determined based on the user's behavior. The user's behavior may be determined based on an analysis of the one or more images captured by image sensor 220. In some embodiments, at least one keyword may be determined based on activities of a user and/or other person. The one or more images captured by image sensor 220 may be analyzed to identify the activities of the user and/or the other person who appears in one or more images captured by image sensor 220. In some embodiments, at least one keyword may be determined based on at least one or more audio segments captured by apparatus 110. In some embodiments, at least one keyword may be determined based on at least GPS information associated with the user. In some embodiments, at least one keyword may be determined based on at least the current time and/or date.

In some embodiments, at least one search query may be determined based on at least one keyword. In some cases, the at least one search query may comprise the at least one keyword. In some cases, the at least one search query may comprise the at least one keyword and additional keywords provided by the user. In some cases, the at least one search query may comprise the at least one keyword and one or more images, such as images captured by image sensor 220. In some cases, the at least one search query may comprise the at least one keyword and one or more audio segments, such as audio segments captured by apparatus 110.

In some embodiments, the at least one search query may be transmitted to a search engine. In some embodiments, search results provided by the search engine in response to the at least one search query may be provided to the user. In some embodiments, the at least one search query may be used to access a database.

For example, in one embodiment, the keywords may include a name of a type of food, such as quinoa, or a brand name of a food product: and the search will output information related to desirable quantities of consumption, facts about the nutritional profile, and so forth. In another example, in one embodiment, the keywords may include a name of a restaurant, and the search will output information related to the restaurant, such as a menu, opening hours, reviews, and so forth. The name of the restaurant may be obtained using OCR on an image of signage, using GPS information, and so forth. In another example, in one embodiment, the keywords may include a name of a person, and the search will provide information from a social network profile of the person. The name of the person may be obtained using OCR on an image of a name tag attached to the person's shirt, using face recognition algorithms, and so forth. In another example, in one embodiment, the keywords may include a name of a hook, and the search will output information related to the book, such as reviews, sales statistics, information regarding the author of the book, and so forth. In another example, in one embodiment, the keywords may include a name of a movie, and the search will output information related to the movie, such as reviews, box office statistics, information regarding the cast of the movie, show times, and so forth. In another example, in one embodiment, the keywords may include a name of a sport team, and the search will output information related to the sport team, such as statistics, latest results, future schedule, information regarding the players of the sport team, and so forth. For example, the name of the sport team may be obtained using audio recognition algorithms.

Camera-Based Directional Hearing Aid

As discussed previously, the disclosed embodiments may include providing feedback, such as acoustical and tactile feedback, to one or more auxiliary devices in response to processing at least one image in an environment. In some embodiments, the auxiliary device may be an earpiece or other device used to provide auditory feedback to the user, such as a hearing aid. Traditional hearing aids often use microphones to amplify sounds in the user's environment. These traditional systems, however, are often unable to distinguish between sounds that may be of particular importance to the wearer of the device, or may do so on a limited basis. Using the systems and methods of the disclosed embodiments, various improvements to traditional hearing aids are provided, as described in detail below.

In one embodiment, a camera-based directional hearing aid may be provided for selectively amplifying sounds based on a look direction of a user. The hearing aid may communicate with an image capturing device, such as apparatus 110, to determine the look direction of the user. This look direction may be used to isolate and/or selectively amplify sounds received from that direction (e.g., sounds from individuals in the user's look direction, etc.). Sounds received from directions other than the user's look direction may be suppressed, attenuated, filtered or the like.

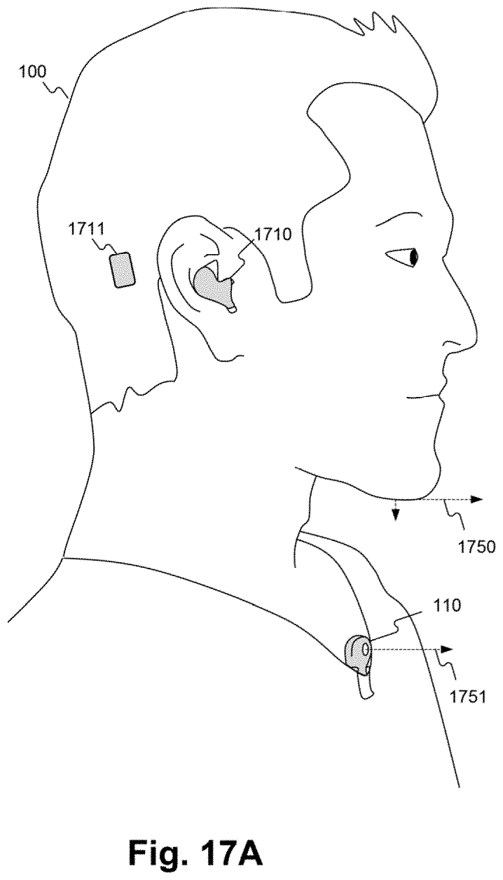

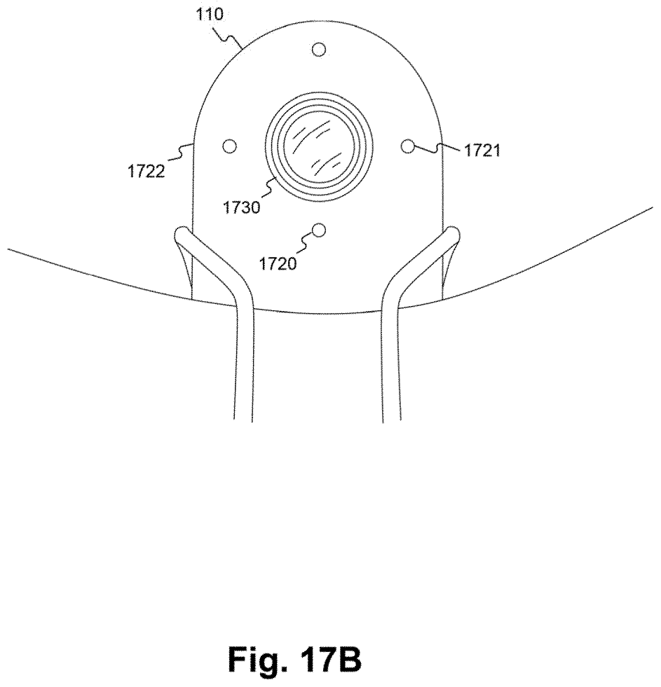

FIG. 17A is a schematic illustration of an example of a user 100 wearing an apparatus 110 for a camera-based hearing interface device 1710 according to a disclosed embodiment. User 100 may wear apparatus 110 that is physically connected to a shirt or other piece of clothing of user 100, as shown. Consistent with the disclosed embodiments, apparatus 110 may be positioned in other locations, as described previously. For example, apparatus 110 may be physically connected to a necklace, a belt, glasses, a wrist strap, a button, etc. Apparatus 110 may be configured to communicate with a hearing interface device such as hearing interface device 1710. Such communication may be through a wired connection, or may be made wirelessly (e.g., using a Bluetooth™, NFC, or forms of wireless communication). In some embodiments, one or more additional devices may also be included, such as computing device 120. Accordingly, one or more of the processes or functions described herein with respect to apparatus 110 or processor 210 may be performed by computing device 120 and/or processor 540.

Hearing interface device 1710 may be any device configured to provide audible feedback to user 100. Hearing interface device 1710 may correspond to feedback outputting unit 230, described above, and therefore any descriptions of feedback outputting unit 230 may also apply to hearing interface device 1710. In some embodiments, hearing interface device 1710 may be separate from feedback outputting unit 230 and may be configured to receive signals from feedback outputting unit 230. As shown in FIG. 17A, hearing interface device 1710 may be placed in one or both ears of user 100, similar to traditional hearing interface devices. Hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, microphones for detecting sounds in the environment of user 100, internal electronics, processors, memories, etc. In some embodiments, in addition to or instead of a microphone, hearing interface device 1710 may comprise one or more communication units, and in particular one or more receivers for receiving signals from apparatus 110 and transferring the signals to user 100.

Hearing interface device 1710 may have various other configurations or placement locations. In some embodiments, hearing interface device 1710 may comprise a bone conduction headphone 1711, as shown in FIG. 17A. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc.

Apparatus 110 may be configured to determine a user look direction 1750 of user 100. In some embodiments, user look direction 1750 may be tracked by monitoring a direction of the chin, or another body part or face part of user 100 relative to an optical axis of a camera sensor 1751. Apparatus 110 may be configured to capture one or more images of the surrounding environment of user, for example, using image sensor 220. The captured images may include a representation of a chin of user 100, which may be used to determine user look direction 1750. Processor 210 (and/or processors 210a and 210b) may be configured to analyze the captured images and detect the chin or another part of user 100 using various image detection or processing algorithms (e.g., using convolutional neural networks (CNN), scale-invariant feature transform (SIFT), histogram of oriented gradients (HOG) features, or other techniques). Based on the detected representation of a chin of user 100, look direction 1750 may be determined. Look direction 1750 may be determined in part by comparing the detected representation of a chin of user 100 to an optical axis of a camera sensor 1751. For example, the optical axis 1751 may be known or fixed in each image and processor 210 may determine look direction 1750 by comparing a representative angle of the chin of user 100 to the direction of optical axis 1751. While the process is described using a representation of a chin of user 100, various other features may be detected for determining user look direction 1750, including the user's face, nose, eyes, hand, etc.

In other embodiments, user look direction 1750 may be aligned more closely with the optical axis 1751. For example, as discussed above, apparatus 110 may be affixed to a pair of glasses of user 100, as shown in FIG. 1A. In this embodiment, user look direction 1750 may be the same as or close to the direction of optical axis 1751. Accordingly, user look direction 1750 may be determined or approximated based on the view of image sensor 220.

FIG. 17B is a schematic illustration of an embodiment of an apparatus securable to an article of clothing consistent with the present disclosure. Apparatus 110 may be securable to a piece of clothing, such as the shirt of user 110, as shown in FIG. 17A. Apparatus 110 may be securable to other articles of clothing, such as a belt or pants of user 100, as discussed above. Apparatus 110 may have one or more cameras 1730, which may correspond to image sensor 220. Camera 1730 may be configured to capture images of the surrounding environment of user 100. In some embodiments, camera 1730 may be configured to detect a representation of a chin of the user in the same images capturing the surrounding environment of the user, which may be used for other functions described in this disclosure. In other embodiments camera 1730 may be an auxiliary or separate camera dedicated to determining user look direction 1750.

Apparatus 110 may further comprise one or more microphones 1720 for capturing sounds from the environment of user 100. Microphone 1720 may also be configured to determine a directionality of sounds in the environment of user 100. For example, microphone 1720 may comprise one or more directional microphones, which may be more sensitive to picking up sounds in certain directions. For example, microphone 1720 may comprise a unidirectional microphone, designed to pick up sound from a single direction or small range of directions. Microphone 1720 may also comprise a cardioid microphone, which may be sensitive to sounds from the front and sides. Microphone 1720 may also include a microphone array, which may comprise additional microphones, such as microphone 1721 on the front of apparatus 110, or microphone 1722, placed on the side of apparatus 110. In some embodiments, microphone 1720 may be a multi-port microphone for capturing multiple audio signals. The microphones shown in FIG. 17B are by way of example only, and any suitable number, configuration, or location of microphones may be utilized. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100.

As a preliminary step before other audio analysis operations, the sound captured from an environment of a user may be classified using any audio classification technique. For example, the sound may be classified into segments containing music, tones, laughter, screams, or the like. Indications of the respective segments may be logged in a database and may prove highly useful for life logging applications. As one example, the logged information may enable the system to to retrieve and/or determine a mood when the user met another person. Additionally, such processing is relatively fast and efficient, and does not require significant computing resources, and transmitting the information to a destination does not require significant bandwidth. Moreover, once certain parts of the audio are classified as non-speech, more computing resources may be available for processing the other segments.

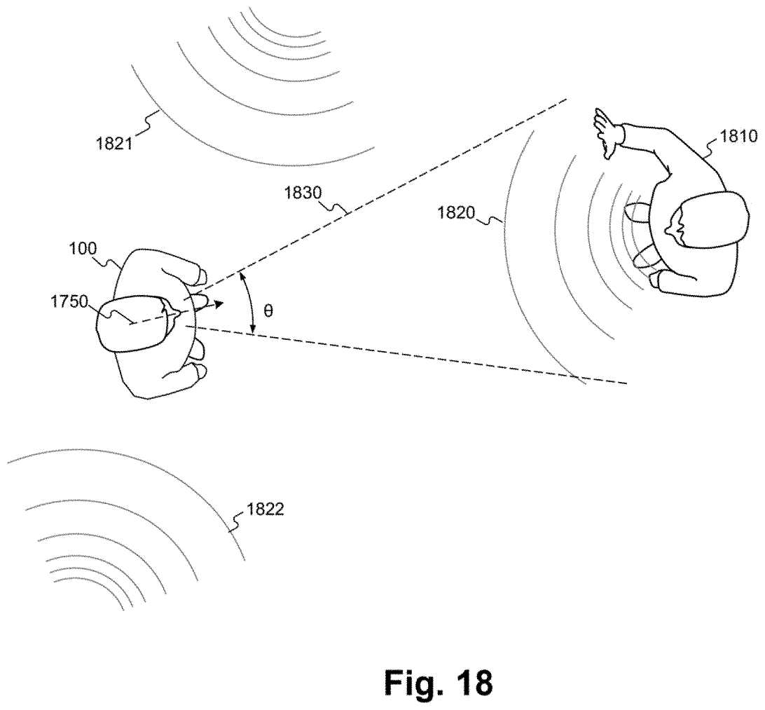

Based on the determined user look direction 1750, processor 210 may selectively condition or amplify sounds from a region associated with user look direction 1750. FIG. 18 is a schematic illustration showing an exemplary environment for use of a camera-based hearing aid consistent with the present disclosure. Microphone 1720 may detect one or more sounds 1820, 1821, and 1822 within the environment of user 100. Based on user look direction 1750, determined by processor 210, a region 1830 associated with user look direction 1750 may be determined. As shown in FIG. 18, region 1830 may be defined by a cone or range of directions based on user look direction 1750. The range of angles may be defined by an angle, θ, as shown in FIG. 18. The angle, θ, may be any suitable angle for defining a range for conditioning sounds within the environment of user 100 (e.g., 10 degrees, 20 degrees, 45 degrees).

Processor 210 may be configured to cause selective conditioning of sounds in the environment of user 100 based on region 1830. The conditioned audio signal may be transmitted to hearing interface device 1710, and thus may provide user 100 with audible feedback corresponding to the look direction of the user. For example, processor 210 may determine that sound 1820 (which may correspond to the voice of an individual 1810, or to noise for example) is within region 1830. Processor 210 may then perform various conditioning techniques on the audio signals received from microphone 1720. The conditioning may include amplifying audio signals determined to correspond to sound 1820 relative to other audio signals. Amplification may be accomplished digitally, for example by processing audio signals associated with 1820 relative to other signals. Amplification may also be accomplished by changing one or more parameters of microphone 1720 to focus on audio sounds emanating from region 1830 (e.g., a region of interest) associated with user look direction 1750. For example, microphone 1720 may be a directional microphone that and processor 210 may perform an operation to focus microphone 1720 on sound 1820 or other sounds within region 1830. Various other techniques for amplifying sound 1820 may be used, such as using a beamforming microphone array, acoustic telescope techniques, etc.

Conditioning may also include attenuation or suppressing one or more audio signals received from directions outside of region 1830. For example, processor 1820 may attenuate sounds 1821 and 1822. Similar to amplification of sound 1820, attenuation of sounds may occur through processing audio signals, or by varying one or more parameters associated with one or more microphones 1720 to direct focus away from sounds emanating from outside of region 1830.

In some embodiments, conditioning may further include changing a tone of audio signals corresponding to sound 1820 to make sound 1820 more perceptible to user 100. For example, user 100 may have lesser sensitivity to tones in a certain range and conditioning of the audio signals may adjust the pitch of sound 1820 to make it more perceptible to user 100. For example, user 100 may experience hearing loss in frequencies above 10 khz. Accordingly, processor 210 may remap higher frequencies (e.g., at 15 khz) to 10 khz. In some embodiments processor 210 may be configured to change a rate of speech associated with one or more audio signals. Accordingly, processor 210 may be configured to detect speech within one or more audio signals received by microphone 1720, for example using voice activity detection (VAD) algorithms or techniques. If sound 1820 is determined to correspond to voice or speech, for example from individual 1810, processor 220 may be configured to vary the playback rate of sound 1820. For example, the rate of speech of individual 1810 may be decreased to make the detected speech more perceptible to user 100. Various other processing may be performed, such as modifying the tone of sound 1820 to maintain the same pitch as the original audio signal, or to reduce noise within the audio signal. If speech recognition has been performed on the audio signal associated with sound 1820, conditioning may further include modifying the audio signal based on the detected speech. For example, processor 210 may introduce pauses or increase the duration of pauses between words and/or sentences, which may make the speech easier to understand.

The conditioned audio signal may then be transmitted to hearing interface device 1710 and produced for user 100. Thus, in the conditioned audio signal, sound 1820 may be easier to hear to user 100, louder and/or more easily distinguishable than sounds 1821 and 1822, which may represent background noise within the environment.

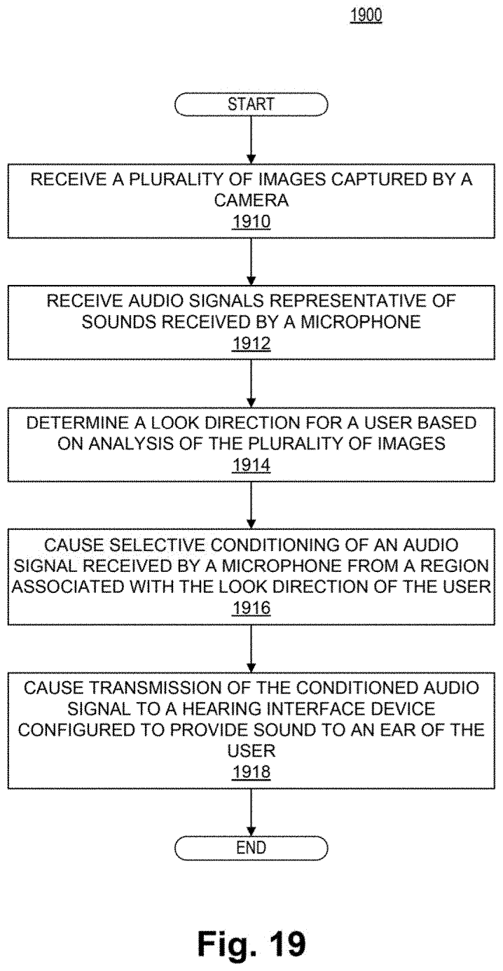

FIG. 19 is a flowchart showing an exemplary process 1900 for selectively amplifying sounds emanating from a detected look direction of a user consistent with disclosed embodiments. Process 1900 may be performed by one or more processors associated with apparatus 110, such as processor 210. In some embodiments, some or all of process 1900 may be performed on processors external to apparatus 110. In other words, the processor performing process 1900 may be included in a common housing as microphone 1720 and camera 1730, or may be included in a second housing. For example, one or more portions of process 1900 may be performed by processors in hearing interface device 1710, or an auxiliary device, such as computing device 120.

In step 1910, process 1900 may include receiving a plurality of images from an environment of a user captured by a camera. The camera may be a wearable camera such as camera 1730 of apparatus 110. In step 1912, process 1900 may include receiving audio signals representative of sounds received by at least one microphone. The microphone may be configured to capture sounds from an environment of the user. For example, the microphone may be microphone 1720, as described above. Accordingly, the microphone may include a directional microphone, a microphone array, a multi-port microphone, or various other types of microphones. In some embodiments, the microphone and wearable camera may be included in a common housing, such as the housing of apparatus 110. The one or more processors performing process 1900 may also be included in the housing or may be included in a second housing. In such embodiments, the processor(s) may be configured to receive images and/or audio signals from the common housing via a wireless link (e.g., Bluetooth™, NFC, etc.). Accordingly, the common housing (e.g., apparatus 110) and the second housing (e.g., computing device 120) may further comprise transmitters or various other communication components.

In step 1914, process 1900 may include determining a look direction for the user based on analysis of at least one of the plurality of images. As discussed above, various techniques may be used to determine the user look direction. In some embodiments, the look direction may be determined based, at least in part, upon detection of a representation of a chin of a user in one or more images. The images may be processed to determine a pointing direction of the chin relative to an optical axis of the wearable camera, as discussed above.

In step 1916, process 1900 may include causing selective conditioning of at least one audio signal received by the at least one microphone from a region associated with the look direction of the user. As described above, the region may be determined based on the user look direction determined in step 1914. The range may be associated with an angular width about the look direction (e.g., 10 degrees, 20 degrees, 45 degrees, etc.). Various forms of conditioning may be performed on the audio signal, as discussed above. In some embodiments, conditioning may include changing the tone or playback speed of an audio signal. For example, conditioning may include changing a rate of speech associated with the audio signal. In some embodiments, the conditioning may include amplification of the audio signal relative to other audio signals received from outside of the region associated with the look direction of the user. Amplification may be performed by various means, such as operation of a directional microphone configured to focus on audio sounds emanating from the region, or varying one or more parameters associated with the microphone to cause the microphone to focus on audio sounds emanating from the region. The amplification may include attenuating or suppressing one or more audio signals received by the microphone from directions outside the region associated with the look direction of user 110.

In step 1918, process 1900 may include causing transmission of the at least one conditioned audio signal to a hearing interface device configured to provide sound to an ear of the user. The conditioned audio signal, for example, may be transmitted to hearing interface device 1710, which may provide sound corresponding to the audio signal to user 100. The processor performing process 1900 may further be configured to cause transmission to the hearing interface device of one or more audio signals representative of background noise, which may be attenuated relative to the at least one conditioned audio signal. For example, processor 220 may be configured to transmit audio signals corresponding to sounds 1820, 1821. and 1822. The signal associated with 1820, however, may be modified in a different manner, for example amplified, from sounds 1821 and 1822 based on a determination that sound 1820 is within region 1830. In some embodiments, hearing interface device 1710 may include a speaker associated with an earpiece. For example, hearing interface device may be inserted at least partially into the ear of the user for providing audio to the user. Hearing interface device may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin, or may be implanted surgically and attached to the bone of the user.

Hearing Aid with Voice and/or Image Recognition

Consistent with the disclosed embodiments, a hearing aid may selectively amplify audio signals associated with a voice of a recognized individual. The hearing aid system may store voice characteristics and/or facial features of a recognized person to aid in recognition and selective amplification. For example, when an individual enters the field of view of apparatus 110, the individual may be recognized as an individual that has been introduced to the device, or that has possibly interacted with user 100 in the past (e.g., a friend, colleague, relative, prior acquaintance, etc.). Accordingly, audio signals associated with the recognized individual's voice may be isolated and/or selectively amplified relative to other sounds in the environment of the user. Audio signals associated with sounds received from directions other than the individual's direction may be suppressed, attenuated, filtered or the like.

User 100 may wear a hearing aid device similar to the camera-based hearing aid device discussed above. For example, the hearing aid device may be hearing interface device 1720, as shown in FIG. 17A. Hearing interface device 1710 may be any device configured to provide audible feedback to user 100. Hearing interface device 1710 may be placed in one or both ears of user 100, similar to traditional hearing interface devices. As discussed above, hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, a communication unit for receiving signals from another system, such as apparatus 110, microphones for detecting sounds in the environment of user 100, internal electronics, processors, memories, etc. Hearing interface device 1710 may correspond to feedback outputting unit 230 or may be separate from feedback outputting unit 230 and may be configured to receive signals from feedback outputting unit 230.

In some embodiments, hearing interface device 1710 may comprise a bone conduction headphone 1711, as shown in FIG. 17A. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc.

Hearing interface device 1710 may be configured to communicate with a camera device, such as apparatus 110. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by computing device 120 and/or processor 540.

As discussed above, apparatus 110 may comprise at least one microphone and at least one image capture device. Apparatus 110 may comprise microphone 1720, as described with respect to FIG. 17B. Microphone 1720 may be configured to determine a directionality of sounds in the environment of user 100. For example, microphone 1720 may comprise one or more directional microphones, a microphone array, a multi-port microphone, or the like. The microphones shown in FIG. 17B are by way of example only, and any suitable number, configuration, or location of microphones may be utilized. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100. Apparatus 110 may comprise one or more cameras, such as camera 1730, which may correspond to image sensor 220. Camera 1730 may be configured to capture images of the surrounding environment of user 100.

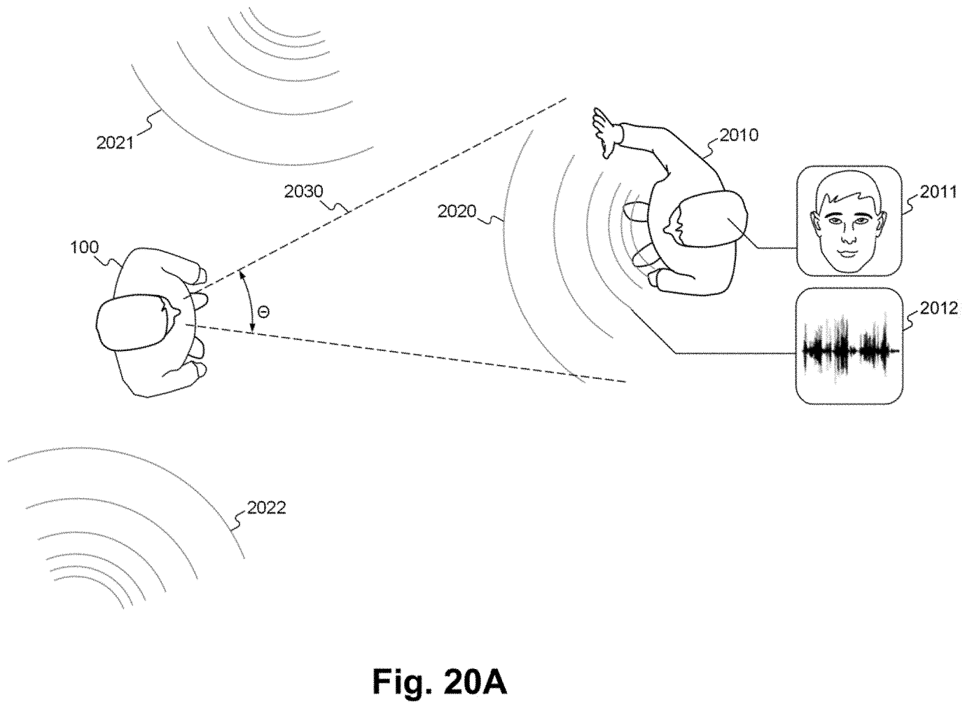

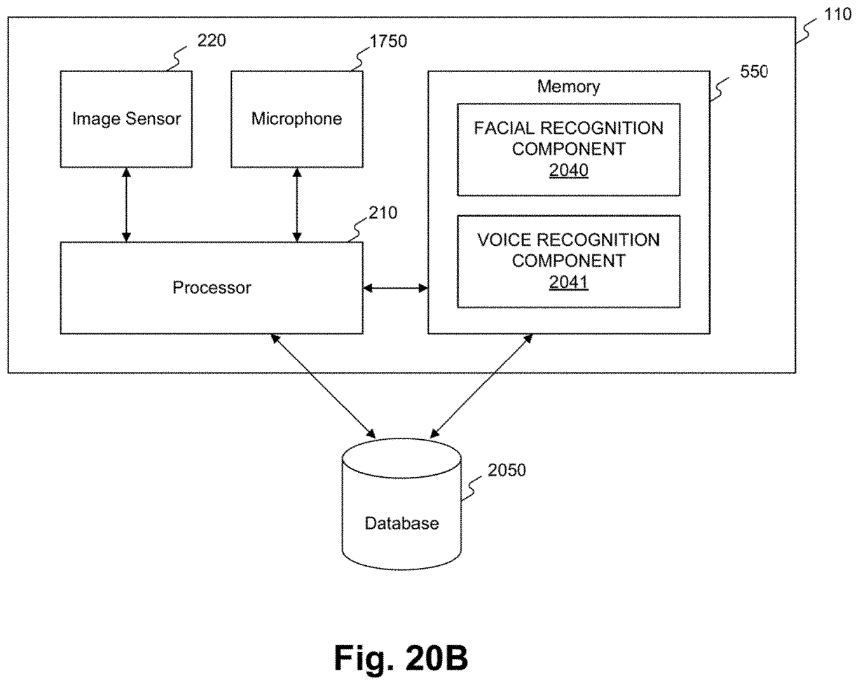

Apparatus 110 may be configured to recognize an individual in the environment of user 100. FIG. 20A is a schematic illustration showing an exemplary environment for use of a hearing aid with voice and/or image recognition consistent with the present disclosure. Apparatus 110 may be configured to recognize a face 2011 or voice 2012 associated with an individual 2010 within the environment of user 100. For example, apparatus 110 may be configured to capture one or more images of the surrounding environment of user 100 using camera 1730. The captured images may include a representation of a recognized individual 2010, which may be a friend, colleague, relative, or prior acquaintance of user 100. Processor 210 (and/or processors 210a and 210b) may be configured to analyze the captured images and detect the recognized user using various facial recognition techniques, as represented by clement 2011. Accordingly, apparatus 110, or specifically memory 550, may comprise one or more facial or voice recognition components.

FIG. 20B illustrates an exemplary embodiment of apparatus 110 comprising facial and voice recognition components consistent with the present disclosure. Apparatus 110 is shown in FIG. 20B in a simplified form, and apparatus 110 may contain additional denims or may have alternative configurations, for example, as shown in FIGS. 5A-5C. Memory 550 (or 550a or 550b) may include facial recognition component 2040 and voice recognition component 2041. These components may be instead of or in addition to orientation identification module 601, orientation adjustment module 602, and motion tracking module 603 as shown in FIG. 6. Components 2040 and 2041 may contain software instructions for execution by at least one processing device, e.g., processor 210, included with a wearable apparatus. Components 2040 and 2041 are shown within memory 550 by way of example only, and may be located in other locations within the system. For example, components 2040 and 2041 may be located in hearing interface device 1710, in computing device 120, on a remote server, or in another associated device.

Facial recognition component 2040 may be configured to identify one or more faces within the environment of user 100. For example, facial recognition component 2040 may identify facial features on the face 2011 of individual 2010, such as the eyes, nose, cheekbones, jaw, or other features. Facial recognition component 2040 may then analyze the relative size and position of these features to identify the user. Facial recognition component 2040 may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH), Scale invariant Feature Transform (SIFT), Speed Up Robust Features (SURF), or the like. Other facial recognition techniques such as 3-Dimensional recognition, skin texture analysis, and/or thermal imaging may also be used to identify individuals. Other features besides facial features may also be used for identification, such as the height, body shape, or other distinguishing features of individual 2010.

Facial recognition component 2040 may access a database or data associated with user 100 to determine if the detected facial features correspond to a recognized individual. For example, a processor 210 may access a database 2050 containing information about individuals known to user 100 and data representing associated facial features or other identifying features. Such data may include one or more images of the individuals, or data representative of a face of the user that may be used for identification through facial recognition. Database 2050 may be any device capable of storing information about one or more individuals, and may include a hard drive, a solid state drive, a web storage platform, a remote server, or the like. Database 2050 may be located within apparatus 110 (e.g., within memory 550) or external to apparatus 110, as shown in FIG. 20B. In some embodiments, database 2050 may be associated with a social network platform, such as Facebook™, LinkedIn™, Instagram™, etc. Facial recognition component 2040 may also access a contact list of user 100, such as a contact list on the user's phone, a web-based contact list (e.g., through Outlook™, Skype™, Google™, SalesForce™, etc.) or a dedicated contact list associated with hearing interface device 1710. In some embodiments, database 2050 may be compiled by apparatus 110 through previous facial recognition analysis. For example, processor 210 may be configured to store data associated with one or more faces recognized in images captured by apparatus 110 in database 2050. Each time a face is detected in the images, the detected facial features or other data may be compared to previously identified faces in database 2050. Facial recognition component 2040 may determine that an individual is a recognized individual of user 100 if the individual has previously been recognized by the system in a number of instances exceeding a certain threshold, if the individual has been explicitly introduced to apparatus 110, or the like.

In some embodiments, user 100 may have access to database 2050, such as through a web interface, an application on a mobile device, or through apparatus 110 or an associated device. For example, user 100 may be able to select which contacts are recognizable by apparatus 110 and/or delete or add certain contacts manually. In some embodiments, a user or administrator may be able to train facial recognition component 2040. For example, user 100 may have an option to confirm or reject identifications made by facial recognition component 2040, which may improve the accuracy of the system. This training may occur in real time, as individual 2010 is being recognized, or at some later time.

Other data or information may also inform the facial identification process. In some embodiments, processor 210 may use various techniques to recognize the voice of individual 2010, as described in further detail below. The recognized voice pattern and the detected facial features may be used, either alone or in combination, to determine that individual 2010 is recognized by apparatus 110. Processor 210 may also determine a user look direction 1750, as described above, which may be used to verify the identity of individual 2010. For example, if user 100 is looking in the direction of individual 2010 (especially for a prolonged period), this may indicate that individual 2010 is recognized by user 100, which may be used to increase the confidence of facial recognition component 2040 or other identification means.

Processor 210 may further be configured to determine whether individual 2010 is recognized by user 100 based on one or more detected audio characteristics of sounds associated with a voice of individual 2010. Returning to FIG. 20A, processor 210 may determine that sound 2020 corresponds to voice 2012 of user 2010. Processor 210 may analyze audio signals representative of sound 2020 captured by microphone 1720 to determine whether individual 2010 is recognized by user 100. This may be performed using voice recognition component 2041 (FIG. 20B) and may include one or more voice recognition algorithms, such as Hidden Markov Models, Dynamic Time Warping, neural networks, or other techniques. Voice recognition component and/or processor 210 may access database 2050, which may further include a voiceprint of one or more individuals. Voice recognition component 2041 may analyze the audio signal representative of sound 2020 to determine whether voice 2012 matches a voiceprint of an individual in database 2050. Accordingly, database 2050 may contain voiceprint data associated with a number of individuals, similar to the stored facial identification data described above. After determining a match, individual 2010 may be determined to be a recognized individual of user 100. This process may be used alone, or in conjunction with the facial recognition techniques described above. For example, individual 2010 may be recognized using facial recognition component 2040 and may be verified using voice recognition component 2041, or vice versa.

In some embodiments, apparatus 110 may detect the voice of an individual that is not within the field of view of apparatus 110. For example, the voice may be heard over a speakerphone, from a back scat, or the like. In such embodiments, recognition of an individual may be based on the voice of the individual only, in the absence of a speaker in the field of view. Processor 110 may analyze the voice of the individual as described above, for example, by determining whether the detected voice matches a voiceprint of an individual in database 2050.

After determining that individual 2010 is a recognized individual of user 100, processor 210 may cause selective conditioning of audio associated with the recognized individual. The conditioned audio signal may be transmitted to hearing interface device 1710, and thus may provide user 100 with audio conditioned based on the recognized individual. For example, the conditioning may include amplifying audio signals determined to correspond to sound 2020 (which may correspond to voice 2012 of individual 2010) relative to other audio signals. In some embodiments, amplification may be accomplished digitally, for example by processing audio signals associated with sound 2020 relative to other signals. Additionally, or alternatively, amplification may be accomplished by changing one or more parameters of microphone 1720 to focus on audio sounds associated with individual 2010. For example, microphone 1720 may be a directional microphone and processor 210 may perform an operation to focus microphone 1720 on sound 2020. Various other techniques for amplifying sound 2020 may be used, such as using a beamforming microphone array, acoustic telescope techniques, etc.

In some embodiments, selective conditioning may include attenuation or suppressing one or more audio signals received from directions not associated with individual 2010. For example, processor 210 may attenuate sounds 2021 and/or 2022. Similar to amplification of sound 2020, attenuation of sounds may occur through processing audio signals, or by varying one or more parameters associated with microphone 1720 to direct focus away from sounds not associated with individual 2010.

Selective conditioning may further include determining whether individual 2010 is speaking. For example, processor 210 may be configured to analyze images or videos containing representations of individual 2010 to determine when individual 2010 is speaking, for example, based on detected movement of the recognized individual's lips. This may also be determined through analysis of audio signals received by microphone 1720, for example by detecting the voice 2012 of individual 2010. In some embodiments, the selective conditioning may occur dynamically (initiated and/or terminated) based on whether or not the recognized individual is speaking.

In some embodiments, conditioning may further include changing a tone of one or more audio signals corresponding to sound 2020 to make the sound more perceptible to user 100. For example, user 100 may have lesser sensitivity to tones in a certain range and conditioning of the audio signals may adjust the pitch of sound 2020. In some embodiments processor 210 may be configured to change a rate of speech associated with one or more audio signals. For example, sound 2020 may be determined to correspond to voice 2012 of individual 2010. Processor 210 may be configured to vary the rate of speech of individual 2010 to make the detected speech more perceptible to user 100. Various other processing may be performed, such as modifying the tone of sound 2020 to maintain the same pitch as the original audio signal, or to reduce noise within the audio signal.

In some embodiments, processor 210 may determine a region 2030 associated with individual 2010. Region 2030 may be associated with a direction of individual 2010 relative to apparatus 110 or user 100. The direction of individual 2010 may be determined using camera 1730 and/or microphone 1720 using the methods described above. As shown in FIG. 20A, region 2030 may be defined by a cone or range of directions based on a determined direction of individual 2010. The range of angles may be defined by an angle, θ, as shown in FIG. 20A. The angle, θ, may be any suitable angle for defining a range for conditioning sounds within the environment of user 100 (e.g., 10 degrees, 20 degrees, 45 degrees). Region 2030 may be dynamically calculated as the position of individual 2010 changes relative to apparatus 110. For example, as user 100 turns, or if individual 1020 moves within the environment, processor 210 may be configured to track individual 2010 within the environment and dynamically update region 2030. Region 2030 may be used for selective conditioning, for example by amplifying sounds associated with region 2030 and/or attenuating sounds determined to be emanating from outside of region 2030.

The conditioned audio signal may then be transmitted to hearing interface device 1710 and produced for user 100. Thus, in the conditioned audio signal, sound 2020 (and specifically voice 2012) may be louder and/or more easily distinguishable than sounds 2021 and 2022, which may represent background noise within the environment.

In some embodiments, processor 210 may perform further analysis based on captured images or videos to determine how to selectively condition audio signals associated with a recognized individual. In some embodiments, processor 210 may analyze the captured images to selectively condition audio associated with one individual relative to others. For example, processor 210 may determine the direction of a recognized individual relative to the user based on the images and may determine how to selectively condition audio signals associated with the individual based on the direction. If the recognized individual is standing to the front of the user, audio associated with that user may be amplified (or otherwise selectively conditioned) relative to audio associated with an individual standing to the side of the user. Similarly, processor 210 may selectively condition audio signals associated with an individual based on proximity to the user. Processor 210 may determine a distance from the user to each individual based on captured images and may selectively condition audio signals associated with the individuals based on the distance. For example, an individual closer to the user may be prioritized higher than, an individual that is farther away. In some embodiments, the angle between the user's looking direction and the individual may also be considered. For example, an individual positioned at a smaller angle relative to the user's look direction may be prioritized higher than individuals positioned at greater angles from the look direction of the user.

In some embodiments, selective conditioning of audio signals associated with a recognized individual may be based on the identities of individuals within the environment of the user. For example, where multiple individuals are detected in the images, processor 210 may use one or more facial recognition techniques to identify the individuals, as described above. Audio signals associated with individuals that are known to user 100 may be selectively amplified or otherwise conditioned to have priority over unknown individuals. For example, processor 210 may be configured to attenuate or silence audio signals associated with bystanders in the user's environment, such as a noisy office mate, etc. In some embodiments, processor 210 may also determine a hierarchy of individuals and give priority based on the relative status of the individuals. This hierarchy may be based on the individual's position within a family or an organization (e.g., a company, sports team, club, etc.) relative to the user. For example, the user's boss may be ranked higher than a co-worker or a member of the maintenance staff and thus may have priority in the selective conditioning process. In some embodiments, the hierarchy may be determined based on a list or database. Individuals recognized by the system may be ranked individually or grouped into tiers of priority. This database may be maintained specifically for this purpose, or may be accessed externally. For example, the database may be associated with a social network of the user (e.g., Facebook™, LinkedIn™, etc.) and individuals may be prioritized based on their grouping or relationship with the user. Individuals identified as “close friends” or family, for example, may be prioritized over acquaintances of the user.

Selective conditioning may be based on a determined behavior of one or more individuals determined based on the captured images. In some embodiments, processor 210 may be configured to determine a look direction of the individuals in the images. Accordingly, the selective conditioning may be based on behavior of the other individuals towards the recognized individual. For example, processor 210 may selectively condition audio associated with a first individual that one or more other users are looking at. If the attention of the individuals shifts to a second individual, processor 210 may then switch to selectively condition audio associated with the second user. In some embodiments, processor 210 may be configured to selectively condition audio based on whether a recognized individual is speaking to the user or to another individual. For example, when the recognized individual is speaking to the user, the selective conditioning may include amplifying an audio signal associated with the recognized individual relative to other audio signals received from directions outside a region associated with the recognized individual. When the recognized individual is speaking to another individual, the selective conditioning may include attenuating the audio signal relative to other audio signals received from directions outside the region associated with the recognized individual.

In some embodiments, processor 210 may have access to one or more voiceprints of individuals, which may facilitate selective conditioning of voice 2012 of individual 2010 in relation to other sounds or voices. Having a speaker's voiceprint, and a high quality voiceprint in particular, may provide for fast and efficient speaker separation. A high quality voice print may be collected, for example, when the user speaks alone, preferably in a quiet environment. By having a voiceprint of one or more speakers, it is possible to separate an ongoing voice signal almost in real time, e.g. with a minimal delay, using a sliding time window. The delay may be, for example 10 ms, 20 ms, 30 ms, 50 ms, 100 ms, or the like. Different time windows may be selected, depending on the quality of the voice print, on the quality of the captured audio, the difference in characteristics between the speaker and other speaker(s), the available processing resources, the required separation quality, or the like. In some embodiments, a voice print may be extracted from a segment of a conversation in which an individual speaks alone, and then used for separating the individual's voice later in the conversation, whether the individual's is recognized or not.

Separating voices may be performed as follows: spectral features, also referred to as spectral attributes, spectral envelope, or spectrogram may be extracted from a clean audio of a single speaker and fed into a pre-trained first neural network, which generates or updates a signature of the speaker's voice based on the extracted features. The audio may be for example, of one second of clean voice. The output signature may be a vector representing the speaker's voice, such that the distance between the vector and another vector extracted from the voice of the same speaker is typically smaller than the distance between the vector and a vector extracted from the voice of another speaker. The speaker's model may be pre-generated from a captured audio. Alternatively or additionally, the model may be generated after a segment of the audio in which only the speaker speaks, followed by another segment in which the speaker and another speaker (or background noise) is heard, and which it is required to separate.

Then, to separate the speaker's voice from additional speakers or background noise in a noisy audio, a second pre-trained neural network may receive the noisy audio and the speaker's signature, and output an audio (which may also be represented as attributes) of the voice of the speaker as extracted from the noisy audio, separated from the other speech or background noise. It will be appreciated that the same or additional neural networks may be used to separate the voices of multiple speakers. For example, if there are two possible speakers, two neural networks may be activated, each with models of the same noisy output and one of the two speakers. Alternatively, a neural network may receive voice signatures of two or more speakers, and output the voice of each of the speakers separately. Accordingly, the system may generate two or more different audio outputs, each comprising the speech of the respective speaker.

In some embodiments, if separation is impossible, the input voice may only be cleaned from background noise.

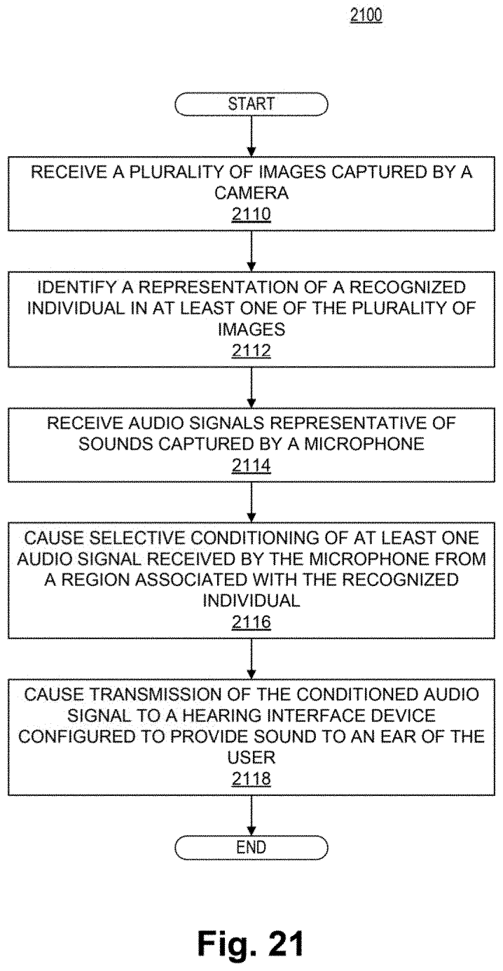

FIG. 21 is a flowchart showing an exemplary process 2100 for selectively amplifying audio signals associated with a voice of a recognized individual consistent with disclosed embodiments. Process 2100 may be performed by one or more processors associated with apparatus 110, such as processor 210. In some embodiments, some or all of process 2100 may be performed on processors external to apparatus 110. In other words, the processor performing process 2100 may be included in the same common housing as microphone 1720 and camera 1730, or may be included in a second housing. For example, one or more portions of process 2100 may be performed by processors in hearing interface device 1710, or in an auxiliary device, such as computing device 120.

In step 2110, process 2100 may include receiving a plurality of images from an environment of a user captured by a camera. The images may be captured by a wearable camera such as camera 1730 of apparatus 110. In step 2112, process 2100 may include identifying a representation of a recognized individual in at least one of the plurality of images. Individual 2010 may be recognized by processor 210 using facial recognition component 2040, as described above. For example, individual 2010 may be a friend, colleague, relative, or prior acquaintance of the user. Processor 210 may determine whether an individual represented in at least one of the plurality of images is a recognized individual based on one or more detected facial features associated with the individual. Processor 210 may also determine whether the individual is recognized based on one or more detected audio characteristics of sounds determined to be associated with a voice of the individual, as described above.

In step 2114, process 2100 may include receiving audio signals representative of sounds captured by a microphone. For example, apparatus 110 may receive audio signals representative of sounds 2020, 2021, and 2022, captured by microphone 1720. Accordingly, the microphone may include a directional microphone, a microphone array, a multi-port microphone, or various other types of microphones, as described above. In some embodiments, the microphone and wearable camera may be included in a common housing, such as the housing of apparatus 110. The one or more processors performing process 2100 may also be included in the housing (e.g., processor 210), or may be included in a second housing. Where a second housing is used, the processor(s) may be configured to receive images and/or audio signals from the common housing via a wireless link (e.g., Bluetooth™, NFC, etc.). Accordingly, the common housing (e.g., apparatus 110) and the second housing (e.g., computing device 120) may further comprise transmitters, receivers, and/or various other communication components.

In step 2116, process 2100 may include cause selective conditioning of at least one audio signal received by the at least one microphone from a region associated with the at least one recognized individual. As described above, the region may be determined based on a determined direction of the recognized individual based one or more of the plurality of images or audio signals. The range may be associated with an angular width about the direction of the recognized individual (e.g., 10 degrees, 20 degrees, 45 degrees, etc.).

Various forms of conditioning may be performed on the audio signal, as discussed above.

In some embodiments, conditioning may include changing the tone or playback speed of an audio signal. For example, conditioning may include changing a rate of speech associated with the audio signal. In some embodiments, the conditioning may include amplification of the audio signal relative to other audio signals received from outside of the region associated with the recognized individual. Amplification may be performed by various means, such as operation of a directional microphone configured to focus on audio sounds emanating from the region or varying one or more parameters associated with the microphone to cause the microphone to focus on audio sounds emanating from the region. The amplification may include attenuating or suppressing one or more audio signals received by the microphone from directions outside the region. In some embodiments, step 2116 may further comprise determining, based on analysis of the plurality of images, that the recognized individual is speaking and trigger the selective conditioning based on the determination that the recognized individual is speaking. For example, the determination that the recognized individual is speaking may be based on detected movement of the recognized individual's lips. In some embodiments, selective conditioning may be based on further analysis of the captured images as described above, for example, based on the direction or proximity of the recognized individual, the identity of the recognized individual, the behavior of other individuals, etc.

In step 2118, process 2100 may include causing transmission of the at least one conditioned audio signal to a hearing interface device configured to provide sound to an ear of the user. The conditioned audio signal, for example, may be transmitted to hearing interface device 1710, which may provide sound corresponding to the audio signal to user 100. The processor performing process 2100 may further be configured to cause transmission to the hearing interface device of one or more audio signals representative of background noise, which may be attenuated relative to the at least one conditioned audio signal. For example, processor 210 may be configured to transmit audio signals corresponding to sounds 2020, 2021, and 2022. The signal associated with 2020, however, may be amplified in relation to sounds 2021 and 2022 based on a determination that sound 2020 is within region 2030. In some embodiments, hearing interface device 1710 may include a speaker associated with an earpiece. For example, hearing interface device 1710 may be inserted at least partially into the ear of the user for providing audio to the user. Hearing interface device may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin, or may be implanted surgically and attached to the bone of the user.

In addition to recognizing voices of individuals speaking to user 100, the systems and methods described above may also be used to recognize the voice of user 100. For example, voice recognition unit 2041 may be configured to analyze audio signals representative of sounds collected from the user's environment to recognize the voice of user 100. Similar to the selective conditioning of the voice of recognized individuals, the voice of user 100 may be selectively conditioned. For example, sounds may be collected by microphone 1720, or by a microphone of another device, such as a mobile phone (or a device linked to a mobile phone). Audio signals corresponding to the voice of user 100 may be selectively transmitted to a remote device, for example, by amplifying the voice of user 100 and/or attenuating or eliminating altogether sounds other than the user's voice. Accordingly, a voiceprint of one or more users of apparatus 110 may be collected and/or stored to facilitate detection and/or isolation of the user's voice, as described in further detail above.

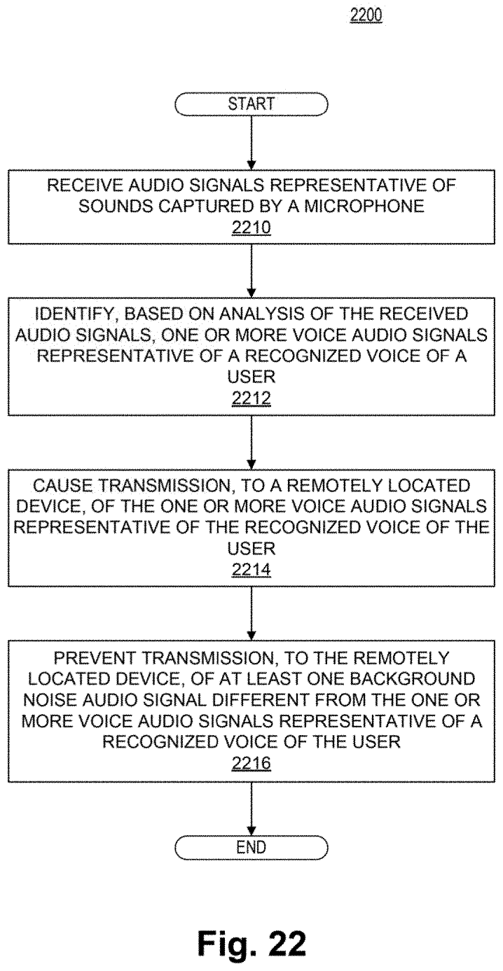

FIG. 22 is a flowchart showing an exemplary process 2200 for selectively transmitting audio signals associated with a voice of a recognized user consistent with disclosed embodiments. Process 2200 may be performed by one or more processors associated with apparatus 110, such as processor 210.

In step 2210, process 2200 may include receiving audio signals representative of sounds captured by a microphone. For example, apparatus 110 may receive audio signals representative of sounds 2020, 2021, and 2022, captured by microphone 1720. Accordingly, the microphone may include a directional microphone, a microphone array, a multi-port microphone, or various other types of microphones, as described above. In step 2212, process 2200 may include identifying, based on analysis of the received audio signals, one or more voice audio signals representative of a recognized voice of the user. For example, the voice of the user may be recognized based on a voiceprint associated with the user, which may be stored in memory 550, database 2050, or other suitable locations. Processor 210 may recognize the voice of the user, for example, using voice recognition component 2041. Processor 210 may separate an ongoing voice signal associated with the user almost in real time, e.g. with a minimal delay, using a sliding time window, The voice may be separated by extracting spectral features of an audio signal according to the methods described above.

In step 2214, process 2200 may include causing transmission, to a remotely located device, of the one or more voice audio signals representative of the recognized voice of the user. The remotely located device may be any device configured to receive audio signals remotely, either by a wired or wireless form of communication. In some embodiments, the remotely located device may be another device of the user, such as a mobile phone, an audio interface device, or another form of computing device. In some embodiments, the voice audio signals may be processed by the remotely located device and/or transmitted further. In step 2216, process 2200 may include preventing transmission, to the remotely located device, of at least one background noise audio signal different from the one or more voice audio signals representative of a recognized voice of the user. For example, processor 210 may attenuate and/or eliminate audio signals associated with sounds 2020, 2021, or 2023, which may represent background noise. The voice of the user may be separated from other noises using the audio processing techniques described above.

In an exemplary illustration, the voice audio signals may be captured by a headset or other device worn by the user. The voice of the user may be recognized and isolated from the background noise in the environment of the user. The headset may transmit the conditioned audio signal of the user's voice to a mobile phone of the user. For example, the user may be on a telephone call and the conditioned audio signal may be transmitted by the mobile phone to a recipient of the call. The voice of the user may also be recorded by the remotely located device. The audio signal, for example, may be stored on a remote server or other computing device. In some embodiments, the remotely located device may process the received audio signal, for example, to convert the recognized user's voice into text.

Lip-Tracking Hearing Aid

Consistent with the disclosed embodiments, a hearing aid system may selectively amplify audio signals based on tracked lip movements. The hearing aid system analyzes captured images of the environment of a user to detect lips of an individual and track movement of the individual's lips. The tracked lip movements may serve as a cue for selectively amplifying audio received by the hearing aid system. For example, voice signals determined to sync with the tracked lip movements or that are consistent with the tracked lip movements may be selectively amplified or otherwise conditioned. Audio signals that are not associated with the detected lip movement may be suppressed, attenuated, filtered or the like.

User 100 may wear a hearing aid device consistent with the camera-based hearing aid device discussed above. For example, the hearing aid device may be hearing interface device 1710, as shown in FIG. 17A. Hearing interface device 1710 may be any device configured to provide audible feedback to user 100. Hearing interface device 1710 may be placed in one or both ears of user 100, similar to traditional hearing interface devices. As discussed above, hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, microphones for detecting sounds in the environment of user 100, internal electronics, processors, memories, etc. In some embodiments, in addition to or instead of a microphone, hearing interface device 1710 may comprise one or more communication units, and one or more receivers for receiving signals from apparatus 110 and transferring the signals to user 100. Hearing interface device 1710 may correspond to feedback outputting unit 230 or may be separate from feedback outputting unit 230 and may be configured to receive signals from feedback outputting unit 230.

In some embodiments, hearing interface device 1710 may comprise a bone conduction headphone 1711, as shown in FIG. 17A. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc.

Hearing interface device 1710 may be configured to communicate with a camera device, such as apparatus 110. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by computing device 120 and/or processor 540.

As discussed above, apparatus 110 may comprise at least one microphone and at least one image capture device. Apparatus 110 may comprise microphone 1720, as described with respect to FIG. 17B. Microphone 1720 may be configured to determine a directionality of sounds in the environment of user 100. For example, microphone 1720 may comprise one or more directional microphones, a microphone array, a multi-port microphone, or the like. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100. Apparatus 110 may comprise one or more cameras, such as camera 1730, which may correspond to image sensor 220. Camera 1730 may be configured to capture images of the surrounding environment of user 100. Apparatus 110 may also use one or more microphones of hearing interface device 1710 and, accordingly, references to microphone 1720 used herein may also refer to a microphone on hearing interface device 1710.

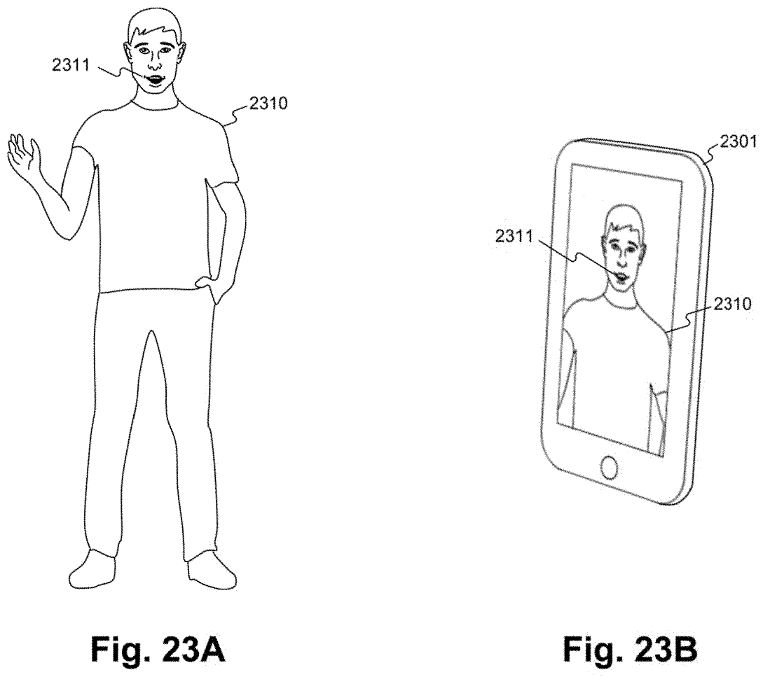

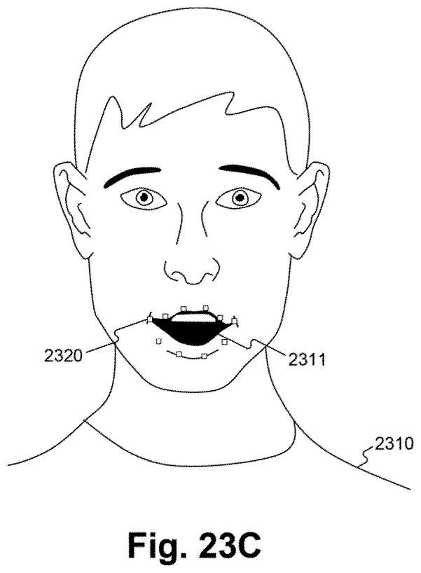

Processor 210 (and/or processors 210a and 2 Mb) may be configured to detect a mouth and/or lips associated with an individual within the environment of user 100. FIGS. 23A and 23B show an exemplary individual 2310 that may be captured by camera 1730 in the environment of a user consistent with the present disclosure. As shown in FIG. 23, individual 2310 may be physically present with the environment of user 100. Processor 210 may be configured to analyze images captured by camera 1730 to detect a representation of individual 2310 in the images. Processor 210 may use a facial recognition component, such as facial recognition component 2040, described above, to detect and identify individuals in the environment of user 100. Processor 210 may be configured to detect one or more facial features of user 2310, including a mouth 2311 of individual 2310. Accordingly, processor 210 may use one or more facial recognition and/or feature recognition techniques, as described further below.

In some embodiments, processor 210 may detect a visual representation of individual 2310 from the environment of user 100, such as a video of user 2310. As shown in FIG. 23B, user 2310 may be detected on the display of a display device 2301. Display device 2301 may be any device capable of displaying a visual representation of an individual. For example, display device may be a personal computer, a laptop, a mobile phone, a tablet, a television, a movie screen, a handheld gaming device, a video conferencing device (e.g., Facebook Portal™, etc.), a baby monitor, etc. The visual representation of individual 2310 may be a live video feed of individual 2310, such as a video call, a conference call, a surveillance video, etc. In other embodiments, the visual representation of individual 2310 may be a prerecorded video or image, such as a video message, a television program, or a movie. Processor 210 may detect one or more facial features based on the visual representation of individual 2310, including a mouth 2311 of individual 2310.

FIG. 23C illustrates an exemplary lip-tracking system consistent with the disclosed embodiments. Processor 210 may be configured to detect one or more facial features of individual 2310, which may include, but is not limited to the individual's mouth 2311. Accordingly, processor 210 may use one or more image processing techniques to recognize facial features of the user, such as convolutional neural networks (CNN), scale-invariant feature transform (SIFT), histogram of oriented gradients (HOG) features, or other techniques. In some embodiments, processor 210 may be configured to detect one or more points 2320 associated with the mouth 2311 of individual 2310. Points 2320 may represent one or more characteristic points of an individual's mouth, such as one or more points along the individual's lips or the corner of the individual's mouth. The points shown in FIG. 23C are for illustrative purposes only and it is understood that any points for tracking the individual's lips may be determined or identified via one or more image processing techniques. Points 2320 may be detected at various other locations, including points associated with the individual's teeth, tongue, cheek, chin, eyes, etc. Processor 210 may determine one or more contours of mouth 2311 (e.g., represented by lines or polygons) based on points 2320 or based on the captured image. The contour may represent the entire mouth 2311 or may comprise multiple contours, for example including a contour representing an upper lip and a contour representing a lower lip. Each lip may also be represented by multiple contours, such as a contour for the upper edge and a contour for the lower edge of each lip. Processor 210 may further use various other techniques or characteristics, such as color, edge, shape or motion detection algorithms to identify the lips of individual 2310. The identified lips may be tracked over multiple frames or images. Processor 210 may use one or more video tracking algorithms, such as mean-shift tracking, contour tracking (e.g., a condensation algorithm), or various other techniques. Accordingly, processor 210 may be configured to track movement of the lips of individual 2310 in real time.

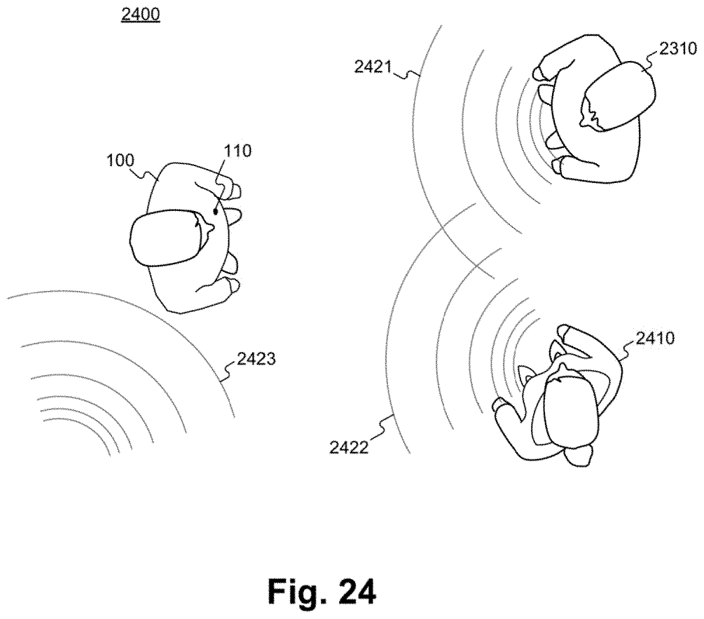

The tracked lip movement of individual 2310 may be used to separate if required, and selectively condition one or more sounds in the environment of user 100. FIG. 24 is a schematic illustration showing an exemplary environment 2400 for use of a lip-tracking hearing aid consistent with the present disclosure. Apparatus 110, worn by user 100 may be configured to identify one or more individuals within environment 2400. For example, apparatus 110 may be configured to capture one or more images of the surrounding environment 2400 using camera 1730. The captured images may include a representation of individuals 2310 and 2410, who may be present in environment 2400. Processor 210 may be configured to detect a mouth of individuals 2310 and 2410 and track their respective lip movements using the methods described above. In some embodiments, processor 210 may further be configured to identify individuals 2310 and 2410, for example, by detecting facial features of individuals 2310 and 2410 and comparing them to a database, as discussed previously.

In addition to detecting images, apparatus 110 may be configured to detect one or more sounds in the environment of user 100. For example, microphone 1720 may detect one or more sounds 2421, 2422, and 2423 within environment 2400. In some embodiments, the sounds may represent voices of various individuals. For example, as shown in FIG. 24, sound 2421 may represent a voice of individual 2310 and sound 2422 may represent a voice of individual 2410. Sound 2423 may represent additional voices and/or background noise within environment 2400. Processor 210 may be configured to analyze sounds 2421, 2422, and 2423 to separate and identify audio signals associated with voices. For example, processor 210 may use one or more speech or voice activity detection (VAD) algorithms and/or the voice separation techniques described above. When there are multiple voices detected in the environment, processor 210 may isolate audio signals associated with each voice. In some embodiments, processor 210 may perform further analysis on the audio signal associated the detected voice activity to recognize the speech of the individual. For example, processor 210 may use one or more voice recognition algorithms (e.g., Hidden Markov Models, Dynamic Time Warping, neural networks, or other techniques) to recognize the voice of the individual. Processor 210 may also be configured to recognize the words spoken by individual 2310 using various speech-to-text algorithms. In some embodiments, instead of using microphone 1710, apparatus 110 may receive audio signals from another device through a communication component, such as wireless transceiver 530. For example, if user 100 is on a video call, apparatus 110 may receive an audio signal representing a voice of user 2310 from display device 2301 or another auxiliary device.

Processor 210 may determine, based on lip movements and the detected sounds, which individuals in environment 2400 are speaking. For example, processor 2310 may track lip movements associated with mouth 2311 to determine that individual 2310 is speaking. A comparative analysis may be performed between the detected lip movement and the received audio signals. In some embodiments, processor 210 may determine that individual 2310 is speaking based on a determination that mouth 2311 is moving at the same time as sound 2421 is detected. For example, when the lips of individual 2310 stop moving, this may correspond with a period of silence or reduced volume in the audio signal associated with sound 2421. In some embodiments, processor 210 may be configured to determine whether specific movements of mouth 2311 correspond to the received audio signal. For example, processor 210 may analyze the received audio signal to identify specific phonemes, phoneme combinations or words in the received audio signal. Processor 210 may recognize whether specific lip movements of mouth 231 I correspond to the identified words or phonemes. Various machine learning or deep learning techniques may be implemented to correlate the expected lip movements to the detected audio. For example, a training data set of known sounds and corresponding lip movements may be fed to a machine learning algorithm to develop a model for correlating detected sounds with expected lip movements. Other data associated with apparatus 110 may further be used in conjunction with the detected lip movement to determine and/or verify whether individual 2310 is speaking, such as a look direction of user 100 or individual 2310, a detected identity of user 2310, a recognized voiceprint of user 2310, etc.

Based on the detected lip movement, processor 210 may cause selective conditioning of audio associated with individual 2310. The conditioning may include amplifying audio signals determined to correspond to sound 2421 (which may correspond to a voice of individual 2310) relative to other audio signals. In some embodiments, amplification may be accomplished digitally, for example by processing audio signals associated with sound 2421 relative to other signals. Additionally, or alternatively, amplification may be accomplished by changing one or more parameters of microphone 1720 to focus on audio sounds associated with individual 2310. For example, microphone 1720 may be a directional microphone and processor 210 may perform an operation to focus microphone 1720 on sound 2421. Various other techniques for amplifying sound 2421 may be used, such as using a beamforming microphone array, acoustic telescope techniques, etc. The conditioned audio signal may be transmitted to hearing interface device 1710, and thus may provide user 100 with audio conditioned based on the individual who is speaking.

In some embodiments, selective conditioning may include attenuation or suppressing one or more audio signals not associated with individual 2310, such as sounds 2422 and 2423. Similar to amplification of sound 2421, attenuation of sounds may occur through processing audio signals, or by varying one or more parameters associated with microphone 1720 to direct focus away from sounds not associated with individual 2310.

In some embodiments, conditioning may further include changing a tone of one or more audio signals corresponding to sound 2421 to make the sound more perceptible to user 100. For example, user 100 may have lesser sensitivity to tones in a certain range and conditioning of the audio signals may adjust the pitch of sound 2421. For example, user 100 may experience hearing loss in frequencies above 10 kHz and processor 210 may remap higher frequencies (e.g., at 15 kHz) to 10 kHz. In some embodiments processor 210 may be configured to change a rate of speech associated with one or more audio signals. Processor 210 may be configured to vary the rate of speech of individual 2310 to make the detected speech more perceptible to user 100. If speech recognition has been performed on the audio signal associated with sound 2421, conditioning may further include modifying the audio signal based on the detected speech. For example, processor 210 may introduce pauses or increase the duration of pauses between words and/or sentences, which may make the speech easier to understand. Various other processing may be performed, such as modifying the tone of sound 2421 to maintain the same pitch as the original audio signal, or to reduce noise within the audio signal.

The conditioned audio signal may then be transmitted to hearing interface device 1710 and then produced for user 100. Thus, in the conditioned audio signal, sound 2421 (may be louder and/or more easily distinguishable than sounds 2422 and 2423.

Processor 210 may be configured to selectively condition multiple audio signals based on which individuals associated with the audio signals are currently speaking. For example, individual 2310 and individual 2410 may be engaged in a conversation within environment 2400 and processor 210 may be configured to transition from conditioning of audio signals associated with sound 2421 to conditioning of audio signals associated with sound 2422 based on the respective lip movements of individuals 2310 and 2410. For example, lip movements of individual 2310 may indicate that individual 2310 has stopped speaking or lip movements associated with individual 2410 may indicate that individual 2410 has started speaking. Accordingly, processor 210 may transition between selectively conditioning audio signals associated with sound 2421 to audio signals associated with sound 2422. In some embodiments, processor 210 may be configured to process and/or condition both audio signals concurrently but only selectively transmit the conditioned audio to hearing interface device 1710 based on which individual is speaking. Where speech recognition is implemented, processor 210 may determine and/or anticipate a transition between speakers based on the context of the speech. For example, processor 210 may analyze audio signals associate with sound 2421 to determine that individual 2310 has reached the end of a sentence or has asked a question, which may indicate individual 2310 has finished or is about to finish speaking.

In some embodiments, processor 210 may be configured to select between multiple active speakers to selectively condition audio signals. For example, individuals 2310 and 2410 may both be speaking at the same time or their speech may overlap during a conversation. Processor 210 may selectively condition audio associated with one speaking individual relative to others. This may include giving priority to a speaker who has started but not finished a word or sentence or has not finished speaking altogether when the other speaker started speaking. This determination may also be driven by the context of the speech, as described above.

Various other factors may also be considered in selecting among active speakers. For example, a look direction of the user may be determined and the individual in the look direction of the user may be given higher priority among the active speakers. Priority may also be assigned based on the look direction of the speakers. For example, if individual 2310 is looking at user 100 and individual 2410 is looking elsewhere, audio signals associated with individual 2310 may be selectively conditioned. In some embodiments, priority may be assigned based on the relative behavior of other individuals in environment 2400. For example, if both individual 2310 and individual 2410 are speaking and more other individuals are looking at individual 2410 than individual 2310, audio signals associated with individual 2410 may be selectively conditioned over those associated with individual 2310. In embodiments where the identity of the individuals is determined, priority may be assigned based on the relative status of the speakers, as discussed previously in greater detail. User 100 may also provide input into which speakers are prioritized through predefined settings or by actively selecting which speaker to focus on.

Processor 210 may also assign priority based on how the representation of individual 2310 is detected. While individuals 2310 and 2410 are shown to be physically present in environment 2400, one or more individuals may be detected as visual representations of the individual (e.g., on a display device) as shown in FIG. 23B. Processor 210 may prioritize speakers based on whether or not they are physically present in environment 2400. For example, processor 210 may prioritize speakers who are physically present over speakers on a display. Alternatively, processor 210 may prioritize a video over speakers in a room, for example, if user 100 is on a video conference or if user 100 is watching a movie. The prioritized speaker or speaker type (e.g. present or not) may also be indicated by user 100, using a user interface associated with apparatus 110.

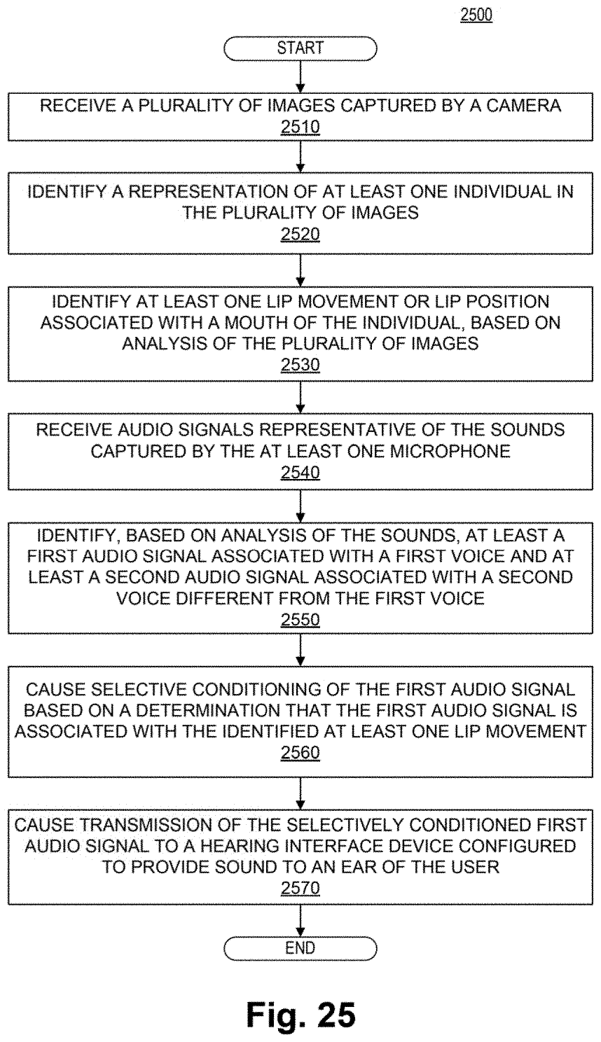

FIG. 25 is a flowchart showing an exemplary process 2500 for selectively amplifying audio signals based on tracked lip movements consistent with disclosed embodiments. Process 2500 may be performed by one or more processors associated with apparatus 110, such as processor 210. The processor(s) may be included in the same common housing as microphone 1720 and camera 1730, which may also be used for process 2500, In some embodiments, some or all of process 2500 may be performed on processors external to apparatus 110, which may be included in a second housing. For example, one or more portions of process 2500 may be performed by processors in hearing interface device 1710, or in an auxiliary device, such as computing device 120 or display device 2301. In such embodiments, the processor may be configured to receive the captured images via a wireless link between a transmitter in the common housing and receiver in the second housing.

In step 2510, process 2500 may include receiving a plurality of images captured by a wearable camera from an environment of the user. The images may be captured by a wearable camera such as camera 1730 of apparatus 110. In step 2520, process 2500 may include identifying a representation of at least one individual in at least one of the plurality of images. The individual may be identified using various image detection algorithms, such as Haar cascade, histograms of oriented gradients (HOG), deep convolution neural networks (CNN), scale-invariant feature transform (SIFT), or the like. In some embodiments, processor 210 may be configured to detect visual representations of individuals, for example from a display device, as shown in FIG. 23B.

In step 2530, process 2500 may include identifying at least one lip movement or lip position associated with a mouth of the individual, based on analysis of the plurality of images. Processor 210 may be configured to identify one or more points associated with the mouth of the individual. In some embodiments, processor 210 may develop a contour associated with the mouth of the individual, which may define a boundary associated with the mouth or lips of the individual. The lips identified in the image may be tracked over multiple frames or images to identify the lip movement. Accordingly, processor 210 may use various video tracking algorithms, as described above.

In step 2540, process 2500 may include receiving audio signals representative of the sounds captured by a microphone from the environment of the user. For example, apparatus 110 may receive audio signals representative of sounds 2421, 2422, and 2423 captured by microphone 1720. In step 2550, process 2500 may include identifying, based on analysis of the sounds captured by the microphone, a first audio signal associated with a first voice and a second audio signal associated with a second voice different from the first voice. For example, processor 210 may identify an audio signal associated with sounds 2421 and 2422, representing the voice of individuals 2310 and 2410, respectively. Processor 210 may analyze the sounds received from microphone 1720 to separate the first and second voices using any currently known or future developed techniques or algorithms. Step 2550 may also include identifying additional sounds, such as sound 2423 which may include additional voices or background noise in the environment of the user. In some embodiments, processor 210 may perform further analysis on the first and second audio signals, for example, by determining the identity of individuals 2310 and 2410 using available voiceprints thereof. Alternatively, or additionally, processor 210 may use speech recognition tools or algorithms to recognize the speech of the individuals.

In step 2560, process 2500 may include causing selective conditioning of the first audio signal based on a determination that the first audio signal is associated with the identified lip movement associated with the mouth of the individual. Processor 210 may compare the identified lip movement with the first and second audio signals identified in step 2550. For example, processor 210 may compare the timing of the detected lip movements with the timing of the voice patterns in the audio signals. In embodiments where speech is detected, processor 210 may further compare specific lip movements to phonemes or other features detected in the audio signal, as described above. Accordingly, processor 210 may determine that the first audio signal is associated with the detected lip movements and is thus associated with an individual who is speaking.

Various forms of selective conditioning may be performed, as discussed above. In some embodiments, conditioning may include changing the tone or playback speed of an audio signal. For example, conditioning may include remapping the audio frequencies or changing a rate of speech associated with the audio signal. In some embodiments, the conditioning may include amplification of a first audio signal relative to other audio signals. Amplification may be performed by various means, such as operation of a directional microphone, varying one or more parameters associated with the microphone, or digitally processing the audio signals. The conditioning may include attenuating or suppressing one or more audio signals that are not associated with the detected lip movement. The attenuated audio signals may include audio signals associated with other sounds detected in the environment of the user, including other voices such as a second audio signal. For example, processor 210 may selectively attenuate the second audio signal based on a determination that the second audio signal is not associated with the identified lip movement associated with the mouth of the individual. In some embodiments, the processor may be configured to transition from conditioning of audio signals associated with a first individual to conditioning of audio signals associated with a second individual when identified lip movements of the first individual indicates that the first individual has finished a sentence or has finished speaking.

In step 2570, process 2500 may include causing transmission of the selectively conditioned first audio signal to a hearing interface device configured to provide sound to an ear of the user. The conditioned audio signal, for example, may be transmitted to hearing interface device 1710, which may provide sound corresponding to the first audio signal to user 100. Additional sounds such as the second audio signal may also be transmitted. For example, processor 210 may be configured to transmit audio signals corresponding to sounds 2421, 2422, and 2423. The first audio signal, which may be associated with the detected lip movement of individual 2310, may be amplified, however, in relation to sounds 2422 and 2423 as described above. In some embodiments, hearing interface 1710 device may include a speaker associated with an earpiece. For example, hearing interface device may be inserted at least partially into the ear of the user for providing audio to the user. Hearing interface device may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin, or may be implanted surgically and attached to the bone of the user.

Multi-Mode Hearing Aid

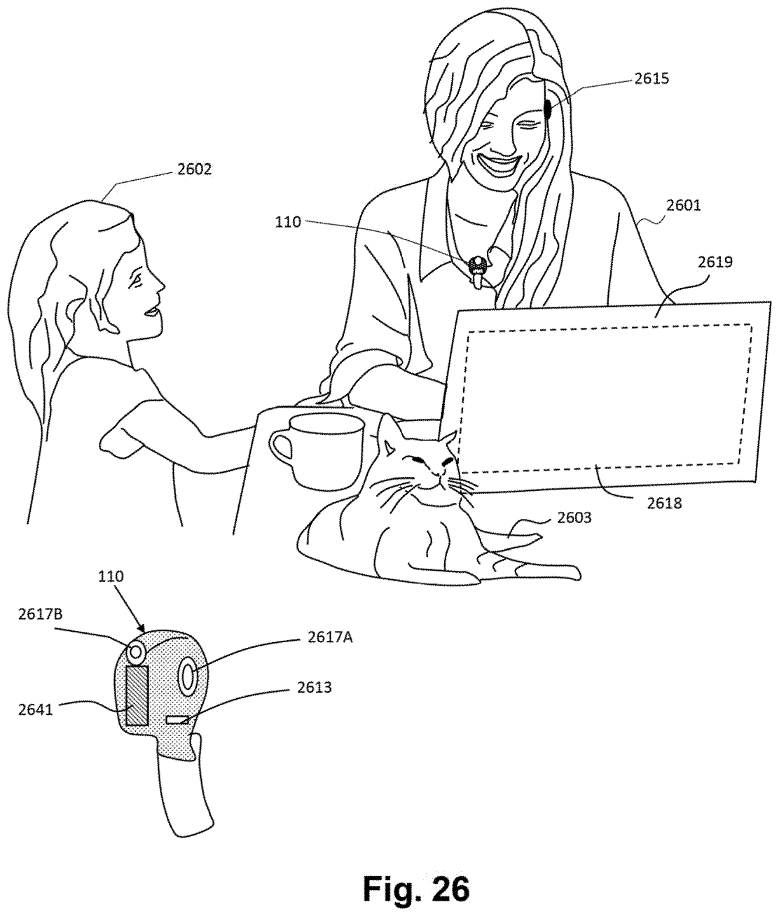

In accordance with embodiments of the disclosure, a hearing aid system may include a wearable camera configured to capture a plurality of images from an environment of a user. In various embodiments, the hearing aid system may include at least one microphone configured to capture sounds from an environment of the user. In some embodiments, the hearing aid system may include more than one microphone. In an example embodiment, the hearing aid system may include a first microphone for capturing audio signals in a first wavelength range and a second microphone for capturing audio signals in a second wavelength range. In an example embodiment, the hearing aid system may include multiple cameras and/or multiple microphones. For example, FIG. 26 shows a user 2601 who may wear apparatus 110, which may include cameras 2617A and 2617B as well as microphone 2613. As described herein, apparatus 110 may be attached to user 2601 at various locations. For example, apparatus 110 may be physically connected to a shin, a necklace, a belt, glasses, a wrist strap, a button, etc.

Apparatus 110 may be configured to communicate with a hearing interface device, such as hearing interface device 2615, as shown in FIG. 26. In an example embodiment, hearing interface device 2615, apparatus 110, and various cameras and microphones form the hearing aid system. In some embodiments, apparatus 110 may receive video and audio data, respectively, from other cameras and microphones. Camera 2617A may point in a first direction (e.g., forward), and camera 2617B may point forward or sideways. It should be appreciated that particular orientations of cameras 2617A and 2617B are only illustrative, and any other suitable orientations for these cameras can be used. While hearing interface device 2615 is shown to be attached to one of the ears of user 2601, in some embodiments, hearing interface device 2615 may have a left part (shown) configured to be attached to a left ear, and a right part (not shown) configured to be attached to the right ear.

It should be appreciated that cameras 2617A-2617B may be any suitable cameras with any suitable optical elements. For example, camera 2617A may have a first resolution, and camera 2617B may have a second (e.g., a higher) resolution. Cameras may be configured to capture image data via an image sensor that may be able to detect any suitable optical signal in any suitable wavelength spectra (e.g., near-infrared, infrared, visible, and ultraviolet spectra). In some cases, cameras 2617A-2617B may be configured to capture images, and in other cases, cameras 2617A-2617B may be configured to capture video data. Cameras 2617A-2617B may include optical lenses (e.g., fisheye ultra-wide-angle lenses for creating wide panoramic or hemispherical images or videos). In some cases, a zoom lens, such as a periscope lens, may be used for zooming to different objects in an environment of user 2601. In an example embodiment, cameras 2617A-2617B may be configured to zoom towards a direction from which the audio signal is detected by microphone 2613. In some cases, cameras 2617A-2617B may have a system of gimbals to eliminate vibrations and/or to maintain certain directions of the cameras. As described above, cameras 2617A-2617B may operate in infrared spectra, particularly in dark environments. Such cameras may include infrared flashlights and may be configured to detect the skin temperature of surrounding people (e.g., a skin temperature may be used to detect a nearby speaker in a dark environment).

Apparatus 110 may include at least one processor 2641 programmed to receive the plurality of images captured by a wearable camera (e.g., by camera 2617A). Processor 2641 may be configured to use a computer-based model to analyze an environment of user 2601 by analyzing images collected by a wearable camera (e.g., camera 2617B). In an example embodiment, camera 2617B may detect a presence of child 2602, who may produce audio signals, and may detect other objects in the environment of user 2601 that may produce audio signals (e.g., camera 2617B may detect a presence of a cat 2603 which can produce audio signals, a computer 2619 that may produce audio signals via a meeting software 2618, and the like). In various embodiments, processor 2641 may execute a suitable software application configured to analyze and recognize objects, people, or animals, within image data (or video data) as discussed herein. In addition to processor 2641 being part of apparatus 110, hearing interface device 2615 may also include a processor configured to modify various audio signals and to provide the modified audio signals to an ear (or ears) of user 2601. In some cases, the processor associated with hearing interface device 2615 may execute some (or all) functions performed by processor 2641.

In an example embodiment, processor 2641 of apparatus 110 may analyze one or more captured images. For example, processor 2641 may be configured to receive various images or characteristics of persons captured by cameras 2617A-2617B. Further, apparatus 110 may be configured to communicate with a server that may store images of various objects and/or people. In an example embodiment, apparatus 110 may upload or download images from the server. Further, apparatus 110 may perform a search for images (or videos) stored at the server. Similar to the embodiments discussed above, processor 2641 may use a computer-based model to analyze and recognize objects. In an example embodiment, the computer-based model may include a trained neural network such as a convolutional neural network (CNN). In some cases, facial features may be analyzed by a suitable computer-based model. For example, a computer-based model such as CNN may be used to analyze images and compare facial features or relations between facial features of the person identified in the captured images with facial features or relations therebetween of people found in images stored in the database of the server. In some embodiments, a video of person's facial dynamic movements may be compared with a video data record for various people obtained from the database in order to establish that the person captured in the video is a recognized individual.

As described herein, hearing interface device 2615 may be any device configured to provide audible feedback to user 2601. Hearing interface device 2615 may be placed in one or both ears of user 2601, similar to traditional hearing interface devices. Hearing interface device 2615 may be of various styles, including in-the-canal, completely-in-canal, in-the-ear, behind-the-ear, on-the-ear, receiver-in-canal, open fit, or various other styles. Hearing interface device 2615 may include one or more speakers for providing audible feedback to user 2601, microphones for detecting sounds in the environment of user 2601, internal electronics, processors, memories, etc. Hearing interface device 2615 may include a hearing interface (e.g., buttons) for manually adjusting audio signal parameters (e.g., loudness, pitch, etc.) of the audio signal transmitted by the hearing interface device. in some cases, device 2615 may include a processor for performing audio signal manipulations, a power supply (e.g., a rechargeable battery), an optional wireless communication device, which may include an antenna, and a set of microphones.

In various embodiments, processor 2641 is configured to receive a plurality of audio signals representative of sounds captured by at least one microphone from the environment of user 2601. Such signals may be a combination of sounds produced by various entities in the environment of user 2601. For example, sounds may include child 2602 speaking, while cat 2603 is meowing, or/and a group of people is attempting to communicate with user 2601 via computer 2619 (e.g., via meeting software 2618). In various embodiments, audio signals may overlap, resulting in a cacophony of sounds. Such an audio environment with multiple sounds may be referred to as a noisy environment, and such an environment may be significantly different from a relatively noiseless (herein, also referred to as a calm) environment. A noisy environment, as shown in FIG. 26, is one example of such an environment. Other examples of noisy environments may include a party with multiple individuals speaking, a television show with multiple individuals speaking over a background that may include street sounds, music, and the like, a play, a meeting, a dinner, a lecture, a computer-based conference, a conversation in a bar or a restaurant, a conversation over a background (e.g., conversation next to a busy road or a construction site), a public transportation (e.g., a bus, a train, a boat, or a plane), and the like. Examples of calm environments may include a private office, a library, a conversation between two individuals at a quiet place, and the like.

In various embodiments, processor 2641 of apparatus 110 may execute software instructions that are configured to analyze visual and audio data of the environment of user 2601 and determine whether the user is in a noisy environment or a calm environment. While it is understood that the analysis is carried out by processor 2641 executing software instructions, which may be any suitable instructions and may include machine-learning algorithms, for brevity, the processor may execute program instructions to analyze various sounds and cause various actions affecting sound characteristics of audio signals received by user 2601 via hearing interface device 2615.

Depending on a type of environment (e.g., noisy or calm environment, or various other distinctions), processor 2641 may be configured to operate in different modes when receiving different types of audio signals from the environment. In an example embodiment, when processor 2641 determines that the environment is calm, the processor may operate in a first mode, which may include particular selective conditioning (herein, referred to as a first selective conditioning) of at least one audio signal (herein, referred to as a first audio signal) of the plurality of audio signals. In some cases, when the environment is sufficiently calm, processor 2641 may be configured to provide no conditioning of the first audio signal and directly transmit the first audio signal to user 2601 via hearing interface device 2615. Alternatively, at least some of the first selective conditioning may be performed. For example, a noise (e.g., the background noise of a fan) may be suppressed, while the sound of a person's voice may be amplified. In some cases, hearing system 2650 may be configured to determine if a speech of a person is partially inaudible or unclear (e.g., processor 2641 may be configured to carry out speech recognition), and when it is determined that the speech is partially inaudible or unclear (e.g., the person does not speak some words loud enough or clearly), the speech of the person may be modified such that the speech clarity is improved. In an example embodiment, the speech of the person may be transcribed, and the transcribed text may be read to user 2601 via a natural reading voice (such process may be referred to as speech rendering) to clarify the speech of the person interacting with user 2601. In an example embodiment, speech rendering may be used to remove an accent of the speaker or to reapply a different accent to the speech. In an example embodiment, the original audio signal of the speech of the person may be combined (e.g., morphed) with a rendered speech so as to retain some of the natural characteristics of the speaker while clarifying the speech. Speech rendering may include changing a pitch of a person speaking (e.g., such rendering may be beneficial if user 2601 has difficulty in discerning particular frequencies), a cadence of the person's speech, the loudness of the person's speech, or any other characteristics of the person's speech (e.g., a filter may be applied to the person's speech to change the voice of a person from a male to a female voice).

It should be noted that even in a calm environment, there can be several sources of sounds (e.g., two people quietly communicating with a third person, a sound of quiet music playing in the background, and the like). In an example embodiment, apparatus 110 may include an interface for adjusting parameters of the first selective conditioning to be applied. In an example embodiment, such interface may include a smartphone-based interface using, for example, an application with graphical user elements, a button (or buttons) that may be part of hearing system 2650, or a voice interface (e.g., user 2601 may be configured to control apparatus 110 via voice commands). Example commands requested by user 2601 for controlling at least some of the parameters of the first selective conditioning may include, among other things, the number of speakers (or other sources) speaking to (or emitting any type of audio signals towards) user 2601. As an example, when user 2601 is attending a lecture (the lecture being a relatively calm environment), he or she may want to hear only a lecturer and none of the background noise or other people speaking. For such a situation, user 2601 may instruct hearing system 2650 (i.e., a processor 2641 via a suitable software application) to reduce an amplitude of environmental audio signals (i.e., signals not related to a speech of the lecturer) and, in some cases, amplify the speech of the lecturer. In case the lecturer is far away from the user, user 2601 may instruct hearing system 2650 to improve the clarity of the speech of the lecturer. In some cases, instructions to hearing system 2650 may also include changing the accent of the lecturer as detailed above, translating the speech of the lecturer to a different language selected by user 2601, or applying any other form of modification. As another example, when user 2601 is at a social event and speaking with several people, he or she may want to hear each one of them when each one of the several people speaks. In some cases, user 2601 may or may not want to hear herself, or she may prefer to hear herself at a tower amplitude. In such cases, user 2601 may instruct apparatus 110 to lower the amplitude of his or her voice. Such alteration of the user's perceived speech may be another example of first selective conditioning. Additionally, as described above, user 2601 may prefer to hear at a lower amplitude (or not to hear) a background noise when other audio signals (e.g., speeches of other individuals) are captured, but may wish to hear the background noise at a higher amplitude when no other audio signals are detected by one or more microphones of hearing aid 2650.

A different mode of operation of a hearing aid system may be performed where the user is in a relatively noisy environment (such a different mode of operation herein is referred to as the second mode of operation). In an example embodiment, processor 2641 of apparatus 110 may operate in the second mode, which may include a particular selective conditioning mode (herein referred to as a second selective conditioning) of at least one audio signal of the plurality of audio signals. In some cases, processor 2641 may determine, based on analysis of at least one of the plurality of images or the plurality of audio signals, to switch to a second mode to cause a second selective conditioning of the first audio signal, the second selective conditioning differing in at least one aspect relative to the first selective conditioning. For instance, when the environment is noisy, processor 2641 may be configured to provide stronger conditioning of audio signals, as compared to the first selective conditioning. In an example embodiment, a strength of selective conditioning may be defined as a difference in audio signal when comparing conditioned versus unconditioned audio signal under a suitable metric. The suitable metric may determine a difference in a pitch of conditioned versus unconditioned audio signals, or difference in amplitude, a cadence, a time stretching, or any other suitable parameter that may be used to characterize an audio signal. In various embodiments, the second selective conditioning may differ in at least one aspect relative to the first selective conditioning.

Examples of the second selective conditioning may include reducing an amplitude of an audio signal from child 2602 while communicating via a web conference using computer 2619. Similarly, the second selective conditioning may include reducing environmental noises (e.g., noises from cat 2603 or any other house noises) while communicating via the web conference.

In various embodiments, a determination of whether to use the first selective conditioning or the second selective conditioning may be done either automatically or manually (i.e., via a command from user 2601 by utilizing a suitable interface, such as a graphical interface, buttons, or voice-activated commands). In an example embodiment, an automatic determination may be performed by processor 2641 by determining whether the environment of user 2601 is calm or noisy. For example, processor 2641 may switch to the first selective conditioning when it determines that the environment is calm and may switch to the second selective conditioning when it determines that the environment is noisy. In some cases, during the switching operation, the first selective conditioning is partially maintained, with the second selective conditioning being superimposed on the first selective conditioning. For example, if user 2601 is communicating via a web conference without the distraction of environmental noises, the first selective conditioning may include reducing the amplitude of user 2601 voice, as described above. However, when child 2602 enters a room, thus, creating a noisy environment, processor 2641 may switch to the second selective conditioning and reduce the amplitude of the perceived child's voice while maintaining the first selective conditioning. In an example embodiment, an image data associated with an arrival of child 2602 (or other image data, such as the arrival of cat 2603) may trigger processor 2641 to determine that user 2601 is about to be immersed into a noisy environment, and, as a result, processor 2641 may determine that the second selective conditioning needs to be used when processing audio signals in the environment of user 2601.

In some cases, user 2601 may determine a set of parameters (e.g., via a suitable interface for apparatus 110) such that when these parameters are observed, processor 2641 may determine that user 2601 may be in a noisy environment. For instance, a list of possible parameters includes audio and image/video parameters. The audio parameters may include a maximum amplitude of audio signal during a given time interval, a maximum variation in audio frequency, a maximum amplitude of the audio signal averaged over a given time interval, a distribution of maximum amplitudes as a function of audio frequency, and the like. The image/video parameters may include a speed at which objects are moving in the environment of user 2601, a rate of change of image gradients for images captured in the environment of user 2601, a presence of objects, people, or animals in the environment of user 2601 as recognized by image recognition software of processor 2641 (or image recognition software of a device with which processor 2641 is communicating via the transmission of image data captured in the environment of user 2601). In some cases, a time correlation between a motion of objects in the environment of user 2601 with audio signals detected in the environment of user 2601 may be used to determine whether user 2601 environment is noisy or calm. For example, if the motion of objects around user 2601 may not be correlated with the emitted sounds, and the amplitude of emitted sounds is low, processor 2641 may conclude that the environment of user 2601 is relatively calm. Alternatively, if processor 2641 is determined that sounds may be emitted following (possibly with some time delay) a rapid movement of objects in the environment of user 2641, processor 2641 may conclude that the environment of user 2601 is chaotic. In some cases, the determination of whether the environment is calm or noisy may be based on actions performed around user 2601 (e.g., processor 2641 may detect, by analyzing image data, that a phone is being picked up by a person next to user 2601, a band is about to start playing, user 2601 is entering a busy street, and the like).

In some cases, apparatus 110 may be further configured to exchange data with various other devices to determine whether user 2601 is placed in a noisy or calm environment. For example, apparatus 110 may be configured to interact with a smartphone (or similar electronic device capable of exchanging data with system 2650), having a variety of sensors that may not necessarily be accessible otherwise by apparatus 110. In an example embodiment, the smartphone may use a GPS location to determine whether user 2601 is in a noisy environment (e.g., if GPS indicates that user 2601 is in a bar, the smartphone may conclude (via a suitable software related to apparatus 110) that user 2601 is in a noisy environment. Additionally, if the smartphone registers loud vibrations in combination with some of the other factors (e.g., excessive noise, which in turn may follow/precede/coincide with the vibrations), the smartphone may determine whether user 2601 is in the noisy environment. In some embodiments, an event such as a lecture, a meeting, a concert or the like in a user's calendar may provide an indication of the user being in a calm or noisy environment. In some cases, recognizing a particular individual (e.g., child 2602) in image data collected by either apparatus 110 or a smartphone interacting with apparatus 110 may indicate to processor 2641 that user 2601 is in a noisy environment. Similarly, recognizing a particular audio signal (e.g., a voice of child 2602) may indicate to processor 2641 that user 2601 is in a noisy environment.

In some embodiments, the operation mode of apparatus 110 may change automatically in accordance with the environment of user 2601, wherein the environment is not necessary classified as noisy or calm. For example, a particular environment (e.g., an event associated with user 2601) may cause processor 2641 (or an associated device, such as a smartphone) to determine that apparatus 110 should operate in a specific mode. For example, when user 2601 is entering a particular location (e.g., a lecture room), processor 2641 may determine to switch to a particular operation mode (e.g., the first selective conditioning) in which only an audio signal from one speaker is transmitted to hearing interface device 2615. As another example, when user 2601 exiting a location (e.g., a lecture room), processor 2641 (and/or an associated device) may determine to switch to another operation mode (e.g., the second selective conditioning) in which audio signals from multiple individuals may be transmitted to hearing interface device 2615 when one of those individuals is speaking (when several individuals are speaking simultaneously, processor 2641 may determine which audio signal to amplify and which to attenuate based on a variety of possible factors discussed herein, e.g., the proximity of an individual to user 2601, whether the individual is in front of user 2601, whether user 2601 is looking at the individual, and the like.

Determining by processor 2641 (or by a related device such as a smartphone in communication with processor 2641) whether user 2601 is in a noisy or calm environment and automatically switching between the first selective conditioning and the second selective conditioning may be one possible way of selecting audio signal conditioning. Alternatively, as discussed above, user 2601 may be provided a suitable interface for manually determining whether to apply the first or the second selective conditioning. For instance, user 2601 may select the desired operation mode by operating a user interface, displayed, for example, on a device coupled with apparatus 110, such as a smartphone, a laptop, or the like.

As discussed, processor 2641 (or user 2601 via a suitable interface) may be configured to differentiate between a noisy or calm environment. However, such an environmental classification is only one possible example, and any other suitable classification may be used, which may lead to differentiation in the operation mode of apparatus 110.

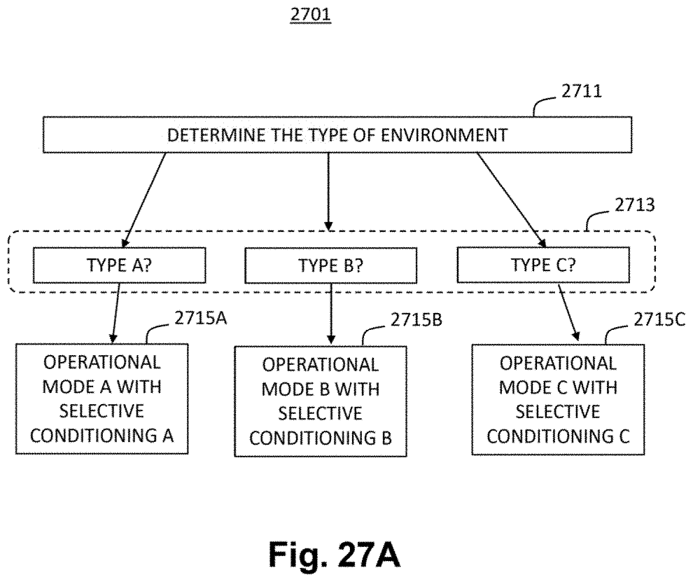

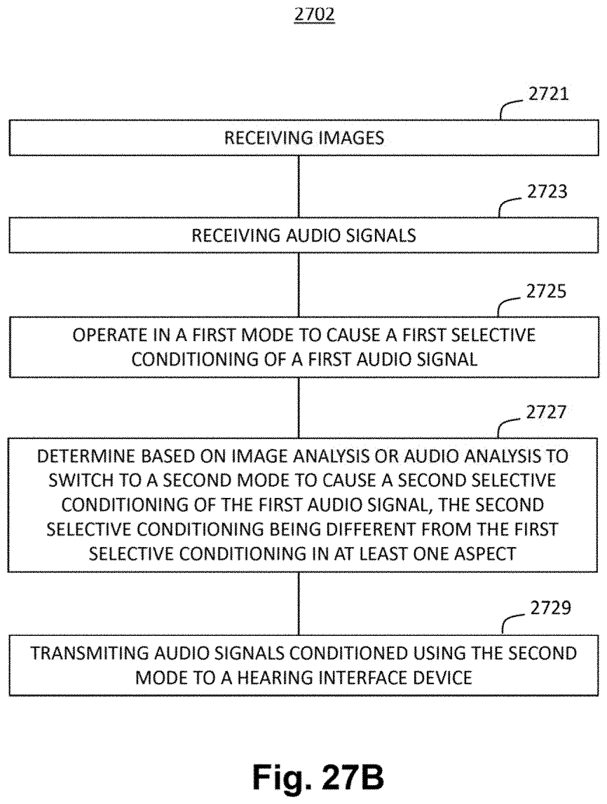

FIG. 27A schematically illustrates a process 2701 for determining an operation mode for apparatus 110. For instance, at step 2711 of process 2701, processor 2641 (or a related device such as a smartphone) may be configured to determine the type of environment of a user (e.g., user 2601). At step 2713, processor 2641 may evaluate whether the type of environment corresponds to one of a plurality of possible types (e.g., the environment may be evaluated to be a type A, type B, or type C environment), and based on the type of the environment a corresponding operation mode with the corresponding selective conditioning may be selected (e.g., operation modes A-C with corresponding selective conditionings 2715A-C may be selected).

FIG. 27B illustrates an example process 2702 for transmitting selectively conditioned audio signals to hearing interface device 2615, consistent with disclosed embodiments. At step 2721 of process 2702, processor 2641 of apparatus 110 is configured to receive images/video of the environment of a user (e.g., user 2601). At step 2723, audio signals from the environment of user 2601 may also be received by processor 2641. In various embodiments, audio signals from the environment may include all the audio sounds detected in the environment of user 2601, such as the speech of individuals in the environment of user 2601 and the environmental noises. At step 2725 of process 2702, processor 2641 may be configured to analyze audio and image data collected in steps 2711 and steps 2713. At step 2725, processor 2641 may be configured to operate in a first mode to cause a first selective conditioning of a first audio signal, as described above. At step 2727, processor 2641 may be configured to determine based on image analysis or audio analysis to switch to a second mode to cause a second selective conditioning of the first audio signal, the second selective conditioning being different from the first selective conditioning in at least one aspect. For example, as described above, when the environment of user 2601 is noisy, processor 2641 may be configured to provide stronger conditioning of the first audio signal (e.g., increase the amplitude of the first audio signal).

At step 2729, processor 2641 may be configured to transmit the conditioned signals to hearing interface device 2615. Note that in some embodiments of process 2702, only the conditioned signals are transmitted to device 2615. In other embodiments, both the conditioned signals and other signals that are not conditioned may be transmitted to device 2615.

Consistent with disclosed embodiments, the operation mode to be applied (e.g., a first operation mode or a second operation mode) may be determined by identifying whether there is a speaking individual in the environment of user 2601. For example, if the individual is detected, the operation mode may switch from the first operation mode to the second operation mode, for which the second selective conditioning may be used and may include reducing the environmental noise and amplifying the audio signal from the speaking individual. In an example embodiment, the background (i.e., environmental) noises may constitute a first audio signal, and the second selective conditioning may reduce such first audio signal. In some cases, the second selective conditioning may include changing the pitch of one of the audio signals (e.g., a first audio signal), changing the amplitude of the audio signal, or time-stretching the audio signal.

As described above, the second selective conditioning may be applied together with the first selective conditioning. For example, the second selective conditioning may be applied to a second audio signal, and the first selective conditioning may be applied to the first audio signal. For example, if the first audio signal is a speech of an individual, and the second audio signal is the background noise, the first selective conditioning may include amplifying the volume of the speech, while the second selective conditioning may include reducing the amplitude of the background noise (or modifying the pitch of the background noise such that it cannot be easily confused with the first audio signal). In some cases, the second selective conditioning may include attenuating at least one second audio signal of the plurality of audio signals with respect to the first audio signal. Additionally, or alternatively, one of the first or the second selective conditioning may include attenuating a pitch of at least one second audio signal of the plurality of audio signals with respect w the first audio signal. In an example embodiment, apparatus 110 may use the first selective conditioning while an individual in the environment of user 2601 is not speaking. However, system 2650 may automatically switch to the second selective conditioning when the individual starts speaking.

In some cases, the first audio signal may be associated with a voice of a first individual, and the second audio signal may be associated with the voice of a second individual. Additionally, in some embodiments, the first audio signal may be associated with the first group of individuals, and the second audio signal may be associated with the second group of individuals.

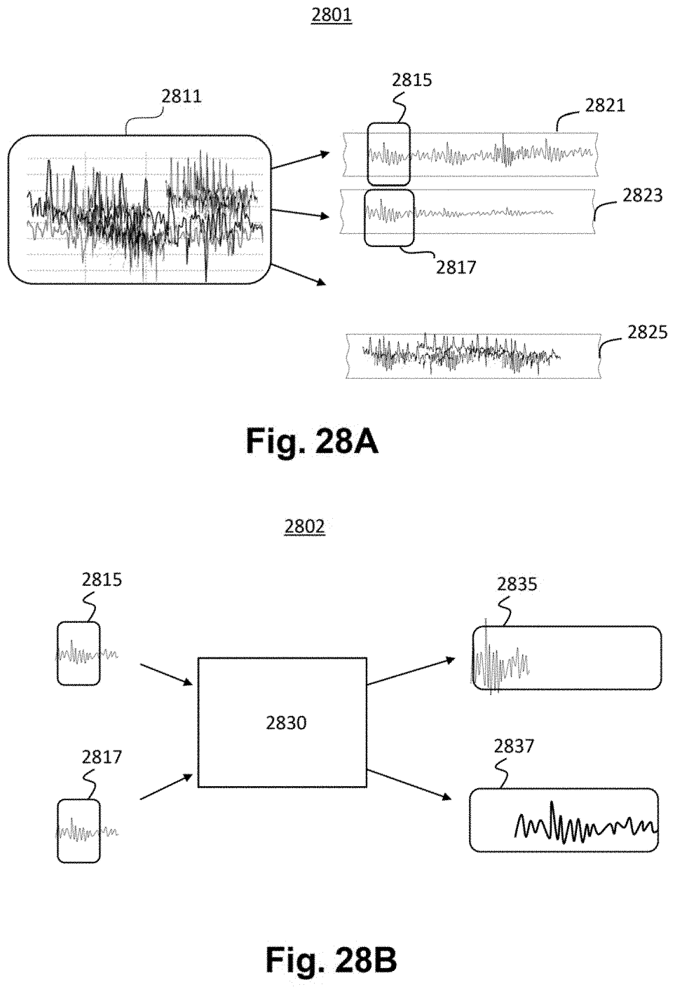

As described before, user 2601 may select a particular selective conditioning by providing instructions to apparatus 110. In an example embodiment, the instructions may include selecting a number of individuals who may generate a subset of audio signals from the plurality of audio signals in the environment of user 2601 and requesting to selectively condition the subset of audio signals using a particular type of selective conditioning (e.g., the second selective conditioning). In some cases, a particular type of selective conditioning (e.g., the second selective conditioning) may condition at least some of the audio signals in the environment of user 2601 for each time point by first determining a speech audio signal for each speaker from the plurality of audio signals, and for a given point in time, determining a pair of speech audio signals having a signal difference smaller than a threshold difference. As discussed before, the signal difference may be measured using a suitable metric. For example, the difference may be measured by measuring a difference in pitch, a difference in amplitude, a cadence, a time stretching, or any other suitable parameter that may be used to characterize an audio signal. The second selective conditioning may then include amplifying the signal difference above the threshold difference by changing either a pitch, an amplitude, or time duration of one of the speech audio signals from the pair of speech audio signals. An example of such a process is schematically illustrated by FIGS. 28A and 28B using respective processes 2801 and 2802. During process 2801, a complex audio signal 2811 (which may contain overlapping conversations) may be decomposed into individual audio signals 2821-2825 using any suitable approach as further described herein. In some cases, such individual audio signals (e.g., signals 2821 and 2823) may overlap, and for some time intervals as indicated by time domains 2815 and 2817 may be similar (e.g., these signals may be sufficiently similar, such that they may be confused by user 2601). For such cases, selective conditioning may include further differentiating signals 2821 and 2823, at least for time domains 2815 and 2817. As shown in FIG. 28B by process 2802, to differentiate between signals 2821 and 2823, at least one of signals 2821 and 2823 may be altered via a computer-based application 2830 to amplify the difference (e.g., amplify the difference such that it is above the threshold difference) as measured using a suitable metric. For example, as shown in FIG. 28B, signal 2817 may be altered (e.g., time-stretched) to result in signal 2837, while signal 2815 may be time-compressed and may have its amplitude increased to result in signal 2835. In an example embodiment, the difference between signal 2835 and 2837 is above the threshold value, resulting in user 2601 easily differentiating between these modified signals.

In some embodiments, a particular operation mode may be selected so as to optimize resource usage of apparatus 110. For example, if there is only one person in the vicinity of user 2601, apparatus 110 may be configured to switch to a single speaker operation mode (e.g., the single speaker operation mode may not require determining an active speaker in a group of speakers, thus, reducing the power consumption of apparatus 110, which otherwise may be associated with determining the amplitude ratio between different speakers). Various other operational modes may be used to reduce power consumption and prolong the battery life of apparatus 110 (e.g., an operation mode that is not heavily dependent on wireless communications with peripheral devices such as smartphones, laptops, and the like, an operation mode characterized by a collection of only a few images per minute, an operation mode that does not require any audio analysis, and the like).

Processor 2641 of hearing aid system (e.g., the hearing aid system may include apparatus 110, hearing interface device 2615, cameras 2617A-2617B, as well as microphone 2613) may determine to switch to a second mode (as discussed above) based on the analysis of the plurality of images in the environment of user 2601 or based on the analysis of the plurality of audio signals in the environment of user 2601. For example, if an individual in the environment of user 2601 is speaking, processor 2641 may switch to the second mode.

In an example embodiment, processor 2641 may operate in the first mode to cause a first selective conditioning. The first selective conditioning (as described above) comprises amplification of the first audio signal. Additionally, processor 2641 may determine, based on analysis of at least one of the plurality of images or the plurality of audio signals, to switch to a second mode to cause a second selective conditioning of the first audio signal, the second selective conditioning differing in at least one aspect relative to the first selective conditioning. In an example embodiment, the second selective conditioning may include attenuating at least one second audio signal of the plurality of audio signals with respect to the first audio signal.

In an example embodiment, the first audio signal may be associated with a voice of a first individual, and the second audio signal may be associated with the voice of a second individual.

In an example embodiment, processor 2641 may be configured to determine to switch to the second mode based on a context associated with at least one of the plurality of images or the plurality of audio signals.

In an example embodiment, processor 2641 may be operated in an active mode control. In such a mode, processor 2641 may, for example, automatically switch between the first mode and the second mode. In the active mode, processor 2641 may control, among other things, a number of speakers for whom the audio is transmitted to a user. For example, if the user is attending a lecture, he or she may want to hear only the lecturer and none of the background noise, or other people speaking, or the like. If, however, the user is in a social event and speaking with a number of people, the user may want to hear each one of them when he or she speaks. The user may or may not want to hear himself or herself or may want to hear himself or herself in a lower amplitude. The user may wish to hear or not to hear the background noise when other audio is captured but may wish to hear it in some amplitude when no other audio is captured, and the like. In some embodiments, the operation mode of processor 2641 may vary in accordance with a user selection. The user may select the desired operation mode by operating a user interface, displayed, for example, on a device coupled to the hearing interface device, such as apparatus 110, a smartphone, a laptop, or the like. In further embodiments, the operation mode may change automatically in accordance with the context (e.g., environment) of the user and the hearing aid system. For example, a specific event may cause processor 2641 to assume a specific operation mode (e.g., a first mode or a second mode). For example, when entering premises identified as a lecture room, processor 2641 may switch to a mode in which only one speaker is transmitted, and when exiting the room, processor 2641 may switch to a mode in which speech by multiple speakers is transmitted in accordance with the active speaker. In an example embodiment, the context is indicative of the user entering a room. Alternatively, the context is indicative of the user exiting a room.

In an example embodiment, processor 2641 may be configured to select the first mode or the second mode based on a context associated with at least one of the plurality of images or the plurality of audio signals. The context is indicative of the user attending a lecture or indicative of the user attending a social event. The context may be indicative of the user entering a lecture room, wherein at least one audio signal includes speech of a lecturer, and wherein the first selective conditioning comprises amplification of the first audio signal from the plurality of audio signals and attenuating at least another one of the plurality of audio signals, such as background noise. The context may be indicative of the user exiting a lecture room, wherein at least one audio signal includes speech of an active speaker outside the lecture room, and wherein the first selective conditioning comprises amplification of the speech. In some cases, the context may be indicative of the user being within a predetermined distance of only one person, and wherein at least one audio signal includes speech of the person, and wherein the first selective conditioning comprises amplification of the speech. The predetermined distance may be any suitable distance (e.g.. a distance in a range of 0.1 meters to 5 meters). In some cases, the predetermined distance may be larger than five meters (e.g., 10 meters).

In various embodiments, as described above, the first selective conditioning includes changing an amplitude of at least one audio signal. Additionally, or alternatively, the first selective conditioning comprises changing a pitch the at least one audio signal. In some cases, the first selective conditioning comprises time stretching the at least one audio signal, as previously described.

In some embodiments, processor 2641 may be configured to select the first mode or the second mode based on a selection received from the user. In an example embodiment, the selection is received from an electronic device such as a smartphone, a laptop, a smartwatch, a bracelet, or any other suitable wearable electronic device.

Custom Filters for Acquaintances

In accordance with embodiments of the disclosure, a hearing aid system for selectively conditioning sounds may include a wearable camera (or multiple wearable cameras) configured to capture a plurality of images from an environment of a user, as described herein. In various embodiments, the hearing aid system may include one or more microphones configured to capture sounds from an environment of the user, as described herein. The hearing aid system may include apparatus 110 and processor 2641, as described below in relation to FIG. 26.

In an example embodiment, processor 2641 may be configured to receive a plurality of images captured by a camera (e.g., camera 2617A or 2617B, as shown in FIG. 26). Additionally, processor 2641 may be configured to receive a plurality of audio signals representative of sounds captured by the at least one microphone from the environment of the user, as described herein. Processor 2641 may be configured to identify at least one recognized individual represented by at least one of the plurality of images or by at least one of the plurality of audio signals. In an example embodiment, processor 2641 of apparatus 110 may analyze one or more captured images. For example, processor 2641 may be configured to receive various images or characteristics of persons captured by camera 2617A or camera 2617B. Further, apparatus 110 may be configured to communicate with a server that may store images of various objects and/or people. In an example embodiment, apparatus 110 may upload or download images from the server. Further, apparatus 110 may perform a search for images (or videos) stored at the server.

Similar to the embodiments discussed above, processor 2641 may use a computer-based model to analyze and recognize objects, as described herein. In some cases, facial features may be analyzed by a suitable computer-based model. For example, a computer-based model may be used to analyze images and compare facial features or relations between facial features of the person identified in the captured images with facial features or relations therebetween of people found in images stored in the database of the server. In some embodiments, a video of person's facial dynamic movements may be compared with a video data record for various people obtained from the database in order to establish that the person captured in the video is a recognized individual.

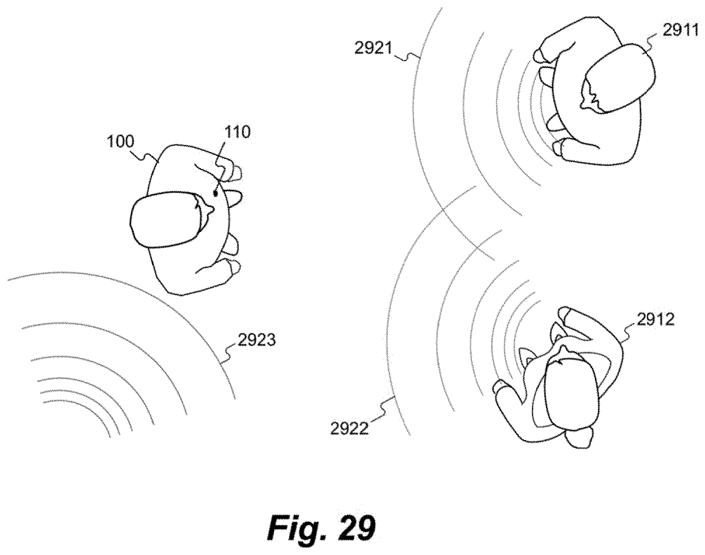

FIG. 29 shows a user 100 with an apparatus 110, which may include camera 2617A and microphone 2613. In an example embodiment, user 100 may face an individual 2911 and individual 2912 producing respective audio signals 2921 and 2922 that are detected by microphone 2613. Images of individuals 2911 and 2912 may be detected by camera 2617A. Additionally, microphone 2613 may detect audio signal 2923 (e.g., a sound from an object or person not visible to user 100). Recognizing an individual (e.g., recognizing individual 2911) using image data may be one possible approach. Alternatively, individual 2911 may be recognized based on a speech detected in audio signal 2921. In an example embodiment, a voiceprint of individual 2911 may be detected, as discussed above. For instance, processor 2641 may determine that sound 2921 corresponds to the voice of individual 2911. This may be performed using voice recognition software (e.g., such voice recognition software may be executed by processor 2641) such as Hidden Markov Models, Dynamic Time Warping, neural networks, or other techniques. In some cases, processor 2641 may be configured to upload audio signals (e.g., 2921 and 2922) to a server, and the server may be configured to process these signals by isolating audio signal 2921 from audio signal 2922 and further using the voiceprint of individual 2911 to determine that signal 2921 belongs to individual 2911. For voice recognition, the server may access a database (e.g., database 2050, as shown in FIG. 20B), which may further include a voiceprint of one or more individuals. After determining that audio signals 2921 match individual 2911 based on, for example, a voiceprint of individual 2911, the hearing aid system may identify individual 2911 as a recognized individual.

This recognition process may be used alone or in conjunction with image recognition techniques (e.g., facial recognition techniques) described above. For example, individual 2911 may be recognized using facial recognition techniques and may be verified using voice recognition, or vice versa. In some cases, a video of individual speaking may be used for recognition of the individual. For example, a synchronization of facial features (e.g., movements of lips of individual 2911) with audio signals 2921 may be used for identifying individual 2911 as a speaker. A voice print extracted for the speaker may then be used to separate a voice associated with individual 2911 from other sounds represented in audio signal 2921. In some embodiments, additional processing may be performed on the audio emitted by individual 2911, such as recognizing words, or other forms of processing described throughout the present disclosure. In various embodiments, processor 2641 may recognize one or more individuals. For example, processor 2641 may be configured to recognize individual 2911 and individual 2912.

In some embodiments, apparatus 110 may detect the voice of an individual that is not within the field of view of apparatus 110, as shown in FIG. 29 as audio signal 2923. For example, the voice may be heard over a speakerphone, from a back seat of a vehicle, or the like. In such embodiments, recognition of an individual may be based on the voice of the individual only, in the absence of a speaker in the field of view.

A processor of the hearing aid system (e.g., processor 2641) may be configured to retrieve, from a storage, a conditioning profile associated with at least one recognized individual. The conditioning profile may be any set of suitable instructions that can be performed by processor 2641 for selectively conditioning an audio signal. Selective conditioning may include an amplification or attenuation of an audio signal, removal of noise from the audio signal (e.g., suppressing some of the frequencies identified within the audio signal), or the like. In some cases, some of the parts of the audio signal may be amplified (e.g., an audio signal corresponding to speech of individual 2911 may be amplified) while other parts of the audio signal (e.g., background music or speech of individual 2912) may be suppressed. In some cases, processor 2641 may be configured to analyze speech of individual 2911 and identify words within the speech. If in a portion of audio signal 2921 words cannot be identified with clarity (e.g., processor 2641 determines a low probability of ascertaining that the words were correctly identified in that portion), processor 2641 may be configured to selectively condition that portion (e.g., amplify that portion of the audio signal). In some cases, processor 2641 may be configured to selectively condition the portion of audio signal 2921 in which words cannot be identified and then repeat the amplification in an attempt to identify words in that portion. Such iterations may be performed several times to optimize the selective conditioning of audio signal 2921.

A conditioning profile may allow for selective conditioning of the audio signals such that, for example, the speech of individual 2911 is modified so that the clarity of the speech is improved. In an example embodiment, speech rendering may be used to remove an accent of the speaker or to reapply a different accent to the speech. In an example embodiment, both the original audio signal of the speech of the person may be combined (e.g., morphed) with a rendered speech as to retain some of the natural characteristics of the speaker while clarifying the speech. Speech rendering may include changing a pitch of a person speaking (e.g., such rendering may be beneficial if user 100 has difficulty in discerning particular frequencies), a cadence of the person's speech, the loudness of the person's speech, or any other characteristics of the person's speech (e.g., a filter may be applied to the person's speech to change the voice of a person from a male to a female voice). Further, selective conditioning may be used for any suitable modification of background sounds unrelated to a speech of individual 2911.

In various embodiments, the conditioning profile may include information for selectively conditioning an audio signal. In some cases, instructions corresponding to the conditioning profile may include any suitable logical elements. For example, an IF logical clause may be used in conditioning profile when selective conditioning is subject to a particular characteristic (e.g., pitch or loudness) observed for a portion of an audio signal (e.g., within audio signal 2921). After performing the selective conditioning, processor 2641 may be configured to cause transmission of the conditioned first audio signal to a hearing interface device configured to provide sound to an ear of a user (e.g., user 100). In an example embodiment, the conditioning profile may include a predefined filter for selectively conditioning an audio signal (e.g., audio signal 2921) based on at least one of a frequency rate or an amplitude of audio signal 2921.

In an example embodiment, the storage may be located within the same housing (i.e., the storage may be local storage) as the wearable camera. The storage may be any suitable storage (e.g., solid-state storage, a hard drive, and the like). In some cases, at least part of the conditioning profile may be stored at the local storage, and another part may be stored at remote storage (e.g., stored in a remote database). In some cases, the conditioning profile may be selected and retrieved from the remote database based on the identified individual.

In an example embodiment, processor 2641 of the hearing aid system is further programmed to determine at least one modification to the selective conditioning associated with a recognized individual (e.g., individual 2911) and update the conditioning profile based on the modification. For example, determining at least one modification may include determining that amplification of audio signal 2921 needs to be performed based on how well user 100 hears individual 2911 (or how well user 100 discerns words of individual 2911). In an example embodiment, user 100 may provide feedback to processor 2641 using any suitable means (e.g., via audio signals or via a suitable interface for the hearing aid system as discussed herein). The interface for the hearing aid system may include buttons on apparatus 110 or may be an application displayed, for example, on a device coupled to the hearing aid system, such as a smartphone, a laptop, or the like. User 100 may provide specific instructions to the hearing aid system (e.g., user 100 may request to increase the amplitude of audio signal 2921 from individual 2911) or may provide a more complex instruction (e.g., improve the clarity of a speech of individual 2911, improve the clarity of an audio signal received from a point at which camera 2617A is directed, or suppress background sounds). Such complex instructions may be interpreted by the hearing aid system, and corresponding modifications may be made. In some cases, the instructions may be selected from a list of possible modifications. Alternatively, when the instructions are provided via voice commands from user 100, such instructions may be analyzed by a language processing application of apparatus 110, and modifications corresponding to the instructions may be made. In an example embodiment, the language processing application of apparatus 110 may be any suitable software application capable of transcribing human speech and determining instructions for modification of an audio signal from the resulted transcribed text.

Additionally, determining the modification by processor 2641 may be based on various environmental factors (presence of noise, background music, other speakers speaking) and may be done automatically without receiving an indication from user 190. In various cases, the conditioning profile may be appropriately updated based on the determined modifications. In some cases, user approval may need to be received by the hearing aid system prior to updating the conditioning profile. Once the modification is determined, processor 2641 may be configured to apply the modification.

As previously described, the modification may include an adjustment (i.e., an instruction) by the user. The adjustment may be made via a suitable interface for the hearing aid system. As described, at least one modification may be determined based on an indication of the difficulty of hearing from the user. The indication of difficulty may be determined via one of an audio signal from the user or input from the user received via an interface for the hearing aid system. In an example embodiment, at least one modification comprises one of amplification of an audio signal (e.g., signal 2921) or modifying a spectrum of audio signal 2921. In some cases, the selective conditioning includes attenuating at least another audio signal (e.g., audio signal 2922 or signal 2923) not associated with recognized individual 2921.

In an example embodiment, processor 2641 of the hearing aid system may be programmed to identify another recognized individual represented by at least one of the plurality of images or by at least one of the plurality of audio signals. For example, processor 2641 may be configured to identify individual 2912. In some cases, processor 2641 may be configured to identify individual 2912 when user 100 points camera 2617A towards individual 2912. In some cases, when apparatus 110 includes two cameras (e.g., camera 2617A and 2617B, as shown in FIG. 26), camera 2617A may be configured to identify individual 2911, and camera 2617B may be configured to identify individual 2912. Upon identifying individual 2912 (identification of an individual using images or audio data is discussed above), processor 2641 may retrieve, from storage, another conditioning profile associated with the another recognized individual. For example, if apparatus 110 includes local storage, processor 2641 may retrieve, from the local storage, a conditioning profile associated with individual 2912. In some cases, a conditioning profile, e.g., CP2912, associated with individual 2912 may be the same as a conditioning profile, e.g., CP2911, associated with individual 2911. Alternatively, CP2912 may be different from CP2911. Processor 2641 may use CP2911 for selectively conditioning audio signal 2921 and may use CP2922 for selectively conditioning audio signal 2922. In some cases, when signals 2921 and 2922 are not clearly separable, CP2911 and CP2922 may be applied to a combined audio signal containing signals 2921 and 2922.

In an example embodiment, audio signal 2921 conditioned using CP2911 may be transmitted to a hearing interface device (e.g., hearing interface device 2615) as shown in FIG. 26, and audio signal 2922 conditioned using CP2912 may also be transmitted to hearing interface device 2615. In an exemplary embodiment, processor 2641 may separate in time audio signals 2921 and 2922. For example, when audio signal 2921 is emitted at about the same time as signal 2922, processor 2641 may separate them by a sufficient amount of time so that each signal is better discerned by user 100. In some cases, when hearing interface device 2615 transmits audio signals to both ears of user 100, a first selectively conditioned audio signal (e.g., selectively conditioned signal 2921) may be transmitted to a left ear (or right ear), and a second selectively conditioned audio signal (e.g., selectively conditioned signal 2922) may be transmitted to a right (or left ear).

In some cases, the hearing aid system may be configured to identify a group of individuals (instead of a single recognized individual) and selectively condition sounds from such a group. For example, camera 2617A may capture images of a group of persons, and processor 2641 may be configured to recognize the group. In an example embodiment, a conditioning profile may exist for the group (as opposed to the conditioning profile for a single individual). For example, if processor 2641 recognizes that an audio signal is received from a group of school children in a classroom, a conditioning profile may include instructions to lower an amplitude of audio signals emitted by every member of the group.

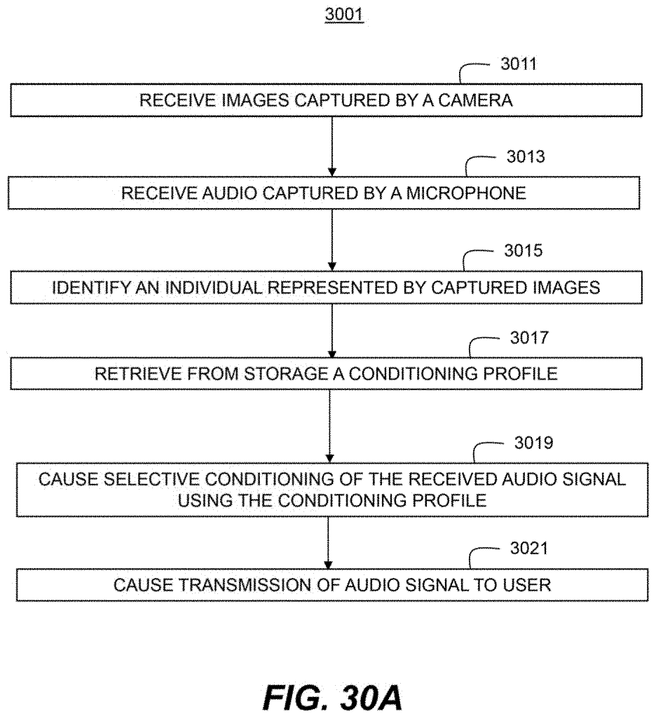

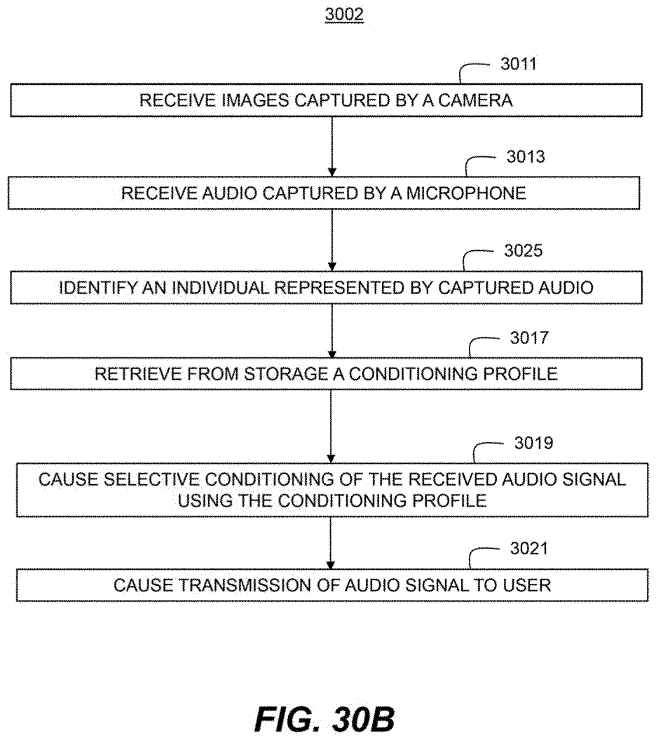

FIG. 30A shows an example process 3001 of selectively conditioning audio signal and transmitting the audio signal to an ear of a user. At step 3011 of process 3001, processor 2641 may receive images captured by a camera associated with the hearing aid system (e.g., camera 2617A). At step 3013, processor 2641 may receive audio signals from a microphone associated with the hearing aid system (e.g., microphone 2613). At step 3015, processor 2641 may identify an individual (e.g., individual 2911) represented by images captured using camera 2617A, as described above, using any suitable image recognition techniques. In some embodiments, an individual may be recognized based on a voice print of the individual. For example, a voice print may be obtained during a time period in which only the individual is speaking, or in other portions of the audio signal where the individual's voice print may be obtained. The voice print may then be compared to a plurality of voice prints pre-stored in a database to identify the individual. At step 3017, processor 2641 may retrieve from storage (e.g., local storage associated with the hearing aid system or remote storage associated with suitable cloud computing resources) a conditioning profile, as described above. At step 3019, processor 2641 may cause selective conditioning, based on the retrieved conditioning profile, of an audio signal received from an environment of a user (e.g., user 100, as shown in FIG. 29). The audio signal may be received from recognized individual 2911 (e.g., audio signal 2921). In some cases, user 100 may direct camera 2617A towards recognized individual 2911 as well as microphone 2613. Process 3001 may be concluded at step 3021, at which processor 2641 may transmit the audio signal as selectively conditioned using instructions obtained from the conditioning profile to an ear of user 100 via hearing interface device 2615 (shown, for example, in FIG. 26).

FIG. 30B shows an example process 3002 of selectively conditioning audio signal and transmitting the audio signal to an ear of a user. Process 3002 is a variation of process 3001. For example, process 3002 may include steps 3011 and 3013, as discussed above in connection with FIG. 30A. Process 3002 may differ from process 304)1 at step 3025. At step 3025, processor 2641 may identify an individual not using image data, as described in step 3015, but instead using audio data received from the individual. The audio data may be identified, for example, via a voiceprint of the individual. As described above, the voice print may be obtained, for example, during a time period in which only the individual is speaking. The voice print may then be compared to voice prints pre-stored in a database to identify the individual. In some embodiments, it should be appreciated that both steps 3015 and 3025 may be performed simultaneously by processor 2641 as described above. Process 3002 may additionally include steps 3017, 3019, and 3021, as discussed above in connection with FIG. 30A.

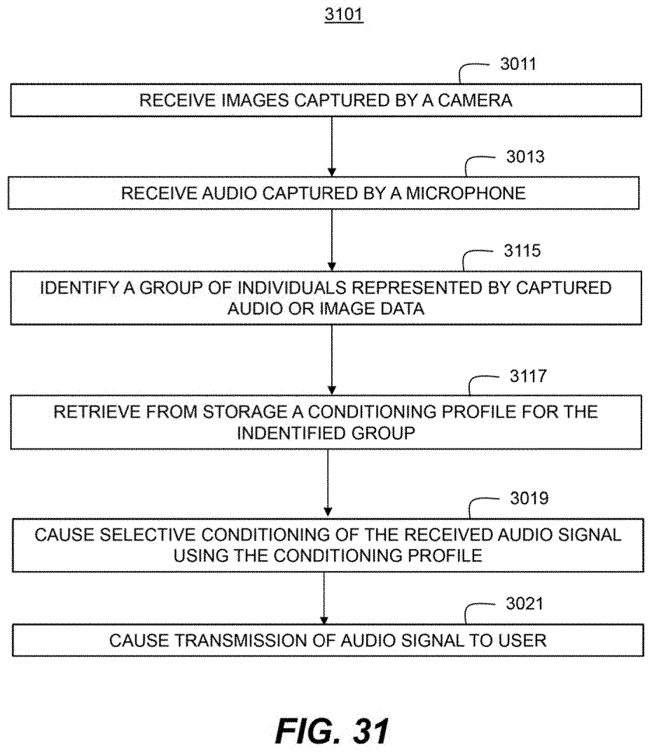

FIG. 31 shows an example process 3101 of selectively conditioning audio signal and transmitting the audio signal to an ear of a user. Process 3101 is a variation of process 3001 or process 3002. For example, process 3101 may include steps 3011 and 3013, as discussed above in connection with FIG. 30A. Process 3101 may differ from process 3001 or 3002 at step 3115 and 3117. At step 3115, processor 2641 may identify a group of individuals represented by images captured by camera 2617A or audio captured by microphone 2613, as described above. At step 3117, processor 2641A may retrieve from a storage a conditioning profile corresponding to the identified group, as described above. Process 3101 may additionally include steps 3019 and 3021, as discussed above in connection with FIG. 30A.

Selective Conditioning Based on User Cues

Hearing aid systems are designed to improve and enhance users' interactions with their environments. Users may rely on hearing aid systems to navigate their surroundings and daily activities. However, different users may require different levels of aid depending on the environment. Typical hearing aid systems may not correct or adjust audio signals sufficiently based on the needs of the user. Therefore, there is a need for apparatuses and methods for automatically conditioning audio signals for a user based on cues from the user.

The disclosed embodiments include hearing aid systems that may be configured to correct or adjust audio signals based on cues from a hearing aid user. For example, the cues may be physical (e.g., the user leaning or turning an ear towards a sound source or speech, the user raising his or her hand to an ear, etc.) or verbal (e.g., the user may state “What?” or “Repeat” or etc.), which may be collected by sensors and/or microphones on a wearable camera device. Based on the detected cues, the system may recognize that the user is having a difficult time hearing (e.g., understanding a speaking individual, etc.) and automatically correct or adjust at least one audio signal. For example, the system may selectively amplify sound from a sound source.

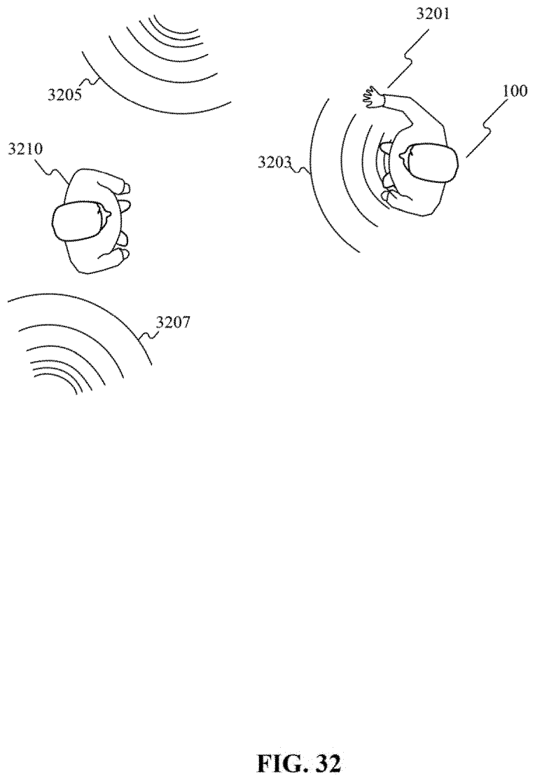

FIG. 32 is a schematic illustration showing an exemplary environment for use of a hearing aid with voice and/or image recognition consistent with the disclosed embodiments. A wearable camera (e.g., a wearable camera of apparatus 110) may be configured to capture a plurality of images from an environment of user 100. Alternatively or additionally, at least one microphone may be configured to capture sounds from the environment of user 100.

For example, processor 210 may receive at least one audio signal 3203, 3205, or 3207 representative of one or more sounds captured by the at least one microphone 1750 from the environment of user 100. In some embodiments, processor 210 may identify, based on analysis of at least one audio signal (e.g., audio signal 3203), at least one action of user 100. In some embodiments, the at least one action may include speech of user 100. For example, identifying at least one action may include detecting words spoken by user 100 based on analysis of at least one audio signal 3203. In some embodiments, the words may indicate that user 100 did not hear well. For example, user 100 may have said “What?” or “Can you please repeat what you said?” or “I do not understand.” In some embodiments, processor 210 may associate a greater difficulty of hearing with user 100 according to the type and/or frequency of detected words. For example, “repeat” may be associated with a greater difficulty of hearing than “I do not understand” and/or repeated words (e.g., user 100 repeatedly stating “What?”) may be associated with a greater difficulty of hearing than non-repeated words.

In some embodiments, microphone 1720 may be configured to determine a directionality of sounds in the environment of user 100. For example, microphone 1720 may comprise one or more directional microphones, which may be more sensitive to picking up sounds in certain directions. Processor 210 may be configured to distinguish sounds within the environment of user 100 and determine an approximate directionality of each sound. For example, using an array of microphones 1720, processor 210 may compare the relative timing or amplitude of a sound among the microphones 1720 to determine a directionality relative to apparatus 100.

In some embodiments, the sound captured from an environment of user 100 may be classified into segments containing speech, music, tones, laughter, screams, or the like. Indications of the respective segments may be logged in database 2050.

In some embodiments, the logged information may enable processor 210 to identify, based on analysis of at least one audio signal 3203, at least one action of user 100. As discussed earlier, the at least one action may include speech of user 104). For example, identifying the at least one action may include detecting words spoken by user 100 based on analysis of the at least one audio signal 3203. The words may indicate that user 100 did not hear sound (e.g., from another individual 3210, sounds associated with audio signal 3205, sounds associated with audio signal 3207, etc.) well.

Processor 210 may be configured to cause, based on the identified action, selective conditioning of at least one audio signal (e.g., from individual 3210, audio signal 3205, audio signal 3207, etc.) in the environment of user 100 received by the at least one microphone. The at least one conditioned audio signal may be transmitted to hearing interface device 1710 configured to provide sound to an ear of user 100, and thus may provide user 100 with audible feedback corresponding to a source (e.g., individual 3210, associated with audio signal 3205, associated with audio signal 3207, etc.) of the at least one audio signal. Processor 210 may perform various conditioning techniques on the audio signals received from microphone 1720. The conditioning may include amplifying audio signals determined to correspond to sound (e.g., individual 3210, associated with audio signal 3205, associated with audio signal 3207, etc.) relative to other audio signals. Amplification may be accomplished digitally, for example, by processing audio signals associated with individual 3210 relative to other audio signals 3205 or 3207. Amplification may also be accomplished by changing one or more parameters of microphone 1720 to focus on audio sounds emanating from individual 3210 (e.g., a region of interest) associated with user 100. For example, microphone 1720 may be a directional microphone and processor 210 may perform an operation to focus microphone 1720 on individual 3210 or other sounds in the environment of user 100. Various other techniques for amplifying sound may be used, such as using a beamforming microphone array, acoustic telescope techniques, etc. In some embodiments, selective conditioning may be implemented on at least one audio signal based on the determined difficulty of hearing of user 100. For example, the amplification of audio signals may be increased with an increase in difficulty of hearing associated with user 100.

Conditioning may also include attenuation or suppressing one or more audio signals received from directions outside of a region of interest (e.g., individual 3210). For example, processor 210 may attenuate audio signals 3205 and 3207. Similar to amplification of sound from individual 3210, attenuation of sounds may occur through processing audio signals, or by varying one or more parameters associated with one or more microphones 1720 to direct focus away from sounds emanating from outside of a region including individual 3210. In some embodiments, the attenuation of audio signals received from outside of a region of interest may be increased if user 100 has been determined via analysis of past interactions to have a predetermined level of hearing loss.

In some embodiments, conditioning may further include changing a tone of audio signals corresponding to sound from a region of interest to make the sound more perceptible to user 100. For example, user 100 may have lesser sensitivity to tones in a certain range and conditioning of the audio signals may adjust the pitch of sound from a region of interest to make it more perceptible to user 100. For example, user 100 may experience hearing loss in frequencies above 10 khz. Accordingly, processor 210 may remap higher frequencies (e.g., at 15 khz) to frequencies below 10 khz. In some embodiments processor 210 may be configured to change a rate of speech associated with one or more audio signals. Accordingly, processor 210 may be configured to detect speech within one or more audio signals received by microphone 1720, for example using voice activity detection (VAD) algorithms or techniques. For example, if sound is determined to correspond to voice or speech from individual 3210, processor 210 may be configured to vary the playback rate of sound from individual 3210. For example, the rate of speech of individual 3210 may be decreased to make the detected speech more perceptible to user 100. Various other processing may be performed, such as modifying the tone of sound from individual 3210 to maintain the same pitch as the original audio signal, or to reduce noise within the audio signal. If speech recognition has been performed on the audio signal associated with sound from individual 3210, conditioning may further include modifying the audio signal based on the detected speech. In some embodiments, conditioning may include modifying a rate of the detected speech. For example, the speech rate may be modified by extending a duration of words included in the audio signal and reducing a duration of pauses between the words (or vice versa), which may make the speech easier to understand.

The conditioned audio signal may then be transmitted to hearing interface device 1710 and produced for user 100. Thus, in the conditioned audio signal, sound from individual 3211) may be easier to hear to user 100, louder and/or more easily distinguishable than sounds from audio signals 3205 or 3207, which may represent background noise within the environment.

In some embodiments, the at least one microphone 1750 may capture one or more audio signals received during moving time windows of predetermined lengths, and processor 210 may be programmed to cause selective conditioning and transmission of a portion of an audio signal received within the moving time window. For example, processor 210 may store a portion of at least one audio signal (e.g., from individual 3210) in database 2050, where the portion is received before the at least one action (e.g., emitting audio signal 3203) of user 100. The portion of the at least one audio signal may be transmitted to hearing interface device 1710 configured to provide sound to an ear of user 100, and thus may provide user 100 with audible feedback corresponding to the source (e.g., another user) of the portion of the at least one audio signal. The portion of the at least one audio signal may be transmitted to hearing device 1710 based on at least one action of user 100. For example, the portion may be transmitted to hearing device 1710 after user 100 indicates that he or she had difficulty hearing one or more sounds, thereby duplicating at least one sound the user 100 had difficulty hearing. The periods missed by replaying previous periods of sound may then be provided to user 100 at an increased rate, for example by reducing the silence periods between words, or in any other suitable manner. In some embodiments, automatically replaying the sound may be performed based on a gesture performed by the user rather than a spoken indication by the user. For example, if the user states verbally that he or she had trouble understanding, another individual may be prompted to repeat the words.

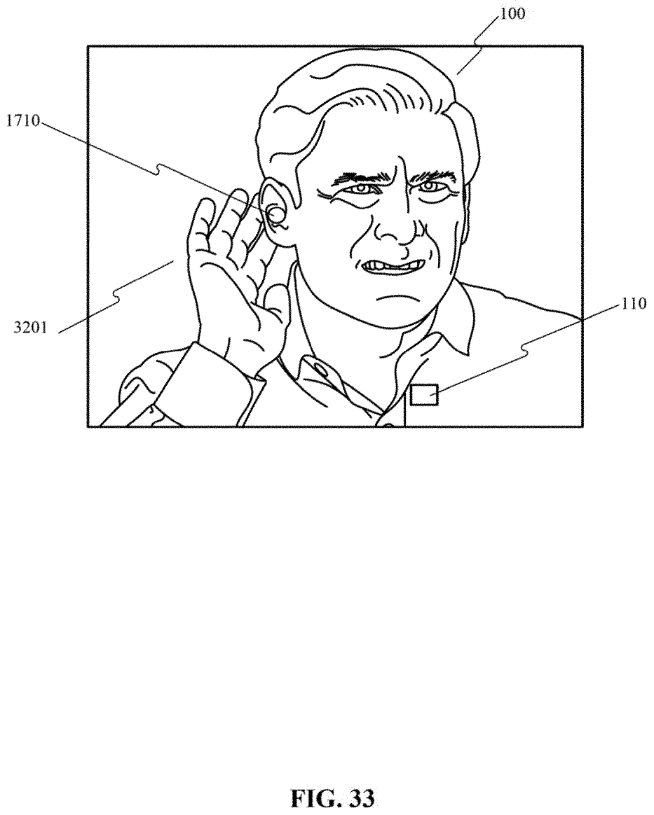

FIG. 33 is an exemplary depiction of user 100 with a hearing aid system consistent with the disclosed embodiments. In some embodiments, the wearable camera may be a component of apparatus 110 (e.g., a camera-based directional hearing aid apparatus) for selectively varying the amplification of sounds based on a motion 3201 (e.g., a hand motion, a leaning motion, a look direction, etc.) of user 100. User 100 may also wear, for example, hearing interface device 1710. In some embodiments, apparatus 110 may capture at least one image from the environment of user 100. In some embodiments, processor 210 may receive the at least one image captured by apparatus 110. Processor 210 may identify at least one action by detecting a motion 3201 of user 100 based on analysis of the at least one image. In some embodiments, motion 3201 may include a hand movement of user 100 or a leaning motion of user 100. For example, user 100 may cup his hand around an ear, indicating that user 100 is having trouble hearing individual 3210. In some embodiments, user 100 may lean toward individual 3210, indicating that user IOU is having trouble hearing individual 3210.

In some embodiments, a motion 3201 of user 100 may be tracked by monitoring a direction of a body part (e.g., hands, arms, etc.) or face part (e.g., nose, eyes, ears, hands near ears, etc.) of user 100 relative to an optical axis of a camera sensor. For example, a wearable camera of apparatus 110 may be configured to capture one or more images of the surrounding environment of user 100, for example, using image sensor 220. For example, the captured images may include a representation of a body part or a face part of user 100, which may be used to determine a hand movement of user 100. Processor 210 (and/or processors 210a and 210b) may be configured to analyze the captured images and detect a motion 3201 of a body part or a face part of user 100 using various image detection or processing algorithms (e.g., using convolutional neural networks (CNN), scale-invariant feature transform (SIFT), histogram of oriented gradients (HOG) features, or other techniques). Based on the detected representation of a body part or a face part of user 100, a motion 3201 of user 100 may be determined.

Motion 3201 may be determined in part by comparing the detected representation of a body part or a face part of user 100 to an optical axis of a camera sensor 1751. For example, the optical axis 1751 may be known or fixed in each image and processor 210 may determine a motion 1750 by comparing a representative angle of the body part or face part of user 100 to the direction of optical axis 1751. For example, the determined motion may include user 100 cupping his hand around an ear, indicating that user 100 is having trouble hearing individual 3210. In some embodiments, the determined motion may include user 100 leaning toward individual 3210, indicating that they are having trouble hearing individual 3210. For example, a leaning motion of user 100 towards a sound emanating object may be identified by a reduction of the distance between user 100 and the object. In some embodiments, the leaning motion may be detected based on comparing the reduction to a predetermined threshold or range, for example 5-30 cm. The distance may be assessed by analyzing one or more images, based on a range finder embedded within apparatus 110, or various other methods.

In some embodiments, processor 210 may cause, based on the identified action, selective conditioning of at least one audio signal (e.g., from individual 3210) received by at least one microphone 1720 and cause transmission of the at least one conditioned audio signal to hearing interface device 1710 configured to provide sound to an ear of user 100. In some embodiments, user 110 may lean toward a particular direction (e.g., toward an individual in an environment of user 110) and causing selective conditioning of the at least one audio signal may comprise amplifying at least one audio signal received from a direction of the leaning motion.

The at least one conditioned audio signal may be transmitted to hearing interface device 1710 configured to provide sound to an ear of user 100, and thus may provide user 100 with audible feedback corresponding to a source (e.g., individual 3210) of the at least one audio signal. Processor 210 may perform various conditioning techniques on the audio signals received from microphone 1720. The conditioning may include amplifying audio signals determined to correspond to sound from individual 3210 relative to other audio signals (e.g., audio signals 3205 or 3207). Amplification may be accomplished digitally, for example, by digitally processing audio signals associated with individual 3210 relative to other signals. Amplification may also be accomplished by changing one or more parameters of microphone 1720 to focus on audio sounds emanating from individual 3210 (e.g., a region of interest) associated with user 100. For example, microphone 1720 may be a directional microphone and processor 210 may perform an operation to focus microphone 1720 on sound 1820 or other sounds within a region of individual 3210. Various other techniques for amplifying sound from individual 3210 may be used, such as using a beamforming microphone array, acoustic telescope techniques, etc.

Conditioning may also include attenuation or suppressing one or more audio signals received from directions outside of a region of interest (e.g., individual 3210). For example, processor 210 may attenuate audio signals 3205 and 3207. Similar to amplification of sound from individual 3210, attenuation of sounds may occur through processing audio signals, or by varying one or more parameters associated with one or more microphones 1720 to direct focus away from sounds emanating from outside of a region including individual 3210.

In some embodiments, conditioning may further include changing a tone of audio signals corresponding to sound from a region of interest to make the sound more perceptible to user 100. For example, user 100 may have lesser sensitivity to tones in a certain range and conditioning of the audio signals may adjust the pitch of sound from a region of interest to make it more perceptible to user 100. For example, user 100 may experience hearing loss in frequencies above 10 khz. Accordingly, processor 210 may remap higher frequencies (e.g., at 15 khz) to frequencies below 10 khz. In some embodiments processor 210 may be configured to change a rate of speech associated with one or more audio signals. Accordingly, processor 210 may be configured to detect speech within one or more audio signals received by microphone 1720, for example using voice activity detection (VAD) algorithms or techniques. For example, if sound is determined to correspond to voice or speech from individual 3210, processor 210 may be configured to vary the playback rate of sound from individual 3210. For example, the rate of speech of individual 3210 may be decreased to make the detected speech more perceptible to user 100. For example, the speech rate may be modified by extending or reducing the duration of spoken words duration and/or silence periods between the spoken words, as described above. Various other processing may be performed, such as modifying the tone of sound from individual 3210 to maintain the same pitch as the original audio signal, or to reduce noise within the audio signal. If speech recognition has been performed on the audio signal associated with sound from individual 3210, conditioning may further include modifying the audio signal based on the detected speech. For example, processor 210 may introduce pauses or increase the duration of pauses between words and/or sentences, which may make the speech easier to understand.

The conditioned audio signal may then be transmitted to hearing interface device 1710 and produced for user 100. Thus, in the conditioned audio signal, sound from individual 3210 may be easier to hear to user 100, louder and/or more easily distinguishable than sounds from audio signals 3205 or 3207, which may represent background noise within the environment.

In some embodiments, the at least one microphone 1750 may capture one or more audio signals received during moving time windows of predetermined lengths, and processor 210 may be programmed to cause selective conditioning and transmission of a portion of an audio signal received within the moving time window. For example, processor 210 may store a portion of at least one audio signal (e.g., from individual 3210) in database 2050, where the portion is received before the at least one action (e.g., motion 3203) of user 100. The portion of the at least one audio signal may be transmitted to hearing interface device 1710 configured to provide sound to an ear of user 100, and thus may provide user 100 with audible feedback corresponding to the source (e.g., another user) of the portion of the at least one audio signal. The portion of the at least one audio signal may be transmitted to hearing device 1710 based on at least one action of user 100. For example, the portion may be transmitted to hearing device 1710 after user 100 states “repeat,” thereby duplicating at least one sound with which user 100 has difficulty hearing.

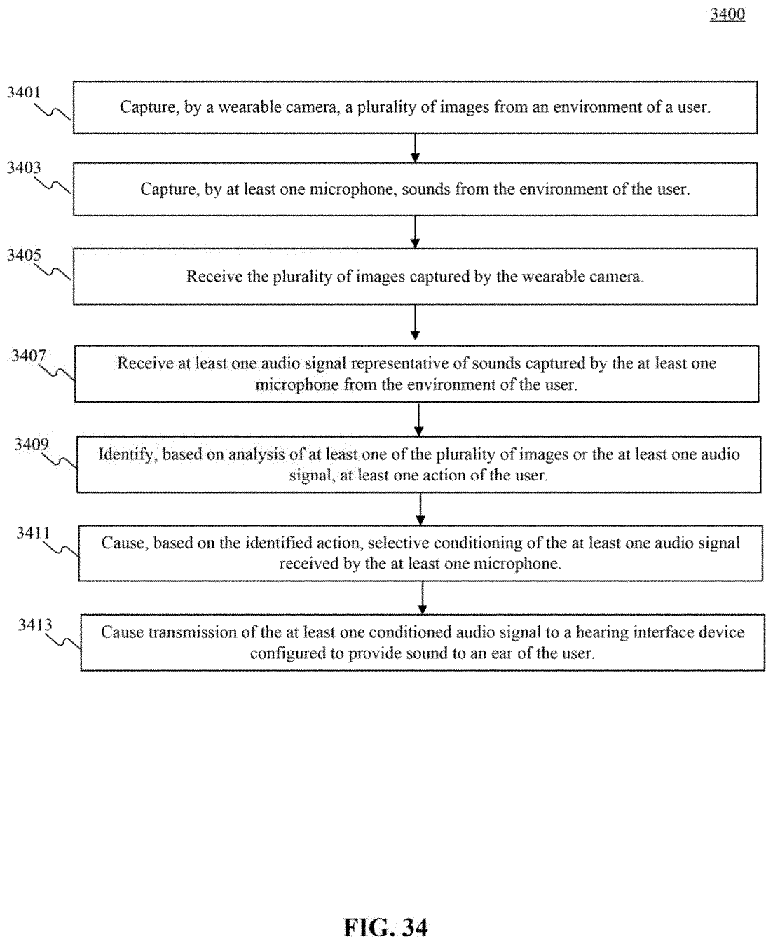

FIG. 34 is a flowchart showing an exemplary process 3400 for selectively amplifying sounds consistent with disclosed embodiments.

In step 3401, a wearable camera (e.g., a wearable camera of apparatus 110) may capture a plurality of images from an environment of user 100. In some embodiments, the wearable camera may be a component of apparatus 110 (e.g., a camera-based directional hearing aid apparatus) for selectively varying the amplification of sounds based on a motion 3201 (e.g., a hand motion, a leaning motion, a look direction, etc.) of user 100. In some embodiments, the wearable camera may capture at least one image from the environment of user 100.

In step 3403, at least one microphone may capture sounds from the environment of user 100. In some embodiments, microphone 1720 may be configured to determine a directionality of sounds in the environment of user 100 For example, microphone 1720 may comprise one or more directional microphones, which may be more sensitive to picking up sounds in certain directions. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100.

In step 3405, processor 210 may receive the plurality of images captured by the wearable camera. For example, a wearable camera may be configured to capture one or more images of the surrounding environment of user 100, for example, using image sensor 220.

In step 3407, processor 210 may receive at least one audio signal representative of sounds captured by the at least one microphone from the environment of the user. For example, processor 210 may receive at least one audio signal 3203, 3205, or 3207 representative of sounds captured by the at least one microphone 1750 from the environment of user 100.

In step 3409, processor 210 may identify, based on analysis of at least one of the plurality of images or the at least one audio signal, at least one action of the user. In some embodiments, processor 210 may identify, based on analysis of at least one audio signal (e.g., audio signal 3203), at least one action of user 100. In some embodiments, the at least one action may include speech of user 100. For example, identifying at least one action may include detecting words spoken by user 100 based on analysis of at least one audio signal 3203. In some embodiments, the words may indicate that user 100 did not hear well. For example, user 100 may have said “What?,” “Can you please repeat what you said?,” “I do not understand,” or similar phrases. In some embodiments, processor 210 may associate a greater difficulty of hearing with user 100 according to the type and/or frequency of detected words. For example, “repeat” may be associated with a greater difficulty of hearing than “I do not understand” and/or repeated words (e.g., user 100 repeatedly stating “What?”) may be associated with a greater difficulty of hearing than non-repeated words.

In some embodiments, the sound captured from an environment of user 100 may be classified using any audio classification technique. Processor 210 may be configured to analyze sounds to separate and identify different sources of audio signals. For example, processor 210 may use one or more speech or voice activity detection (VAD) algorithms, voice separation techniques, and/or sound classification techniques. Processor 210 may isolate audio signals associated with different sources of sound when multiple sounds are detected in the environment of user 100. In some embodiments, processor 210 may perform further analysis on audio signals associated with detected voice activity to recognize speech of individuals. For example, processor 210 may use one or more voice recognition algorithms (e.g., Hidden Markov Models, Dynamic Time Warping, neural networks, or other techniques) to recognize the voice and/or the words spoken by individuals. For example, the sound may be classified into segments containing speech, music, tones, laughter, screams, or the like. Indications of the respective segments may be logged in database 2050.

In some embodiments, the logged information may enable processor 210 to identify, based on analysis of at least one audio signal 3203, at least one action of user 100. In some embodiments, the at least one action may include speech of user 100. For example, identifying the at least one action may include detecting words spoken by user 100 based on analysis of the at least one audio signal 3203. In some embodiments, the words may indicate that user 100 did not hear sound (e.g., from another individual 3210, sounds associated with audio signal 3205, sounds associated with audio signal 3207, etc.) well.

In some embodiments, processor 210 may receive the at least one image captured by the wearable camera and may identify, based on analysis of the at least one image, at least one action of user 100. Processor 210 may identify the at least one action by detecting a motion 3201 of user 100 based on analysis of the at least one image. In some embodiments, motion 3201 may include a hand movement of user 100 or a leaning motion of user 100. For example, user 100 may cup his hand around an ear, indicating that they are having trouble hearing individual 3210. In some embodiments, user 100 may lean toward individual 3210, indicating that they are having trouble hearing individual 3210.

In some embodiments, a motion 3201 of user 100 may be tracked by monitoring a direction of a body part (e.g., hands, arms, etc.) or face part (e.g., nose, eyes, ears, hands near ears, etc.) of user 100 relative to an optical axis of a camera sensor. For example, the captured images may include a representation of a body part or a face part of user 100, which may be used to determine a hand movement or a leaning motion of user 100. Processor 210 (and/or processors 210a and 210b) may be configured to analyze the captured images and detect a motion 3201 of a body part or a face part of user 100 using various image detection or processing algorithms (e.g., using convolutional neural networks (CNN), scale-invariant feature transform (SIFT), histogram of oriented gradients (HOG) features, or other techniques). Based on the detected representation of a body part or a face part of user 100, a motion 3201 of user 100 may be determined.

Motion 3201 may be determined in part by comparing the detected representation of a body part or a face part of user 100 to an optical axis of a camera sensor 1751. For example, the optical axis 1751 may be known or fixed in each image and processor 210 may determine a motion 1750 by comparing a representative angle of the body part or face part of user 100 to the direction of optical axis 1751. For example, the determined motion may include user 100 cupping his hand around an ear, indicating that they are having trouble hearing individual 3210. In some embodiments, the determined motion may include user 100 leaning toward individual 3210, indicating that they are having trouble hearing individual 3210.

In step 3411, processor 210 may cause, based on the identified action, selective conditioning of the at least one audio signal received by the at least one microphone as described in greater detail above.

In step 3413, processor 210 may cause transmission of the at least one conditioned audio signal to a hearing interface device configured to provide sound to an ear of the user. For example, the at least one conditioned audio signal may be transmitted to hearing interface device 1710 configured to provide sound to an ear of user 100, and thus may provide user 100 with audible feedback corresponding to a source (e.g., individual 3210, associated with audio signal 3205, associated with audio signal 3207, etc.) of the at least one audio signal. For example, in the conditioned audio signal, sound from individual 3210 may be easier to hear to user 100, louder and/or more easily distinguishable than sounds from audio signals 3205 or 3207, which may represent background noise within the environment.

Intuitive Control of Active Speaker

Hearing aid systems are designed to improve and enhance users' interactions with their environments. Users may rely on hearing aid systems to navigate their surroundings and daily activities. However, different users may require different levels of aid depending on the environment. In some cases, a user may prioritize hearing sounds from a source in his or her environment over one or more additional sources in his environment. For example, the user may prioritize hearing sounds from family members in his environment over strangers or background noise in his environment. Typical hearing aid systems may not correct or adjust audio signals sufficiently based on the needs of the user. Therefore, there is a need for apparatuses and methods for automatically conditioning audio signals for a user based on cues from the environment of the user.

The disclosed embodiments include hearing aid systems that may be configured to correct or adjust audio signals based on cues from an environment of a hearing aid user. The cues may include distances between the user and one or more individuals, directions of individuals relative to a look direction of a user, gesture of an active speaker, look directions of individuals toward an active speaker, or other visual cues. For example, sounds from an individual who is closer to the user may have a higher priority over sounds from an individual who is further away from the user. In some embodiments, the user may manually define or assign priorities to different sources of sounds via a device. For example, the user may assign a higher priority to individuals he knows (e.g., family members, friends, etc.) over other sources of sound (e.g., sounds from devices, strangers, background noise, etc.). In some embodiments, the hearing aid system may recognize individuals and use priorities assigned to the individuals accordingly.

In some embodiments, the hearing aid system may correct or adjust audio signals by selectively conditioning (e.g., amplifying, attenuating, muting, etc.) audio signals based on a priority of sound sources. For example, the hearing aid system may preferentially amplify audio signals from sound sources with a higher priority. In some embodiments, the hearing aid system may preferentially attenuate or mute audio signals from sound sources with a lower priority.

FIG. 35 is a schematic illustration showing an exemplary environment including a hearing aid with voice and/or image recognition consistent with the disclosed embodiments. In some embodiments, a wearable camera (e.g., a wearable camera of apparatus 110) may be configured to capture a plurality of images from an environment of user 100. In some embodiments, at least one microphone may be configured to capture sounds from the environment of user 100.

For example, processor 210 may receive at least one audio signal 3511, 3513, or 3515 representative of sounds captured by the at least one microphone 1750 from the environment of user 100. In some embodiments, processor 210 may identify, based on analysis of at least one audio signal (e.g., audio signals 3511, 3513, or 3515), a first audio signal 3511 associated with a first voice associated with a first individual 3501 and a second audio signal 3513 associated with a second voice associated with a second individual 3503.

A hearing aid system may store voice samples, images, voice characteristics and/or facial features of a recognized person to aid in recognition and selective amplification. For example, when an individual (e.g., first individual 3501 or second individual 3503) enters the field of view of apparatus 110, the individual may be recognized as an individual that has been introduced to user 110, or that has possibly interacted with user 100 in the past (e.g., a friend, colleague, relative, prior acquaintance, etc.). Accordingly, audio signals (e.g., audio signal 3511 or audio signal 3513) associated with the recognized individual's voice may be isolated and/or selectively amplified relative to other sounds in the environment of the user. Audio signals (e.g., audio signal 3515) associated with sounds received from directions other than the individual's direction may be suppressed, attenuated, filtered or the like.

User 100 may want audio signals to be amplified based on a priority of sounds user 100 wishes to receive. For example, processor 210 may determine a hierarchy of individuals and assign priority based on the relative status of the individuals. This hierarchy may be based on the individual's position within a family or an organization (e.g., a company, sports team, club, etc.) relative to user 100. For example, user 100 may be in a work environment and may need to hear his boss before his co-worker. Therefore, the boss of user 100 may be ranked higher than a co-worker or person from a different department and thus may have priority in the selective conditioning process. In some embodiments, user 100 may be in an environment with “close friends,” family, and acquaintances. Individuals identified as close friends or family, for example, may be prioritized over acquaintances of user 100 since user 100 may wish to hear close friends or family, but not acquaintances.

In some embodiments, the wearable camera may be a component of apparatus 110 (e.g., a camera-based directional hearing aid apparatus) for selectively varying the amplification of sounds based on the identification of individuals (e.g., first individual 3501 or second individual 3503) in the environment of user 100. In some embodiments, the wearable camera may capture at least one image from the environment of user 100 using image sensor 220. In some embodiments, processor 210 may receive the at least one image captured by the wearable camera and may identify, based on analysis of the at least one image, at least one individual in the environment of user 100. Processor 210 (and/or processors 210a and 210b) may be configured to analyze the captured images and detect features of a body part or a face part of at least one individual using various image detection or processing algorithms (e.g., using convolutional neural networks (CNN), scale-invariant feature transform (SIFT), histogram of oriented gradients (HOG) features, or other techniques). Based on the detected representation of a body part or a face part of at least one individual, the at least one individual may be identified. In some embodiments, processor 210 may be configured to identify at least one individual using facial and/or voice recognition components as described for apparatus 110 in FIG. 20A or 20B.

For example, facial recognition component 2040 may be configured to identify one or more faces within the environment of user 100. Facial recognition component 2040 may identify facial features on the faces of individuals, such as the eyes, nose, cheekbones, jaw, or other features. Facial recognition component 2040 may analyze the relative size and position of these features to identify the individual. In some embodiments, facial recognition component 2040 may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), or the like. Additional facial recognition techniques, such as 3-Dimensional recognition, skin texture analysis, and/or thermal imaging, may be used to identify individuals. Other features, besides facial features, of individuals may also be used for identification, such as the height, body shape, or other distinguishing features of the individuals.

Facial recognition component 2040 may access a database or data associated with user 100 to determine if the detected facial features correspond to a recognized individual. For example, processor 210 may access database 2050 containing information about individuals known to user 100 and data representing associated facial features or other identifying features. Such data may include one or more images of the individuals, or data representative of a face of the user that may be used for identification through facial recognition. Facial recognition component 2040 may also access a contact list of user 100, such as a contact list on the user's phone, a web-based contact list (e.g., through Outlook™, Skype™, Google™, SalcsForce™, etc.) or a dedicated contact list associated with hearing interface device 1710. In some embodiments, database 2050 may be compiled by apparatus 110 through previous facial recognition analysis. For example, processor 210 may be configured to store data associated with one or more faces recognized in images captured by apparatus 110 in database 2050. Each time a face is detected in the images, the detected facial features or other data may be compared to previously identified faces in database 2050. Facial recognition component 2040 may determine that an individual is a recognized individual of user 100 if the individual has previously been recognized by the system in a number of instances exceeding a certain threshold, if the individual has been explicitly introduced to apparatus 110, or the like.

Apparatus 110 may be configured to recognize an individual (e.g., first individual 3501 or second individual 3503) in the environment of user 100 based on the received plurality of images captured by the wearable camera. For example, apparatus 110 may be configured to recognize a face 3521 associated with first individual 3501 or a face 3523 associated with second individual 3503 within the environment of user 100. For example, apparatus 110 may be configured to capture one or more images of the surrounding environment of user 100 using camera 1730. The captured images may include a representation of a recognized individual (e.g., first individual 3501 or second individual 3503), which may be a friend, colleague. relative, or prior acquaintance of user 100. Processor 210 (and/or processors 210a and 210b) may be configured to analyze the captured images and detect the recognized individual using various facial recognition techniques. Accordingly, apparatus 110, or specifically memory 550, may comprise one or more facial recognition components (e.g., software programs, modules, libraries, etc.).

In some embodiments, processor 210 may be configured to cause selective conditioning of an audio signal (e.g., audio signals 3511 or 3513) based on a determination by processor 210 that a first audio signal is associated with a priority that is higher than a priority of a second audio signal. A hierarchy of sounds may be determined using various methods. For example, a hierarchy of sounds may be determined by a comparative analysis of two sounds or of more than two sounds. In some embodiments, the sound sources may include people, objects, (e.g., televisions, automobiles, etc.), the environment (e.g., running water, wind, etc.), etc. For example, processor 210 may use a comparative analysis to determine that sounds from people have priority over sounds from objects or the environment.

In some embodiments, selective conditioning of audio signals associated with a recognized individual may be based on the identities of individuals within the environment of user 100. For example, where multiple individuals are detected in the images, processor 210 may use one or more facial recognition techniques to identify the individuals, as described above. Audio signals associated with individuals that are known to user 100 may be selectively amplified or otherwise conditioned to have priority over unknown individuals. For example, processor 210 may be configured to attenuate or silence audio signals associated with bystanders in the environment of user 100, such as a noisy office mate, etc. In some embodiments, processor 210 may also determine a hierarchy of individuals and assign priority based on the relative status of the individuals. This hierarchy may be based on the individual's position within a family or an organization (e.g., a company, sports team, club, etc.) relative to user 100. For example, the boss of user 100 may be ranked higher than a co-worker or person from a different department and thus may have priority in the selective conditioning process. In some embodiments, the hierarchy may be determined based on a list or database. Individuals recognized by the system may be ranked individually or grouped into tiers of priority. This database may be maintained specifically for this purpose or may be accessed externally. For example, the database may be associated with a social network of the user (e.g., Facebook™, LinkedIn™, etc.) and individuals may be prioritized based on their grouping or relationship with the user. Individuals identified as “close friends” or family, for example, may be prioritized over acquaintances of user 100.

In some embodiments, processor 210 may selectively condition audio signals associated with an individual based on the individual's proximity to user 100. Processor 210 may determine a distance from user 100 to each individual based on captured images a rangefinder, or other methods, and may selectively condition audio signals associated with the individuals based on the distance. For example, an individual physically closer to user 100 may be prioritized higher and his or her voice may be amplified at a greater magnitude than an individual that is farther away from user 100. In some embodiments, processor 210 may determine a direction of an individual relative to a look direction of the user. Individuals at closer angles relative to the look direction may be prioritized higher.

In some embodiments, processor 210 may determine priority levels by identifying at least one action based on analysis of at least one of the plurality of images. For example, processor 210 may determine, based on lip movements and detected sounds, which individuals in the environment of user 100 are speaking. For example, processor 210 may track lip movements associated with individuals 3501 or 3503 to determine that individuals 3501 or 3503 are speaking. A comparative analysis may be performed between the detected lip movements and the received audio signals. For example, processor 210 may determine that individual 3501 is speaking based on a determination that the mouth of individual 3501 is moving at the same time as sounds associated with audio signal 3511 are detected. In some embodiments, when the lips of individual 3501 stop moving, this may correspond with a period of silence or reduced volume in the sound associated with audio signal 3511.

In some embodiments, data associated with apparatus 110 may further be used in conjunction with the detected lip movement to determine and/or verify whether individuals are speaking, such as a look direction of user IOU or individuals 3501 or 3503, a detected identity of individuals 3501 or 3503, a recognized voiceprint of individuals 3501 or 3503, etc.

In some embodiments, processor 210 may be configured to selectively condition multiple audio signals based on which individuals associated with the audio signals are currently speaking. That is, in some embodiments, processor 210 may prioritize an individual who is speaking rather than an individual who is not speaking. For example. individual 3501 and individual 3503 may be engaged in a conversation within the environment of user l00 and processor 210 may be configured to transition from amplifying audio signal 3511 associated with individual 3501 to amplifying audio signal 3513 associated with individual 3503 based on the respective lip movements of individuals 3501 and 3503. For example, lip movements of individual 3501 may indicate that individual 3501 has stopped speaking or lip movements associated with individual 3503 may indicate that individual 3503 has started speaking. Accordingly, processor 210 may transition between amplifying audio signal 3511 to audio signal 3513. In some embodiments, processor 210 may be configured to process and/or condition both audio signals concurrently but only selectively transmit the conditioned audio to hearing interface device 1710 based on which individual is speaking. Where speech recognition is implemented, processor 210 may determine and/or anticipate a transition between speakers based on the context of the speech. For example, processor 210 may analyze audio signal 3511 to determine that individual 3501 has reached the end of a sentence or has asked a question, which may indicate individual 3501 has finished or is about to finish speaking.

In some embodiments, processor 210 may be configured to select between multiple active speakers to selectively condition audio signals. For example, individuals 3501 and 3503 may both be speaking at the same time or their speech may overlap during a conversation. Processor 210 may amplify audio associated with one speaking individual over other individuals. This may include giving priority to a speaker who has started, but not finished, a word or sentence or has not finished speaking altogether when the other speaker started speaking. This determination may also be driven by the context of the speech, as described above.

In some embodiments, a look direction of user 100 or individuals 3501 or 3503 may be determined and the individual to whom the look direction is directed may be given a higher priority among the active speakers. For example, if individual 3503 is looking at individual 3501, audio signal 3511 associated with individual 3501 may be selectively conditioned (e.g., amplified). In some embodiments, priority may be assigned based on the relative behavior of other individuals in the environment of user 100. For example, if both individual 3501 and individual 3503 are speaking and additional individuals are looking at individual 3501 instead of individual 3503, audio signal 3511 associated with individual 3501 may be amplified over those associated with individual 3503. In embodiments where the identity of the individuals is determined, priority may be assigned based on the relative status of the speakers, as discussed previously.

In some embodiments, processor 210 may be configured to cause, based on a determined priority, selective conditioning of at least one audio signal (e.g., audio signal 3511 or audio signal 3513) in the environment of user 100 received by the at least one microphone. The at least one conditioned audio signal may be transmitted to hearing interface device 1710, and hearing interface device 1710 may be configured to provide sound to an ear of user 100. Thus, hearing interface device 1710 may provide user 100 with audible feedback corresponding to a source (e.g., associated with audio signal 3511, associated with audio signal 3513, etc.) of the at least one audio signal. Processor 210 may perform various conditioning techniques on the audio signals received from microphone 1720. The conditioning may include amplifying audio signals determined to have a higher priority than other audio signals. Amplification may be accomplished digitally, for example, by processing audio signals associated with higher priority sources relative to other audio signals. Amplification may also be accomplished by changing one or more parameters of microphone 1720 to focus on audio sounds emanating from higher priority sources. For example, microphone 1720 may be a directional microphone and processor 210 may perform an operation to focus microphone 1720 on individuals 3501 or 3503 or other sounds in the environment of user 100. Various other techniques for amplifying sound may be used, such as using a beamforming microphone array, acoustic telescope techniques, etc.

Conditioning may also include attenuation or suppressing one or more audio signals received from sources that are of lower priority. For example, processor 210 may determine that individual 3501 has a higher priority than individual 3503 and attenuate audio signals 3513 and 3515. Similar to amplification of sound, attenuation of sounds may occur through processing audio signals, or by varying one or more parameters associated with one or more microphones 1720 to direct focus away from sounds emanating from lower priority sources.

In some embodiments, conditioning may further include changing a tone of audio signals corresponding to sound from higher priority sources to make the sound more perceptible to user 100. For example, user 100 may have lesser sensitivity to tones in a certain range and conditioning of the audio signals may adjust the pitch of sound from a higher priority source to make it more perceptible to user 100. For example, user 100 may experience hearing loss in frequencies above 10 khz. Accordingly, processor 210 may remap higher frequencies (e.g., at 15 khz) to frequencies below 10 khz. In some embodiments processor 210 may be configured to change a rate of speech associated with one or more audio signals. Accordingly, processor 210 may be configured to detect speech within one or more audio signals received by microphone 1720, for example using voice activity detection (VAD) algorithms or techniques. For example, if sound is determined to correspond to voice or speech from individual 3501, processor 210 may be configured to vary the playback rate of sound from individual 3501. For example, the rate of speech of individual 3501 may be decreased to make the detected speech more perceptible to user 100. Various other processing may be performed, such as modifying the tone of sound from individual 3501 to maintain the same pitch as the original audio signal, or to reduce noise within the audio signal. If speech recognition has been performed on the audio signal associated with sound from individual 3501, conditioning may further include modifying the audio signal based on the detected speech. For example, processor 210 may introduce pauses or increase or decrease the duration of pauses between words and/or sentences, which may make the speech easier to understand.

The conditioned audio signal may then be transmitted to hearing interface device 1710 and produced for user 100. Thus, in the conditioned audio signal, sound from higher priority sources may be easier to hear to user 100, louder, and/or more easily distinguishable than sounds from lower priority sources, which may represent background noise within the environment.

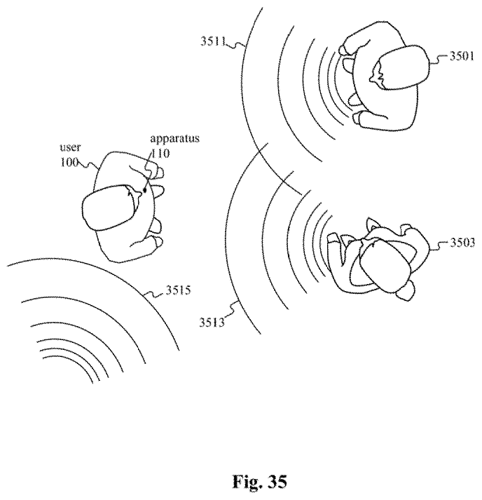

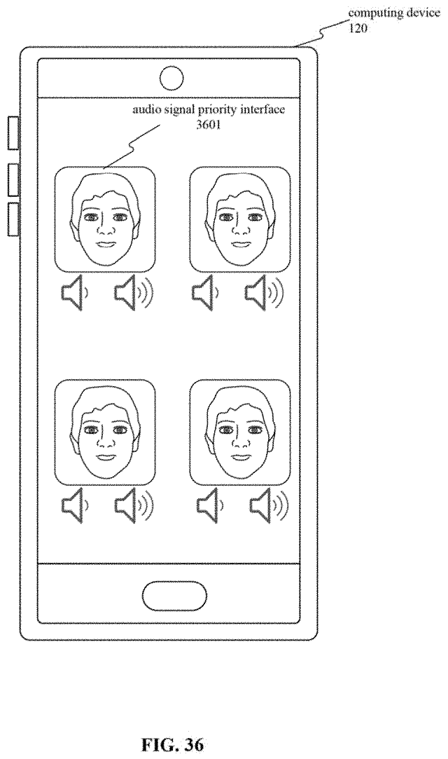

FIG. 36 illustrates an exemplary computing device 120 for use with a hearing aid with voice and/or image recognition consistent with the disclosed embodiments. In some embodiments, user 100 may provide input for prioritizing speakers through predefined settings or by actively selecting which speaker to focus on. In some embodiments, computing device 120 may be paired with apparatus 110. For example, computing device 120 (e.g., a mobile device) may display at least one audio signal priority interface 3601 (e.g., a graphical user interface) associated with an individual (e.g., individual 3501). In some embodiments, user 100 may interact with at least interface 3601 to submit at least one priority setting. For example, user 100 may input a priority setting that indicates that individual 3501 has a higher priority than other individuals via interface 3601 on computing device 120.

In some embodiments, user 100 may input a priority setting for one or more sound sources by interacting with various interfaces that indicate adjusting the volume of sound sources (e.g., individuals, objects, the environment, etc.) via computing device 120. For example, user 100 may input a priority setting for individual 3501 by interacting with (e.g., selecting an icon, moving a slider icon, etc.) an interface that indicates an increase in sound volume of individual 3501. In some embodiments, user 100 may input a priority setting for individual 3501 by interacting with interfaces that decrease or mute the sound volume of one or more sound sources (e.g., other individuals, objects, the environment, etc.). In some embodiments. user 100 may assign a hierarchy to sound sources by numerically ranking the priority of sound sources via interfaces of computing device 120. In some embodiments, user 100 may “favorite” (e.g., assign a star symbol via an interface of computing device 120) some sound sources that he prioritizes over other sound sources.

In some embodiments, audio signal priority interface 3601 may display an image captured by apparatus 110 from the environment of user 100. In some embodiments, computing device 120 may include plurality of audio signal priority interfaces, where each audio signal priority interface includes an image captured by apparatus 110 from the environment of user 100. As discussed previously, processor 210 may identify at least one action based on analysis of at least one of a plurality of captured images. For example, processor 210 may determine, based on user 100 pointing at one or more sound sources (e.g., individuals), a hierarchy of sound sources. In some embodiments, user 100 may point to at least one sound source of each sound source in order from highest priority to lowest priority. Based on the actions of user 100, the audio signal priority interfaces of computing device 120 may display a hierarchy of sounds associated with each sound source. Processor 210 may selectively condition the audio signals associated with each sound source based on the hierarchy of sound sources. For example, higher priority audio signals may be isolated and/or selectively amplified relative to lower priority audio signals in the environment of user 100. In some embodiments, lower priority audio signals may be suppressed, attenuated, filtered, unchanged, or the like.

In some embodiments, user 100 may input a priority setting for one or more sound sources by inputting a condition via computing device 120. For example, user 100 may input a condition such that sound sources that emit keywords (e.g., individuals who say “Look out,” “Emergency,” etc.) are prioritized (e.g., amplified) over other sound sources. In some embodiments, user 100 may input priority settings for sound sources by inputting other conditions or criteria. For example, user 100 may prioritize sound sources based on time (e.g., time of the day, day of the week, time of the year, etc.) such that sounds are conditioned during a specified time span. For example, user 100 may input priority settings such that sounds are amplified Monday through Friday from 9:00 AM to 5:00 PM during work hours.

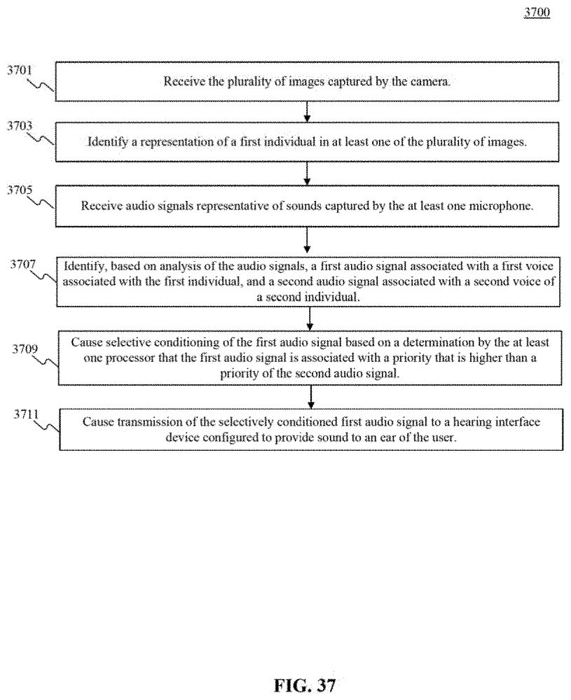

FIG. 37 is a flowchart showing an exemplary process 3700 for selectively amplifying sounds consistent with the disclosed embodiments. Hearing aid systems may be configured to correct or adjust audio signals by selectively conditioning (e.g., amplifying, attenuating, muting, etc.) audio signals based on a priority of sound sources, for example, according to process 3700.

In step 3701, a wearable camera (e.g., a wearable camera of apparatus 110) may capture a plurality of images from an environment of user 100. In some embodiments, the wearable camera may be a component of apparatus 110 (e.g., a camera-based directional hearing aid apparatus) for selectively varying the amplification of sounds based on the identification of individuals (e.g., first individual 3501 or second individual 3503) in the environment of user 100. In some embodiments, the wearable camera may capture at least one image from the environment of user 100 using image sensor 220. In some embodiments, processor 210 may receive the at least one image captured by the wearable camera.

In step 3703, processor 210 may identify, based on analysis of the at least one image, at least one individual in the environment of user 100. Processor 210 (and/or processors 210a and 210b) may be configured to analyze the captured images and detect features of a body part or a face part of at least one individual using various image detection or processing algorithms (e.g., using convolutional neural networks (CNN), scale-invariant feature transform (SIFT), histogram of oriented gradients (HOG) features, or other techniques), as described above. Based on the detected representation of a body part or a face part of at least one individual, at least one identification of an individual may be determined. In some embodiments, processor 210 may be configured to identify at least one individual using facial and/or voice recognition components as described for apparatus 110 in FIG. 20A or 20B.

Apparatus 110 may be configured to recognize an individual (e.g., first individual 3501 or second individual 3503) in the environment of user 100 based on the received plurality of images captured by the wearable camera. Apparatus 110 may be configured to recognize a face 3521 associated with first individual 3501 or a face 3523 associated with second individual 3503 within the environment of user 100. For example, apparatus 110 may be configured to capture one or more images of the surrounding environment of user 100 using camera 1730. The captured images may include a representation of a recognized individual (e.g., first individual 3501 or second individual 3503), which may be a friend, colleague, relative, or other prior acquaintance of user 100. Processor 210 (and/or processors 210a and 210b) may be configured to analyze the captured images and detect the recognized individual using various facial recognition techniques. Accordingly, apparatus 110, or specifically memory 550, may comprise one or more facial recognition components.

For example, facial recognition component 2040 may access a database or data associated with user 100 to determine if the detected facial features correspond to a recognized individual. For example, processor 210 may access database 2050 (e.g., remotely, over a network, etc.) containing information about individuals known to user 100 and data representing associated facial features or other identifying features. Such data may include one or more images of the individuals, or data representative of a face of the user that may be used for identification through facial recognition. In some embodiments, database 2050 may be compiled by apparatus 110 through previous facial recognition. For example, processor 210 may be configured to store data associated with one or more faces recognized in images captured by apparatus 110 in database 2050. Each time a face is detected in the images, the detected facial features or other data may be compared to previously identified faces in database 2050. Facial recognition component 2040 may determine that an individual is a recognized individual of user 100 if the individual has previously been recognized by the system in a number of instances exceeding a certain threshold, if the individual has been explicitly introduced to apparatus 110, or the like.

In some embodiments, audio signal priority interface 3601 may display an image captured by apparatus 110 from the environment of user 100. For example, computing device 120 may include plurality of audio signal priority interfaces, where each audio signal priority interface includes an image (e.g., of an individual or other sound source) captured by apparatus 110 from the environment of user 100.

In step 3705, at least one microphone may capture sounds from the environment of user 100. Processor 210 may receive at least one audio signal 3511, 3513, or 3515 representative of sounds captured by the at least one microphone 1750 from the environment of user 100.

In step 3707, processor 210 may identify, based on analysis of at least one audio signal (e.g., audio signals 3511, 3513, or 3515), a first audio signal 3511 associated with a first voice associated with a first individual 3501 and a second audio signal 3513 associated with a second voice associated with a second individual 3503. A hierarchy of sounds may be determined using various methods. For example, a hierarchy of sounds may be determined by a comparative analysis of two or more sounds. In some embodiments, the sound sources may include people, objects, (e.g., televisions, automobiles, etc.), the environment (e.g., running water, wind, etc.), etc. For example, processor 210 may use a comparative analysis to determine that sounds from people have priority over sounds from objects or the environment. The hierarchy of sounds may be determined based upon a user input, default settings, or the like, as described above.

In step 3709, processor 210 may be configured to cause selective conditioning of a first audio signal and a second audio signal (e.g., audio signals 3511 and 3513) based on a determination by processor 210 that a first audio signal is associated with a priority that is higher than a priority of a second audio signal.

In some embodiments, selective conditioning of audio signals associated with a recognized individual may be based on the identities of individuals within the environment of user 100. For example, where multiple individuals are detected in the images, processor 210 may use one or more facial recognition techniques to identify the individuals, as described above. Audio signals associated with individuals that are known to user 100 may be selectively amplified or otherwise conditioned to have priority over unknown individuals. For example, processor 210 may be configured to attenuate or silence audio signals associated with bystanders in the environment of user 100, such as a noisy office mate, etc. In some embodiments, processor 210 may also determine a hierarchy of individuals and give priority based on the relative status of the individuals. In some embodiments, the hierarchy may be determined based on a list or database. Individuals recognized by the system may be ranked individually or grouped into tiers of priority. Individuals identified as “close friends” or family, for example, may be prioritized over acquaintances of user 100.

In some embodiments, processor 210 may selectively condition audio signals associated with one or more individuals based on the individuals proximity to user 100. Processor 210 may determine a distance from user 100 to each individual based on captured images and may selectively condition audio signals associated with the individuals based on the distance. For example, an individual closer to user 100 may be prioritized higher than an individual that is farther away from user 100. Similarly, individuals at angles that are closer to a look direction of the user may be prioritized higher than individuals at greater angles from the look direction of the user.

In some embodiments, processor 210 may determine priority levels by identifying at least one action based on analysis of at least one of the plurality of images. For example, processor 210 may determine, based on lip movements and the detected sounds, which individuals in the environment of user 100 are speaking. For example, processor 210 may track lip movements associated with individuals 3501 or 3503 to determine that individuals 3501 or 3503 are speaking. A comparative analysis may be performed between the detected lip movements and the received audio signals. For example, processor 210 may determine that individual 3501 is speaking based on a determination that the mouth of individual 3501 is moving at the same time as sounds associated with audio signal 3511 are detected. In some embodiments, when the lips of individual 3501 stop moving, this may correspond with a period of silence or reduced volume in the sound associated with audio signal 3511.

In some embodiments, data associated with apparatus 110 may further be used in conjunction with the detected lip movement to determine and/or verify whether individuals are speaking, such as a look direction of user 100 or individuals 3501 or 3503, a detected identity of individuals 3501 or 3503, a recognized voiceprint of individuals 3501 or 3503, etc.

In some embodiments, a look direction of user 100 or individuals 3501 or 3503 may be determined and the individual to whom the look direction is directed may be given higher priority among the active speakers. For example, if individual 3503 is looking at individual 3501, audio signal 3511 associated with individual 3501 may be selectively conditioned. In some embodiments, priority may be assigned based on the relative behavior of other individuals in the environment of user 100. For example, if both individual 3501 and individual 3503 are speaking and more additional individuals are looking at individual 3501 than individual 3503, audio signal 3511 associated with individual 3501 may be selectively conditioned over those associated with individual 3503. In embodiments where the identity of the individuals is determined, priority may be assigned based on the relative status of the speakers, as discussed previously.

In some embodiments, processor 210 may identify at least one action based on analysis of at least one of a plurality of captured images. For example, processor 210 may determine, based on user 100 pointing at one or more sound sources (e.g., individuals), a hierarchy of sound sources. In some embodiments, user 100 may point to at least one sound source of each sound source in order from highest priority to lowest priority. Based on the actions of user 100, the audio signal priority interfaces of computing device 120 may display a hierarchy of sounds associated with each sound source. Processor 210 may selectively condition the audio signals associated with each sound source based on the hierarchy of sound sources. For example, higher priority audio signals may be isolated and/or selectively amplified relative to lower priority audio signals in the environment of user 100. In some embodiments, lower priority audio signals may be suppressed, attenuated, filtered, unchanged, or the like.

In step 3711, processor 210 may be configured to cause transmission of the selectively conditioned first audio signal to hearing interface device 1710 configured to provide sound to an ear of user 100. Thus, in the conditioned audio signal, sound from higher priority sources may be easier to hear to user 100, louder, and/or more easily distinguishable than sounds from lower priority sources, which may represent background noise within the environment.

Hearing Aid and Paired Camera System

According to embodiments of the present disclosure, a hearing aid system may selectively amplify sounds. The hearing aid system may include a wearable camera device and a hearing aid device. The wearable camera device may refer to a device with image, sound, audio, and/or video capturing capabilities, the wearable camera device may be attachable to a user, or clothing or accessories of a user. The hearing aid device may refer to a device that outputs audio or sound to ears of a user. The output of the hearing aid device may be generated based on inputs received from or by the wearable camera device. The hearing aid system may include several devices paired together to provide improved functionality. For example, the hearing aid system may include a hearing aid device for providing sounds to an ear of a user, wherein the sounds may be acoustically captured by the hearing aid or received electronically from another source, such as the wearable camera device. The hearing aid device may pair with the wearable camera device (and vice versa) and the wearable camera device may capture images and/or audio. The wearable camera device may capture the images and/or audio in accordance with instructions received from the hearing aid device. In response, the hearing aid device may receive audio and other information from the wearable camera device. The system may also include a mobile device paired with the wearable camera device and the hearing aid device. For example, a GUI displayed on a display of the mobile device may enable a user to provide input to control how sound is processed and received at the hearing aid device. The hearing aid system may also include the pairing of other devices, such as a rangefinder.

As discussed above, in some embodiments, the hearing aid system may include a mobile device. The mobile device may be a mobile phone, or other examples of devices such as PDA, tablet, wearable electronics, and other types of portable electronic devices. The mobile device may be paired with at least one of the hearing aid device or the wearable camera device, or both. Pairing may refer to enabling communications between two or more devices, and the mobile device may be paired with the hearing aid device or the wearable camera device wirelessly. Examples of wireless pairing includes Wi-Fi, Bluetooth, NFC, and other similar wireless communication technology.

In some embodiments, the hearing aid system may include a rangefinder. A rangefinder may refer to a device that is capable of determining a range (or distance) between an object and itself. In some embodiments, a rangefinder may be paired wirelessly to the wearable camera device, the hearing aid device, and/or the mobile device, with one or more of those paired devices receiving a range measurement generated by the rangefinder. In some embodiments, the range finder may be incorporated into the wearable camera device.

In some embodiments, the wearable camera device may include at least one camera configured to capture a plurality of images from an environment of a user. The camera may include one or more image sensors (such as image sensor 220, discussed above) for capturing one or more images (and/or video) from an environment of a user of the wearable camera device. In some embodiments, the wearable camera device includes at least one microphone configured to capture sounds from the environment of the user. The at least one microphone may refer to a component or device capable of receiving soundwaves and generating audio signals based on the received sound waves. In some embodiments, the hearing aid device may include at least one speaker configured to provide sound to an ear of the user. The at least one speaker may refer to components or device capable of generating sound, often based on an audio signal.

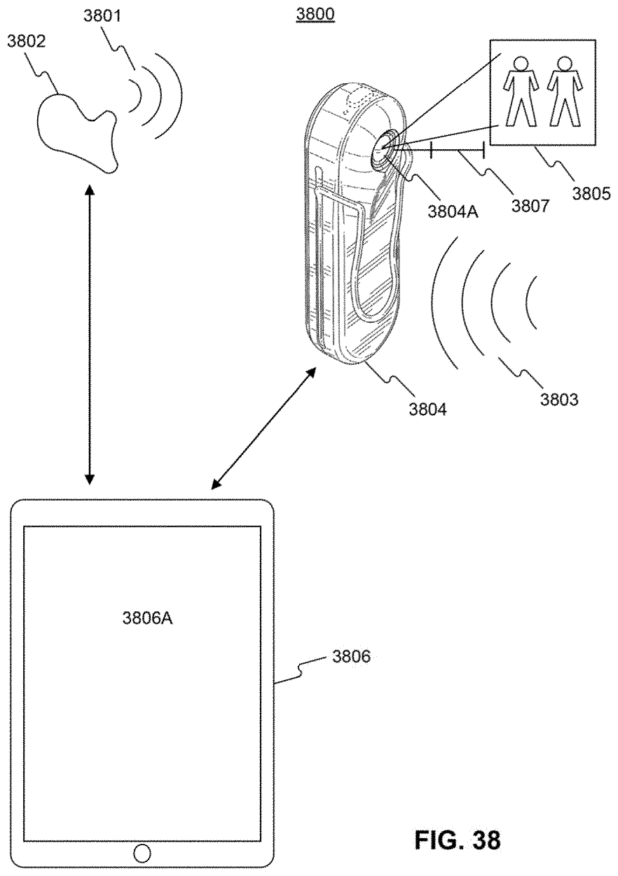

By way of example, FIG. 38 depicts a hearing aid system 3800 including a wearable camera device and a hearing aid device. Hearing aid system 3800 includes a hearing aid device 3802 and a wearable camera device 3804. In some embodiments, hearing aid device 3802 and wearable camera device 3804 are paired to communicate with a mobile device 3806. In some embodiments, hearing aid device 3802 may be paired with wearable camera device 3804, and data may be communicated between the paired devices. In some embodiments, wearable camera device 3804 may correspond to apparatus 110 depicted in FIG. 4A-K. In some alternative embodiments, wearable camera device 3804 may correspond to apparatus 110 depicted in FIG. 3A-B. In some embodiments, hearing aid device 3802 may correspond to hearing interface device 1710.

As depicted in FIG. 38, wearable camera device 3804 includes a camera 3804A. Camera 3804A may be disposed on wearable camera device 3804 so as to face in a direction toward objects or persons to be imaged. Camera 3804A may include an image sensor (e.g., image sensor 220) for capturing real-time image data from the field-of-view of a user. Camera 3804A may be a device capable of detecting and converting optical signals in the near-infrared, infrared, visible, ultraviolet spectrums, or any combination thereof, into electrical signals. The electrical signals may be used to form an image or a video stream (i.e., image data) based on the detected signal. The term “image data” includes any form of data retrieved from optical signals in the near-infrared, infrared, visible, ultraviolet spectrums, or any combination thereof. Examples of image sensors may include semiconductor charge-coupled devices (CCD), active pixel sensors in complementary metal-oxide-semiconductor (CMOS), or N-type metal-oxide-semiconductor (NMOS, Live MOS). In some embodiments, camera 3804A may have range finding feature. For example, camera 3804A may determine a range measurement 3807 of one or more objects in image 3805.

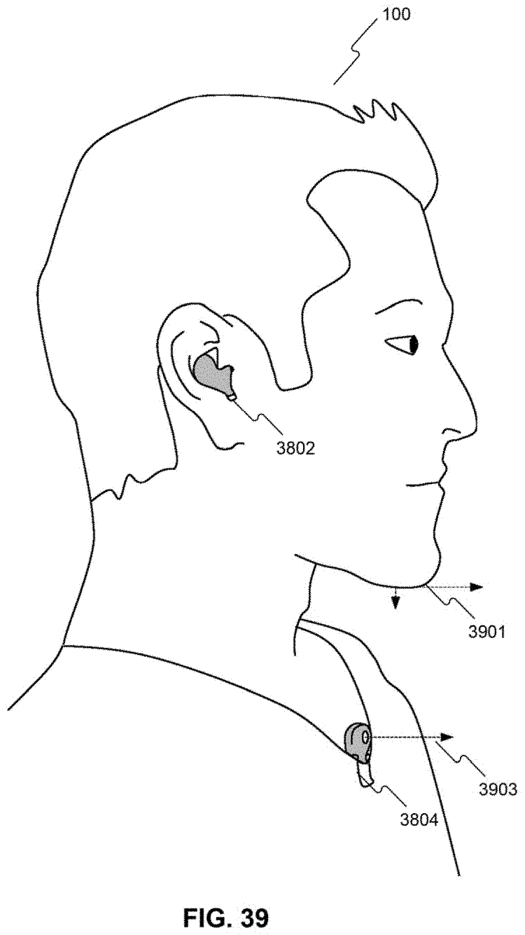

By way of example, FIG. 39 depicts an example of a user using hearing aid system 3800. User 100 may wear wearable camera device 3804 and hearing aid device 3082 according to the disclosed embodiments. User 100 may wear wearable camera device 3804 that is physically connected to a shirt or other piece of clothing of user 100, as shown. Consistent with the disclosed embodiments, wearable camera device 3804 may be positioned in other locations, such as being connected to a necklace, a belt, glasses, a wrist strap, a button, a cap, etc. Wearable camera device 3804 may be paired with hearing aid device 3802, and/or with mobile device 3806 wirelessly.

As depicted in FIG. 39, hearing aid device 3802 may be placed in one or both ears of user 100, similar to traditional hearing interface devices. Hearing aid device 3802 may be of various styles, including in-the-canal, completely-in-canal, in-the-ear, behind-the-ear, on-the-ear, receiver-in-canal, open fit, or various other styles. Hearing aid device 3802 may include one or more speakers for providing audible feedback to user 100. In some embodiments, hearing aid device 3802 may be hearing interface device 1710, as shown in FIG. 17A.

In some embodiments, hearing aid device 3802 may comprise a bone conduction headphone 1711, as shown in FIG. 17A. Bone conduction headphone 1711 may be surgically implanted and may provide audible feedback to user 100 through bone conduction of sound vibrations to the inner ear.

The environment of the user may generally refer to surroundings of the user who is using wearable camera device 3804. The environment of the user may include objects and persons. some of which may be producing sound waves 3803 received by one or more microphones (not depicted) located in wearable camera device 3804. Depending on the direction and field of view of camera 3804A, camera 3804A may capture image 3805, representing objects and persons in the environment of the user as seen by camera 3804A along optical axis 3903. In some embodiments, soundwave 3803 may be generated by objects or persons captured in image 3805. In some embodiments, image 3805 may include a representation of a chin of user 100, which may be used to determine user look direction 3901, which may coincide with a field of view of user 100.

Camera device 3804 may include at least one processor (which may be referred to as at least one first processor in this disclosure). The term “processor” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. In some embodiments, processor 210 depicted in FIG. 5A-C may be examples of the at least one first processor.

In some embodiments, the at least one first processor is programmed to selectively condition audio signals received from the at least one microphone representative of the sounds captured by the at least one microphone. Conditioning may refer to operation of editing, altering or otherwise processing of audio signals. In some embodiments, processor 210 may condition soundwave 3083 based in instruction received from hearing aid device 3802.

In some embodiments, the hearing aid device may include at least one second processor. In some embodiments, the at least one second processor is programmed to cause transmission of one or more instructions to the wearable camera device 3804. The one or more instructions may be transmitted wirelessly through channels created by the pairing between hearing aid device 3802 and wearable camera device 3804.

In some embodiments, the mobile device may include a user interface for providing an output to the user. A user interface refers to a system or a device capable of interacting with a user, such as providing output information for a display or receiving input from the user. In some embodiments, the user interface may be provided by mobile device 3806. For example, mobile device 3806 may include a display for displaying user interface 3806A to allow user 100 to interact with hearing aid system 3800. In some embodiments, user interface 3806A may include an interface for receiving a visual, audio, tactile, or any other suitable signal or input from user 100. For example, user interface 3806A may include a display that may be part of mobile device 3800, such as a touch screen having GUI elements that may be manipulated by user gestures (e.g., touch gestures on a touch screen), or by appropriate physical or virtual (i.e., on screen) devices (e.g., keyboard, mouse, etc.). In some embodiments, user interface 3806A may be an audio interface capable of receiving user 100 audio inputs (e.g., user 100 voice inputs) for adjusting one or more parameters of system 3800. For example, user 100 may provide inputs via user interface 3806A via audio commands. The audio interface may be provided by mobile device 3806, such as a microphone associated with mobile device 3806.

In some embodiments, user interface 3806A may also present information relating to hearing aid system 3800, such as information relating to the operations of hearing aid device 3802 and/or wearable camera device 3804. Such information may serve to inform user 100 of the status of hearing aid system 3800, such that user 100 may control parameters of hearing aid device 3802 and/or wearable camera device 3804.

In some embodiments, information relating to the operation of hearing aid device 3802 may include status information relating to a pairing between mobile device 3806, wearable camera 3804, and/or hearing aid device 3802. In some embodiments, user 100 may initiate or terminate the pairing between mobile device 3806, wearable camera 3804, and/or hearing aid device 3802 through user interface 3806A. In some embodiments, information relating to the operation of hearing aid system 3800 may include operating status information for hearing aid device 3802, such as a battery level and/or a volume level, and user 100 may control parameters of hearing aid device 3802, such as adjusting the volume level of one or more speakers of hearing aid device 3802. In some embodiments, information relating to the operation of wearable camera device 3804 may include an operating status of wearable camera device 3804, such as a battery level, information relating to images that have been captured by wearable camera device 3804, and/or audio conditioning operations.

In some embodiments, images captured by wearable camera device 3804, such as image 3805, may be displayed in real time to user 100 via user interface 3806A. Image 3805 may be presented in a manner such that user 100 may manipulate image 3805 in a variety of manners. For example, user 100 may zoom in or out to maximize or minimize image 3805, crop image 3805, edit image 3805, and/or save image 3805 in memory storage, and other image manipulation techniques known in the art. In some embodiments, a range measurement 3807 determined by camera 3804A may be presented to user 100 via user interface 3806A. The range measurement may be associated with an object or person represented in image 3805.

In some embodiments, a status of one or more audio conditioning operations may be presented to user 100 via user interface 3806A. For example, any on-going audio conditioning setting or settings may be presented to user 100. In some embodiments, user interface 3806A may display to user 100 options to cancel on-going audio conditioning operations, and/or select different audio conditioning operations by modifying one or more audio conditioning settings.

User interface 3806A may also be capable of receiving input from user 100. For example, based on the output displayed on a display, user 100 may desire to alter one or more operations of hearing aid system 3800. The input from user 100 may be processed into instructions for hearing aid system 3800. In some embodiments, the at least one second processor may be configured to determine the one or more instructions based on the input from the user. In some embodiments, mobile device 3806 may comprise a user interface for receiving an input from the user. User input received via user interface 3806A may be transmitted wirelessly from mobile device 3806 to hearing aid device 3802, where a second processor (e.g., processor 210) may convert the user input into instructions for controlling one or more operations of hearing aid system 3800.

In some embodiments, wearable camera device 3804 may be configured to capture a plurality of images and sounds based on the one or more instructions. User 100, through user interface 3806A may manually alter how wearable camera device 3804 captures images. For example, user 100 may desire to focus in on a person or an object, thus user input may result in instructions to narrow a field of view of camera 3804A and/or magnify one or more captured images. In another example, images 3805 being displayed by user interface 3806A may be out of focus or blurred, and user 100 may desire to alter the focus of camera 3804A to improve image quality, causing instructions to refocus camera 3804A. In yet another example, user 100 may desire to change a lighting condition of image 3805 to compensate for low/high light conditions, and thus user input may result in instructions to camera 3804A to change the lighting conditions accordingly.

In some embodiments, the at least one first processor may be programmed to selectively condition audio signals based on the one or more instructions. For example, the at least one first processor (e.g., processor 210) of wearable camera device 3804 may edit, alter, or otherwise process soundwaves 3803 captured from the environment of the user. The conditioned audio signal may be provided to hearing aid device 3802 so that sound 3801 may be generated for hearing by user 100. Sound 3801 may be generated based on a conditioned audio signal outputted by wearable camera device 3804.

In some embodiments, selectively conditioning an audio signal may include modifying an amplitude, tone, pitch, bass, and/or other audio effects of soundwave 3803. For example, user 100 may be presented with a menu-like interface (such as audio mixing sliders) on user interface 3806A, and user 100 may select one or more audio effects as desired. In some embodiments, user 100 may change a tone of one or more audio signals corresponding to soundwave 3803 to make the sound more perceptible to user 100. For example, user 100 may have lesser sensitivity to tones in a certain range and conditioning of the audio signals may include adjusting the pitch of sound 3803. For example, user 100 may experience hearing loss in frequencies above 10 kHz and the first processor (e.g., processor 210) may remap higher frequencies (e.g., at 15 kHz) to frequencies below 10 kHz. In some embodiments, the first processor (e.g., processor 210) may be configured to change a rate of speech associated with one or more audio signals. For example, the first processor (e.g., processor 210) may be configured to vary the rate of speech of an individual in the conditioned audio signal to make the detected speech more perceptible to user 100, for example by making each word last longer and reducing the silence periods between consecutive words, accordingly.

In some embodiments, selectively conditioning an audio signal may include classifying sounds into different category of sounds. For example, the first processor (e.g., processor 210) may classify soundwaves 3803 into segments containing music, tones, laughter, speech, screams, background noise, or the like. Indications of the respective segments may be logged in a database and may prove highly useful for life logging applications. As one example, the logged information may enable hearing aid system 3800 to retrieve and/or determine a mood when the user meets another person. Additionally, such processing may occur relatively fast and efficiently, and may not use significant computing resources. Thus, transmitting the information to a destination (e.g., another device, an external server, etc.) may not require significant bandwidth. Moreover, once certain parts of the audio are classified as non-speech, more computing resources may be available for processing the other segments. In some embodiments, user 100 may provide input via user interface 3806A to apply different audio effects discussed above to different segments of soundwaves 3803.

In some embodiments, selectively conditioning an audio signal may include attenuation of the audio signal. For example, the first processor (e.g., processor 210) may apply one or more filters (such as digital filters) to soundwaves 3803 based on inputs from user 100. In some cases, the filters may selectively attenuate the audio signal, such as soundwave 3803. In some cases, soundwave 3803 may include environmental noises (e.g., various background sounds such as music, sounds/noises from people not participating in conversation with user 100, and the like). User 100 may select various filtering option so that environmental noises may be eliminated or attenuated from the conditioned audio signal. For example, user 100 may desire to attenuate soundwaves 3803 in environment with high level of background noise.

In some embodiments, selective conditioning may include amplification of an audio signal. For example, the first processor (e.g., processor 210) may select one or more portions of soundwave 3803 for amplification. In some embodiments, a selected portion of soundwave 3803 may correspond to audio related to a conversation of user 100 with another person, or from an audio source (such as a TV, a radio, a speaker, etc.) of interest to user 100. For example, user 100 may provide input to user interface 3806A to amplify a selected portion soundwave 3803.

In some embodiments, selective conditioning may include separating the voice of the speaker from background sounds. Separating may be performed using any suitable approach, for example, using a multiplicity of microphones, such as ones included on wearable camera device 3804. In some cases, at least one microphone may be a directional microphone or a microphone array. For example, one microphone may capture background noise, while another microphone may capture an audio signal comprising the background noise as well as the voice of a particular person. The voice may then be obtained by subtracting the background noise from the combined audio. In some embodiments, the first processor (e.g., processor 210) may analyze image 3805 to determine sources of soundwave 3803. For example, image 3805 may help to identify objects or persons generating soundwave 3803. In some embodiments, user 100 may select from er interface 3806A an object or person from which to filter audio.

In some embodiments, user 100 may provide input to selectively engage or turn off various audio processing features. For example, user 100 may provide input to selectively condition soundwave 3803 based on lip reading functionality discussed above. For example, lip movements of persons may be captured in image 3805, and the first processor (e.g., processor 210) may selectively amplify or attenuate soundwave 3803 based on image 3805. In other examples, user 100 may provide input to selectively condition soundwave 3803 based on speech recognition discussed above. The first processor (e.g., processor 210) may perform speech recognition of speed content soundwave 3803 and may selectively amplify or attenuate sound wave 3803 based on whether words are recognized from soundwave 3803.

In some embodiments, user 100 may select a particular source of audio signal for selective amplification or attenuation. For example, the first processor (e.g., processor 210) may identify different components of soundwave 3803 and their respectively sources based on analysis of image 3805. In some examples, user 100 may interact with image 3805 displayed on user interface 3806A and select different portions of image 3805. Based on this user selection, the first processor (e.g., processor 210) may selectively amplify portions of soundwave 3803 emanating from the selected portion of image 3805, and selective attenuate other portions of soundwave 3803 emanation from a non-selected portion or portions of image 3805. In some embodiments, the first processor may amplify sounds obtained from areas within the field of view of user 100, or parts of the field of view of user 100.

In some embodiments, the at least one second processor may receive, from the wearable camera device, the conditioned audio signal. The conditioned audio signal may be wirelessly transmitted from wearable camera device 3804 connected via the pairing, to hearing aid device 3802.

In some embodiments, the at least one second processor may provide, based on the conditioned audio signals, sound to the ear of the user using the at least one speaker. The at least one speaker of hearing aid device 3802 may generate sound 3801 to the ears of user 100.

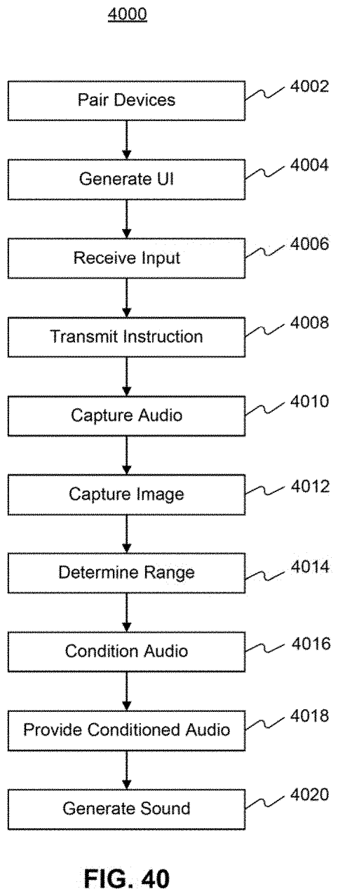

FIG. 40 depicts a flowchart of an exemplary process 4000 of the hearing aid and paired camera system, consistent with the disclosed embodiments. In some embodiments, the hearing aid and paired camera system may be system 3800 depicted in FIG. 38 and FIG. 39, which includes hearing aid device 3802, wearable camera device 3804, and/or mobile device 3806.

In step 4002, hearing aid device 3802 and wearable camera device 3804 may be paired to communicate with each other, and/or with mobile device 3806. Examples of wireless pairing includes Wi-Fi, Bluetooth, NFC, and other similar wireless communication technology. In some embodiments, pairing may be initiated by user 100 using mobile device 3806. For example, when hearing aid device 3802 and/or wearable camera device 3804 are within a communication range with mobile device and/or each other, a notification may be presented to user 100 on mobile device 3806, allowing user 100 to select pairing of devices. In some embodiments, pairing between hearing aid device 3802, wearable camera device 3804 and/or mobile device 3806 may be terminated by user 100 on mobile device 3806. In other embodiments, pairing may be automatically initiated (e.g., when hearing aid device 3802 and/or wearable camera device 3804 are within a communication range with mobile device 3806 and/or each other).

In step 4004, mobile device 3806 may generate or display user interface 3806A. User interface 3806A may be configured to receive a visual, audio, tactile, or any other suitable signal from user 100. For example, user interface 3806A may be shown on a display that may be part of mobile device 3806, such as a touch screen including GUI elements that may be manipulated by user gestures, or by appropriate physical or virtual (i.e., on screen) devices (e.g., keyboard, mouse, etc.). In some embodiments, user interface 3806A may be an audio interface capable of receiving user 100 audio inputs (e.g., user 100 voice inputs) for adjusting one or more parameters of system 3800. The audio interface may be provided by mobile device 3806 which may include a microphone.

In some embodiments, user interface 3806A may also present information relating to hearing aid system 3800, such information relating to the operation of hearing aid device 3802 and/or wearable camera device 3804. Such information may serve to inform user 100 of the status of hearing aid system 3800, such that user 100 may control parameters of hearing aid device 3802 and/or wearable camera device 3804. For example, user 100 may initiate or terminate the pairing between mobile device 3806, wearable camera 3804, and/or hearing aid device 3802 through user interface 3806A.

In some embodiments, images captured by wearable camera device 3804, such as image 3805, may be displayed in real time to user 100 via user interface 3806A. Image 3805 may be presented in a manner that is capable of being manipulated by user 100. For example, user 100 may zoom in/out to maximize or minimize image 3805, crop image 3805, edit image 3805, and/or save image 3805 in memory storage, and other image manipulation known in the art. In some embodiment, a range measurement determined by camera 3804A may be presented to user 100 via user interface 3806A. The range measurement may be associated with image 3805.

In step 4006, mobile device 3806 may receive input from user 100 via user interface 3806A. In some embodiments, a status of an audio conditioning operation may be presented to user 100 via user interface 3806A. For example, any on-going audio conditioning setting may be presented to user 100. In some embodiments, user interface 3806A may display to a user options to cancel on-going audio conditioning operation, and/or select a different audio conditioning operating by modifying on or more audio conditioning setting.

In step 4008, mobile device 3806 may transmit the user inputs received via user interface 3806A to hearing aid device 3802 or to wearable camera device 3804. At least one second processor (e.g., processor 210) of hearing aid device 3802 or of wearable camera device 3804 may be programmed to determine instructions for system 3800 based on user inputs. The instructions may be then carried out by components of hearing aid device 3802 and/or by wearable camera device 3804.

In step 4010, wearable camera device 3804 may capture audio, such as soundwave 3803 from the environment of the user. Wearable camera device 3804 may use at least one microphone to generate audio signals based on the received soundwaves 3803.

In step 4012, wearable camera device 3804 may capture a plurality of images, such as image 3805. Wearable camera device 3804 may use camera 3804A to capture real-time image data of the field-of-view of user 100, as depicted in FIG. 38 and FIG. 39. Camera 3804A may capture images objects and persons, some of which may be producing sound waves 3803 received by the one or more microphones located in wearable camera device 3804.

In step 4014, wearable camera device 3804 may determine range measurement 3807. For example, wearable camera device 3804 may use a rangefinder to determine a range (or distance) between an object or person and wearable camera device 3804. In some embodiments, an angle relative to a look direction of the user may be determined.

In step 4016, wearable camera device 3804 may condition soundwave 3803. Conditioning may include operations by at least one first processor (e.g., process 210) of modifying tone, pitch, bass, and/or other audio effects of soundwave 3803; classifying sounds into different categories of sounds; performing attenuation of soundwave 3803; and/or causing amplification of soundwave 3803. The conditioning may be based on instructions transmitted from hearing aid device 3802 and/or mobile device 3806, which are in turn generated based on inputs from user 100.

For example, user 100 may be presented with a menu-like interface (such as audio mixing sliders) on user interface 3806A, and user 100 may select one or more audio effects as desired. In some embodiments, changing a tone of one or more audio signals corresponding to soundwave 3803 may make the sound more perceptible to user 100. For example, user 100 may have lesser sensitivity to tones in a certain range and conditioning of the audio signals may adjust the pitch of sound 3803. For example, user 100 may experience hearing loss in frequencies above 10 kHz and the first processor (e.g., processor 210) may remap higher frequencies (e.g., at 15 kHz) to frequencies below 10 kHz. In some embodiments the first processor (e.g., processor 210) may be configured to change a rate of speech associated with one or more audio signals. The first processor (e.g., processor 210) may be configured to vary the rate of speech of an individual in the conditioned audio signal to make the detected speech more perceptible to user 100.

For example, the first processor (e.g., processor 210) may classify soundwaves 3803 into segments containing music, tones, laughter, speech, screams, background noise, or the like. Once certain parts of the audio are classified as non-speech, more computing resources may be available for processing the other segments. In some embodiments, user 100 may provide input via user interface 3806A to apply different audio effects discussed above to different segments of soundwaves 3803.

For example, the first processor (e.g., processor 210) may apply one or more filters (such as digital filters) to soundwaves 3803 based on inputs from user 100. In some cases, the filters may selectively attenuate the audio signal, such as soundwave 3803. In some cases, soundwave 3803 may include environmental noises (e.g., various background sounds such as music, sounds noises from people not participating in conversation with user 100, and the like). User 100 may select various filtering options so that environmental noises may be eliminated or attenuated from the conditioned audio. For example, user 100 may desire to attenuate soundwaves 3803 in the environment associated with background noise.

For example, the first processor (e.g., processor 210) may select one or more portions of soundwave 3803 for amplification. In some embodiments, a selected portion of soundwave 3803 may correspond to audio related to the conversation of user 100 with another person, or from an audio source (such as a TV, a radio, a speaker, etc.) of interest to user 100. For example, user 100 may provide input to user interface 3806A to amplify a selected portion of soundwave 3803. Separating the voice of the speaker from the background sounds may be performed using any suitable approach, for example, using a multiplicity of microphones, such as ones included on wearable camera device 3804. In some cases, at least one microphone may be a directional microphone or a microphone array. For example, one microphone may capture background noise, while another microphone may capture an audio signal comprising the background noise as well as the voice of a particular person. The voice may then be obtained by subtracting the background noise from the combined audio. In some embodiments, the first processor (e.g., processor 210) may utilize image 3805 to aid user 100 to determine sources of soundwave 3803. For example, image 3805 may be analyzed to identify objects or persons generating soundwave 3803, and which may in turn be displayed to user 100 via user interface 3806A.

For example, user 100 may provide inputs to selective conditioning of soundwave 3803 based on lip reading functionality discussed above. Lip movements of persons may be captured in image 3805, and the first processor (e.g., processor 210) may selectively amplify or attenuate soundwave 3803 based on image 3805. In some other example, user 100 may provide input to selectively condition soundwave 3803 based on speech recognition discussed above. The first processor (e.g., processor 210) may perform speech recognition of content soundwave 3803 and may selectively amplify or attenuate sound wave 3803 based on whether words are recognized from soundwave 3803.

For example, the first processor (e.g., processor 210) may identify different components of soundwave 3803 and their respective sources when captured in image 3805. User 100 may interact with image 3805 displayed on user interface 3806A and select different portions of image 3805. Based on the user selection, the first processor (e.g., processor 210) may selectively amplify portions of soundwave 3803 emanating from the selected portion of image 3805, and selectively attenuate other portions of soundwave 3803 emanating from non-selected portion of image 3805.

In step 4018, wearable camera device 3804 may provide the conditioned audio signal to hearing aid device 3802. For example, the conditioned audio signal may be wirelessly transmitted from wearable camera device 3804 connected via pairing, to hearing aid device 3802. Transmission of the conditioned audio signal may include transmission over one or more networks and using one or more transmission protocols.

In step 4020, one or more speakers of hearing aid device 3802 may generate sounds 3801 to an ear or ears of user 100.

For example, in some embodiments, the least one second processor may receive, from the wearable camera device, the conditioned audio signal, and may provide sound, based on the conditioned audio signals, to the ear of the user using the at least one speaker. The at least one speaker of hearing aid device 3802 may generate sound 3801 to an ear or ears of user 100.

Adaptive Capture Rate

In some embodiments, the hearing aid system may have an adaptive capture rate. For example, parameters associated with a microphone and/or a camera associated with the hearing aid system may be adjusted based on a particular situation or context. For example, the hearing aid system may analyze images captured by the camera and/or sounds captured by the microphone to determine that a particular parameter should be changed. Depending on the situation or context of a user of the hearing aid system, different parameters may be optimized. For example, when the user is interacting with a fast-speaking individual, the hearing aid system may increase the capture rate of the camera (e.g., frames per second). This may allow the hearing aid system to more effectively analyze captured images of the speaker (e.g., for detecting lip movements, etc.). In situations where an individual is speaking more slowly, or where there are no active speakers, the system may reduce the capture rate of the camera. This may be beneficial, for example, to reduce the power consumption of the camera device, to reduce the amount of memory used, or the like. Other sensors or information may also be used to control parameters of the camera or microphone, such as location information, a detected light level, a time of day, etc.

The disclosed hearing aid system may selectively amplify sounds. In an embodiment, the hearing aid system may include a wearable camera, a hearing aid, and at least one microphone. The wearable camera may refer to a device with image, sound, audio, and/or video capturing capability, which are attachable to a user, or clothing or accessories of a user. The hearing aid may refer to a device that outputs audio or sound to ears of a user. The output of the hearing aid may be generated based on inputs received from or by the wearable camera and/or the at least one microphone. The hearing aid system may include several devices paired together to provide improved functionality. For example, the hearing aid system may include a hearing aid for providing sounds to an ear of a user, wherein the sounds may be acoustically captured by the hearing aid or received electronically from another source, such as the wearable camera or the at least one microphone.

In some embodiments, the wearable camera may be configured to capture a plurality of images from an environment of a user, and the wearable camera may have an image capture parameter. A camera may refer to a component or device capable of receiving light from persons, objects and/or environments, and forming images or videos based on the received light. The plurality of images may be a video clip containing numerous still images, referred to as frames. In some embodiments, the hearing aid system may include at least one microphone configured to capture sounds from the environment of the user. The microphone may be a component or device capable of receiving soundwaves and generating audio signals based on the received sound waves.

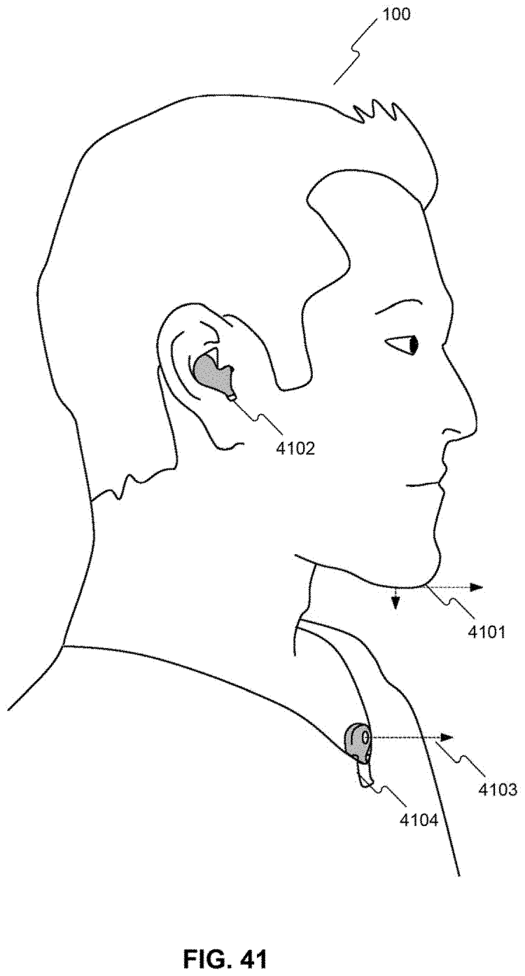

By way of example, FIG. 41 depicts the hearing aid system including a wearable camera 4104 and a hearing aid 4102. In some embodiments, hearing aid device 4102 and wearable camera device 4104 are paired to communicate with a mobile device (not depicted) having a graphic user interface (GUI). In some embodiments, hearing aid 4102 may be paired with wearable camera 4104, and data may be communicated between the paired devices. In some embodiments, wearable camera 4104 may correspond to apparatus 110 depicted in FIG. 4A-K. In some alternative embodiments, wearable camera device 4104 may correspond to apparatus 110 depicted in FIGS. 3A and 3B. Hearing aid 4102 may correspond to hearing interface device 1710.

Wearable camera 4104 may include an image sensor (e.g., image sensor 220) for capturing real-time image data substantially corresponding to the field-of-view of a user. For example, wearable camera 4104 may be a device capable of detecting and converting optical signals in the near-infrared, infrared, visible, and ultraviolet spectrums into electrical signals. The electrical signals may be used to form an image or a video stream (i.e., image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS).

User 100 may wear wearable camera 4104 and hearing aid 4102 according to the example depicted in FIG. 41. User 100 may wear wearable camera 4104 that is physically connected to a shirt or other piece of clothing of user 100, as shown. Consistent with the disclosed embodiments, wearable camera 4104 may be positioned in other locations, such as being connected to a necklace, a belt, glasses, a wrist strap, a button, etc. As depicted in FIG. 41, hearing aid 4102 may be placed in one or both ears of user 100, similar to traditional hearing interface devices. Hearing aid 4102 may be of various styles, including in-the-canal, completely-in-canal, in-the-ear, behind-the-ear, on-the-ear, receiver-in-canal, open fit, or various other styles. Hearing aid 4102 may include one or more speakers for providing audible feedback to user 100.

The environment of the user may generally refer to surrounding of the user that is using wearable camera device 4104. The environment of the user may include objects and persons, some of which may be producing sound waves received by one or more microphones (not depicted) located in wearable camera device 4104. Depending on the direction and field of view of wearable camera 4104, wearable camera 4104 may capture images which include representations of objects and persons in the environment of the user as seen by wearable camera 4104 along optical axis 4103.

The wearable camera may include at least one processor. The term “processor” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. In some embodiments, processor 210 depicted in FIG. 5A-C may be examples of the at least one processor.

In some embodiments, the at least one processor may receive the plurality of images captured by the wearable camera. In some embodiments, the at least one processor may receive audio signals representative of sounds captured by the at least one microphone. The audio signals may be representative of sounds emanating from the environment of the user.

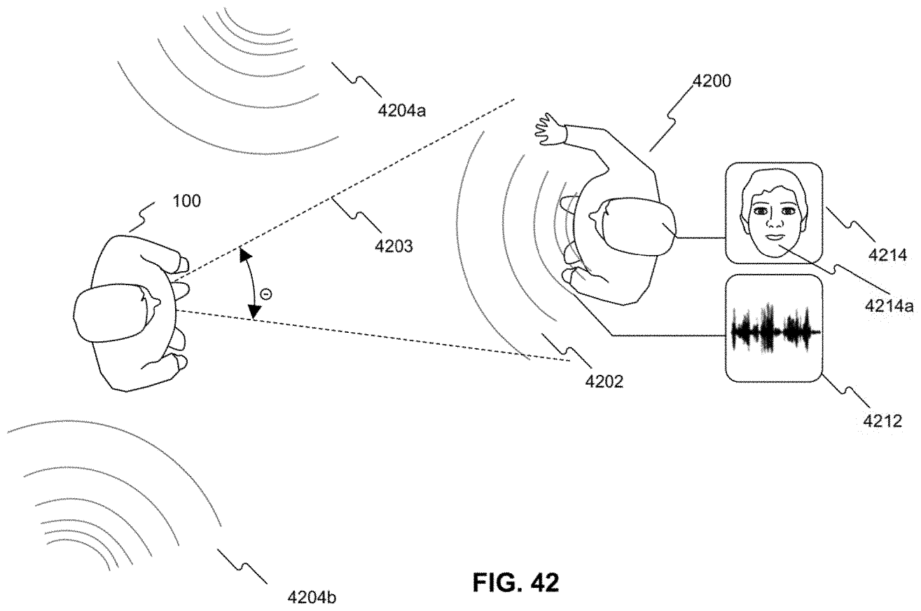

By way of example, FIG. 42 depicts the hearing aid system capturing images and audio from an environment of a user. The area, region, and/or space around user 100 may constitute the environment of user 100. In some embodiments, wearable camera 4104 may have a field of view as defined by cone 4203 depicted in FIG. 42, along optical axis 4103. The width of cone 4203 may be a property of wearable camera 4104 as defined by its components or settings, such as lens or aperture, zoom, or the like. Within cone 4203, there may exist persons or objects within views of wearable camera 4104, such as person 4200. In some embodiments, wearable camera 4104 may capture image 4214. Image 4214 may include representations of persons or objects within view of cone 4203. In some embodiments, image 4214 are images of a person, such as person 4200, and a face of person 4200 may be imaged such that the lip 4214a and lip movements of person 4200 can be seen in image 4214.

In some embodiments, soundwaves may emanate from within cone 4203, such as soundwave 4202 generated by person 4200. In some embodiments, other soundwaves may emanate from outside of cone 4203, such as soundwave 4204a and/or sound wave 4204b. Thus, audio signals captured by the at least one microphone may be from persons or objects captured in image 4214. In some embodiments, soundwaves that are not generated by persons or objects from within cone 4203 may be considered background sounds. In some embodiments, soundwaves may be characterized by various physical properties, such as amplitude, frequency, tone, pitch, etc.

Processor 210 may separate the voice of person 4200 from the background sounds by performing any suitable approach, for example, by using a multiplicity of microphones, such as ones included on wearable camera 4104. In some cases, the at least one microphone may be a directional microphone or a microphone array. For example, one microphone may capture background noise (e.g., soundwave 4204a and/or soundwave 4204b), while another microphone may capture an audio signal comprising the background noise (e.g., soundwave 4204a and/or soundwave 4204b) as well as the voice of a particular person (soundwave 4202). The voice may then be obtained by subtracting the background noise from the combined audio. In some embodiments, the processor (e.g., processor 210) may analyze image 4214 to determine sources of soundwave 4202. For example, soundwave 4202 may contain voice 4212 spoken by person 4200. Voice 4212 may match up with movement of lip 4214a seen in image 4214.

In some embodiments, the hearing aid system may alter or adjust an image capturing parameter of wearable camera 4104. An image capturing parameter may refer to an operational setting, parameter, condition, and/or other factor characterizing one or more operations of wearable camera 4104. Adjusting an image capturing may, for example, increase a performance characteristic of wearable camera 4104, whereas decreasing a performance characteristic of wearable camera 4104 may reduce the power consumption of wearable camera 4104, or may reduce the amount of memory used, or the like.

In some embodiments, the image capture parameter may be a frame rate of the camera. A frame may refer to a single image among a plurality of images (such as video). A frame rate may thus refer to a number of images per a unit of time. In some embodiments, a frame rate of wearable camera 4104 may refer to a number of images capture per a unit of time when the wearable camera captures a video clip. For example, if wearable camera 4104 captures video at 100 frames per second (fps), 100 still images are being captured every second while wearable camera 4104 is capturing video. The frame rate of the camera may affect the quality of the video clip captured. For example, a camera using a higher frame rate may capture more images during a particular time frame than a camera using a slower frame rate, and the higher number of images may increase video quality, for example, providing greater detail of motion. For example, in a situation or context where an object of interest (such as person 4200) exhibits quick or rapid movements, it may be more desirable to have wearable camera 4104 operate with a higher frame rate. Alternatively, in certain situations or contexts, a higher frame rate may not be optimal. For example, when an object of interest (such as person 4200) does not exhibit quick or rapid movements, a video having a slower frame frate (or lower number of still images) may not compromise video quality significantly. Instead, having the camera operate using a slower frame frate may consume lower energy, and the captured images may require less memory for storage.

In additional or alternative embodiments, the image capture parameter may include a resolution of captured images, a compression rate of the captured images, and/or a parameter for optimizing compression quality of a captured audio signal.

In some embodiments, the image capture parameter may be adjusted based on a detected speech rate. For example, a speech rate may refer to a pace or speed for which words are spoken or sounds are made. In some instances, the speech rate may relate to lip movements of an individual such as person 4200. For example, a high speech rate may suggest rapid lip movements, while a low speech may suggest slower lip movements. In some embodiments, hearing aid system may include features such as lip-tracking algorithms, and the plurality of captured images may be utilized by the lip-tracking algorithms.

Additionally or alternatively, the image capture parameter may be adjusted based on a detected light level. For example, a higher frame frate setting may require more light than a lower frame rate setting. Processor 210 may determine, based on one or more light sensor reading (e.g., from wearable camera 4104), a frame rate that is optimal for wearable camera 4104 under certain environmental conditions (e.g., certain light conditions).

Additionally or alternatively, the image capture parameter may be adjusted based on a location information. For example, the environment of user 100 may be determined based on location information (e.g., GPS information, location information determined from analyzing captured images and/or audio, location information provided by user 100, etc.) of user 100. Processor 210 may determine, based on the location information, relevant factors to adjust a frame rate for wearable camera 4104, such as whether user 100 is located at a busy location, an amount of and type of objects for imaging at the location, an availability of electric outlet for recharging, or other such factors that may determine optimal performance and/or optimal battery life management for wearable camera 4104. In some embodiments, processor 210 may receive the location information based on a GPS coordinate of hearing aid system, or inputs from user 100. In some embodiments, the location information may be a user setting selectable by user 100. For example, wearable camera 4104 may be configured to operate with predetermined frame rates based on a user setting of locations, such as in an urban environment, a rural environment, a crowded location, a sparse location, low lighting environment, etc.

Additionally or alternatively, the image capture parameter may be adjusted based on a user setting. For example, user 100 may increase or decrease a frame rate of wearable camera 4104 as needed based on circumstances of a particular situation. In some embodiments, user 100 may select predefined settings of wearable camera 4104 (e.g., through verbal commands or via a user interface of a paired device) and cause an adjustment of the image capture parameter. For example, wearable camera 4104 may be configured to allow user 100 to select among several settings, each programmed with a frame rate for wearable camera 4104. User 100 may, for example, select an energy saving setting to conserve power, causing wearable camera 4104 to operate with a slower frame rate. User 100 may, for example, select a high-performance setting to maximize video quality, which may cause wearable camera 4104 to operate with a higher frame rate. In some embodiments, wearable camera 4104 may adjust a frame rate based on an identity of a speaker. For example, based on prior interactions, person 4200 may be known to have a particular speech rate, and wearable camera 4104 may automatically elect a frame rate for wearable camera 4104 whenever person 4200 comes into view of wearable camera 4104. Alternatively, user 100 may select certain frame rate settings based on persons previously detected by wearable camera 4104.

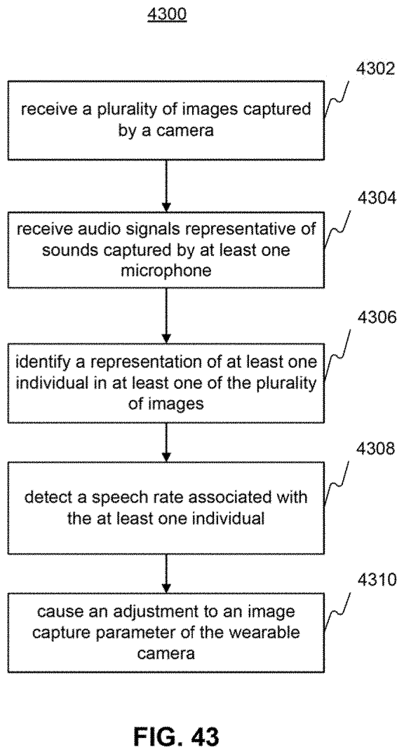

FIG. 43 depicts a flow chart of an exemplary process of the adjusting a capture parameter of a wearable camera, consistent with the disclosed embodiments.

In step 4302, the at least one processor (e.g., processor) 210 may receive a plurality of images captured by the camera. The plurality of images may be still images or a video clip containing numerous still images. The images may contain objects or persons within the field of view wearable camera 4104. For example, wearable camera 4104 may capture image 4214, which depicts face of person 4200 who is located within cone 4203. In some embodiments, image 4214 may contain images of lip 4214a of person 4200 or its movements.

In step 4304, the at least one processor (e.g., processor 210) may receive audio signals representative of sounds captured by at least one microphone. For example, wearable camera 4104 may capture soundwaves emanating from within cone 4203, such as soundwave 4202 generated by person 4200. Wearable camera 4104 may also capture other soundwaves emanating from outside of cone 4203, such as soundwave 4204a and/or sound wave 4204b.

In step 4306, the at least one processor (e.g., processor 210) may identify a representation of at least one individual in at least one of the plurality of images. In some embodiments, processor 210 may be configured to execute one or more image classifying algorithms to recognize whether a person is present in image 4214. In some embodiments, processor 210 may execute a facial recognition program or algorithm to identify one or more faces within image 4214. For example, processor 210 may identify facial features on the face of person 4200 captured in image 4214, such as the eyes, nose, cheekbones, jaw, lips, or other features. Processor 210 may use one or more algorithms to analyze the detected features, such as principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), or the like. Other facial recognition techniques such as 3-Dimensional recognition, skin texture analysis, and/or thermal imaging may also be used to identify individuals. Other features besides facial features may also be used for identification, such as the height, body shape, or other distinguishing features of person 4200.

In steps 4308, the at least one processor (e.g., processor 210) may detect a speech rate associated with the at least one individual. The at least one processor (e.g., processor 210) may detect a speech rate associated with the at least one individual based on the plurality of images or the audio signals captured, or both.

In some embodiments, the at least one processor (e.g., processor 210) may identify, based on analysis of the plurality of images, at least one lip movement associated with a mouth of the at least one individual. Processor 210 may identify at least one lip movement or lip position associated with a mouth of the individual, based on analysis of the plurality of images (e.g., image 4214). Processor 210 may be configured to identify one or more points associated with the mouth of the individual. In some embodiments, processor 210 may develop a contour associated with the mouth of the individual, which may define a boundary associated with the mouth or lips of the individual. The lips identified in the image may be tracked over multiple frames or images to identify the lip movement. Accordingly, processor 210 may use various video tracking algorithms, as described above. For example, processor 210 may identify lip 4214a of person 4200 within image 4214 and may analyze its movements. In some cases, processor 210 may identify correlations between particular facial expressions (such as lip movement) and particular sounds or sound fluctuations. For example, a facial expression related to a particular lip movement may be associated with a sound or word that may have been said during a conversation captured in the first audio signal. In some embodiments, the analysis of the plurality of images is performed by a computer-based model such as a trained neural network. For example, the trained neural network may be trained to receive an image and/or video data related to facial expressions of an individual and predict a sound associated with the received image and/or video data. As another example, the trained neural network may be trained to receive an image and/or video data related to facial expressions of an individual and a sound, and output whether the facial expressions correspond to the sound. In some embodiments, other factors, such as gestures of the individual, the position of the individual, the orientation of the individual's face, etc., may be identified in the one or more images captured by a wearable camera. By associating lip movement with predicted sounds or words, process 210 may determine a number of words or sounds associated with lip movements captured in image 4214 over a period of time. The at least one processor (e.g., processor 210) may determine the speech rate based on the lip movements.

In some embodiments, the at least one processor (e.g., processor 210) may analyze the received audio. For example, processor 210 may identify voice 4212 associated with soundwave 4202, containing a voice of person 4200. In some embodiments, processor 210 may analyze the sounds received from microphone of wearable camera 4104 to separate soundwave 4202 from soundwave 4204a and 4204b using any currently known or future developed techniques or algorithms. For example, processor 210 may receive audio signals representative of sounds emanating from objects in an environment of user 100 and analyze the received audio signals to obtain an isolated audio stream associated with one sound-emanating object.

Based on the audio analysis, the at least one processor (e.g., processor 210) may identify a plurality of words spoken by the individual. Processor 210 may be configured to recognize the words spoken by individual 4200. For example, processor 210 may analyze soundwave 4202 to identify specific phonemes, phoneme combinations, or words in soundwave 4202. In some embodiments, processor 210 may identify spoken words using various speech-to-text algorithms. In some embodiments, identifying the plurality of words may include using a voice recognition algorithm. Voice recognition may refer to an ability of a machine, a processor, or a program for receiving and interpreting, sound, voice, dictation or to like. For example, voice recognition algorithm may be executed by processor 210 to identify or interpret words or commands received in a sound. Examples of voice recognition algorithm may be implemented by AI, deep learning algorithms, neural embedding models or other known methods in the art. The at least one processor (e.g., processor 210) may determine the speech rate based on the plurality of words

In step 4310, the at least one processor (e.g., processor 210) may cause, based on the detected speech rate, an adjustment to one or more image capture parameters of the wearable camera. In one example, when processor 210 detects an amount of lip movements by person 4200 greater than a threshold, processor 210 may determine a high speech rate. Processor 210 may increase the frame rate of wearable camera 4104 when there is a high amount of lip movements by person 4200. This may allow the hearing aid system to maintain accuracy of a lip-tracking algorithm by ensuring an adequate number of images of lip movements are captured. In another example, when processor 210 detects a speech rate less than a threshold, processor 210 may determine that a low amount of lip movements by person 4200 have been detected. Processor 210 may decrease the frame rate of wearable camera 4104 when there is a low amount of lip movements by person 4200. This may reduce power usage and/or memory storage usage without compromising the accuracy of the lip-tracking algorithm.

The at least one microphone may have one or more parameters for capturing the audio signals, and in particular, speech, may also be adapted in accordance with the speech rate or other parameters or settings. In some embodiments, the at least one processor may be further programmed to cause, based on the detected speech rate, an adjustment to one or more audio capture parameters of the at least one microphone. Examples of audio capture parameters may include tone, pitch, amplitude, sensitivity level, frequencies, and/or sampling rate. For example, the at least one processor may apply filters to audio signals arriving at the at least one microphone to selectively capture audio signals having particular tone, pitch, or frequency. As another example, the least processor may amplify or attenuate audio signals arriving audio signals arriving at the at least one microphone to alter the amplitude of the captured audio signals, and/or alter the sensitivity of the at least one microphone.

In some embodiments, the at least one processor (e.g., processor 210) may adjust a sampling rate of the at least one microphone based on a detected speech rate in step 4308. Sampling rate may refer to a frequency in time for which a device samples a signal. For example, an audio signal recorded (i.e., sampled) at a higher sampling rate would include more of the audio signal than if recorded at a lower sampling rate. When, for example, processor 210 determines that the detected speech rate is higher than a threshold, processor 210 may cause the sampling rate of the at least one microphone to increase to record more of soundwave 4202 per unit time. This may be desirable because when speech rate is high, more words may be spoken per unit time, and lower sampling rates may impact features such as word/voice recognition.

Alternatively, for example, when processor determines that the detected speech rate is below a threshold, processor may case the sampling rate of the at least one microphone to decrease to record less of soundwave 4202 per unit time. When speech rate is low, a lower sampling rate may still adequately capture sufficient details to maintain integrity of features such as word and/or voice recognition.

Processing Audio Signals with Variable Audio Quality

As described above, audio signals captured from within the environment of a user may be processed prior to presenting the audio to the user. This processing may include various conditioning or enhancements to improve the experience for the user. For example, as described above, speech from an individual the user is looking at may be amplified, while other audio, such as background noise, speech from other speakers, or the like, may be muted or attenuated. Accordingly, the speech from the individual the user is speaking with may be easier for the user to hear and understand.

The quality and/or effectiveness of this processing may depend on various aspects or variables of how the audio signals are captured and/or processed. These aspects may result in various tradeoffs between a quality of the processed audio signals and other factors, such as a delay in the audio, battery life, or the like. For example, many audio processing techniques use a buffer of collected audio to perform the processing. In particular, the system may analyze samples captured before and after the audio sample currently being processed to glean additional information that may improve processing of the sample. For example, the system may use a sliding window ranging from 0-30 seconds of accumulated audio. The sliding window may include samples preceding the processed sample but also “lookahead” samples following the sample being processed. A longer time window provides a greater amount of audio sample data and thus results in a higher quality output.

However, a longer lookahead implies longer delay. With a longer lookahead period, in order to process a given sample, the system must wait longer until future samples are collected, which necessarily creates a delay in processing the samples. For example, if the required lookahead period is one second, the audio output by processing a current sample will delayed by at least one second. In some situations, this delay may be unpleasant or distracting to a user. For example, when speaking with another individual, the speech from the individual may not match the movement of his or her lips. Further, the delay may create uncomfortable pauses in the conversation. Accordingly, there is a tradeoff between a time delay for processing the audio and the quality of the audio processing that is performed. Similar tradeoffs may arise associated with other aspects of the capturing and processing of audio signals as well. For example, the audio quality may depend on other aspects, such as whether to use a camera to assist with identifying an active speaker, a number of microphones that are used, or the like. These variables may create similar tradeoffs for audio quality versus processing delay, audio quality versus battery consumption, or other tradeoffs.

The disclosed systems and methods may determine how to balance these tradeoffs in various ways. In some embodiments, a user may manually adjust one or more settings to balance these tradeoffs. Different users may have different preferences and thus may apply different settings regarding audio quality. For example, some users may be more tolerant of lower audio processing quality and thus may prefer shorter delay times. Other users may rely more on audio processing to hear and thus may be more tolerant of the delay. Further, the same user may have different preferences in different situations. For example, in a face-to-face meeting with low background noise, a shorter time delay may be preferred. On the other hand, when in a noisy multi-speaker environment, the user may prefer higher audio processing quality.

In other embodiments, the system may automatically adjust one or more settings to achieve the best tradeoff for audio quality. For example, the user may input feedback regarding audio quality or time delay and the system may adjust one or more settings. In some embodiments, the system may process the audio signal according to multiple schemes in parallel and determine which scheme provides the best tradeoff. For example, the system may perform a first processing with a short delay and a second processing with a longer delay and may compare the resulting processed audio signals to determine which scheme provides the best results. Thus, the disclosed embodiments may provide, among other advantages, improved efficiency, convenience, and functionality over prior art hearing aid devices.

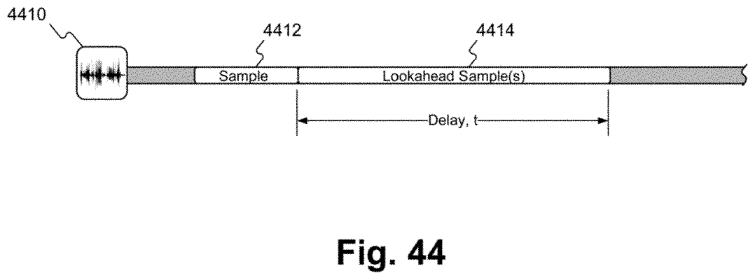

FIG. 44 illustrates an example audio signal 4410 that may be processed consistent with the disclosed embodiments. Audio signal 4410 may be captured by one or more microphones of wearable apparatus 110, such as microphones 443 or 444, as described above. In some embodiments, audio signal 4410 may be received from multiple microphones, such as a microphone array. Audio signal 4410 may include representations of sounds from the environment of a user of wearable apparatus 110. The audio signal thus may include voices from one or more individuals, background noise, music, and/or other sounds that may be processed by wearable apparatus 110 prior to presenting it to the user. For example, the system may selectively condition audio sample 4410 to attenuate background noise, amplify sounds from a particular source (e.g., an object or person the user is looking at), adjust a pitch of the audio signal, adjust a playback rate of the audio signal, remove noise or artifacts from the signal, perform audio compression, or perform other enhancements to improve the quality of the audio for the user.

As noted above, the quality of the processed audio signal may depend on various factors, including a time delay allowed for collecting and analyzing additional audio samples after the audio sample currently being analyzed. For example, as shown in FIG. 44, the system may process an audio sample 4412 included within audio signal 4410. This processing may include any of the various enhancements or conditioning described throughout the present disclosure. The disclosed system may also analyze previous and/or subsequent audio samples to improve processing of the current sample. As illustrated in FIG. 44, this may include one or more “lookahead” samples 4414. Increasing the amount of information included in lookahead sample 4414 may result in a greater quality of audio processing, as the system may be able to better determine a progression of the audio signal. For example, given a greater range of sample data, the system may be able to more effectively reduce background or other noise from audio signal 4410. In order to process audio sample 4412, the system may introduce a time delay (t) to allow time for lookahead sample 4414 to be processed. Accordingly, a greater time delay (t) may allow for increased audio quality for a processed audio signal. The time delay experienced by the user may be greater than the time delay (t) shown in FIG. 44. For example, the actual time delay experienced by the user may include additional delay for processing audio sample 4412, transmitting it to a hearing aid device, or other steps that may increase the delay. Although FIG. 44 shows a single lookahead sample 4414, it is to be understood that this may include more than one sample, and thus lookahead sample 4414 may be divided into a plurality of samples.

The appropriate or desired balance between the time delay and audio quality may be determined in a variety of ways. In some embodiments, the time delay may be defined based on an input from a user. For example, a user may provide input indicating a preference for higher audio quality or a preference for a shorter processing delay. As used herein, audio quality may refer to any measure of how effectively an audio signal is processed by a system. In some embodiments, audio quality may refer to how well a particular form of conditioning or enhancement is applied. For example, if selective conditioning of an audio signals is performed to attenuate background noise relative to speech of an individual, the audio quality may refer to how much of the background noise is attenuated, how well the system distinguishes between speech and background noise, a clarity of the speech, how well the system can recognize voices of particular individuals, or how much the speech is amplified. Audio quality may also refer to more general properties of the resulting audio signal, such as a sample rate, how much noise is in the signal, or the like.

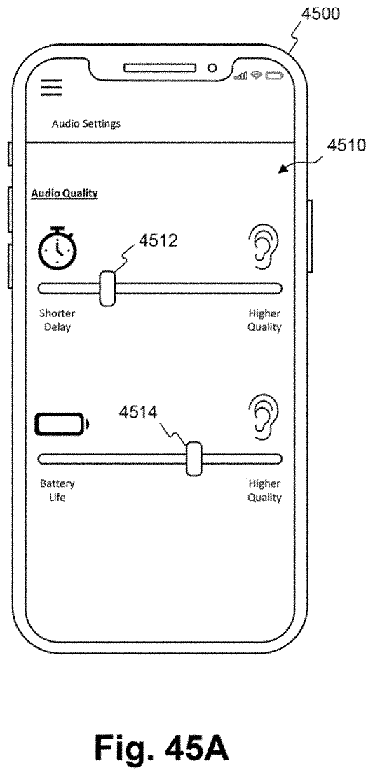

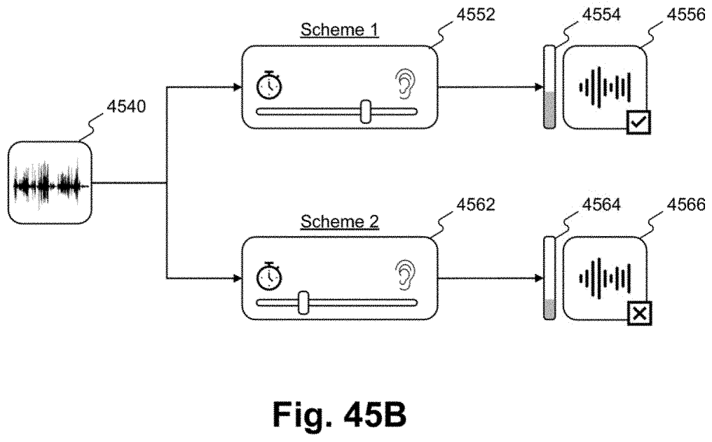

FIG. 45A illustrates an example user interface 4510 through which a user may define aspects of processing audio signals, consistent with the disclosed embodiments. User interface 4510 may be a graphical user interface displayed on a computing device 4500, as shown in FIG. 45A. Computing device 4500 may be any device associated with wearable apparatus 110 and/or hearing interface device 1710 through which a user may provide an input. For example, computing device 4500 may include a mobile phone, a tablet, a laptop, a desktop computer, a television, a wearable device (e.g., a smartwatch, smart jewelry, etc.), a home IoT device, or the like. In some embodiments, computing device 4500 may correspond to computing device 120 described above. In some embodiments, user interface 4510 may be presented on wearable apparatus 110.

User interface 4510 may include one or more controls through which a user may provide an input. For example, user interface 4510 may include one or more slider controls 4512 and 4514, as shown in FIG. 44. Using slider control 4512, a user may indicate a preference as to a tradeoff between audio processing delay and audio quality. Dragging slider control 4512 to the left may reduce the time delay, thus limiting the amount of lookahead audio that is available for processing. Alternatively, the user may drag slider control 4512 to the right, which may increase the time delay to produce a higher quality processed audio signal. User 4512 may access user interface 4510 when he or she feels the balance between time delay and audio quality is not ideal. For example, in a situation where the user is speaking with an individual one-on-one with minimal background noise, the audio quality may not be as important and therefore, the user may prefer to minimize the time delay. In other environments, however, such as a crowded restaurant, a user may have difficulty hearing and thus may be more tolerant of the delay to improve the quality of the audio processing.

In some embodiments, slider control 4512 may control other aspects of how audio is processed besides the audio sampling time delay. For example, factors such as the number of microphones used to capture the audio, whether or not image processing is performed to enhance processing of the audio, or any other variables affecting processing time may also be adjusted or controlled through slider control 4512. In some embodiments, separate controls for each of these variables may also be provided. For example, user interface 4510 may include one or more checkboxes, radio buttons, switches, or similar controls allowing a user to enable enhanced processing through the use of the camera, or the like. In some embodiments, user interface 4510 may allow a user to control other aspects of the audio processing. For example, slider control 4514 may allow a user to define a preference between battery life (e.g., of wearable apparatus 110, computing device 120, or hearing interface device 1710) versus audio processing quality. For example, the use of a camera to enhance the processing of the audio signals (e.g., to perform lip tracking techniques, determine an active speaker, etc.) may drain a battery of wearable apparatus 110 faster, and thus the user may use slider control 4514 to manage or define this tradeoff. In some embodiments, this may be presented as a binary option, such as an option to enter a battery saver mode. Further, while slider controls 4512 and 4514 are shown in FIG. 45A by way of example, various other forms of controls may be used. For example, a user may type in a value in a text field, which may correspond to a time delay (e.g., in seconds or milliseconds), a value within a range or scale (e.g., 0-5, 0-100, or the like) defining a time delay, a percentage, or any other values that may indicate a time delay preference. Controls may also include checkboxes, radio buttons, dropdown lists, buttons, dropdown buttons, toggles, icons, or the like.

In some embodiments, the time delay or other aspects of how the audio is processed may he designated based on feedback from a user. Rather than directly controlling one or more variables through user interface 4510, a user may provide feedback regarding the processed audio, which the system may use to adjust one or more aspects affecting audio quality. For example, the system may provide a prompt to the user inquiring “how was the sound quality?” and provide one or more response options for the user (e.g., selecting a number of stars or otherwise selecting a numerical rating, selecting “thumbs up” or “thumbs down” options, selecting options such as “speech was unclear” or “audio was delayed,” etc.). Based on the response, the system may be configured to adjust one or more aspects of the audio processing. Feedback from the user may be obtained in various other ways. For example, the system may detect actions of the user, which may indicate feedback from the user. In some embodiments, the feedback may be explicit. For example, the user may make a thumbs up or a thumbs down gesture that may be recognized by the system. In some embodiments, the feedback may also be implicit. For example, the system may detect, based on images or captured audio, whether the user is leaning in towards a speaker, putting his or her hand around their ear, asking the speaker to repeat themselves, or other actions that may indicate the user is having difficulty hearing, which may prompt the system to adjust one or more aspects of the audio processing.

According to some embodiments of the present disclosure, the system may be configured to automatically and dynamically adjust various aspects of audio processing. For example, the system may analyze captured or processed audio signals to determine the appropriate number or duration of lookahead samples. In some embodiments, this may include processing a captured audio signal according to different settings or schemes of settings in parallel. The system may then compare the resulting processed audio signals to determine the best tradeoff for time delay versus audio quality, or other tradeoffs. Accordingly, the system may automatically adjust one or more aspects of audio processing without input by the user.

FIG. 45B illustrates an example process for processing audio signals in parallel, consistent with the disclosed embodiments. The system may receive an audio signal 4540, as shown in FIG. 45B. Similar to audio signal 4410, audio signal 4540 may be captured by one or more microphones of wearable apparatus 110, such as microphones 443 or 444. In some embodiments, audio signal 4540 may be received from multiple microphones, such as a microphone array. Audio signal 4540 may include representations of sounds from the environment of a user of wearable apparatus 110, which may include voices from one or more individuals, background noise, music, and/or other sounds that may be processed by wearable apparatus 110 prior to presenting it to the user.

To determine a value for a time delay period, or other aspects of the audio processing, the system may perform multiple parallel audio processing streams and compare the results. As shown in FIG. 45B, the system may process audio stream 4540 according to a first scheme 4552 and a second scheme 4562. As used herein, a scheme may be a set of one or more defined parameters, aspects or variables affecting how an audio signal is processed. For example, scheme 4552 may include a first value for a lookahead time delay period, and scheme 4562 may include a different value for the lookahead time delay. For example, scheme 4552 may be associated with a longer delay and scheme 4562 may be associated with a shorter delay. Schemes 4552 and 4562 may define other aspects of how the audio signal is processed, such as a number of microphones that are used to capture the audio signal, whether a camera is used to process the audio signal, or any other variable or setting that may affect audio quality. Further aspects may relate to internal parameters or variables used for processing an audio signal through the various schemes. As a result of the parallel processing, the system may generate a first processed audio signal 4556 and a second processed audio signal 4566.

The system may then compare processed audio signals 4556 and 4566 to determine which scheme provides a better tradeoff between one or more aspects defined in scheme 4552 and 4562 and the audio quality of processed audio signals 4556 and 4566. Accordingly, the system may be configured to evaluate the resulting audio quality of processed audio signals 4556 and 4566, which may be performed in a variety of ways. As one example, when processing audio signal 4540 certain frequencies may be removed to “clean” the audio signal. For example, this may include removing certain frequencies associated with background noise, other speakers, or other audio sources. This processing may result in a decrease in the amount of accumulated energy of the signal. Thus, after the parallel processing, an energy level 4554 of processed audio signal 4556 and an energy level 4564 of processed audio signal 4566 may be compared. If the difference in energy levels is small, this may indicate that both schemes were similarly effective in attenuating unwanted noise from the signal. Therefore, the additional time delay introduced by scheme 4552 may not provide a significant advantage over the shorter time delay introduced by scheme 4562. On the other hand, if the difference between energy levels 4554 and 4564 is relatively large, this may indicate that the additional time delay introduced by scheme 4552 significantly improves the quality of the processed audio signal, and thus scheme 4552 may be selected. Accordingly, comparing processed audio signals 4556 and 4566 may include comparing a difference between energy levels 4554 and 4564 to a threshold energy level difference.

Various other comparisons between processed audio signals 4556 and 4566 may be used. For example, the system may analyze a sample rate of the audio signals, an amount of noise in the signal, or other characteristics of processed audio signals 4556 and 4566. In some embodiments, the audio quality may be assessed based on input from a user. For example, the system may present processed audio signals 4556 and 4566 to the user and the user may provide input regarding how much of an improvement one provides over the other, or whether they are relatively close in audio quality.

Based on the comparison of processed audio signals 4556 and 4566, the system may select a scheme providing a better tradeoff between time delay (or other aspects) and audio quality. The system may also present the selected processed audio signal to the user, for example, through hearing interface device 1710. In some embodiments, this parallel processing may be performed periodically such that the time delay or other aspects of audio processing are adjusted dynamically. For example, the parallel processing may be performed as a check every second, 2 seconds, 10 seconds, 60 seconds, 5 minutes, 10 minutes, hour, or other suitable periods. In some embodiments, the user may manually initiate the parallel processing, for example, by selecting a calibration button on a user interface, a physical button on wearable apparatus 110, or the like. In some embodiments, the parallel processing may be initiated based on other cues detected by wearable apparatus 110, computing device 210, or hearing interface device 1710. In some embodiments, a camera of wearable apparatus 110 may detect when the user enters a different environment, such as moving from a quiet vehicle to a noisy restaurant. Accordingly, a lookahead time delay may become more important when the user is in the restaurant since there may be more background noise that must be attenuated. As another example, camera may detect whether an individual in the environment of the user is speaking to the user, which may indicate additional lookahead time delay is required. The parallel processing may be initiated based on other sensor data, such as a change in GPS position of the user, a change in lighting detected by a sensor, a change in noise levels, or various other sensor data. In some embodiments, the system may be configured to vary the predetermined time intervals based on this information. For example, the system may perform the parallel processing more frequently in environments where conditioning the audio signal may be more important or may require longer lookahead samples.

While two parallel processing schemes are shown in FIG. 45B, in some embodiments, the parallel processing may be performed according to more than two schemes. Accordingly, the system may compare differences in energy levels (or other audio metrics) across more than two processed audio signals. In some embodiments, the system may not necessarily select a value defined in one of the schemes. For example, the system may interpolate or extrapolate energy levels across multiple processed audio signal outputs and may determine a lookahead time delay or other value that represents a best tradeoff for audio quality.

In instances where the system determines that the lookahead time delay or other aspects should be changed, the system may implement the change in various ways. In some embodiments, the change may be implemented immediately, or shortly after the parallel processing. In some embodiments, the change may not necessarily be implemented immediately. For example. when extending a lookahead delay, the delay may be prolonged by extending a stationary segment of the audio signal, such as a quiet period, a period of relatively consistent noise (e.g., water flowing, etc.), or other periods where a change in audio processing settings may be less noticeable. Accordingly, the change may not be noticeable to the user. In some embodiments, if a stationary period is not detected within a predetermined period of time, the transition may be performed over another part of the audio signal. In some embodiments, the delay may be changed gradually to reduce an impact on the user. For example, if the delay is to be extended from 30 ms to 100 ms it may be performed over 7 cycles in which the delay is extended by 10 ms on each cycle. If a stationary segment of the audio signal (e.g., a quiet period) is detected after one or more cycles, the rest of the delay may be extended during the stationary segment.

In some embodiments, although one processed audio signal is selected over another, multiple processed audio signals may be presented to the user. For example, when the user is speaking, he or she may want to hear themselves speaking. In particular, the user may want to hear how he or she sounds to other individuals. In such embodiments, the user may want to hear themselves with minimal delay. Therefore, a processed audio signal based on a scheme with minimal time delay may be presented to the user. For example, the audio signal may be transmitted within 300 ms of receiving the audio signal. In some embodiments, this may be faster (e.g., at 200 ms, 100 ms, 80 ms, 40 ms, etc.). When wearable apparatus 110 detects that a user is speaking, it may present the processed audio signal with minimal delay. In some embodiments, this processed audio signal having minimal delay may be presented along with the selected processed audio signal (e.g., as a mixed or combined audio signal), which may be presented with a longer delay. In other embodiments, the system may switch back and forth between the preferred scheme and the scheme with minimal delay.

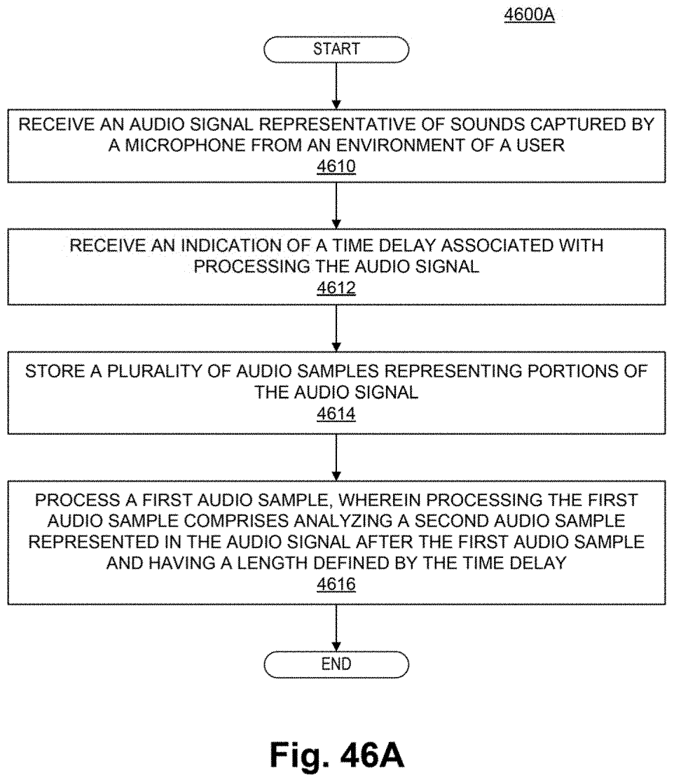

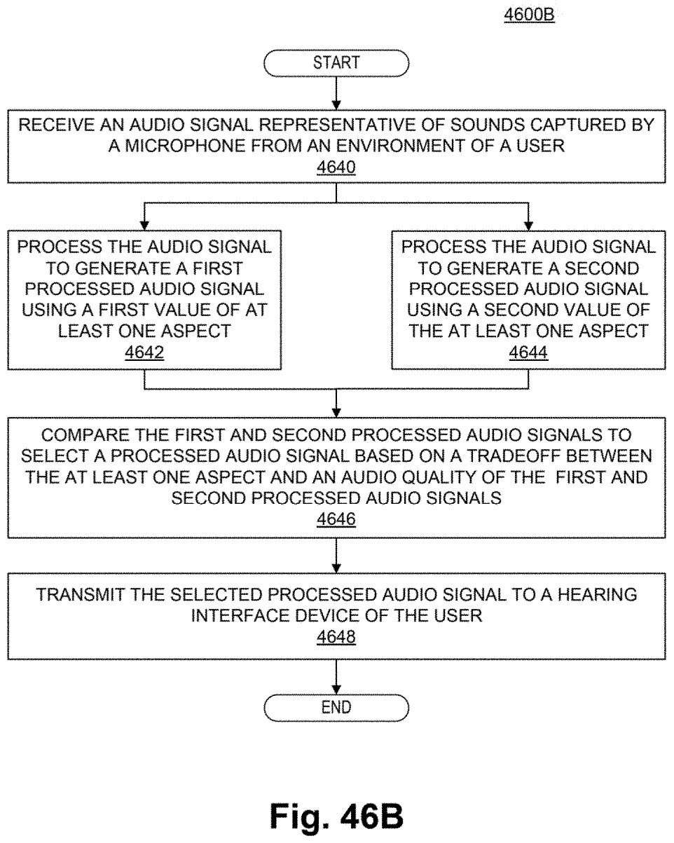

FIG. 46A is a flowchart showing an example process 4600A for selectively amplifying audio signals, consistent with the disclosed embodiments. Process 4600A may be performed by at least one processing device of a wearable apparatus, such as processor 210, as described above. In some embodiments, some or all of process 4600A may be performed by a different device, such as computing device 120. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 4600A. Further, process 4600A is not necessarily limited to the steps shown in FIG. 46A, and any steps or processes of the various embodiments described throughout the present disclosure may also be included in process 4600A, including those described above with respect to FIGS. 44 and 45A. While process 4600A is described in context of a time delay, it is understood that process 4600A may be applied to other aspects of processing an audio signal, including a number of microphones used to capture the audio signal, whether a camera is used to process the audio signal, or any other aspects that may affect audio quality.

In step 4610, process 4600A may include receiving audio signals representative of sounds received by at least one microphone from an environment of the user. For example, microphones 443 or 444 (or microphones 1720) may capture sounds from the environment of the user and may transmit them to processor 210. This may include audio signal 4410 as described above.

In step 4612, process 4600A may include receiving an indication of a time delay associated with processing the audio signal. As described in greater detail above, the time delay may be determined in a variety of ways. In some embodiments, the time delay may be defined by a user through a user interface. The user interface may be included on a device interfacing with the hearing aid system, such as computing device 120. For example, the device may be at least one of a mobile phone, a desktop, a laptop or a tablet. In some embodiments, a setpoint defining the time delay may be stored on a remote storage device. For example, the setpoint may be stored on computing device 120, hearing aid device 1710, a remote server (e.g., a cloud storage platform, network-based server, etc.), or the like. Accordingly receiving the indication of a time delay may include accessing the remote storage device. In some embodiments, the time delay may be determined by the hearing aid system based on feedback from the user regarding a previous processed audio signal. For example, the user may provide a rating of the audio quality, may provide feedback regarding a delay associated with the audio signal, or other feedback that may indicate a preferred time delay or audio quality setting.

In step 4614, process 4600A may include storing, in a buffer, a plurality of audio samples representing portions of the audio signal. For example, the plurality of audio samples may include audio samples 4412 and 4414, as described above with respect to FIG. 44. The buffer may be any storage location where audio samples are stored, at least temporarily, for analysis and/or processing. In some embodiments, the buffer may correspond to memory 550, as described above.

In step 4616, process 4600A may include processing a first audio sample of the plurality of audio samples to generate a processed first audio sample. For example, the first audio sample may correspond to audio sample 4412. Processing the first audio sample may comprise analyzing a second audio sample, such as lookahead audio sample 4414, as described above. Accordingly, the second audio sample may be represented in the audio signal after the first audio sample and may have a length defined by the time delay, as shown in FIG. 44. While step 4616 describes a single second audio sample, it is to be understood that processing the first audio sample may include analyzing multiple lookahead audio samples. Accordingly, in some embodiments, the second audio sample may include multiple audio samples. In some embodiments, an audio quality of the processed first audio sample may depend on the length of the second audio sample. For example, a greater lookahead sample 4414 may result in more data available for processing audio signal 4412, which may result in a better ability to condition or enhance the audio signal. Accordingly, a longer second audio sample may be associated with a higher audio quality.

FIG. 46B is a flowchart showing an example process 4600B for selectively amplifying audio signals, consistent with the disclosed embodiments. Process 4600B may be performed by at least one processing device of a wearable apparatus, such as processor 210, as described above. In some embodiments, some or all of process 4600B may be performed by another device, such as computing device 120. In some embodiments, a non-transitory computer readable medium may contain instructions that when executed by a processor cause the processor to perform process 4600B. Further, process 4600B is not necessarily limited to the steps shown in FIG. 46B, and any steps or processes of the various embodiments described throughout the present disclosure may also be included in process 4600B, including those described above with respect to FIGS. 44-46A.

In step 4640, process 4600B may include receiving an audio signal representative of sounds captured by at least one microphone from an environment of the user. For example, microphones 443 or 444 (or microphones 1720) may capture sounds from the environment of the user and may transmit them to processor 210. This may include audio signal 4540 as described above.

In step 4642, process 4600B may include processing the audio signal to generate a first processed audio signal using a first value of at least one aspect. For example, audio signal 4540 may be processed to generate processed audio signal 4556, as described above with respect to FIG. 45B. The at least one aspect may include any form of variable, setting, option, or other parameter associated with processing an audio signal that may affect audio quality of a processed audio signal. In some embodiments, the at least one aspect may comprise a tune delay for processing the audio signal. The time delay may define a length of a lookahead sample used to process samples of the audio signal, as described above. In some embodiments, the at least one aspect may comprise a number of microphones used to capture the audio signal. In some embodiments, the at least one aspect may include whether or not images are processed in addition to the audio signal to improve processing of the audio signal. Accordingly, process 4600B may further comprise receiving, from a wearable camera, at least one image captured from the environment of a user and the at least one aspect may comprise whether the at least one image is processed.

In step 4644, process 4600B may include processing the audio signal to generate a second processed audio signal, using a second value of the at least one aspect. For example, audio signal 4540 may be processed to generate processed audio signal 4566. Accordingly, at least part of step 4644 may be performed in parallel with step 4642. However, it is to be understood that in some embodiments, step 4644 may be performed before or after step 4642. In some embodiments, the second value may be different from the first value. For example, if the at least one aspect comprises a time delay, the first value may be a shorter time delay than the second value, or vice versa. In some embodiments, the first processed audio signal or the second processed audio signal may be processed to minimize the time delay. In some embodiments, the first value and the second value may be defined according to first and second schemes. For example, the audio signal may be processed according to schemes 4552 and 4562, as described above.

In step 4646, process 4600B may include comparing the first processed audio signal to the second processed audio signal to select the first processed audio signal or the second processed audio signal. The processed audio signal may be selected based on a tradeoff between the at least one aspect of the audio quality of the first processed audio signal and the second processed audio signal. For example, where the at least one aspect comprises a time delay, the selected processed audio signal may be the processed audio signal providing the lowest time delay without compromising audio quality. The comparison may be performed in various ways. For example, comparing the first processed audio signal and the second processed audio signal may comprise determining a difference in energy levels between the first processed audio signal and the second processed audio signal, as described in greater detail above. In some embodiments, selecting the first processed audio signal or the second processed audio signal comprises determining that a difference in the energy levels is below a predetermined threshold. For example, if the difference in energy levels is relatively low, this may indicate that minimal gains in audio quality are achieved by the difference between the first value and the second value. In some embodiments, multiple aspects may be taken into account and weighted together with the delay and audio quality. For example, the processing power or other resources required for processing may be accounted for. Accordingly, the value that provides the greatest benefit (e.g., a shorter time delay and lower battery consumption) may be selected. In some embodiments, the energy level of the selected processed audio signal is lower than the energy level of the unselected processed audio signal. For example, if the difference in energy level is below a certain threshold, step 4646 may include selecting the processed audio signal with the lowest energy level, which may indicate a better audio quality.

In step 4648, process 4600B may include transmitting the selected processed audio signal to a hearing interface device of the user. For example, wearable apparatus 110 may transmit the selected processed audio signal to hearing interface device 1710 through wireless transceiver 530. Accordingly, the selected processed audio signal may be audibly presented in an ear of the user. In some embodiments, transmitting the selected processed audio signal may comprise transitioning a value of the at least one aspect to a different value (e.g., to the first or second value). As described above, this change may occur at a detected stationary period of the audio signal, gradually over a number of cycles, or in another manner to reduce perceptibility by the user.

As described above, process 4600B may be performed as a calibration process such that the at least one aspect may be automatically and dynamically updated without requiring input by a user. Accordingly, some or all of process 4600B may be performed periodically. For example, process 4600B may further comprise comparing the first processed audio signal and the second processed audio signal at predetermined time intervals. As described above, some or all of process 4600B may be performed based on other cues. For example, process 4600B may be performed based on detecting a change of environments of a user (e.g., through camera images, GPS sensor data, light sensor data, or other sensor data), based on changes in audio signals, based on an input from a user (e.g., pressing a calibration button, etc.) or various other indicators.

Wearable Apparatus for Active Sound Substitution

As described above, audio signals captured from within the environment of a user may be processed prior to presenting the audio to the user. This processing may include various conditioning or enhancements to improve the experience for the user. For example, as described above, speech from an individual the user is looking at may be amplified, while other audio, such as background noise, speech from other speakers, or the like, may be muted or attenuated. Accordingly, the speech from the individual the user is speaking with may be easier for the user to hear and understand. Due to the processing time required to condition the audio, the user may initially hear the voice of the speaker from within his or her surrounding environment and may later hear the delayed conditioned voice of the speaker through the hearing aid device. The user may therefore experience an unwanted “echo” due to the processing time for conditioning the audio, which may be undesirable for the user.

Accordingly, the hearing aid system may be configured to at least partially cancel sounds in real time, and provide the conditioned sounds to the user, thereby reducing or eliminating the echo. For example, the hearing aid may cancel a speaker's voice in real time and then provide a conditioned version of the speaker's voice to the user through the hearing aid device. In order to cancel noise in real time, the system may determine a time difference between the sound reaching the microphone and the sound reaching the user's ear. This may be accomplished using the time difference between the individual's voice traveling through air at the speed of sound and the transmission time of the noise cancelation signal traveling as electricity (e.g., at the speed of light). Determining this difference enables the cancelation of noise/sound for the user in real time.

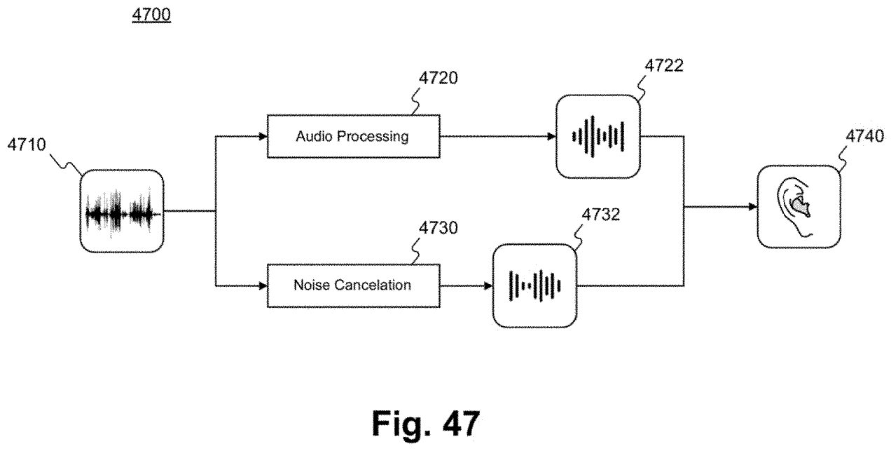

FIG. 47 is a block diagram illustrating an example process 4700 for active sound substitution, consistent with the disclosed embodiments. Process 4700 may be used to process an audio signal 4710, as shown in FIG. 47. Audio signal 4710 may be captured by one or more microphones of wearable apparatus 110, such as microphones 443 or 444, as described above. In some embodiments, audio signal 4710 may be received from multiple microphones, such as a microphone array. Audio signal 4710 may include representations of sounds from the environment of a user of wearable apparatus 110. For example, the audio signal thus may include voices from one or more individuals, background noise, music, and/or other sounds that may be processed by wearable apparatus 110 prior to presenting it to the user.

Process 4700 may include performing audio processing 4720 on audio signal 4710. Audio processing 4720 may include any form of conditioning or enhancement on an audio signal, including any form of selective conditioning described throughout the present disclosure. For example, the system may selectively condition audio signal 4710 to attenuate background noise, amplify sounds from a particular source (e.g., an object or person the user is looking at), adjust a pitch of the audio signal, adjust a playback rate of the audio signal, remove noise or artifacts from the signal, perform audio compression, or perform other enhancements to improve the quality of the audio for the user as disclosed herein. Audio processing 4720 may be used to generate a selectively conditioned audio signal 4722, which may be transmitted to a hearing interface device 4740 as shown in FIG. 47.

In addition to audio processing 4720, process 4700 may also perform noise cancelation 4730. Noise cancelation 4730 may be any form of processing of an audio signal configured to cancel or attenuate one or more sounds from the audio signal. Noise cancelation 4730 may be used to generate at least one cancelation audio signal 4732, as shown in FIG. 47. Noise cancelation audio signal 4732 may be any audio signal that is configured to cancel or neutralize another audio signal. For example, noise cancelation 4730 may include an active noise control (ANC) process. Accordingly, cancelation audio signal 4732 may include a “negative” audio signal that is out of phase with another audio signal having undesired sounds, such as one predicted to reach the ear of a user. Cancelation audio signal 4732 may be configured such that when a sound pressure of a sound wave of the undesired sounds is high, the sound pressure of a wave of the cancelation audio signal 4732 is low. Accordingly, when cancelation audio signal is combined with the predicted audio signal, the waves of the two audio signals may be neutralized or “canceled.” As with selectively conditioned audio signal 4722, cancelation audio signal 4732 may be transmitted to hearing interface device 4740.

Cancelation audio signal 4732 may be configured to cancel at least a portion of audio signal 4710. In some embodiments, cancelation audio signal 4732 may be configured to cancel a specific portion of audio signal 4710 at the required phase, such as an individual's voice. Accordingly, this specific portion may be canceled when it reaches the user's ear. In some embodiments, this portion may also be included in audio processing 4720. For example, if audio processing 4720 is configured to selectively condition an individual's voice from audio signal 4710, cancelation audio signal 4732 may neutralize or cancel the individual's voice from the sounds reaching the user's ear. Accordingly, cancelation audio signal 4732 may eliminate or reduce an echo that may otherwise be experienced by the user when selectively conditioned audio signal 4722 is transmitted to hearing interface device 4740. In some embodiments, cancelation audio signal 4732 may be configured to cancel all sounds from the environment of the user. Accordingly, the user may hear selectively conditioned audio signal 4722 without hearing any sounds or some of the sounds from the user's environment. For example, audio processing 4720 may selectively condition a plurality of sounds within the user's environment to adjust a volume or other properties of the sounds relative to each other and the user may hear the selectively conditioned sounds without an echo effect.

To effectively cancel sounds from the environment of the user, cancelation audio signal may be transmitted such that it is presented in the ear of the user at the same time as the sounds that are being canceled. Accordingly, the system may be configured to determine a time delay defining a time between when audio signal 4710 is received by apparatus 110 (or, in some embodiments, when cancelation audio signal 4732 is generated) and a time when the cancelation signal is presented to the user. Accordingly, the system may predict a sound that will be received at the ear of the user based on audio signal 4710 and the time delay may be determined such that cancelation audio signal 4732 cancels the predicted sound. In some embodiments, the time delay may be a preset or predefined value associate with wearable apparatus 110. For example, the system may assume a time it takes for a predicted sound to be heard by the user after being captured as audio signal 4710. This predetermined time delay may be adjusted based on an input from a user. For example, the user may be able to fine-tune the delay through a user interface or may be able to provide feedback that an echo is being experienced.

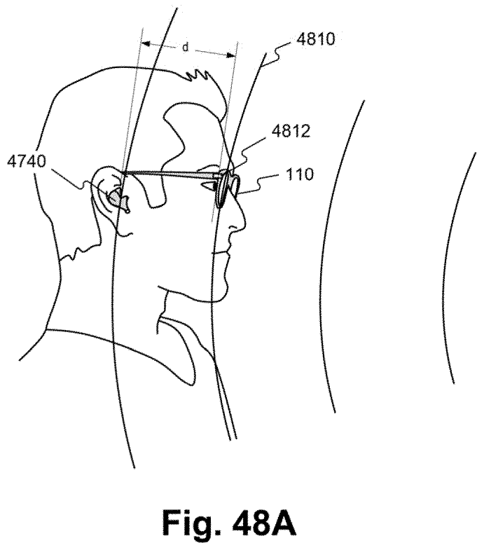

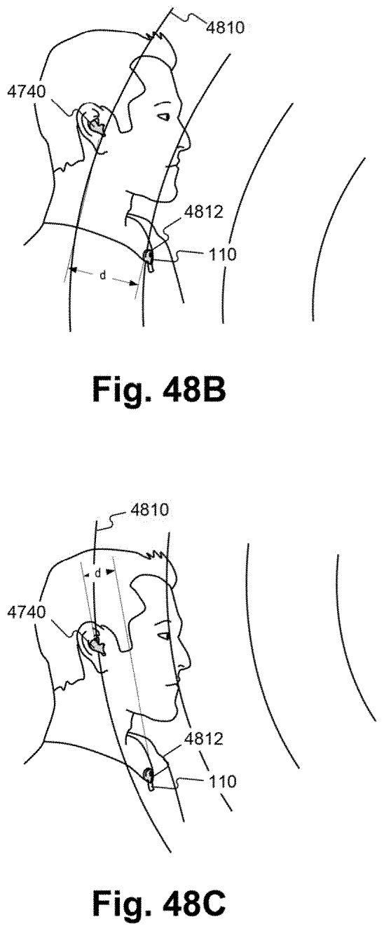

In some embodiments, the time delay may be determined based on a distance the sound will travel between a location where it is captured as audio signal 4710 and the ear of the user. FIGS. 48A, 48B, and 48C illustrate example configurations of a wearable apparatus 110 and hearing interface device 4820 for active sound substitution, consistent with the disclosed embodiments. In some embodiments, wearable apparatus 110 may be worn as glasses, as shown in FIG. 48A. Wearable apparatus 110 may be worn in other locations on the user as described above. For example, wearable apparatus 110 may be worn on a belt, shirt, wrist, or various other locations on a user. Wearable apparatus 110 may include a microphone 4812, which may be configured to capture audio signals, such as audio signal 4710 described above. Microphone 4812 may be any device configured to capture sounds from the environment of the user. For example, microphone 4812 may correspond to microphones 443. 444, or 1720 described above.

Wearable apparatus 110 may transmit one or more signals to hearing aid device 4740, as described above. For example, wearable apparatus 110 may transmit selectively conditioned audio signal 4722 and cancelation audio signal 4732 to hearing interface device 4740 using wireless transceiver 530. Hearing interface device 4740 may correspond to hearing interface device 1710 as described above. Accordingly, any details or embodiments described above with respect to hearing interface device 1710 may apply to hearing interface device 4740. For example, while hearing interface device 4740 is shown as an in-ear device, hearing interface device 4740 may include another form of hearing interface device, such as bone conduction headphone, an over-ear device, or the like.

The disclosed methods and systems may include determining a distance, d, representing a difference between a distance a sound wave 4810 will travel before being captured at microphone 4812 and a distance the sound wave will travel before reaching the ear of the user (or hearing interface device 4740). The time delay discussed above may be determined based on how long it will take sound wave 4810 to travel distanced (assuming it is traveling at the speed of sound). Accordingly, distanced may be determined perpendicular to the travel of sound wave 4810. In some embodiments, the time delay may be determined in view of other factors, such as a time required for transmitting cancelation audio signal 4732, a time for processing and playing cancelation audio signal 4732 at hearing interface device 4740, or various other factors (or combination thereof) that may affect the timing at which cancelation audio signal is presented to the user. In some embodiments, the disclosed system may need an accumulated audio context for processing the cancelation audio signal. For example, the system may introduce a delay of 40-80 ms (or other suitable delays) to allow for processing of audio signal 4710. In some embodiments, this accumulated audio context delay may be variable or adjustable as described above with respect to FIGS. 44-46B.

As described above, wearable apparatus 110 may be placed in various other locations on a user. Distance d may depend at least partially on a placement of wearable apparatus 110. FIG. 48B illustrates a wearable apparatus 110 clipped on a collar of a user. As shown in FIG. 48B, distanced may vary depending on the placement of wearable apparatus 110. Distance d may similarly vary based on a type, or other characteristic of wearable apparatus 110. For example, wearable apparatus 110 may have a different predetermined time delay when implemented as a pair of glasses than a device attachable to a user's clothing. In some embodiments, distance d (and the time delay) may depend on the placement of the device by the user. For example, the same device may be capable of being clipped or otherwise fastened in various locations on the user. Accordingly, the device may receive data indicating the placement location. In some embodiments, the data may be a user input indicating the placement location. For example, the user may provide the input through a user interface of computing device 120 (or other computing devices). This may include selecting from a list of locations, tapping an image of a user indicating the approximate placement location, or other interfaces. The user input may be received through other means, such as a physical switch or button on wearable apparatus 110. In some embodiments, wearable apparatus 110 may infer a placement location based on a perceived camera location based on images captured by image sensor 220 of wearable apparatus 110, a perceived directionality of the user's speech or other sounds, or the like. In some embodiments, the time delay may depend on a size of the device. For example, when implemented as a pair of glasses, devices with longer temples may assume longer time delays than devices with shorter temples. The time delay may also be configured based on placement or other properties of hearing interface device 4740 (e.g., in-ear versus bone conduction, processing speeds, etc.).

The distance d and the associated time delay may also depend on a location of a sound emanating object relative to the user. FIG. 48C illustrates a sound wave 4810 being received from a higher location relative to FIG. 48B, where the placement of wearable apparatus 110 and hearing interface device 4740 remain the same. Because the angle at which sound wave 4810 reaches microphone 4812 and the ear of the user is different, distance d is also different (in this case, shortened). Accordingly, wearable apparatus 110 may be configured to account for a position of the sound emanating object generating a sound wave 4810 that is to be canceled when determining the time delay. Wearable apparatus 110 may determine or estimate the position of the sound emanating object in various ways. In some embodiments, the position may be assumed based on a type of the sound emanating object. For example, if wearable apparatus 110 determines sound wave 4810 is associated with an individual, wearable apparatus 110 may assume the sound emanating object is at an average height of an individual's mouth. As another example, if sound wave 4810 is associated with an animal such as a dog or a cat, wearable apparatus may assume wound wave 4810 is emanating from near a ground level. Various other types of sound emanating objects may be recognized and associated with predetermined heights.

In some embodiments, the location of a sound emanating object may be determined based on sensor data received by wearable apparatus 110. For example, wearable apparatus 110 may analyze one or more images captured by image sensor 220 to determine a position of the sound emanating object. This may include various object or feature detection or other image processing techniques, as described throughout the present disclosure. In some embodiments, the location of the sound emanating object may be determined based on input from microphone 4812. For example, microphone 4812 may include a multidirectional array of microphones or other type of microphone configured to determine a direction from which sounds are being captured. Accordingly, the time delay (and direction d) may depend on various inputs to wearable apparatus 110. As described above, a user may be able to tune or adjust the determined delay through a graphical user interface (e.g., on computing device 120, on wearable apparatus 110, etc.), though a physical control (e.g., a button, dial, switch, etc.) or various other input devices.

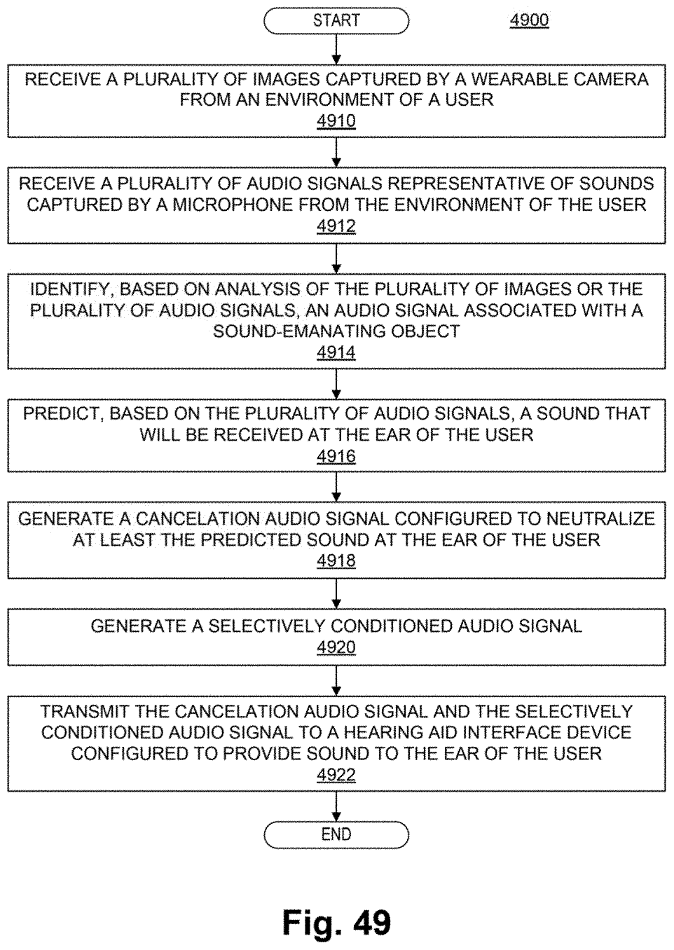

FIG. 49 is a flowchart showing an example process 4900 for selectively substituting audio signals, consistent with the disclosed embodiments. Process 4900 may be performed by at least one processing device of a wearable apparatus, such as processor 210, as described above. In some embodiments, some or all of process 4900 may be performed by a different device, such as computing device 120 or hearing interface device 4740. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 4900. Further, process 4900 is not necessarily limited to the steps shown in FIG. 49, and any steps or processes of the various embodiments described throughout the present disclosure may also be included in process 4900, including those described above with respect to FIGS. 47, 48A, 48B, and 48C.

In step 4910, process 4900 may include receiving a plurality of images captured by a wearable camera from an environment of a user. For example, step 4910 may include receiving images captured by image sensor 220. The captured images may include representations of individuals or other sound-emanating objects within the environment of the user.

In step 4912, process 4900 may include receiving an audio signal representative of sounds captured by at least one microphone from the environment of the user. For example, microphones 443 or 444 (or microphone 1720) may capture sounds from the environment of the user and may transmit them to processor 210. This may include audio signal 4710 as described above.

In step 4914, process 4900 may include identifying, based on analysis of the plurality of images or the audio signals, an audio signal from among the plurality of audio signals associated with one or more sound-emanating objects in the environment of the user. In some embodiments, the sound-emanating object may be an individual. For example, step 4914 may include processing the plurality of images to identify an individual that is speaking to the user. This may be based on lip movement of the individual, a look direction of the user, a voice print, or various other methods for identifying an audio signal associated with the individual described throughout the present disclosure.

In step 4916, process 4900 may include predicting, based on the plurality of audio signals, a sound that will be received at the ear of the user from the environment of the user. The predicted sound may correspond to the sound the user will hear when a sound wave associated with the identified audio signal reaches the ear of the user. For example, referring to FIG. 48A, the predicted sound may be a sound the user is expected to hear once sound wave 4810 reaches the ear of the user after being recorded by microphone 4812.

In step 4918, process 4900 may include generating a cancelation audio signal configured to neutralize at least the predicted sound at the ear of the user. For example, this may include generating cancelation audio signal 4732 through noise cancelation 4730, as described above. In some embodiments, the noise cancelation audio signal may be configured to neutralize at least one sound from the environment of the user in addition to a sound from a an individual speaking with the user. For example, the noise cancelation audio signal may be configured to neutralize background noise, other speakers, or sounds from other sound emanating objects in the environment of the user.

In step 4920, process 4900 may include generating a selectively conditioned audio signal based on the identified audio signal. For example, step 4920 may include generating selectively conditioned audio signal 4722 through audio processing 4720, as described above. Accordingly, generating the selectively conditioned audio signal may include any form of conditioning or enhancement of the identified audio signal. For example, the selective conditioning may comprise amplifying the identified audio signal relative to an additional audio signal of the plurality of audio signals. Various other forms of selective conditioning are described throughout the present disclosure.

In step 4922, process 4900 may include transmitting the cancelation audio signal and the selectively conditioned audio signal to a hearing aid interface device configured to provide sound to the ear of the user. For example, selectively conditioned audio signal 4722 and cancelation audio signal 4732 may be transmitted to hearing interface device 4740, as shown in FIG. 47. In some embodiments, the cancelation audio signal and the selectively conditioned audio signal may be transmitted together, although they may be time shifted relative to each other. For example, the cancelation audio signal and the selectively conditioned audio signal may be combined or mixed such that when presented to the ear of the user along with the predicted sound, only the conditioned audio signal is heard. In some embodiments, the cancelation audio signal and the selectively conditioned audio signal may be transmitted separately. For example, the cancelation audio signal may be transmitted prior to transmitting the selectively conditioned audio signal. Accordingly, the predicted sound may be canceled at the ear of the user such that the selectively conditioned audio signal does not introduce an echo for the user.

As described above, presentation of the cancelation audio signal may be timed to coincide with the predicted sounds reaching the ear of the user. Accordingly, in some embodiments, process 4900 may further include determining a time delay between when the plurality of audio signals are received and when the predicted sound will be received at the ear of the user. In these embodiments, the cancelation audio signal may be transmitted at a time based on the time delay. In some embodiments, the time delay may be determined at least partially based on a speed of sound traveling through air. For example, the time delay may correspond to the time it takes for sound wave 4810 to travel distance d, as described above with respect to FIGS. 48A, 48B, and 48C. In some embodiments, the time delay may be determined at least partially based on a position of the sound emanating object relative to the at least one microphone and the hearing aid interface device. For example, the position of the sound emanating object may be determined based on the plurality of images, as described above with respect to FIG. 48C. The position of the sound emanating object may be determined based on other inputs, such as a directionality determined based on the microphone, or other data. In some embodiments, the time delay may be determined at least partially based on an input from a user. For example, the input is received through a user interface of an external device, such as computing device 120. The user interface may include controls similar to those shown in FIG. 45A and described above. In some embodiments, the user input may be provided through a physical control, such as a button, dial, switch, or the like.

Simulated Directionality of Sound

Consistent with the disclosed embodiments, a hearing aid system may selectively amplify sounds based on a location of a sound emanating object. Existing hearing aid systems may be unable to replicate timing and volume of sounds with sufficient fidelity and accuracy to enable a user to identify the source of a sound. In some situations, a user may have learning difficulties, brain damage, misshaped ears or ear canals, or effects from an injury that diminish the user's ability to locate an object based on sound location. For example, a user may have unequal hearing loss in his or her ears, resulting in a mistaken perception that objects are closer to the user's ear with less hearing loss than to the user's ear with greater hearing loss. Additionally, in some cases, a user may wish to enhance sound localization ability by combining delay perception and sound intensity perception.

Therefore, the hearing aid system may analyze captured images and sounds of an environment of a user to determine a location of a source of a sound. The hearing aid system may then transmit sounds to a user such that the sounds arrive at the user's ears at different times and volumes so as to produce a stereo sound effect. By doing so, the hearing aid system may provide users with replacement and/or enhanced sound localization abilities.

User 100 may wear a hearing aid device consistent with the camera-based hearing aid device discussed above. For example, the hearing aid device may be hearing interface device 1710, as shown in FIG. 17A. Hearing interface device 1710 may be any device configured to provide audible feedback to user 100. A hearing interface device 1710 may be placed in each ear of user 100, similar to traditional hearing interface devices. As discussed above, hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, microphones for detecting sounds in the environment of user 100, internal electronics, processors, memories, etc. In some embodiments, in addition to or instead of a microphone, hearing interface device 1710 may comprise one or more communication units, and one or more receivers for receiving signals from apparatus 110 and transferring the signals to user 100. Hearing interface device 1710 may correspond to feedback outputting unit 230 or may be separate from feedback outputting unit 230 and may be configured to receive signals from feedback outputting unit 230.

In some embodiments, hearing interface device 1710 may comprise a bone conduction headphone 1711, as shown in FIG. 17A. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc. In some embodiments, two hearing interface devices 1710, one for each ear, may be provided. The two hearing interface devices 1710 may be connected with a wire or may be connected wirelessly. Further, a first hearing interface device may receive instructions or audio from a second hearing interface device. Additionally, two hearing interface devices 1710 may receive audio from another source, such as apparatus 110 or a paired device.

Hearing interface device 1710 may be configured to communicate with a camera device, such as apparatus 110. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, a necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by computing device 120 and/or processor 540.

As discussed above, apparatus 110 may comprise at least one microphone and at least one image capture device. Apparatus 110 may comprise microphone 1720, as described with respect to FIG. 17B. Microphone 1720 may be configured to determine a directionality of sounds in the environment of user 100. For example, microphone 1720 may comprise one or more directional microphones, a microphone array, a multi-port microphone, or the like. Processor 210 may be configured to distinguish sounds within the environment of user 100 and determine an approximate directionality of each sound. For example, using an array of microphones 1720, processor 210 may compare the relative timing or amplitude of an individual sound among the microphones 1720 to determine a directionality relative to apparatus 100. Apparatus 110 may comprise one or more cameras, such as camera 1730, which may correspond to one or more image sensors such as image sensor 220. Camera 1730 may be configured to capture images of the surrounding environment of user 100. Apparatus 110 may also use one or more microphones of hearing interface device 1710 and, accordingly, references to microphone 1720 used herein may also refer to a microphone on hearing interface device 1710.

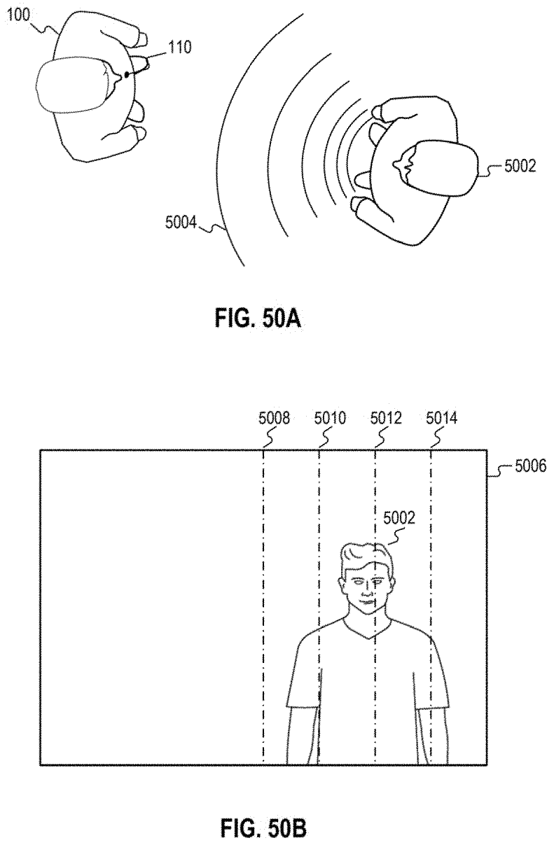

Processor 210 (and/or processors 210a and 210b) may be configured to detect a sound emanating object, such as an individual, within the environment of user 100. FIG. 50A is a schematic illustration showing an exemplary environment. As shown in FIG. 50A, user 100, wearing apparatus 110, may be physically present in the environment with an individual 5002 producing sounds 5004. Thus, in the scenario presented in FIG. 50A, individual 5002 is a sound emanating object. Although FIG. 50A shows an individual as a sound emanating object, a sound emanating object may be any item in the environment which produces sound waves that may be heard by user 100 or detected by apparatus 100. For instance, the sound emanating object may be a machine, an animal, or a naturally occurring sound source, such as wind. In some scenarios, the sound emanating object may move while producing a sound. Alternatively, the sound emanating object may produce sound without observable movements, such as a speaker of a radio.

The location of a sound emanating object may be determined by detecting differences in arrival time of a sound at multiple listening devices, and/or detecting differences in volume. For example, in humans, sound localization occurs by determining a difference in when a sound arrives at a person's left and right ears. Sound localization also occurs by determining difference in volume of the sound at the left and right ears. For example, in FIG. 50A, user 100 may be able to determine that individual 5002 is standing forward and to the right of user 100 by noticing that sounds 5004 arrive sooner and louder at the right ear of user 100 than at the left ear of user 100. However, if user 100 is hearing-impaired, user 100 may have to rely on sight to determine the location of individual 5002. If user 100 is sight-impaired, or looking in a different direction, user 100 may be unable to determine the location of a sound, and thus be unable to determine the source of a sound.

To remedy this, certain embodiments of the present disclosure may provide stereo sound signals based on a determined location of a sound emanating object. In some embodiments, apparatus 110 may determine the location of a sound emanating object using images captured by camera 1730. For example, FIG. 50B is a schematic illustration of an exemplary image captured by an imaging capture device consistent with the present disclosure. Processor 210 may be configured to analyze images captured by camera 1730 to detect a sound emanating object in the field of view 5006 of camera 1730, such as individual 5002, and determine a direction from user 100 to the sound emanating object. For example, processor 210 may determine a location of individual 5002 within the field of view 5006. As illustrated, field of view 5006 may be divided into sections representing angles. For instance, field of view 5006 may have a center line 5008 aligned with the user look direction 1750. Field of view 5006 may be divided into sections representing a region 0-5 degrees off center, demarcated by lines 5008 and 5010; a region 5-10 degrees of center, demarcated by lines 5010 and 5012; and a region 10-15 degrees off center, demarcated by lines 5012 and 5014. The location of individual 5002 or other sound emanating object may be determined by reference to these sections of field of view 5006. For example, as shown in FIG. 50B, the mouth of individual 5002 is located within the region demarcated by lines 5010 and 5012. Accordingly, to determine a direction towards a sound emanating object, processor 210 may use motion detection and/or sound localization techniques, as described further below. Although FIG. 50B illustrates lines 5008-5014, processor 210 may use alternative metrics to determine a direction of a sound emanating object relative to user 100, such as x and/or y coordinates of field of view 5006, or smaller and/or larger sections of field of view 5006. Additionally, processor 210 may use sound arrival time information, rather than or in addition to, images captured by camera 1730, as will be described in greater detail below.

Based on the detected location of a sound emanating object, processor 210 may cause selective conditioning of audio in order to convey the location of a sound emanating object to user 100. The conditioning may include amplifying audio signals determined to correspond to sound 5004 (which may correspond to a voice of individual 5002) relative to other audio signals. In some embodiments, amplification may be accomplished digitally, for example, by processing audio signals associated with sound 5004 relative to other signals. Additionally, or alternatively, amplification may be accomplished by changing one or more parameters of microphone 1720 to focus on audio sounds associated with individual 5002. For example, microphone 1720 may be a directional microphone and processor 210 may perform an operation to focus microphone 1720 on sound 5004. Various other techniques for amplifying sound 5004 may be used, such as using a beamforming microphone array, acoustic telescope techniques, etc. The conditioned audio signal may be transmitted to two hearing interface devices 1710, and thus may provide user 100 with audio conditioned based on the location of a sound source. Selective conditioning may also include introducing an amplitude difference or a delay between when a sound is conveyed to a first ear and when the sound is conveyed to a second ear. Further details of selective conditioning will be provided below.

The degree of conditioning of the sound, such as the difference in amplification, or the length of a delay, may be based on a determined direction to a sound emanating object, relative to user 100. For example, by reference to FIG. 50B, if individual 5002 were located near center line 5008 of field of view 5006, processor 210 may provide a small or no degree of conditioning. Alternatively, if individual 5002 were located near the right edge of field of view 5006, processor 210 may provide a greater degree of conditioning. Further, if individual 5002 were outside of field of view 5006, process 210 may determine the location of individual 5002 based on sound arrival times at a plurality of microphones, and introduce a still greater degree of conditioning.

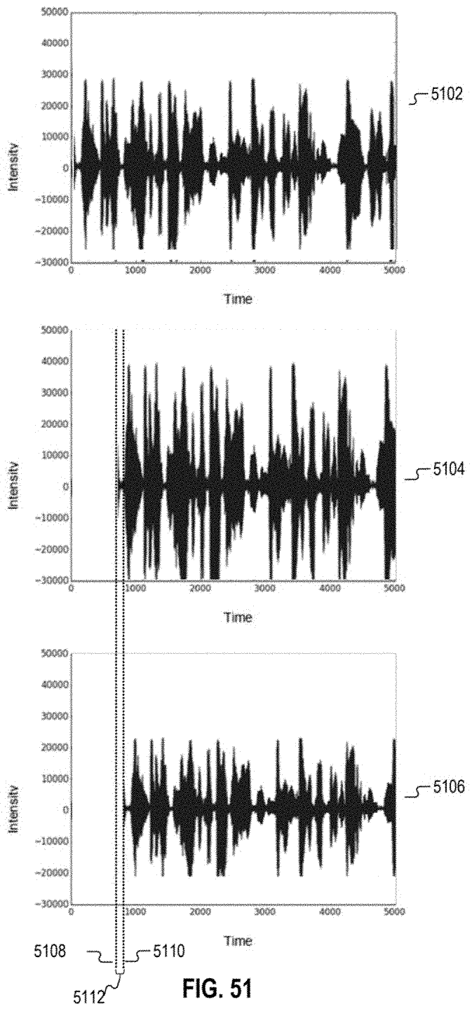

Sound conditioning may be further understood by reference to FIG. 51 showing a schematic illustration of an audio signal acquired and replayed by a hearing aid system consistent with the present disclosure. In accordance with the present disclosure, apparatus 110 may receive audio signals acquired by wearable microphone 1720 that reflect sounds generated by a sound emanating object such as individual 5002. Received signal 5102 is an audio signal representative of sounds captured by at least one microphone. Received signal 5102 may be, for instance, sounds 5004 of FIG. 50A. Once received signal 5102 arrives at process 210, processor 210 may determine a location of a sound emanating object corresponding to received signal 5102. Processor 210 may determine the location by, for instance, identifying moving objects in a field of view of a camera as illustrated in FIG. 50B, by calculating a difference in arrival time of the received signal at a plurality of microphones, by manipulation of a directional microphone, and other methods.

After processor 210 analyzes received signal 5102, processor 210 may cause transmission of a stereo sound representation. For instance, as shown in FIG. 51, processor 210 may generate a first signal 5104 and a second signal 5106. First signal 5104 may be sent to a hearing interface device 1710 associated with the right ear of user 100, and second signal 5106 may be sent to a hearing interface device 1710 associated with the left ear of user 100, for example.

In order to create a stereo sound representation, processor 210 may delay transmission of second signal 5106 for a time period after the transmission of first signal 5014. For example, processor 210 may begin transmission of first signal 5104 100 milliseconds after the sound arrives at apparatus 110, as indicated by first transmission start line 5108. While 100 milliseconds is used by way of example, other suitable time periods may be used. For example, the time period may range from 50-400 milliseconds, or any other suitable time period. Processor 210 may then transmit second signal 5106 800 milliseconds after the sound arrives at apparatus 110, as shown by second transmission start line 5110. Accordingly, second signal 5106 may be transmitted approximately 100 milliseconds after first signal 5104, as illustrated by delay 5112 of FIG. 51. Thus, user 100 will hear first signal 5104 before second signal 5106. If first signal 5104 is associated with, for instance, the user's right ear, user 100 will perceive that the source of the sound is towards his right side. Although the first transmission start is illustrated 100 milliseconds after the arrival of received signal 5102, in certain embodiments, processor 210 may cause transmission of first signal 5104 to hearing interface device 1710 in other time flames, such as less than 100 milliseconds after arrival of received signal 5102. Similarly, delay 5112 may be other durations, and may vary depending on the location of the sound emanating object.

FIG. 51 also illustrates that the received signal may be amplified and reduced in each signal, providing additional indications of the location of a sound emanating object. For example, received signal 5102 has a maximum intensity of nearly 30,000 units. However, first signal 5104 has a maximum intensity of nearly 40,000, illustrating that processor 210 has amplified first signal 5104. On the other hand, second signal 5106 has a maximum intensity of roughly 20,000, indicating that processor 210 has attenuated second signal 5106. Thus, assuming that the first signal 5104 is sent to a hearing interface device 1710 in the user's right ear and second signal 5106 is sent to a hearing interface device 1710 in the user's left ear, the user would hear a louder sound in his right ear than in his or her left ear, enhancing the user's ability to determine the source of a sound.

In some embodiments, selective conditioning may include attenuation or suppressing one or more audio signals not associated with a determined sound emanating object, such as background noise. Conditioning may further include changing a tone of received signal 5102 to make the sound more perceptible to user 100. For example, user 100 may have lesser sensitivity to tones in a certain range and conditioning of the audio signals may adjust the pitch of received signal 5102. For example, user 100 may experience hearing loss in frequencies above 10 kHz and processor 210 may remap higher frequencies (e.g., at 15 kHz) to frequencies below 10 kHz. In some embodiments processor 210 may be configured to change a rate of speech associated with one or more audio signals.

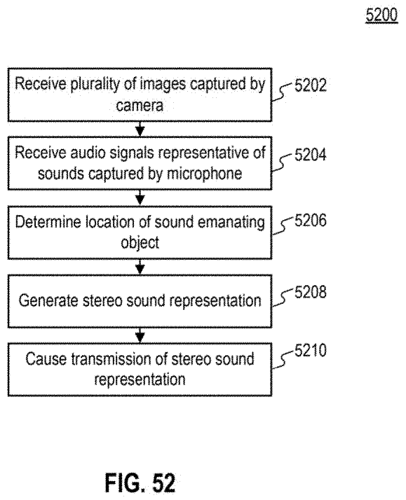

FIG. 52 is a flowchart showing an exemplary process for generating stereo sound representation consistent with disclosed embodiments. Process 5200 may be performed by one or more processors associated with apparatus 110, such as processor 210. The processor(s) may be included in the same common housing as microphone 1720 and camera 1730, which may also be used for process 5200. For example, apparatus 110 may include at least one microphone configured to capture sounds from the environment of the user. Apparatus 110 may also include a wearable camera configured to capture a plurality of images from the environment of the user. In some embodiments, some or all of process 5200 may be performed on processors external to apparatus 110, which may be included in a second housing. For example, one or more portions of process 5200 may be performed by processors in hearing interface device 1710, or in an auxiliary device, such as computing device 120 or display device 2301. In such embodiments, the processor may be configured to receive the captured images via a wireless link between a transmitter in the common housing and receiver in the second housing.

In step 5202, process 5200 may include receiving the plurality of images captured by the camera. For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that does not substantially include the environment surrounding the person. Similarly, apparatus 110 may, for example, store a portion of an image that includes an object that appears in the image, but does not substantially include the environment surrounding the object. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

Step 5202 may also include determining differences in a series of images. For example, a previous image may be subtracted, such as a pixel-by-pixel subtraction, to indicate sections of the image that have moved between the time of a first image and the time of a second image. In some embodiments, this difference image may be stored as a representation of an image.

In step 5204, process 5200 may include receiving audio signals representative of sounds captured by the at least one microphone. In some embodiments, process 5200 may receive and combine multiple audio signals from a plurality of microphones. For instance, apparatus 110 may include a microphone designed to collect sounds having low frequencies, and a microphone designed to collect sounds having high frequencies. Step 5204 may then combine the sounds into a single audio signal representing both low and high frequencies. Step 5204 may also include determining a delay between arrival times of a sound in each of a plurality of microphones.

In step 5206, process 5200 may include determining, based on analysis of the plurality of images and/or on analysis of the received sounds, a location of the sound emanating object. The location may be an angle of a sound emanating object relative to the user, as illustrated in FIG. 50B. Additionally or alternatively, the location may be a distance from the user to the sound emanating object. Processor 210 may determine distances using reference objects in the captured images or a focal length of a lens of camera 1730. In some embodiments, apparatus 110 may include a plurality of cameras providing a stereoscopic image, which may enable processor 210 to determine distances to objects. In some embodiments, process 5200 may include determining a Doppler effect of a sound to identify the location of the sound emanating object, for instance, by calculating a frequency change of sound wave. Additionally, process 5200 may match a sound to a sound profile to help identify a type of sound emanating object in the plurality of images. For instance, processor 210 may identify a plurality of possible sound emanating objects, such as a car and a lawn mower, based on analysis of the plurality of images. Processor 210 may also compare a received sound to the sound profile of a car and a lawn mower, and determine that the lawn mower is the sound emanating object. Further, processor 210 may use data from inertial measurements or from a range finder of apparatus 110 to determine distances. For example, processor 210 may calculate, based on the inertial measurements, that apparatus 110 moved two feet to the left, while an object in a field of view of camera 1730 moved fifteen degrees to the right of the center of the field of view. Processor 210 may use measurements from a range finder disposed, for instance, on apparatus 110 to identify a distance to a nearest object. For example, the range finder may measure a distance in front of or to the side of the user, and the distance may be used to determine the location. Based on these measurements, processor 210 may determine a distance to the sound emanating object.

If processor 210 detects multiple possible sound emanating objects, additional steps may be needed to determine which among a plurality of possible objects is associated with a received sound. For example, step 5206 may include determining a closest object to user 100. Thus, step 5206 may include determining a distance of a first object to the user, and determining a distance of a second object to the user. Once processor 210 determines a distance from the user to the first object and the second object, processor 210 may select, based on the determined distances, one of the first and second objects as the sound emanating object. For example, processor 210 may select the closest object as the sound emanating object.

In step 5206, process 5200 may further include identifying a representation of a sound emanating object in at least one of the plurality of images. In one embodiment, step 5206 may include identifying at least one lip movement or lip position associated with a mouth of the individual, based on analysis of the plurality of images. Processor 210 may be configured to identify one or more points associated with the mouth of the individual. In some embodiments, processor 210 may develop a contour associated with the mouth of the individual, which may define a boundary associated with the mouth or lips of the individual. The lips identified in the image may be tracked over multiple frames or images to identify the lip movement. Processor 210 may also use one or more video tracking algorithms, such as mean-shift tracking, contour tracking (e.g., a condensation algorithm), or various other techniques.

In some scenarios, a sound emanating object may be associated with other movement. For example, a sound emanating object may be a moving car, a person splashing in a pool, or a hammer striking a nail. Therefore, in some embodiments, processor 210 may identify the representation of the sound emanating object by identifying at least one moving object in the environment of the user. Step 5206 may include background subtraction between a series of captured images to identify movement, which may aid in movement detection if user 100 is still. Step 5206 may use other subtraction techniques to determine if an observed movement is periodic, and determine that the observed movement is or is not associated with a received audio signal based on the period of movement and a period of a sound In step 5208, process 5200 may include generating, based on the location of the sound emanating object, a stereo sound representation comprising a first audio signal and a second audio signal, the first audio signal differing from the second audio signal in at least one aspect to simulate the location of the object relative to the user. For instance, the first audio signal and second audio signal may differ as illustrated by first signal 5104 and second signal 5106 of FIG. 51.

For example, in some embodiments, a sound associated with the sound emanating object may be attenuated in the first audio signal relative to the second audio signal. Processor 210 may increase the amplitude of the sound by a factor less than one to produce the first audio signal, which may have an intensity less than the original sound. Alternatively or additionally, processor 210 may multiply the sound by a factor greater than one to produce the second audio signal having an intensity greater than the original sound, as well as being greater than the first audio signal. In some embodiments, amplification and attenuation may be performed digitally by processor 210. Amplification and attenuation may also be performed by an amplifier or attenuator circuit housed in apparatus 110.

Further, a degree of attenuation or amplification may be determined based on the location of the sound emanating object, for instance, the location determined at step 5206 of process 5200. Processor 210 may perform a conversion of location to attenuation and/or amplification. For example, processor 210 may calculate an attenuation factor as a function of the direction toward the sound emanating object, relative to a center line of a field of view of camera 1730. Processor 210 may determine the attenuation factor by multiplying the angle toward the sound emanating object by a coefficient, e.g., 0.5. For instance, by reference to FIG. 50B, the sound emanating object, i.e., individual 5002, is located between 5 and 10 degrees from the center of field of view 5006. Processor 210 may divide a sound from individual 5002 by an attenuation factor determined as (10 degrees×0.5)=5, such that the first signal is five times quieter than the second signal. As an additional example, if individual 5002 were located at center line 5008 of FIG. 50B, the attenuation factor would be 0 (0 degrees×0.5=0), resulting in a first signal having an equal volume to the second signal. In this manner, sounds from sound emanating objects that are further from a center line of the field of view of camera 1730 result in first signals that are attenuated by a greater degree than sounds from sounds from sound emanating objects near the center line of the field of view of camera 1730. The present example is for illustration purposes only and is not necessarily limiting of the present embodiment.

In embodiments where a distance from the user to the sound emanating object is determined, the attenuation factor may be based on the distance rather than, or in addition to, the direction. For example, if an object is far away from user 100, the attenuation factor may be less than an object closer to user 100 but at a same direction relative to user 100. This may simulate stereo sound and enable more accurate sound localization by user 100, since differences in arrival time and volume in each ear is reduced as a distance from the ears increases. Additional methods to determine an attenuation factor, such as alternative conversion methods, are envisioned. Further, processor 210 may calculate an amplification factor based on the location of the sound emanating object.

The first audio signal may also, or alternatively, differ from the second audio signal by being delayed. That is, a sound associated with the sound emanating object may be delayed in the first audio signal relative to the second audio signal, as previously illustrated in FIG. 51 by delay 5112. Processor 210 may calculate the delay based on the location of the sound emanating object, similar to the calculations described above of an attenuation or amplification factor. For example, in some embodiments, the sound associated with the sound emanating object is delayed in the first audio signal for a delay duration based on a distance of the sound emanating object from the user. Further, the sound associated with the sound emanating object may be delayed in the first audio signal for a delay duration based on a direction, relative to the user, of the sound emanating object. As described above, in some embodiments, the delay may be based on both a direction and a distance of a sound emanating object. For example, if a sound emanating object is close to a user and to a user's right side, the sound will arrive at the user's right ear earlier than the user's left ear. The difference in arrival time may then be large in comparison to the total travel time of the sound. For instance, it the sound emanating object is six inches from a user's right ear, and the user's right ear is six inches from the user's left ear, the sound travels twice as long to arrive at the user's left ear than the user's right ear. However, if the sound emanating object is one hundred feet from the user, the difference in arrival time at the user's ears is small compared to the total sound travel time. Thus, processor 210 may determine an attenuation factor based on both the direction and distance of a sound emanating object to better enable a user's sound localization ability.

In some scenarios, a sound emanating object may be outside the field of view of camera 1730, or may not produce movements detectable by camera 1730, such as a radio. Processor 210 may then be unable to determine a direction and/or distance to a sound based on the received plurality of images. Therefore, to enable sound localization even when a sound emanating object is outside the field of view of camera 1730, apparatus 110 may include multiple microphones. For example, the at least one microphone may include a first microphone, the hearing aid system may further comprise a second microphone. Processor 210 may be configured to determine a difference between a time of arrival of the sound associated with the sound emanating object at the first microphone and a time of arrival of the sound associated with the sound emanating object at the second microphone. For instance, processor 210 may analyze received audio signals from multiple microphones to determine if the audio signals match, such as determining timing of peak intensities or comparing other waveform characteristics. Additionally, processor 210 may apply a timing window based on the speed of sound and the distance between the microphones, such that when a sound is measured at a first microphone, it is only analyzed for similarity if a sound arrives at the second microphone within the timing window. Processor 210 may then determine a difference in arrival time if the received audio signals are from the same source. The duration of the delay may then be based a difference between a time of arrival of the sound associated with the sound emanating object at the first microphone and a time of arrival of the sound associated with the sound emanating object at the second microphone. In some embodiments, the duration of the delay may be reduced or increased relative to the difference of arrival times, which may enable augmented sound localization abilities for users.

In some embodiments, generating the first audio signal and the second audio signal in step 5208 may also comprise selectively conditioning at least one audio signal associated with the sound emanating object. That is, conditioning may include changing the tone or playback speed of an audio signal. For example, conditioning may include remapping the audio frequencies or changing a rate of speech associated with the audio signal. In some embodiments, the conditioning may include other amplification methods of a first audio signal relative to other audio signals, such as operation of a directional microphone, varying one or more parameters associated with the microphone, or digitally processing the audio signals. The conditioning may include attenuating or suppressing one or more audio signals that are not associated with a person. The attenuated audio signals may include audio signals associated with other sounds detected in the environment of the user, including other voices such as a second audio signal. For example, processor 210 may selectively attenuate the second audio signal based on a determination that the second audio signal is not associated with a person.

In step 5210, process 5200 may include causing transmission of the stereo sound representation to a hearing aid interface device configured to provide sound based on the first audio signal to a first ear of the user and sound based on the second audio signal to a second ear of the user. The stereo sound representation, for example, may be transmitted to a hearing interface device 1710 connected to a user's right ear, and a hearing interface device 1710 connected to a user's left ear, thereby providing sound corresponding to the received audio signals to user 100. In some embodiments, hearing interface device 1710 may include a speaker associated with an earpiece. For example, hearing interface device may be inserted at least partially into the ear of the user for providing audio to the user. Hearing interface device may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin, or may be implanted surgically and attached to the bone of the user.

Live Alteration of Voice Traits

Consistent with the disclosed embodiments, a hearing aid system may selectively condition sounds based on voice traits to enable a user to better understand individuals with speech impediments, accents, or other voice traits that may inhibit the user's understanding. Although existing hearing aid systems may amplify sounds to overcome hearing loss, these systems may be unable to eliminate impediments to understanding. For example, users of hearing aid systems may have a cognitive disability in addition to hearing loss, and simple sound amplification methods provided by traditional hearing aid systems do not address these cognitive disabilities. Additionally, even when users do not exhibit cognitive disability, the users may encounter people with heavy accent or speech impediments that sound amplification does not address, or even worsens. Therefore, the hearing aid system of the present disclosure may selectively condition audio associated with speech to reduce barriers to understanding.

User 100 may wear a hearing aid device consistent with the camera-based hearing aid device discussed above. For example, the hearing aid device may be hearing interface device 1710, as shown in FIG. 17A. Hearing interface device 1710 may be any device configured to provide audible feedback to user 100. A hearing interface device 1710 may be placed in each ear of user 100, similar to traditional hearing interface devices. As discussed above, hearing interface device 1710 may be of various styles, including in-the-canal, completely-in-canal, in-the-ear, behind-the-ear, on-the-ear, receiver-in-canal, open fit, or various other styles. Hearing interface device 1710 may include one or more speakers for providing audible feedback to user 100, microphones for detecting sounds in the environment of user 100, internal electronics, processors, memories, etc. In some embodiments, in addition to or instead of a microphone, hearing interface device 1710 may comprise one or more communication units, and one or more receivers for receiving signals from apparatus 110 and transferring the signals to user 100. Hearing interface device 1710 may correspond to feedback outputting unit 230 or may be separate from feedback outputting unit 230 and may be configured to receive signals from feedback outputting unit 230.

In some embodiments, hearing interface device 1710 may comprise a bone conduction headphone 1711, as shown in FIG. 17A. Bone conduction headphone 1711 may be surgically implanted and may provide audible feedback to user 100 through bone conduction of sound vibrations to the inner ear. Hearing interface device 1710 may also comprise one or more headphones (e.g., wireless headphones, over-ear headphones, etc.) or a portable speaker carried or worn by user 100. In some embodiments, hearing interface device 1710 may be integrated into other devices, such as a Bluetooth™ headset of the user, glasses, a helmet (e.g., motorcycle helmets, bicycle helmets, etc.), a hat, etc.

Hearing interface device 1710 may be configured to communicate with a camera device, such as apparatus 110. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, a necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by computing device 120 and/or processor 540. Apparatus 110 may also use one or more microphones of hearing interface device 1710 and, accordingly, references to microphone 1720 used herein may also refer to a microphone on hearing interface device 1710.

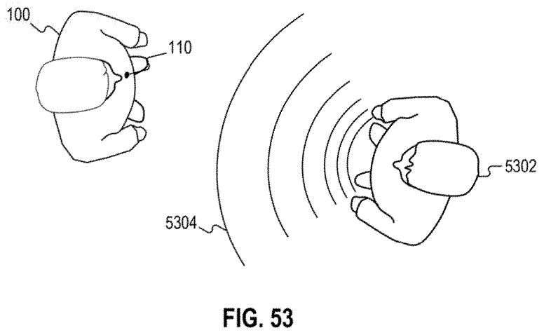

Processor 210 (and/or processors 210a and 210b) may be configured to detect an individual within the environment of user 100. FIG. 53 is a schematic illustration showing an exemplary environment for use of a hearing aid providing live alteration of voice traits consistent with the present disclosure. As shown in FIG. 53, user 100 wearing apparatus 110 may be physically present in an environment with an individual 5302 producing sounds 5304. Although FIG. 53 shows individual 5302 as speaking, a microphone of apparatus 110 may also capture other sounds from the environment of user 100, such as machines, animals, or naturally occurring sound sources, such as wind. Thus, processor 210 may be configured to identify and isolate sounds corresponding to speech from among a plurality of sounds captured by a microphone of apparatus 110. For example, sounds produced by machines often have a period corresponding to a motion of the machine, such as a running motor producing a sound for every cycle, or a jackhammer producing a sound for every strike. In these cases, processor 210 may filter periodic sounds to isolate speech. As a further example, processor 210 may filter sounds that are louder or quieter than a range of typical speech volumes, sounds that have harmonics differing from harmonics of typical speech, or pitches that are outside typical speech pitches. Processor 210 may employ signal analysis methods, such as Fourier transforms, to isolate speech signals.

Isolation of speech from other sounds may enable a user wearing a hearing aid system according to the present disclosure to better understand conversations with others. For example, processor 210 may selectively condition sounds by increasing the volume of sounds associated with speech and decreasing or even eliminating sounds associated with sources besides speech. Thus, the hearing aid system may help a user focus on the conversation and avoid distractions. However, in some scenarios, selectively increasing the volume of sounds may be insufficient to enable a user to understand a speaker. For instance, as stated above, the user may have a cognitive disability that inhibits understanding of typical speech, such as needing greater than usual time to distinguish words. The user may also have a physical impediment to understanding speech, such as hearing loss in certain frequencies corresponding to ranges of human voices. The user may also have a cultural difference with the speaker making the speaker difficult to understand, such as an accent.

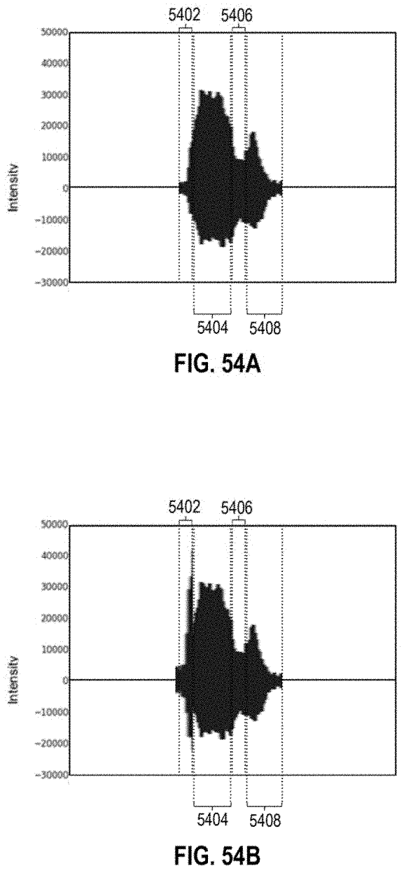

To address these issues, certain embodiments of the present disclosure may provide additional selective conditioning of speech to further improve user understanding. For example, FIG. 54A is a schematic illustration of an audio signal acquired by a hearing aid system consistent with the present disclosure, while FIG. 54B is a schematic illustration of an audio signal replayed by a hearing aid system consistent with the present disclosure. FIGS. 54A and 54B may be spectrograms derived from a microphone of apparatus 110. Comparison of the acquired audio signal of FIG. 54A with the replayed audio signal of FIG. 54B illustrates an embodiment of selective conditioning as in an embodiment of the present disclosure.

Processor 210 may isolate a word from a longer sample of sound corresponding to speech by removing non-speech sounds as described above, and separating sounds associated with speech into segments based on periods of silence indicating a word break. For instance, FIG. 54A notionally represents a word extracted from speech. In the present example, the word may be a word that is difficult for a user to understand when spoken by a speaker or may be easily confused with a similar sounding word, due to, for instance, the speaker's accent. For example, the graph shown in word of FIG. 54A may correspond to a speaker saying the word “hearing” which, in some accents or for some people with certain speech impediments, may sound like “earring” or even “Erin”. That is, some speakers may drop the leading “h” or the final “g” in the word “hearing” or may alter the vowel pronunciation.

Processor 210 may further partition the identified word into phonemes. For example, as shown in FIG. 54A, processor 210 may divide the word “hearing” into four phonemes: the “h” phoneme in region 5402, the “ea” phoneme in region 5404, the “r” phoneme in region 5406, and the “ng” phoneme in region 5408. Processor 210 may identify phonemes by matching a spectrogram derived from audio to a library of spectrograms stored in relation with strings describing the sound. For instance, processor 210 may store the library in memory 550 of apparatus 110, or processor 210 may access a database storing the library. For instance, the spectrogram of region 5402 may be stored in the library and linked to the letter “h”. Further, the library may store an indication that the phoneme should be emphasized to enhance user understanding. For instance, as stated above, some accents lightly pronounce the “h” phoneme, or drop the “h” phoneme completely, and the library may store an indication that, when detected, the “h” sound should be emphasized. Further, the library may store conditional emphasis indications, such as a rule that “h” should be emphasized at the beginning of a word, but not in the middle. The library may also store emphasis rules, such as introducing a delay before a phoneme, increasing the volume, decreasing the volume, increasing the duration, or decreasing the duration.

Accordingly, FIG. 54B illustrates a replayed sound produced by processor 210 based on the received sound of FIG. 54A and a rule that “h” sounds should be elongated and amplified at the beginning of a word to enhance user understanding of the word. Thus, the phoneme of “h” in region 5402 of FIG. 54B has a greater intensity than the sound in region 5402 of FIG. 54A, amplified to over 30,000 arbitrary intensity units from an initial intensity if approximately 20,000. Additionally, the phoneme of “h” in FIG. 54B begins earlier than the start of region 5402, showing that the phoneme has an increased duration to further enhance user understanding. In some embodiments, processor 210 may also shorten other phonemes in a word so that the overall word duration is unchanged, thereby preventing delays between speaking and hearing that may confuse the user, for instance, for users who read lips to aid in hearing comprehension. In some embodiments, one or more phonemes may have an increased duration, while others may be unchanged. Accordingly, the duration of the word as a whole may be increased. In some embodiments, a duration of one or more spaces between consecutive words may be decreased to avoid an accumulated delay due to the increased phoneme duration.

In some embodiments, selective conditioning may include changing a tone of a speaker's voice to make the sound more perceptible to user 100. For example, user 100 may have lesser sensitivity to tones in a certain range and conditioning of the audio signals may adjust the pitch of received signal 5102. For example, user 100 may experience hearing loss in frequencies above 10 kHz and processor 210 may remap higher frequencies (e.g., at 15 kHz) to frequencies below 10 kHz. In some embodiments processor 210 may be configured to change a rate of speech associated with one or more audio signals.

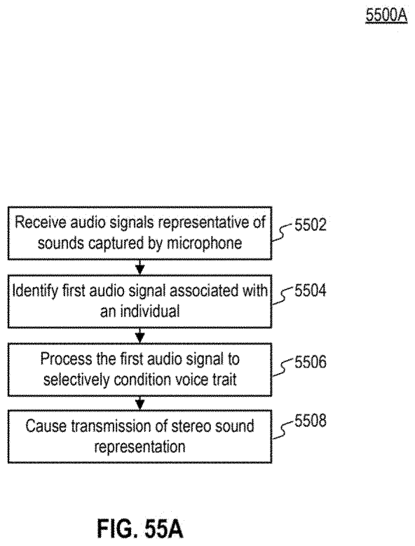

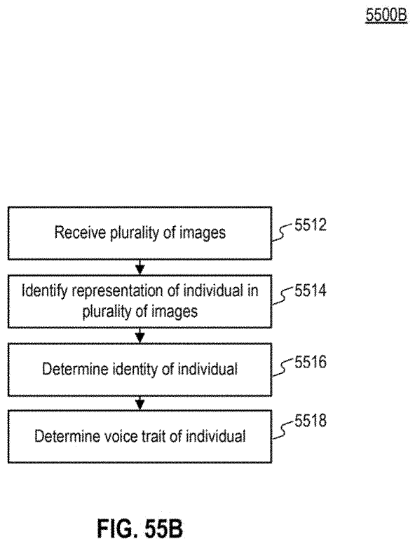

FIG. 55A is a flowchart showing an exemplary process for selectively conditioning an audio signal consistent with disclosed embodiments. Process 5500A may be performed by one or more processors associated with apparatus 110, such as processor 210. The processor(s) may be included in the same common housing as microphone 1720 and camera 1730, which may also be used during process 5500A. For example, apparatus 110 may include at least one microphone configured to capture sounds from the environment of the user. In some embodiments, some or all of process 5500A may be performed on processors external to apparatus 110, which may be included in a second housing. For example, one or more portions of process 5500A may be performed by processors in hearing interface device 1710, or in an auxiliary device, such as computing device 120 or display device 2301. In such embodiments, the processor may be configured to receive the captured images and sounds via a wireless link between a transmitter in the common housing and receiver in the second housing.

In step 5502, process 5500A may include receiving a plurality of audio signals representative of sounds captured by the at least one microphone. In some embodiments, process 5500A may receive and combine multiple audio signals from a plurality of microphones. For instance, apparatus 110 may include a first microphone designed to collect sounds having a low frequency, and a second microphone designed to collect sounds having a high frequency. Step 5502 may then combine the sounds into a single audio signal representing both low and high frequencies.

In step 5504, process 5500A may include identifying a first audio signal of the plurality of audio signals, the first audio signal associated with an individual. For instance, as described above, process 5500A may remove audio signals among the plurality of audio signals having frequencies, periods, pitches, and volumes outside of a range of normal human conversation. In some scenarios, a user may be near multiple speakers. In these situations, process 5500A may select the loudest audio signal, which may correspond to the closest speaker who may be the speaker a user wishes to hear clearly. Alternatively, process 5500A may receive an indication from the user to focus on a signal from a different speaker. For instance, process 5500A may cause audio to be played by hearing interface device 1710 from a first individual, receive a button press or other indication from the user, and then cause audio from a second individual to be played by hearing interface device 1710.

In step 5506, process 5500A may include processing the first audio signal to selectively condition at least one voice trait of the individual. In process 5500A, a voice trait may be any characteristic of an individual's speech that may inhibit understanding by a user. Examples of voice traits may include but are not limited to accents, speech impediments (such as lisps, stutters, verbal tics, abnormal stresses, abnormal tongue movement, or missing teeth), distracting sounds such as whistling, or voice quality (such as high pitch or dysphonia, i.e., hoarse voice).

For example, in some embodiments, the at least one voice trait may include an accent of the individual, and selective conditioning may include altering the accent. A memory such as memory 550, or another database accessed by apparatus 110, may store characteristics of a plurality of accents. For instance, memory 550 may store selective conditioning rules for British accents that cause phoneme replacements to a user's native accent. For example, some British English speakers may substitute the “t” phoneme with a glottal stop. As a result, memory 550 may include a selective conditioning rule to replace glottal stops detected in the first audio signal with a “t” sound, thus making a British English speaker easier to understand for an American English speaker.

As a further example, in some embodiments, the at least one voice trait may include a lisp of the individual and the selective conditioning includes removing the lisp. In this case, processor 210 may replace “th” sounds with an “s” sound in the first audio signal. However, because the “th” sound may be properly used in some words by a speaker having a lisp, processor 210 may include a natural language processing algorithm to determine if a word identified in the first audio signal should be pronounced with a “th” rather than an “s”, and, as a result, refrain from replacing the “th” with an “s” sound. Alternatively, processor 210 may access a dictionary of words and determine if the observed word is a real word, and replace the “th” sound with an “s” sound. For example, a first audio signal may include a representation of a speaker saying “thit”. Processor 210 may determine that “thit” is not a word in the dictionary of words. Processor 210 may then determine that “sit” is a word in the dictionary, and selectively condition the lisp voice trait of the individual.

As yet another example, the at least one voice trait may comprise a pronunciation of a word and the selective conditioning includes changing the pronunciation of the word. For example, an individual, such as a child, may be known to mispronounce the word “cookie” as “tootie”. Further, the individual may have no other discernable voice traits that impede user understanding. Processor 210 may then selectively condition the voice trait of mispronunciation of the word “cookie” by playing a recording of the individual properly saying the word “cookie” whenever the individual mispronounces the word. In other words, processor 210 may replace entire words with properly-pronounced words, rather than replacing individual phonemes. Further, the voice trait may comprise a plurality of pronunciations of words, and processor 210 may access a memory containing replacement audio files for each of the plurality of words. Alternatively, processor 210 may generate a proper pronunciation when a mispronounced word is detected. Processor 210 may also condition the generated pronunciation to match the voice characteristics of the individual, such as tone, pitch, and quality.

In some embodiments, the selective conditioning may further include altering the voice of the individual to simulate a voice of a second individual. For example, processor 210 may create a transcription of the first audio signal and provide the transcription to a speech synthesis algorithm having a voice selected to match a user preference. Alternatively, processor 210 may filter components, or add other components, to the first audio signal to enhance or reduce certain features and make the first audio signal more closely match the characteristics of another voice. For example, processor 210 may alter the voice of the individual by altering the pitch of the individual's voice. Thus, if the individual is a man, processor 210 may process the first audio signal to increase its pitch so as to more clearly match a woman's voice or may add overtones characteristic of a particular person's voice. Selective conditioning may also include translation, such as providing a machine translation of the transcription into the user's language, and then using a speech synthesis algorithm to read the translated text aloud. Selective conditioning may further include playing the voice of the individual in a slower or faster rate, for instance by playing one or more words faster or slower. In some embodiments, this may further include decreasing or increasing a duration of silent periods between words to account for the change in duration of the spoken words.

The voice trait of the individual may be identified during processing. Thus, in some embodiments, step 5506 may include analyzing the first audio signal to determine at least one voice trait by, for instance, frequency analysis, or phoneme strength and duration analysis. Step 5506 may also include determining user preference for selective conditioning, such as an instruction to selectively condition British accents, or to emphasize the letter “h” in speech. User preferences may be stored in memory 550, for instance. Memory 550 may also store processing algorithms and constants, such as an algorithm to emphasize the letter “h” by amplifying an identified section of the audio signal corresponding to the letter “h” by 1.5 times the original audio and lengthening the duration by 10%.

Alternatively or additionally, step 5506 may include identifying a voice signature in the first audio signal, and determining an identify of the individual based on the voice signature. For instance, a voice signature extraction may be performed by extracting spectral features, also referred to as spectral attributes, spectral envelope, or spectrogram from clean audio of a single speaker. An audio signal may include a short sample (e.g., one second long, two seconds long, and the like) of the voice of a single speaker isolated from any other sounds such as background noises or other voices. This clean audio may be input into a computer-based model such as a pre-trained neural network, which may output a signature of the speaker's voice based on the extracted features. In some embodiments, the voice signature may be a speech impediment, a mispronunciation, a speech rate, or an accent. For example, British accents may have a common spectral feature that may be identified as a voice signature. Further, an individual may mispronounce a word, such as a commonly used word, in a unique manner, and the spectrogram of the mispronounced word may be part of the individual's voice signature. Similarly, an individual's speed impediment may result in certain phoneme being absent from his speech, or, alternatively, a certain phoneme being present at unusual rates. This phoneme presence or absence may form a voice signature, as well.

The output signature may be a vector of numbers. For example, for each audio sample submitted to a computer-based model (e.g., a trained neural network), the computer-based model may output a set of numbers forming a vector. Any suitable computer-based model may be used to process the audio data captured by one or more microphones of the hearing aid system to return an output signature. In an example embodiment, the computer-based model may detect and output various statistical characteristics of the captured audio such as average loudness or average pitch of the audio, spectral frequencies of the audio, variation in the loudness, or the pitch of the audio, rhythm pattern of the audio, and the like. Such parameters may be used to form an output signature comprising a set of numbers forming a vector.

Once a voice signature has been established, step 5506 may include performing one or more voice recognition algorithms, such as Hidden Markov Models, Dynamic Time Warping, neural networks, or other techniques by accessing a database which includes a voiceprint of one or more individuals. Thus, processor 210 may determine an identity of the individual based on the voice signature. Additionally, after determining the identity, processor 210 may further access a memory to determine the at least one voice trait, the at least one voice trait being stored in association with the individual in the memory.

To further illustrate, user 100 may have a friend with a low, gravelly voice, who is unable to pronounce the letter “l”. Processor 210 may establish a voice signature for the friend based on the friend's pitch and an overtone resulting from the gravelly quality of the friend's voice. Further, the voice signature may note that the letter “l” is not identified in audio signals resulting from the friend. This voice signature may be stored in memory 220. Additionally, a user may specify that the friend's inability to say words containing “l” inhibits the user's understanding of the friend. Processor 210 may store a rule that when the friend's voice signature matches the first audio signal (indicating that the user is speaking with the friend), some segments of the first audio signal should be replaced with an audio signal properly saying the “l” sound. Processor 210 may further employ natural language processing methods to determine if the original sound was correct and refrain from inserting the “l” sound, for instance. Processor 210 may also selectively condition the voice to a higher pitch and remove overtones responsible for the gravelly quality of the friend's voice.

In some scenarios, a voice trait may be common to a language, rather than being limited to a particular speaker. For example, some words in English, referred to as near homophones, sound similar except for a small difference, such as a stronger emphasis on a single letter. The words “refuse” and “refuge,” “hiss” and “his,” and “advice” and “advise” may all be considered to be near homophones. In certain embodiments, the hearing aid system of the present disclosure may enhance a user's ability to distinguish near-homophones. For example, processor 210 may identify a word in the first audio signal, as described previously. Processor 210 may then access a database to determine a near homophone of the word. For example, the database may be stored in memory 220, or may be accessed through a mobile device such as computing device 120. The database may store a pre-populated list of near-homophones of the languages understood by the user. If no near-homophones are present in the database, processor 210 may move to analyze the next word in the first audio signal. Alternatively, if the word is present, processor 210 may compare the word in the received audio with an audio file or distinguishing characteristics to determine a difference between the word and the near homophone. Once a difference is identified, processor 210 may increase at least one of a volume or a duration of a phoneme corresponding to the difference. To illustrate, an individual near the user may say the word “his” which, in American English, is often pronounced as “hiz”. Processor 210 may determine that the individual said the word “his” and determine that the word “hiss” (pronounced in American English with an elongated, soft “s” sound) is a near homophone. Processor 210 may then determine a difference between “his” and “hiss” as being the pronunciation of the ending “s” and increase the volume of the segment of the first audio signal corresponding to the ending “s”. In this way, a user wearing the hearing aid system of the present disclosure may more clearly understand individuals.

After processor 210 has selectively conditioned a voice trait, if conditioning is required, processor 210 advances to step 5508 of process 5500A. In step 5508, process 5500A may cause transmission of the processed first audio signal to a hearing interface device configured to provide sound to an ear of the user. The first audio signal, for example, may be transmitted to a hearing interface device 1710 connected to a user's ear, or to two hearing interface devices connected to both of a user's ears, thereby providing sound corresponding to the received audio signals to user 100. In some embodiments, hearing interface 1710 device may include a speaker associated with an earpiece. For example, hearing interface device may be inserted at least partially into the ear of the user for providing audio to the user.

Hearing interface device 1710 may also be external to the ear, such as a behind-the-ear hearing device, one or more headphones, a small portable speaker, or the like. In some embodiments, hearing interface device may include a bone conduction microphone, configured to provide an audio signal to user through vibrations of a bone of the user's head. Such devices may be placed in contact with the exterior of the user's skin or may be implanted surgically and attached to the bone of the user.

In addition to voice signature matching process, hearing aid systems according to the present disclosure may also rely on visual identification techniques to identify an individual speaking. FIG. 55B is a flowchart showing an exemplary process for determining a voice trait based on visual identification of an individual consistent with disclosed embodiments. The visual identification method of process 5500B, shown in FIG. 55B, may be used in place of, or in conjunction with, step 5504 of process 5500A.

For example, apparatus 110 may include a wearable camera configured to capture a plurality of images from the environment of the user, and processor 210 may perform the steps of process 5500B. Thus, in step 5512, process 5500B may include receiving the plurality of images captured by the camera. For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that docs not substantially include the environment surrounding the person. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In step 5514, process 5500B may include identifying a representation of the individual in at least one of the plurality of images. The individual may be identified using various image detection algorithms, such as Haar cascade, histograms of oriented gradients (HOG), deep convolution neural networks (CNN), scale-invariant feature transform (SIFT), or the like. In some embodiments, processor 210 may be configured to detect visual representations of individuals, for example from a display device.

In some embodiments, step 5512 may include identifying at least one lip movement or lip position associated with a mouth of the individual, based on analysis of the plurality of images, to help identify the representation of the individual in the plurality of images, as described above by reference to FIG. 23. For example, many individuals may be within the field of view of camera 1760, but one person may be speaking. Thus, to determine how to selectively condition the first audio signal, processor 210 may identify a speaking individual from among a plurality of individuals. Processor 210 may further use various other techniques or characteristics, such as color, edge, shape, or motion detection algorithms to identify the face of individual 2310.

In step 5516, process 5500B may include determining, based on the representation, an IS identity of the individual. Step 5516 may include performing a facial analysis of an image of the individual. Accordingly, processor 210 may identify facial features on the face of the individual, such as the eyes, nose, cheekbones, jaw, or other features. Processor 210 may use one or more algorithms for analyzing the detected features, such as principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), or the like.

In step 5518, process 5500B may include accessing a memory to determine the at least one voice trait, the at least one voice trait being stored in association with the identity in the memory. For example, processor 210 may identify an individual in an image at step 5514. Processor 210 may further analyze the representation of the individual in the image at step 5516 to determine characteristics of the person's face. Then, processor 210 may compare the determined characteristics to a database having characteristic sets in association with identifiers of individuals, and obtain an individual's identifier, such as a name. At step 5518, processor 210 may access the same, or an alternate, database to obtain selective conditioning rules applicable for a voice trait of the identified individual. Further, as stated above, process 5500B may be combined with voice signature identification processes to provide greater certainty of an individual's identity, for instance, in cases where the individual's face is obscured by glasses or facial hair, or the individual's voice is obscured by ambient noise.

Selective Conditioning Based on Voice Signature and Lip Reading

Human beings have distinct and different voices. While some people have a good voice memory and can easily recognize their first primary school teacher, other people may have difficulty recognizing their closest friends only from their voice, especially when there are several voices in an environment. Therefore, there is a need to identify an active speaker or determine which voice of a plurality of voices to focus on. For example, when user 100 is at the park with his child, he may wish to amplify the voice of the child relative to the voices of other nearby children.

The disclosed hearing aid system may be configured to use voice signatures in conjunction with lip reading to selectively condition or otherwise process a voice of an individual. The hearing aid system may receive audio signals representing sounds captured by a microphone from an environment of a user. The sounds may be used to determine a voice signature of an individual, which may be stored. This voice signature may be used to identify individuals within the environment of the user. For example, the hearing aid system may determine whether an individual is recognized by the user by comparing the detected voice signature to stored voice signatures. The hearing aid system may also detect lip movements of the individual based on images received from the camera, which may also be used to identify an active speaker. While the voice signature detection and lip reading may be performed separately to identify individuals or an active speaker, each of these alone may result in some degree of uncertainty. When used in combination (i.e., a voice signature and lip reading), the hearing aid system may identify voices to be selectively conditioned, transcribed, or otherwise processed in a more efficient and/or effective manner.

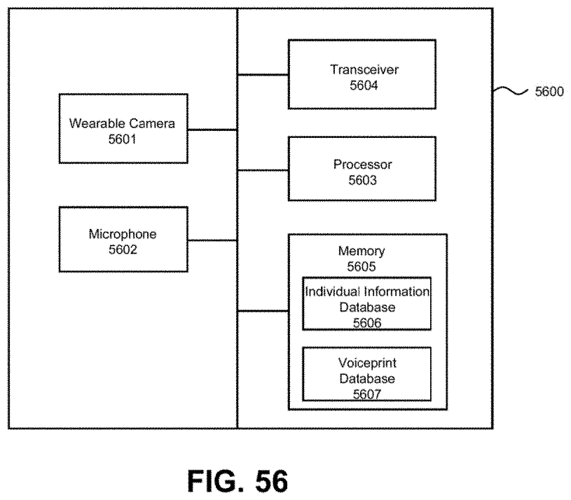

FIG. 56 is a schematic illustration of an exemplary hearing aid system 5600 for selectively conditioning sounds consistent with the disclosed embodiments. Hearing aid system 5600 is shown in FIG. 56 in a simplified form, and hearing aid system 5600 may include additional elements or may have alternative configurations, for example, as shown in FIGS. 5A-5C. As shown, hearing aid system 5600 includes a wearable camera 5601, a microphone 5602, a processor 5603, a transceiver 5604, and a memory 5605.

Wearable camera 5601 may be configured to capture a plurality of images from an environment of user 100. For example, wearable camera 5601 may be camera 1730, as described above. Wearable camera 5601 may have an image capture rate, which may be configurable by a user or based on predetermined settings. In some embodiments, wearable camera 5601 may include one or more cameras, which may each correspond to image sensor 220.

Microphone 5602 may be configured to capture sounds from the environment of user 100. For example, microphone 5601 may be microphone 1720, as described above. Microphone 5602 may include one or more microphones. Microphone 5602 may include a directional microphone, a microphone array, a multi-port microphone, or various other types of microphones. In some embodiments, microphone 5602 and wearable camera 5601 may be included in a common housing, such as the housing of apparatus 110.

Transceiver 5604 may be configured to transmit an audio signal to a hearing interface device (e.g., 1710) configured to provide sound to an ear of user 100. Transceiver 5604 may include one or more wireless transceivers. The one or more wireless transceivers may be any devices configured to exchange transmissions over an air interface by use of radio frequency, infrared frequency, magnetic field, or electric field. The one or more wireless transceivers may use any known standard to transmit and/or receive data (e.g., Wi-Fi, Bluetooth®, Bluetooth Smart, 802.15.4, or ZigBee). In some embodiments, transceiver 5604 may transmit data (e.g., raw image data, processed image and/or audio data, extracted information) from hearing aid system 5600 to the hearing interface device and/or server 250. Transceiver 5604 may also receive data from the hearing interface device and/or server 250. In some embodiments, transceiver 5604 may transmit data and instructions to an external feedback outputting unit 230.

Memory 5605 may include an individual information database 5606 and a voiceprint database 5607. Voiceprint database 5607 may include one or more voiceprints of one or more individuals. Individual information database 5606 may include information associating the one or more voiceprints stored in voiceprint database 5607 with the one or more individuals. The information associating the one or more voiceprints with the one or more individuals may include a mapping table. Individual information database 5606 may also include information indicating whether the one or more individuals are known to user 100. For example, the mapping table may further include information indicating a relationship of individuals to user 100. Optionally, memory 5605 may also include other components, for example, as shown in FIG. 20B. Optionally, memory 5605 may also include orientation identification module 601, orientation adjustment module 602, and monitoring module 603 as shown in FIG. 6. Individual information database 5606 and voiceprint database 5607 are shown within memory 5605 by way of example only, and may be located in other locations. For example, the databases may be located in hearing interface device 1710, on a remote server, or in another associated device. Individual information database 5606 and voiceprint database 5607 may be implemented within the same database, or may be implemented as two or more separate databases.

Processor 5603 may include one or more processing units. Processor 5603 may be programmed to receive a plurality of images captured by wearable camera 5601. Processor 5603 may also be programmed to receive a plurality of audio signals representative of sounds captured by microphone 5602. In an embodiment, processor 5603 may be included in the same housing as microphone 5602 and wearable camera 5601. In another embodiment, microphone 5602 and wearable camera 5601 may be included in a first housing, and processor 5603 may be included in a second housing. In such an embodiment, processor 5603 may be configured to receive the plurality of images and/or audio signals from the first housing via a wireless link (e.g., Bluetooth™, NFC, etc.). Accordingly, the first housing and the second housing may further comprise transmitters or various other communication components. Processor 5603 may be programmed to analyze the received plurality of audio signals to recognize a speech of an individual within the environment of user 100 using a voiceprint of the individual created ad-hoc or stored in memory 5605. Processor 5603 may also be programmed to detect, based on analysis of the plurality of images, at least one lip movement associated with a mouth of the individual. Processor 5603 may also be programmed to identify, based on at least one of a voice print or the detected lip movement, a first audio signal of the plurality of audio signals associated with a voice of the individual. Processor 5603 may also be programmed to cause selective conditioning or other processing of the first audio signal. Processor 5603 may also be programmed to cause transceiver 5604 to transmit the selectively conditioned first audio signal to a hearing interface device configured to provide sound to an ear of user 100.

In some embodiments, processor 5603 may be programmed to obtain a voice print of the individual. For example, a voice print may be identified based on a speech of the individual collected earlier in a conversation (e.g., when he individual spoke alone without further background noise). As used herein, “earlier” may refer to a preceding segment within the same event, or to a previous encounter during which a voice print has been created and stored. The first audio signal may then be recognized based on a combination of the voice print and the detected lip movement. In some embodiments, in causing selective conditioning of the first audio signal, processor 5603 may be programmed to amplify the first audio signal relative to at least one second audio signal of the plurality of audio signals or remove a background noise from the first audio signal. In some embodiments, in causing selective conditioning of the first audio signal, processor 5603 may be programmed to attenuate at least one second audio signal of the plurality of audio signals relative to the first audio signal, or filter out the at least one second audio signal of the plurality of audio signals. In some embodiments, in causing selective conditioning of the first audio signal, processor 5603 may be programmed to change a rate of the recognized speech or introduce one or more pauses between words or sentences of the recognized speech.

In some embodiments, identifying the first audio signal may include determining that the individual is known to user 100. Determining that the individual is known to user 100 may include retrieving information from individual information database 5606 stored in memory 5605. Individual information database 5606 may associate the voiceprint with the individual and/or an image of the individual.

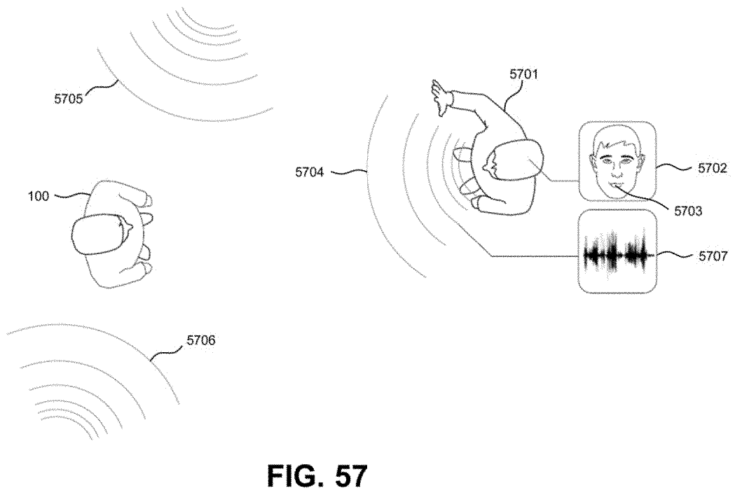

FIG. 57 is a schematic illustration showing an exemplary environment of user 100 of hearing aid system 5600 consistent with the disclosed embodiments. Hearing aid system 5600, worn by user 100 may be configured to capture a plurality of sounds 5704, 5705, and 5706, and identify one or more individuals within the environment of the user. For example, among the plurality of sounds 5704, 5705, and 5706, user 100 may wish to focus on sound 5704 originated from individual 5701. In some embodiments, individual 5701 may be a friend, colleague, relative, or prior acquaintance of user 100. In some embodiments, individual 5701 may be unknown to user 100. As shown in FIG. 57, hearing aid system 5600 may be configured to detect one or more movements of lips 5703 or recognize voice 5707 associated with an individual 5701 within the environment of user 100.

Hearing aid system 5600 may be configured to capture sounds 5704, 5705, and 5706 using microphone 5602. Sound 5704 is associated with the voice 5707 of individual 5701, and sounds 5705 and 5706 may be associated with additional voices or background noise in the environment of user 100. In some embodiments, the plurality of sounds may include speech or non-speech sounds by one or more persons and/or one or more objects in the vicinity of user 100, environmental sound (e.g., music, tones, or environmental noise), or the like. Processor 5603 may be configured to analyze the audio signal captured by microphone 5602 to separate sound 5704 associated with voice 5707 of individual 5701. For example, processor 5603 may use a pre-acquired voice print of individual 5701, who may be determined to be speaking. If individual 5701 is known to user 100, a previously stored voice print may be retrieved and used. For example, processor 5603 may access voiceprint database 5607, which may include one or more voiceprints corresponding to one or more individuals. Processor 5603 may compare a voiceprint representative of sound 5704 with voiceprints stored in voiceprint database 5607 to determine whether a better voiceprint exists in the database for individual 5701.

Hearing aid system 5600 may be configured to capture one or more facial images 5702 of individual 5701 using wearable camera 5601. Processor 5603 may be configured to analyze the captured facial images 5702 of individual 5701. For example, processor 5603 may be configured to detect one or more facial features of individual 5701, which may include, but is not limited to mouth 5703 of individual 5701, using one or more image processing techniques such as convolutional neural networks (CNN), scale-invariant feature transform (SIFT), histogram of oriented gradients (HOG) features, or other techniques, as described above with regard to FIGS. 23A-23C. Processor 5603 may also be configured to detect one or more points associated with mouth 5703 of individual 5701, and track movement of the lips of individual 5701 in real time. Based on the detected lip movements, processor 5603 may identify an audio signal associated with a sound 5704 of individual 5701 from among a plurality of audio signals. For example, processor 5603 may compare the timing of a detected lip movement with the timing of the voice patterns in the received audio signals to determine an audio signal corresponding to the lip movement. Thus, speech by individual 5701 may be identified as being separate from other signals and/or processed using lip reading in conjunction with a pre-acquired voice print. This combined analysis may provide improved results as compared to using each technique alone.

In some embodiments, before transmitting the audio signal associated with the sound 5704 of individual 5701, processor 5603 may be programmed to perform selective conditioning of the sound for user 100. In some embodiments, selective conditioning of the sound for user 100 may include amplifying the audio signal of the user relative to at least one second audio signal from the environment of the user or removing a background noise from the audio signal of the user. In some embodiments, selective conditioning of the sound for user 100 may include attenuating at least one second audio signal from the environment of the user relative to the audio signal of the user or filter out the at least one second audio signal. In some embodiments, selective conditioning of the sound for user 100 may include changing a rate of the user's speech or introduce one or more pauses between words or sentences of the user's speech.

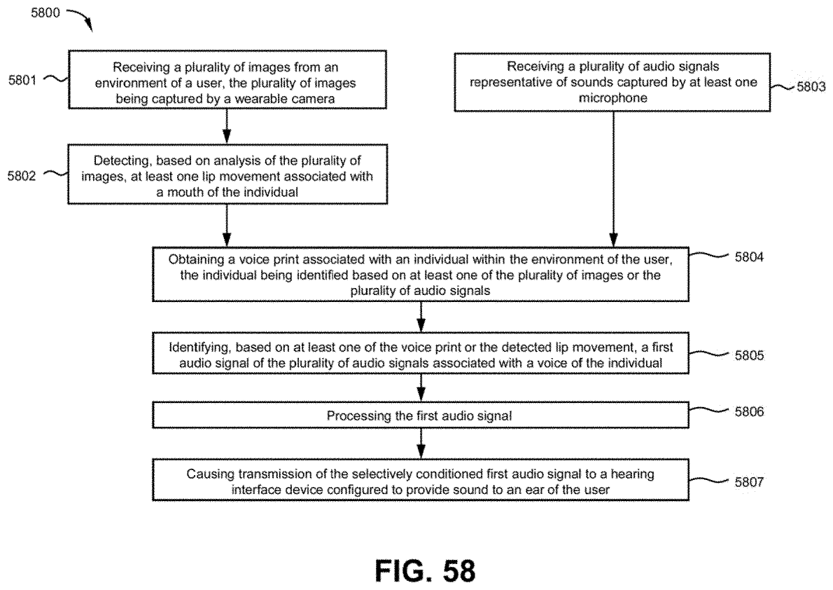

FIG. 58 is a flowchart showing an exemplary method 5800 for selectively conditioning or otherwise processing sounds in a hearing aid system consistent with the disclosed embodiments. Processor 5603 may perform process 5800 to selectively condition sounds from surrounding environment of user 100 after system 5600 captures an audio signal of speech of individual 5701 and/or images of individual 5701.

Method 5800 may include a step 5801 of receiving a plurality of images from an environment of a user. The plurality of images may be captured by a wearable camera. For example, at step 5801, processor 5603 may receive the plurality of images captured by wearable camera 5601. In some embodiments, the plurality of images may include facial images 5702 of individual 5701.

Method 5800 may include a step 5802 of detecting, based on analysis of the plurality of images, at least one lip movement associated with a mouth of the individual. For example, at step 5802, process 5603 may detect at least one lip movement or lip position associated with mouth 5703 of individual 5701, based on analysis of the plurality of images. Processor 5603 may identify one or more points associated with the mouth 5703 of individual 5701. In some embodiments, processor 5603 may develop a contour associated with mouth 5703 of individual 5701, which may define a boundary associated with the mouth or lips of the individual. The lips identified in the image may be tracked over multiple frames or images to identify the lip movement. Accordingly, processor 5603 may use various video tracking algorithms, as described above.

Method 5800 may include a step 5803 of receiving a plurality of audio signals representative of sounds captured by at least one microphone. For example, at step 5802, microphone 5602 may capture a plurality of sounds 5704, 5705, and 5706, and processor 5603 may receive a plurality of audio signals representative of the plurality of sounds 5704, 5705, and 5706. Sound 5704 is associated with the voice of individual 5701, and sounds 5705 and 5706 may be additional voices or background noise in the environment of user 100. In some embodiments, sounds 5705 and 5706 may include speech or non-speech sounds by one or more persons other than individual 5701, environmental sound (e.g., music, tones, or environmental noise), or the like.

Method 5800 may include a step 5804 of obtaining a voice print associated with an individual within the environment of the user. In some embodiments, the individual may be identified based on at least one of the plurality of images or the plurality of audio signals. For example, step 5804 may include using facial recognition, speech recognition, or other means for identifying the individual. The voice print may be obtained in various ways. In some embodiments, obtaining the voice print may comprise generating the voice print based on a previous audio signal associated with a speech of the individual. For example, this may include detecting a segment in which individual 5701 is speaking alone, and extracting a voice print of individual 5701 during that segment. In some embodiments, obtaining the voice print may comprise retrieving the voice print from a database based upon recognition of a speaker in at least one of the plurality of images. For example, individual 5701 may be identified by comparing a representation or feature of individual 5701 in one or more captured images to entries in individual information database 5606. Based on this comparison, a previous voice print of individual 5701 may be retrieved from voiceprint database 5607. The extracted voice print or the retrieved voice print may be used for analyzing the received audio signals to separate and process a speech of individual 5701. In some embodiments, if no previous voice print is available, or if the extracted voice print is of higher quality than the one retrieved from voiceprint database 5607 (e.g., generated upon audio captured in a quieter area, etc.), the newly generated voice print may be stored in addition to or instead of the previously stored voice print in the database. Step 5804 may use a trained model to determine whether or not an audio signal comprises speech associated with a particular voiceprint, or provide a probability that the audio signal comprises speech associated with the particular voiceprint. In some embodiments, only steps 5801 and 5802 may occur so that only lip reading is performed. In some embodiments, only steps 5803 and 5804 may occur so that only voice signature detection is performed. In some embodiments, all the steps 5801-5804 may occur so that both lip reading and voice signature detection are performed.

Method 5800 may include a step 5805 of identifying, based on at least one of the voice print or the detected lip movement, a first audio signal of the plurality of audio signals associated with a voice of individual 5701. For example, this may include separating the first audio signal from one or more audio signals not associated with the individual. For example, at step 5805, processor 5603 may identify, based on at least one of the voice print created or retrieved at step 5804 or the lip movement detected at step 5802, an audio signal associated with the voice 5707 of individual 5701 from among a plurality audio signals associated with sound 5704, 5705, and 5706. In some embodiments, processor 5603 may identify the audio signal associated with the voice of individual 5701 from among the plurality audio signals based on a combination of the voice print obtained at step 5804 and the detected lip movement at step 5802. Once the first audio signal is separated, processor 5603 may compare detected specific lip movements to phonemes or other features recognized in the first audio signal, as described above. In some embodiments, identifying the first audio signal may comprise determining that the individual is known to the user. Determining the individual is known to the user may comprise retrieving information from a database stored in a memory, the database associating the voiceprint with the individual. For example, the information in the database associating the one or more voiceprints with the one or more individuals may include a mapping table, which may further include the information indicating whether the one or more individuals are known to user 100 and their relationship to user 100. Processor 5603 may access individual information database 5606 to retrieve the individual information stored in memory 5605 and determine whether the individual is known to the user.

Method 5800 may include a step 5806 of processing the first audio signal. In some embodiments, the processing may include a selective conditioning, as described throughout the present disclosure. For example, at step 5806, processor 5603 may perform various forms of selective conditioning of the audio signal associated with the voice of individual 5701. In some embodiments, processing the first audio signal may include amplifying the first audio signal relative to at least one second audio signal of the plurality of audio signals or removing a background noise of the first audio signal. For example, processor 5603 may amplify the audio signal associated with the voice of individual 5701 relative to at least one of the audio signals associated with sounds 5705 and 5706. Amplification may be performed by various means, such as operation of a directional microphone, varying one or more parameters associated with the microphone, or digitally processing the audio signals. Processor 5603 may also remove background noise of audio signal associated with the voice of individual 5701. In some embodiments, processing the first audio signal may include attenuating at least one second audio signal of the plurality of audio signals relative to the first audio signal or filtering out the at least one second audio signal of the plurality of audio signals. For example, processor 5603 may selectively attenuate at least one of audio signals associated with sounds 5705 and 5706, or filter out the at least one of audio signals associated with sounds 5705 and 5706. In some embodiments, processing the first audio signal may include changing a rate of the recognized speech or introducing one or more pauses between words or sentences of the recognized speech. For example, processor 5603 may change a rate of the recognized speech associated with the audio signal associated with the voice of individual 5701 or introduce one or more pauses between words or sentences of the recognized speech associated with the audio signal associated with the voice of individual 5701. In some embodiments, processing the first audio signal may include changing the tone of the audio signal associated with the voice of individual 5701. In some embodiments, processing the first audio signal may include transcribing the first audio signal.

Method 5800 may include a step 5807 of causing transmission of the selectively conditioned first audio signal to a hearing interface device configured to provide sound to an ear of the user. For example, transceiver 5604 may transmit the conditioned audio signal to a hearing interface device, such as hearing interfact device 1710, which may provide sound corresponding to the audio signal associated with the voice of individual 5701 to user 100. In some embodiments, the hearing interface device may include a speaker associated with an earpiece. For example, hearing interface device may be inserted at least partially into the ear of the user for providing audio to the user. The hearing interface device may also be external to the ear, such as a behind-the-ear hearing device, one or more headphones, a small portable speaker, or the like. In some embodiments, the hearing interface device may include a bone conduction headphone 1711 (such as bone conduction headphone 1711, discussed above), configured to provide an audio signal to user through vibrations of a bone of the user's head. Such devices may be placed in contact with the exterior of the user's skin, or may be implanted surgically and attached to the bone of the user.

In some embodiments, memory 5605 may include a non-transitory computer readable storage medium storing program instructions which are executed by processor 5603 to perform the method 5800 as described above.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1-161. (canceled)

162. A hearing aid system for selectively substituting signals, the hearing aid system comprising:
a wearable camera configured to capture a plurality of images from an environment of a user;
at least one microphone configured to capture sounds from the environment of the user; and
at least one processor programmed to:
receive the plurality of images captured by the camera;
receive a plurality of audio signals representative of the sounds captured by the at least one microphone;
identify, based on analysis of the plurality of images or the plurality of audio signals, an audio signal from among the plurality of audio signals associated with a sound-emanating object in the environment of the user;
predict, based on the plurality of audio signals, a sound that will be received at the ear of the user from the environment of the user;
generate a cancelation audio signal configured to neutralize at least the predicted sound at the ear of the user;
generate a selectively conditioned audio signal based on the identified audio signal; and
transmit the cancelation audio signal and the selectively conditioned audio signal to a hearing aid interface device configured to provide sound to the ear of the user.

163. The hearing aid system of claim 162, wherein the at least one processor is further programmed to:
determine a time delay between when the plurality of audio signals are received and when the predicted sound will be received at the ear of the user; and
transmit the cancelation audio signal at a time based on the time delay.

164. The hearing aid system of claim 163, wherein the time delay is determined at least partially based on a speed of sound traveling through air.

165. The hearing aid system of claim 163, wherein the time delay is determined at least partially based on a position of the sound emanating object relative to the at least one microphone and the hearing aid interface device.

166. The hearing aid system of claim 163, wherein the position of he sound emanating object is determined based on the plurality of images.

167. The hearing aid system of claim 163, wherein the time delay is determined at least partially based on an input from a user.

168. The hearing aid system of claim 167, wherein the input is received through a user interface of an external device.

169. The hearing aid system of claim 162, wherein the selective conditioning comprises amplifying the identified audio signal relative to an additional audio signal of the plurality of audio signals.

170. The hearing aid system of claim 162, wherein the sound-emanating object is an individual.

171. The hearing aid system of claim 162, wherein the cancelation audio signal is further configured to neutralize at least one additional sound from the environment of the user.

172. A method for selectively substituting audio signals, the method comprising:
receiving a plurality of images captured by a wearable camera from an environment of a user;
receiving a plurality of audio signals representative of sounds captured by at least one microphone from the environment of the user;
identifying, based on analysis of the plurality of images or the plurality of audio signals, an audio signal from among the plurality of audio signals associated with a sound-emanating object in the environment of the user;
predicting, based on the plurality of audio signals, a sound that will be received at the ear of the user from the environment of the user;
generating a cancelation audio signal configured to neutralize at least the predicted sound at the ear of the user:
generating a selectively conditioned audio signal based on the identified audio signal; and
transmitting the cancelation audio signal and the selectively conditioned audio signal to a hearing aid interface device configured to provide sound to the ear of the user.

173. The method of claim 172, wherein the method further comprises:
determining a time delay between when the plurality of audio signals are received and when the predicted sound will be received at the ear of the user; and
transmitting the cancelation audio signal at a time based on the time delay.

174. The method of claim 173, wherein the time delay is determined at least partially based on a speed of sound traveling through air.

175. The method of claim 173, wherein the time delay is determined at least partially based on a position of the sound emanating object relative to the at least one microphone and the hearing aid interface device.

176. The method of claim 175, wherein the position of the sound emanating object is determined based on the plurality of images.

177. The method of claim 173, wherein the time delay is determined at least partially based on an input from a user.

178. The method of claim 177, wherein the input is received through a user interface of an external device.

179. The method of claim 172, wherein the selective conditioning comprises amplifying the identified audio signal relative to an additional audio signal of the plurality of audio signals.

180. The method of claim 172, wherein the sound-emanating object is an individual.

181. The method of claim 172, wherein the cancelation audio signal is further configured to neutralize at least one additional sound from the environment of the user.

182-250. (canceled)
